(19) United States
(12) Patent Application Publication
(10) Pub. No.: US 2021/0314419 A1
(43) Pub. Date: Oct. 7, 2021

(54) DIRECT NETWORK CONNECTIONS USING CLOUD INSTANCE FOR INTERNET APPLICATION SERVICES

(71) Applicant: Kang Wing LEUNG, Hong Kong (CN)

(72) Inventor: Kang Wing LEUNG, Hong Kong (CN)

(21) Appl. No.: 16/837,097

(22) Filed: Apr. 1, 2020

(51) Int. Cl. H04L 29/08; G06F 9/54; G06F 9/455; H04L 29/12

(52) U.S. Cl. CPC H04L 67/32; G06F 9/547; G06F 9/45558; G06F 2009/45595; H04L 67/10; H04L 67/141; H04L 67/02; H04L 61/2007

(57) ABSTRACT

Direct network connections using cloud instance for Internet application services is provided between two or more computers on a network. A first computer sends a request to start an Internet application service to a server. The server requests a computing cloud to launch a cloud instance for the first computer. The computer cloud launches a bank of cloud instances offering the Internet application service. The computing cloud attempts to connect to the cloud instances, and selects the fastest cloud instance to respond as the first computer cloud instance. The first computer cloud instance sends its connection information to the server. A second computer may make a request to the server to join the Internet application service of the first computer. The server sends to the second computer the connection information for the first computer cloud instance. The second computer uses the connection information for the first computer cloud instance to send to the first computer cloud instance connection information for the second computer via direct network connection. From this point on, the first computer and the second computer exchange data for the Internet application service via a direct network connection using the first computer cloud instance, independently of the server.

### CROSS-REFERENCE TO RELATED APPLICATION

This application claims priority under 35 U.S.C. § 119(e) from co-pending U.S. Provisional Patent Application No. 62/827,202 entitled “Direct Network Connections using Cloud Instance for Internet Application Service”, filed on Apr. 1, 2019, which is incorporated by reference herein in its entirety.

### BACKGROUND OF THE INVENTION

### 1. Field of the Invention

The present invention relates to creating network connections within computer networks. More specifically, the present invention relates to creating direct network connections between computers using cloud instance via the Internet.

### 2. Description of the Related Art

A first computer on a network (e.g., the Internet) may host Internet application service with a second computer on the network, to facilitate a variety of activities, including website service (e.g. Global 2000's websites such as Amazon.com), database service (e.g. Oracle Database), desktop applications service (e.g. Microsoft Office), e-commerce service, etc. For example, a user may use the first computer to host an Internet application service and add a second computer as a client computer. Users of one or more other computers on the network may join the Internet application service hosted by the first computer. However, in order for computers to do Internet application service with one another over a computer network, a network connection must first be created between the computers.

Referring now to FIG. 1, an (U.S. patent application Ser. No. 15/396,347) architecture for creating network connections between two computers is illustrated. The architecture includes a host computer 205, a client computer 215, and a server 222A providing a website 212A. The server 222A requests a computing cloud (not shown) to launch a host computer cloud instance 205-C for the host computer 205, and stores the connection information for the host computer cloud instance 205-C. If the client computer 215 wants to do Internet application service with the host computer 205, the client computer 215 may make a request to the server 222A. The server 222A sends to the client computer 215 the connection information it has stored for the host computer cloud instance 205-C. The client computer 215 uses the connection information for the host computer cloud instance 205-C to send to the host computer cloud instance 205-C connection information for the client computer 215 via a direct network connection 245. From this point on, the host computer 205 and the client computer 215 exchange data for Internet application service via direct network connections 240, 245 using the host computer cloud instance 205-C, independently of the server.

Table 1 of FIG. 1 is from Table 1 of FIG. 39A of (prior art) U.S. patent application Ser. No. 15/396,347 (which (prior art) “U.S. patent application Ser. No. 15/396,347” is incorporated by reference herein in its entirety), and shows the table of number of (virtualized)-hardware (implemented in the host computer cloud instance 205-C) for maximum users (of an Internet application service Moodle LMS on the LAMP (Linux, Apache server, MySQL database, and PHP language) platform) from 100 to 400,000. FIG. 39B (of prior art, not shown) allows the the computing cloud (not shown) dynamically or via prior-planning to have the needed bandwidth and computing resources for the host computer cloud instance 205-C, when varying numbers (from one to 400,000) of the client computers 215 are joining the Moodle learning management system (or simply the LAMP platform popular for websites) Internet application service hosted by the host computer 205.

FIG. 1 illustrates that prior art: “U.S. patent application Ser. No. 15/396,347”, has the first drawback of needing to contact Amazon-(or-other-computing-cloud-vendors) (to customize) if the number-of-(virtualized)-hardware (in host computer cloud instance 205-C in FIG. 1) is greater-than-or-equal-to 100X (in FIG. 1, row C, columns VIII-to-X) for maximum-concurrent-users of 4,001-to-400,000 (in FIG. 1's Table 1, row B, columns VIII-to-X) respectively. A second drawback is that today(-in-2019) Amazon-(or-other-computing-cloud-vendors) may not have the technology (e.g. 4000X virtualized-hardware (or many-times-more-hardware, in one cloud-instance) to support 400,000 (or many-times-more) concurrent-users) for the customization in above first drawback. A third drawback is that the prior art (U.S. patent application Ser. No. 15/396,347) does not mention when-to-do increase-(or-decrease) virtualized-hardware of host-computer-cloud-instance 205-C, e.g. needed-or-desired to increase-(or-decrease) virtualized-hardware when host-computer-cloud-instance's response-time/Level-of-Service (LOS) is outside the targeted-range (illustrated in FIG. 2A's Table 2's columns II-to-V, and described in Para [0045E] below for FIG. 4's Table 3). A fourth drawback is that if (#-of-1X)-virtualized-hardware is greater than 100X in the cloud instance, the cloud vendor (e.g. Amazon.com) needs to be contacted (to pre-arrange/customize, as illustrated in FIG. 1's Table-1's row-“E”-and-columns-“V”-to-“X”). A fifth drawback is that there is a maximum number of concurrent users (e.g. maximum-number-of-400,000-users in FIG. 1-(Prior-Art) Table-1's rows-A-&-B), which may pose problems in Internet-of-Things (IoT) applications using 5G technology, where number of connected devices-(users) can be in the many-millions-(and-billion(s)).

### SUMMARY OF THE INVENTION

Embodiments of the present invention include a method of providing Internet application services via direct network connections using cloud instance between two or more computers on a network to facilitate a variety of activities, including website service (e.g. Global 2000's websites such as Amazon.com), database service (e.g. Oracle Database), desktop applications service (e.g. Microsoft Office), and e-commerce service, etc.

A “cloud instance” refers to a virtual machine instance from a public or private cloud network. In cloud instance computing, single hardware is implemented into software and run on top of single-or-multiple computers. For a user, the network elements representing the provider-rendered services are invisible, as if obscured by a cloud.

In one embodiment, a first computer sends its connection information to a server. The server requests a computing cloud to launch-or-assign a cloud instance for the first computer. The computing cloud launches-or-assigns a bank of cloud instances (each of which offering the Internet application service of the first computer). The computing cloud attempts to connect to any available cloud instance (of the bank), and selects the fastest cloud instance (of the bank) to respond as the first computer cloud instance. The server stores the connection information for the cloud instance of the first computer. The server also sends the connection information of the first computer to the cloud instance of the first computer, which is communicatively coupled to the first computer. If a second computer wants to do the Internet application service (of the first computer) with the first computer, the second computer may make a request to the server. The server sends to the second computer the connection information it has stored for the cloud instance of the first computer. The second computer uses the connection information for the cloud instance of the first computer to send to the cloud instance of the first computer connection information for the second computer via a direct network connection. From this point on, the first computer and the second computer exchange data for the Internet application service via direct network connections using the cloud instance of the first computer, independently of the server.

In another embodiment, the first computer may be in a private network and may not be publicly accessible over a network. However, as described below, the first computer is communicatively coupled to a cloud instance of the first computer which can be publicly accessed over the network. The first computer sends its connection information to a server. The server requests a computing cloud to launch-or-assign a cloud instance for the first computer. The computing cloud launches-or-assigns a bank of cloud instances (each of which offering the Internet application service of the first computer). The computing cloud attempts to connect to any available cloud instance, and selects the fastest cloud instance to respond as the first computer cloud instance. The server stores the connection information for the cloud instance of the first computer. The cloud instance of the first computer is communicatively coupled to the first computer. If a second computer wants to do Internet application service with the first computer, the second computer may make a request to the server to connect to the first computer. The server sends to the second computer the connection information it has stored for the cloud instance of the first computer. The second computer uses the connection information for the cloud instance of the first computer to send to the cloud instance of the first computer connection information for the second computer via a direct network connection. From this point on, the cloud instance of the first computer and the second computer exchange data for the Internet application service via direct network connections using the cloud instance of the first computer, independently of the server; and the cloud instance of the first computer is communicatively coupled to the first computer in the private network.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 is a block diagram illustrating prior art: “U.S. patent application Ser. No. 15/396,347” for direct network connections using cloud instance for Internet application service over a computer network.

FIG. 2A is a block diagram illustrating providing direct network connections using cloud instance for Internet application service over a computer network in accordance with an embodiment of the present invention.

FIGS. 2B, 2C, 2D are block diagrams illustrating computers with which an embodiment of the present invention may be used.

FIG. 2E illustrates Overview of Virtualization (of hardware implemented in software) in accordance with another embodiment of the present invention.

FIG. 3 is a snapshot of a web page hosted by an Internet application service server in accordance with an embodiment of the present invention.

FIG. 4 shows tables illustrating maximum-users for different-(virtualized)-hardware (in Table 1), maximum-users for different-banks-of-cloud-instances (in Table 2), and targeted response-time for cloud-instances (in Table 3), using cloud instance for Internet application service in accordance with an embodiment of the present invention.

FIG. 5 illustrates examples of banks-of-cloud-instances (in column 1), different host computers, and their maximum-#-of-concurrent-users (in column 3) for Intend application services, in accordance with an embodiment of the present invention.

FIG. 6 shows tables of features of Amazon EC2 cloud offering, and Amazon EC2 cloud-instance response-time in 2010.

FIG. 7 shows charts of response-time (in milliseconds) of small, medium, and large instances (in 2010) of Amazon EC2 cloud-instances.

FIGS. 8A and 8B show examples of virtualized-hardware's Windows-task-manager showing ˜0%-H/W-usage with no-client-load (in 2018).

FIGS. 9A and 9B are block diagrams illustrating providing direct network connections using cloud instance for Internet application service over a computer network in accordance with another embodiment of the present invention.

FIGS. 9C-to-9H, and 9J have tables illustrating examples of bank(s) of cloud instances, providing direct network connections using cloud instance for Internet application service over a computer network in accordance with an embodiment of the present invention.

FIGS. 9K and 9L ping software response and time-out examples.

FIGS. 9I, 10A-to-10L, 11A, 11B, and 11C are flow-charts illustrating providing direct network connections using cloud instance for Internet application service over a computer network in accordance with an embodiment of the present invention.

FIGS. 12, 13A, 13B, and 13C are flow-charts illustrating providing direct network connections using cloud instance for Internet application service over a computer network in accordance with an embodiment of the present invention.

FIGS. 14A, 14B, 15A, 15B, and 15C are flow-charts illustrating providing direct network connections using cloud instance for Internet application service over a computer network in accordance with an embodiment of the present invention.

FIGS. 16, 17A, 17B, and 17C are flow-charts illustrating providing direct network connections using cloud instance for Internet application service over a computer network in accordance with an embodiment of the present invention.

FIGS. 18A-to-18F are tables illustrating providing direct network connections using cloud instance for Internet application service over a computer network in accordance with an embodiment of the present invention.

FIGS. 19A-to-19L are flowcharts illustrating providing direct network connections using cloud instance for Internet application service over a computer network in accordance with another embodiment of the present invention.

FIGS. 19M, 19N, 19O, 19P, and 19Q are flowcharts illustrating providing direct network connections using cloud instance for Internet application service over a computer network in accordance with another embodiment of the present invention.

FIGS. 20A, 20B, 20C, 20D are flowcharts illustrating providing direct network connections using cloud instance for Internet application service over a computer network in accordance with another embodiment of the present invention.

FIGS. 21A and 21B are block diagrams illustrating providing direct network connections using cloud instance for Internet application service over a computer network in accordance with an embodiment of the present invention.

FIGS. 22 and 23 are tables illustrating providing direct network connections using cloud instance for Internet application service over a computer network in accordance with an embodiment of the present invention.

FIGS. 24A, 24B, 24C are flow-charts illustrating providing direct network connections using cloud instance for Internet application service over a computer network in accordance with an embodiment of the present invention.

FIGS. 25, 26A, 26B, 26C, 26D are flow-charts illustrating providing direct network connections using cloud instance for Internet application service over a computer network in accordance with an embodiment of the present invention.

FIGS. 27A and 27B are block diagrams illustrating providing direct network connections using cloud instance for Internet application service over a computer network in accordance with an embodiment of the present invention.

FIGS. 27C-to-27H are tables illustrating providing direct network connections using cloud instance for Internet application service over a computer network in accordance with an embodiment of the present invention.

FIGS. 28A, 28B are flow-charts illustrating providing direct network connections using cloud instance for Internet application service over a computer network in accordance with an embodiment of the present invention.

FIGS. 29A (for mobile) and 29B (for 5G) are tables of Amazon Cloud-Instance Pricing (strawman) with targeted-response-time/LOS (in columns III-to-VI), to illustrate providing direct network connections using cloud instance for application services over a computer network in accordance with another embodiment of the present invention.

FIGS. 29C-and-29D are conceptual sketches for 5G. 5G is next-generation global mobile communications including Massive Machine Type Communications (mMTC) (illustrated in FIG. 29D), such as auto-(automatic-driverless)-driving (illustrated in FIG. 29C), intelligent transport/E-vehicles, E-health, office/home automation, industrial automation, intelligent building, smart-grid/utilities.

5G (and mobile communications) may also be used to implement the present invention providing direct network connections using cloud instance for application services over a computer network.

FIGS. 30A-to-30H are block diagrams illustrating providing direct network connections using cloud instance for Internet application service over a computer network in accordance with an embodiment of the present invention.

FIGS. 31A-to-31F are tables illustrating providing direct network connections using cloud instance for Internet application service over a computer network in accordance with an embodiment of the present invention.

FIGS. 32A-to-32H are block diagrams illustrating providing direct network connections using cloud instance for Internet application service over a computer network in accordance with an embodiment of the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Architectural Considerations

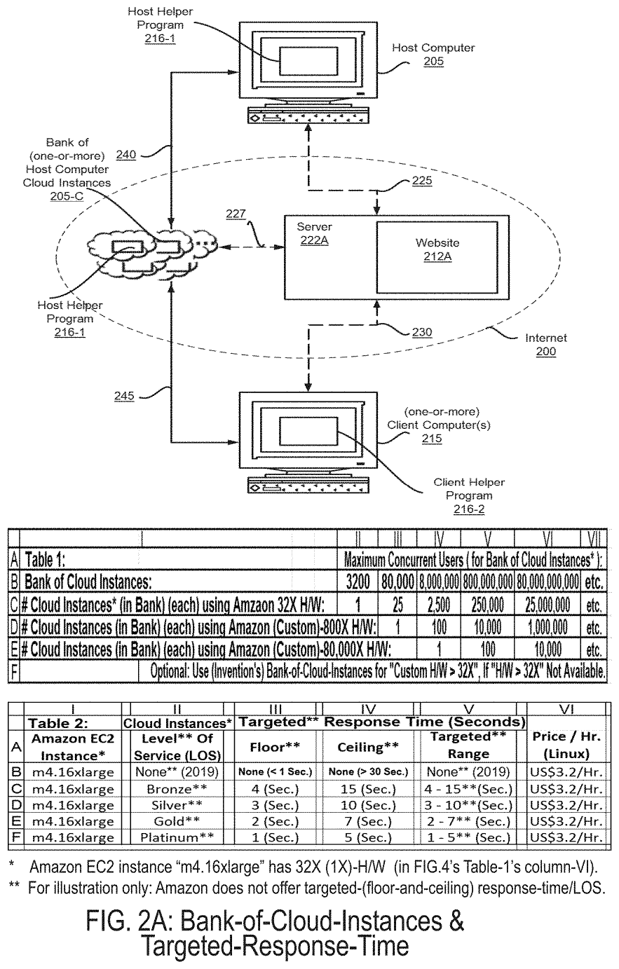

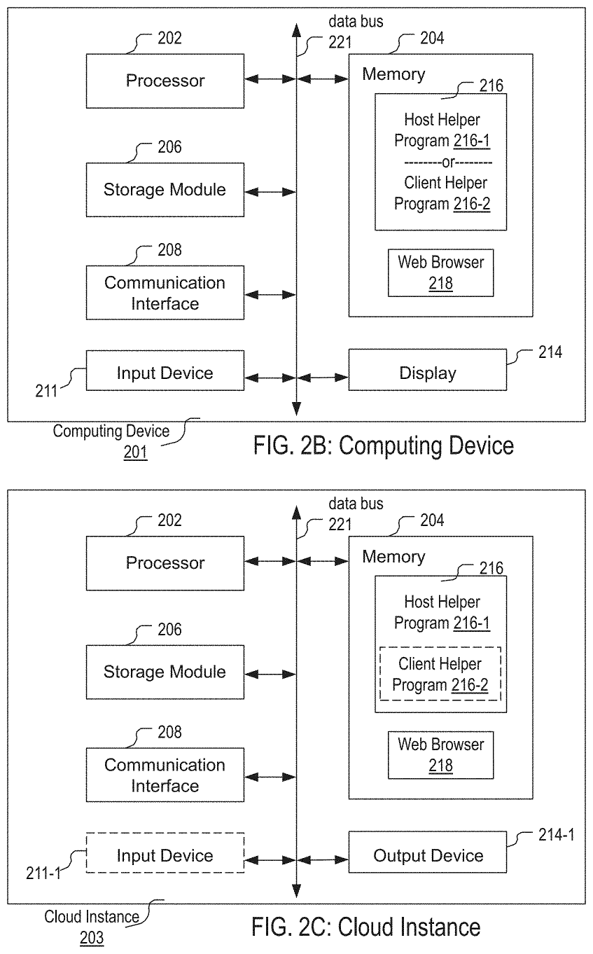

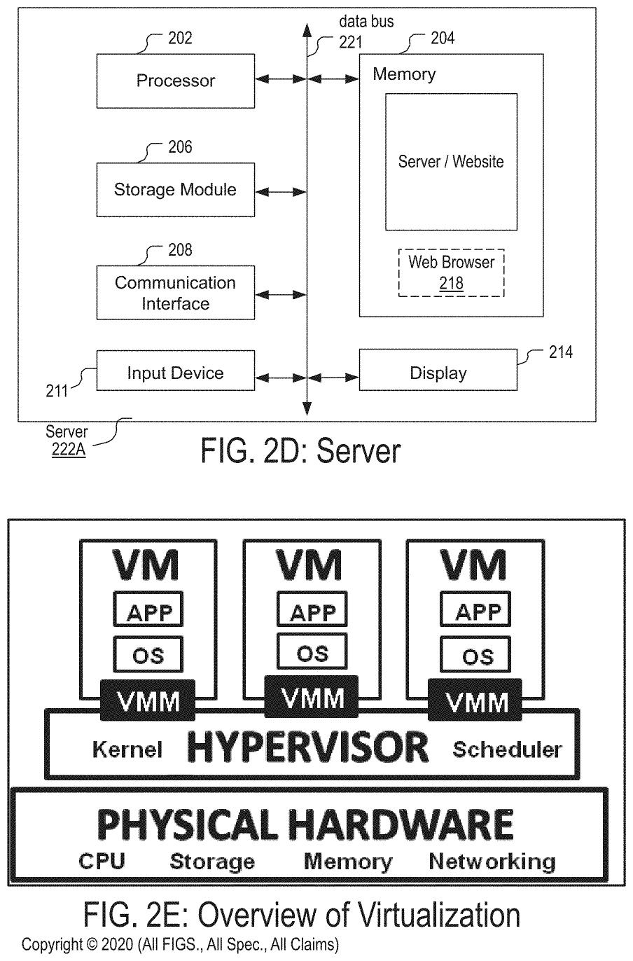

FIG. 2A's Table 1: “Bank of Cloud Instances” is identical to FIG. 4's Table 2, which is described in Para [0044](ii)-(on-Table-2), and Para [0045A]-to-[0045D]-(on-Table-2) below.

FIG. 2A's Table 2: “Cloud Instances' Targeted-Response-Times” is identical to FIG. 4's Table 3, which is described in Para [0044](iii)-(on-Table-3), and Para [0045E]-to-[0045G]-(on-Table-3) below.

FIG. 2A illustrates providing a network connection between two networked computers in accordance with one embodiment of the present invention. The embodiment illustrated by FIG. 2A comprises a host computer 205, (one-or-more) client computer(s) 215, and a server 222A hosting a website 212A. In one embodiment, the host computer 205, the (one-or-more) client computer(s) 215, and the server 222A are each connected to the Internet 200. The host computer 205 runs a host helper program 216-1 and the (one-or-more) client computer(s) 215 (each) runs a client helper program 216-2. In direct network connections using cloud instance, the host computer 205 and the (one-or-more) client computer(s) 215 exchange data via direct network connections 240, 245 using the bank of (one-or-more) host computer cloud instance(s) 205-C: (a) each (of the (one-or-more) host computer cloud instance(s) 205-C) uses the host helper program 216-1, and (b) each of the (one-or-more) client computer(s) 215 uses the client helper program 216-2, and they will be explained in further detail below.

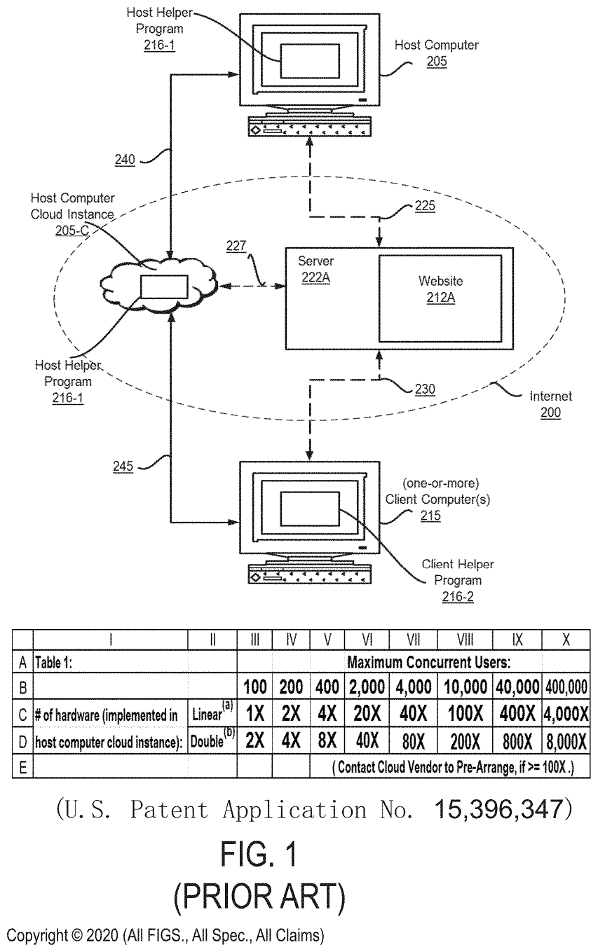

For computers 205, 215 coupled to the Internet, an associated IP address provides a distinct destination to which data may be sent and from which data may be received. In prior art, as illustrated in FIG. 1, two computers 205, 215 must somehow obtain one another's IP addresses before any data exchange between them may occur. In the embodiment depicted in FIG. 2A, the computers 205, 215 are each coupled to the Internet 200. The server 222A hosts a website 212A. A user of a computer 205, 215 may access the website 212A, log in to an account (e.g. supply the website 212A with a username and an associated password), and interact with the website 212A to select from a variety of services offered by the server 222A.

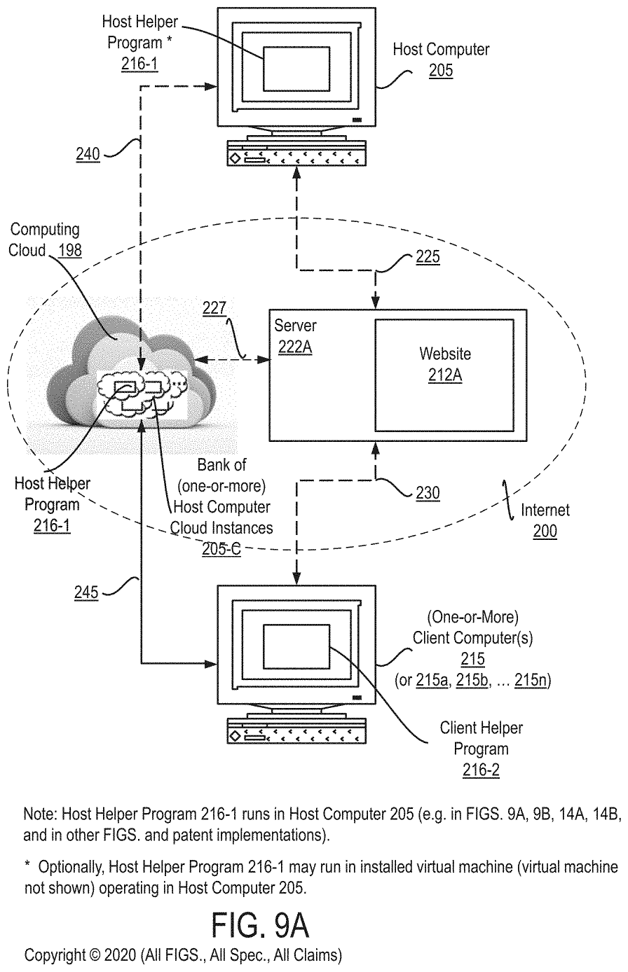

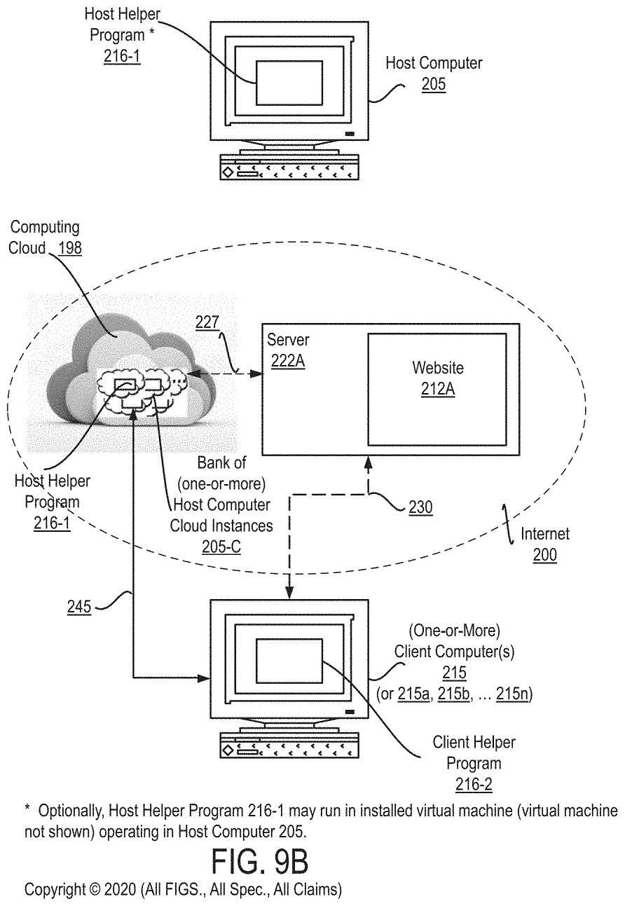

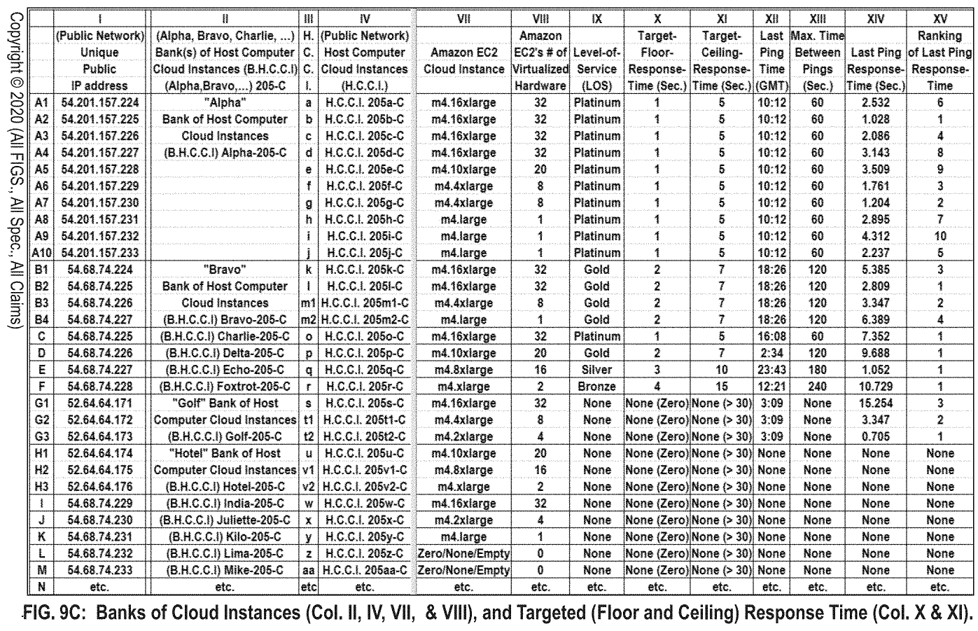

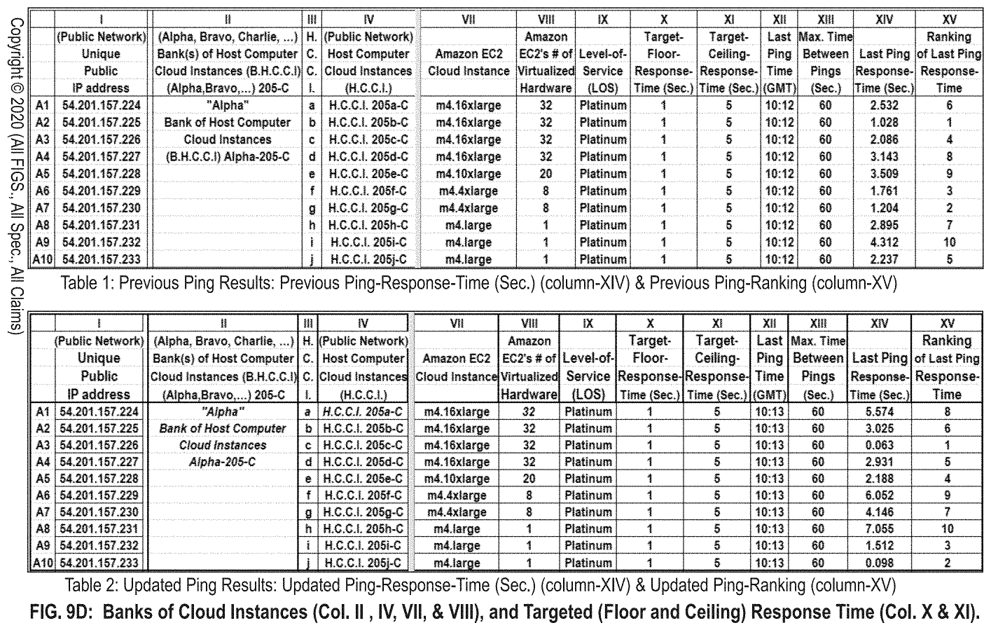

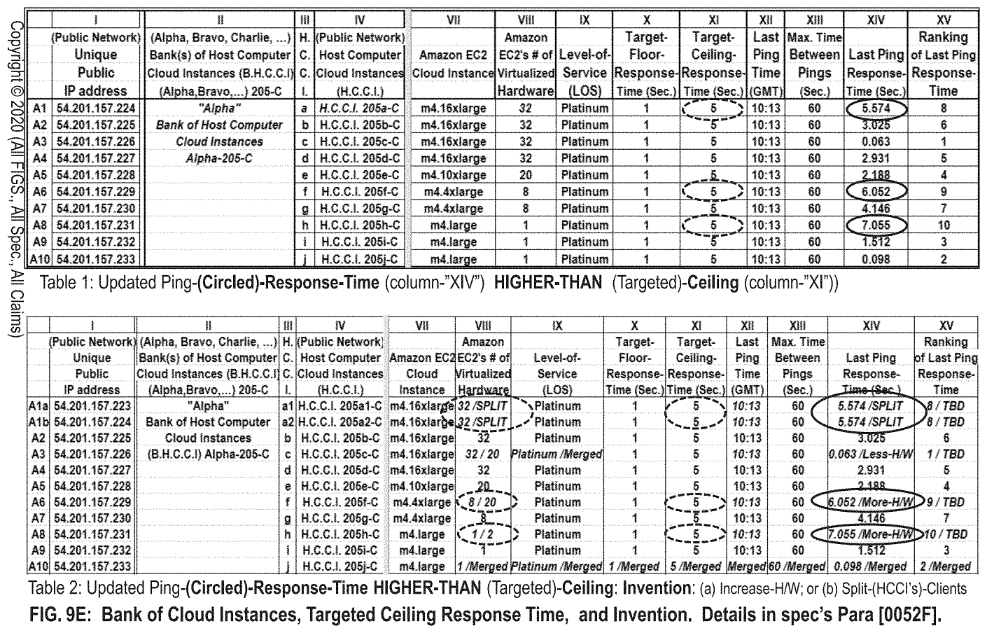

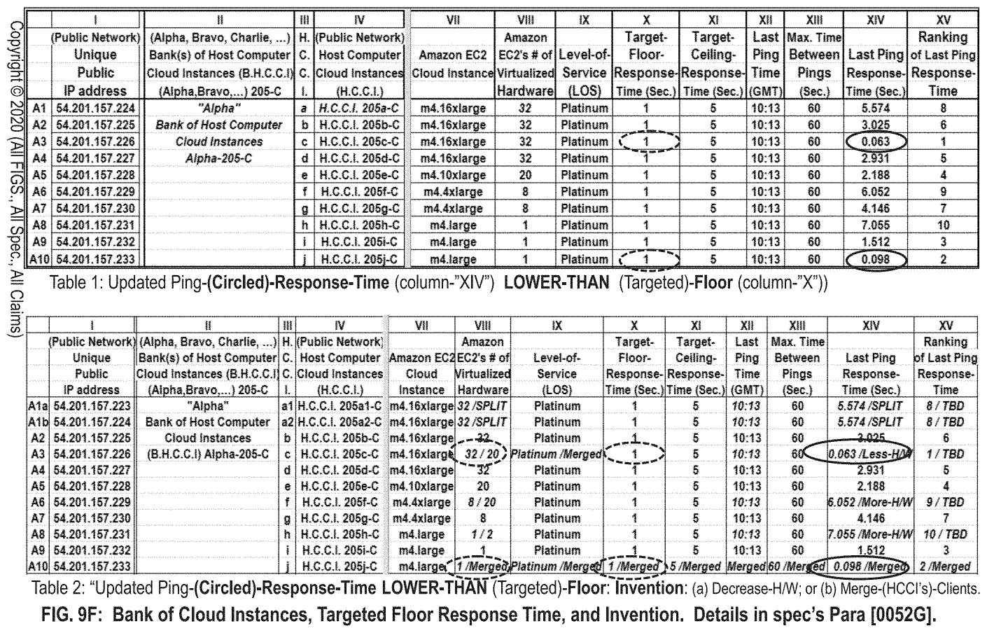

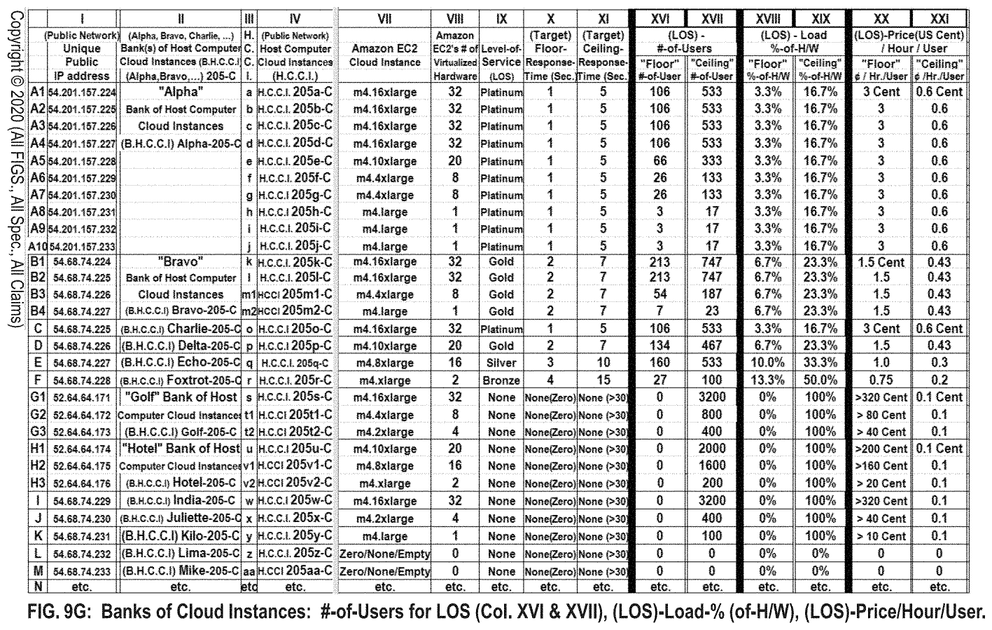

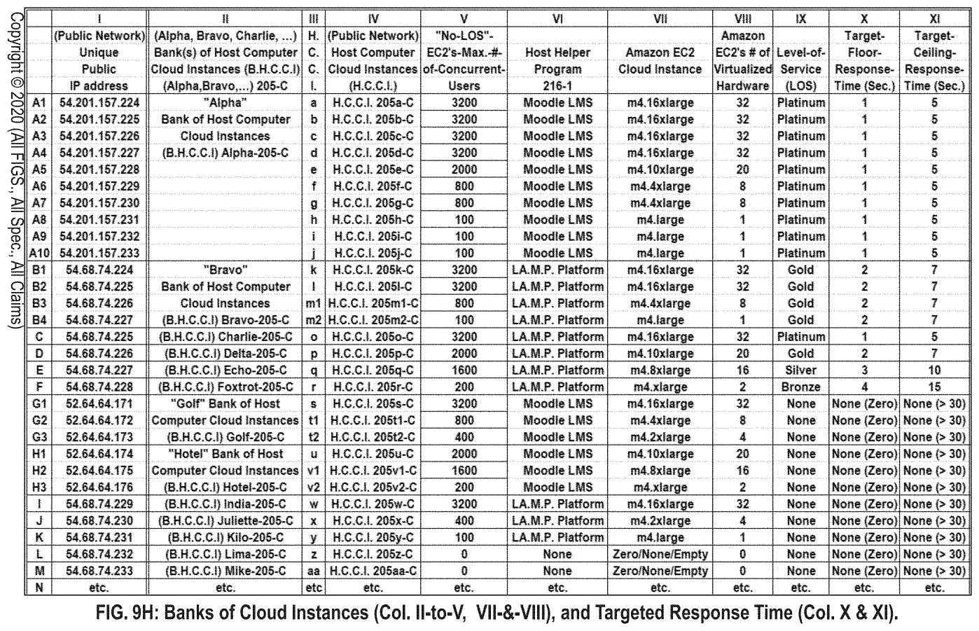

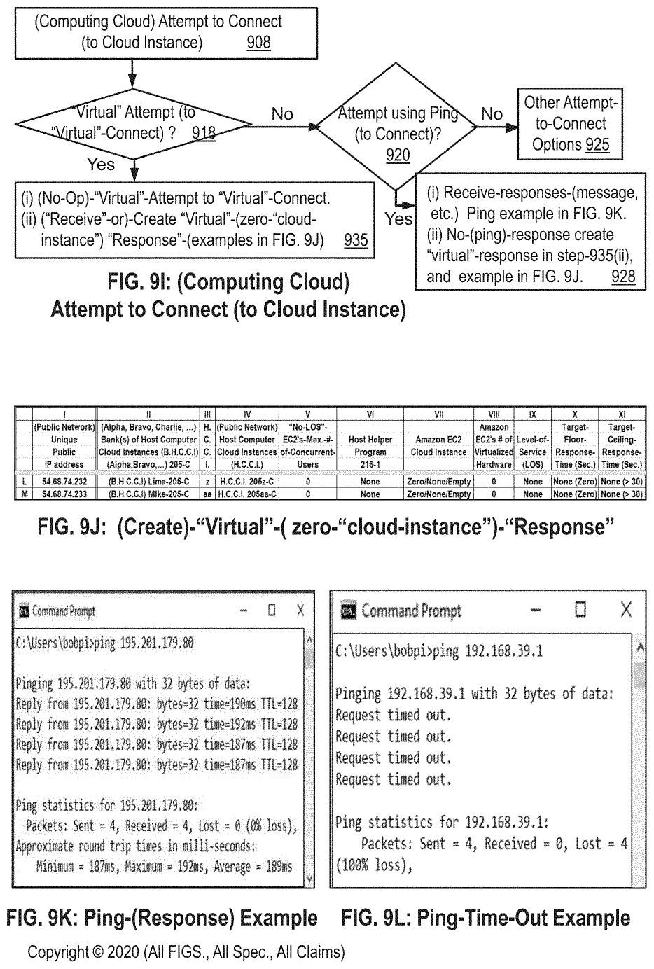

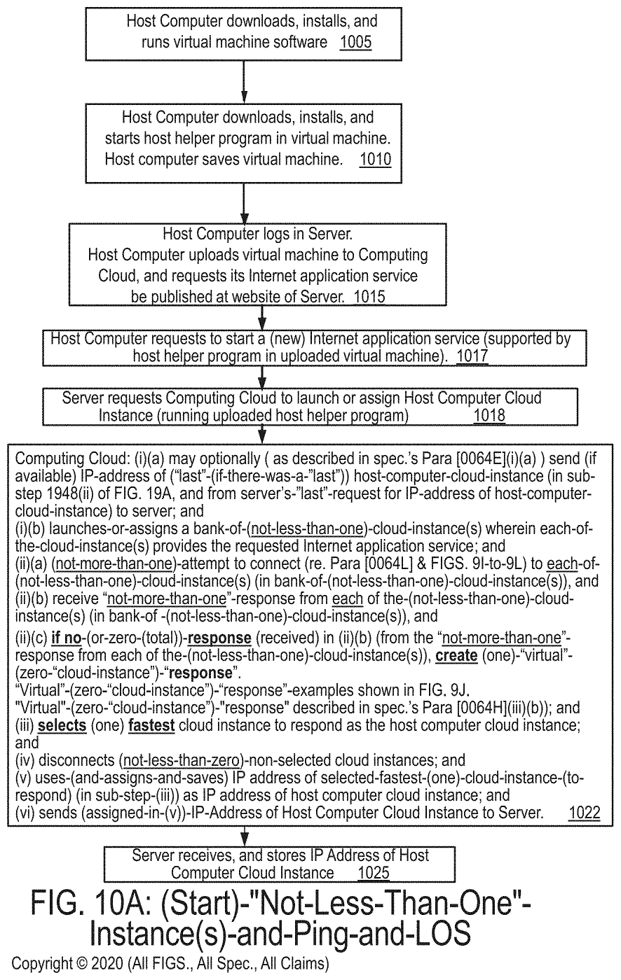

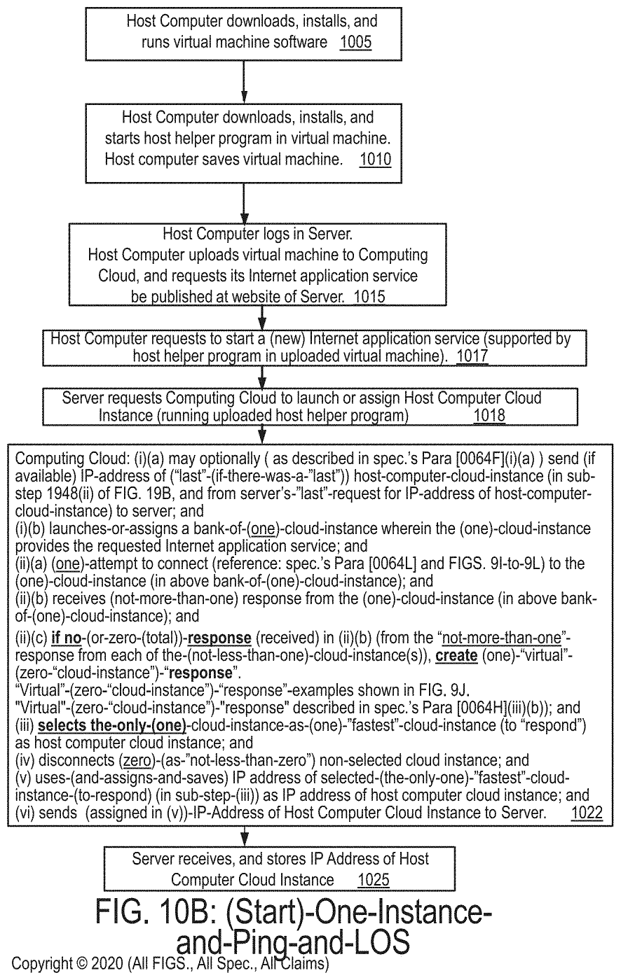

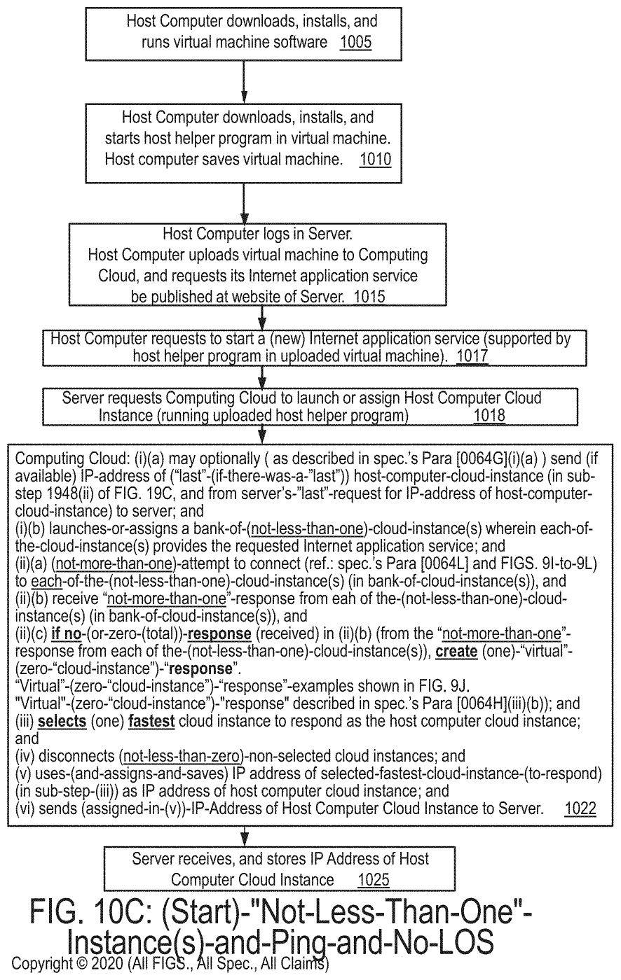

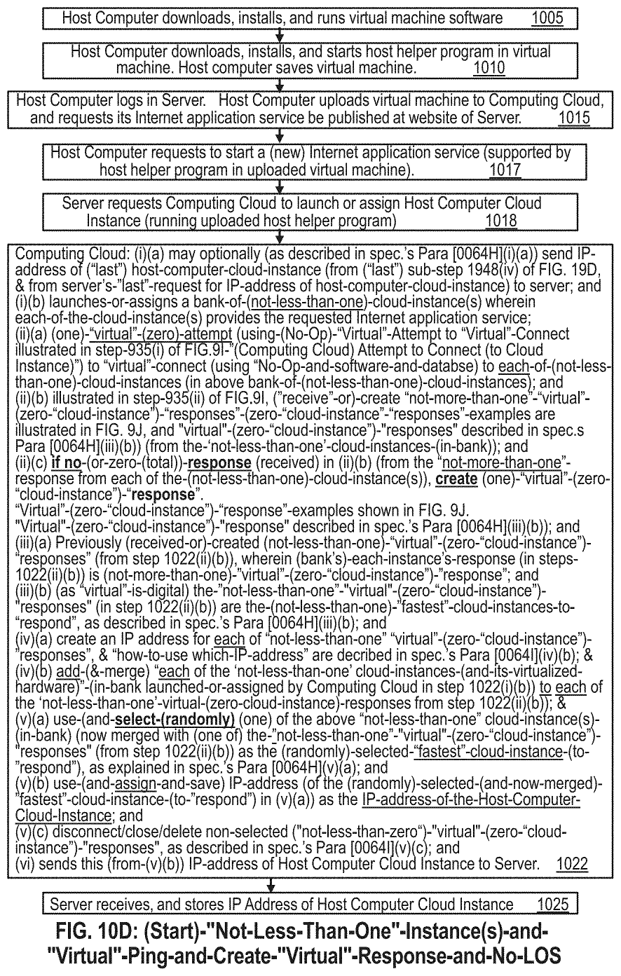

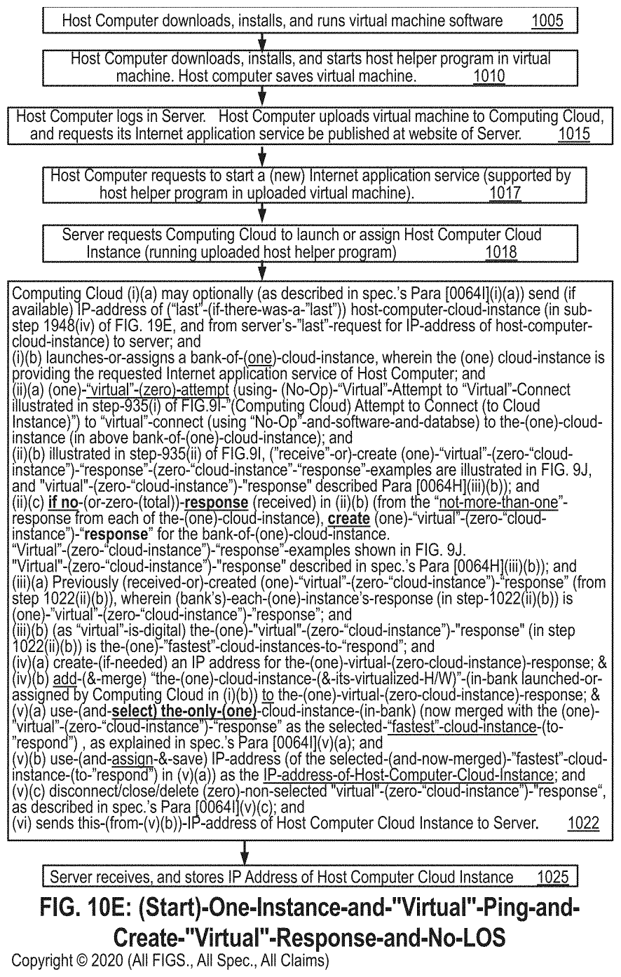

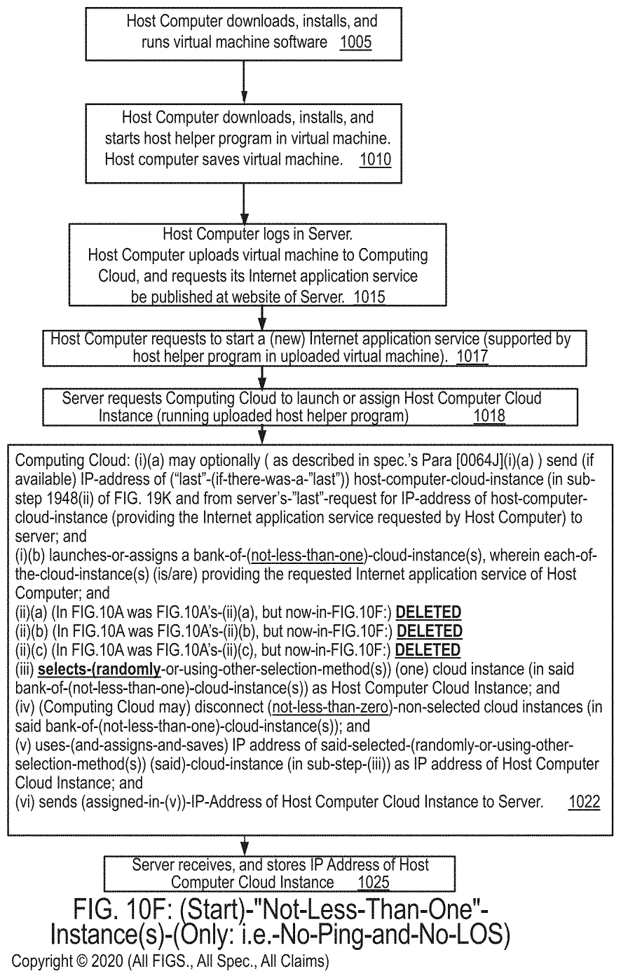

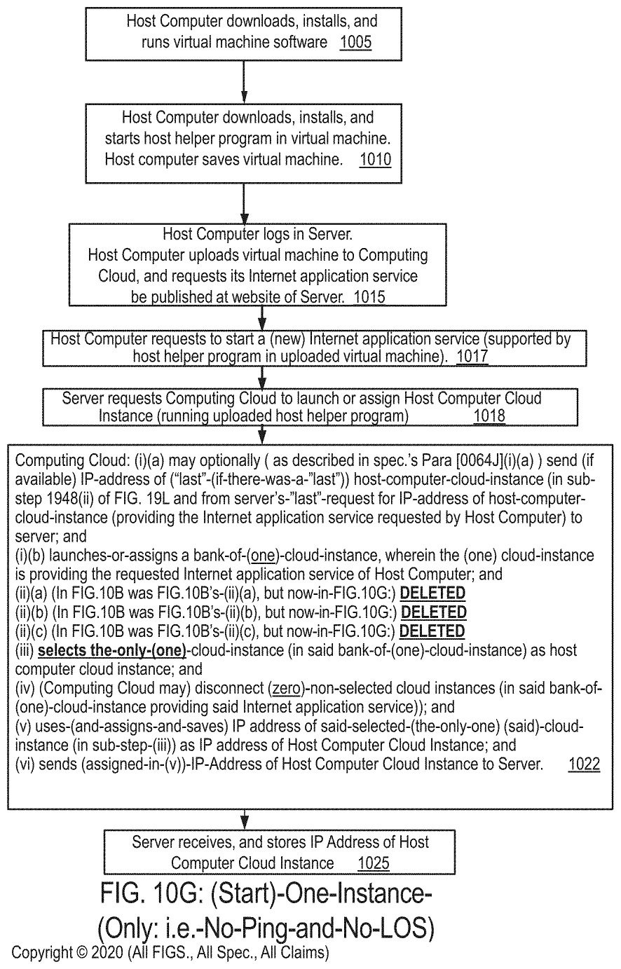

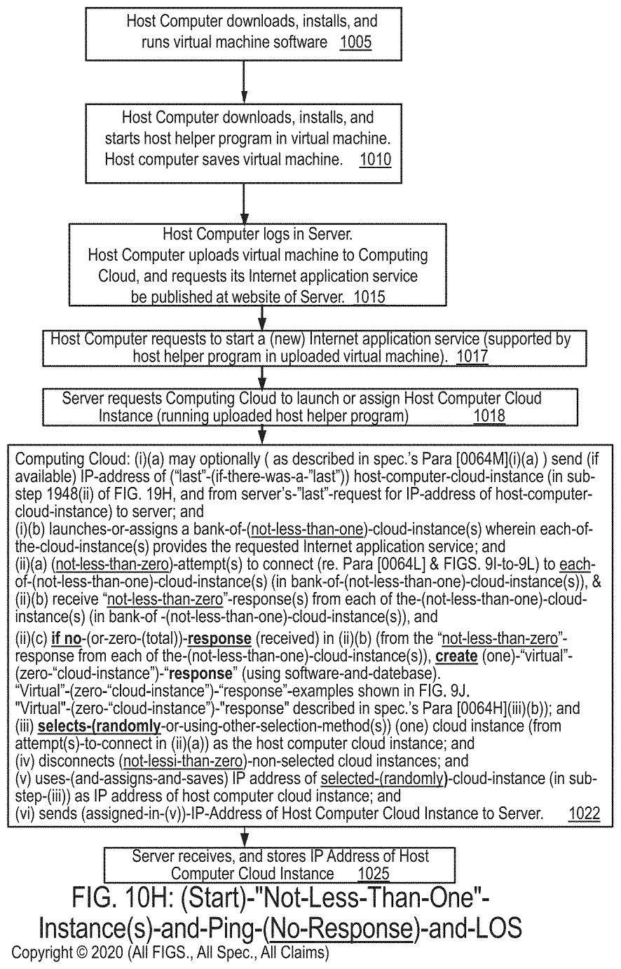

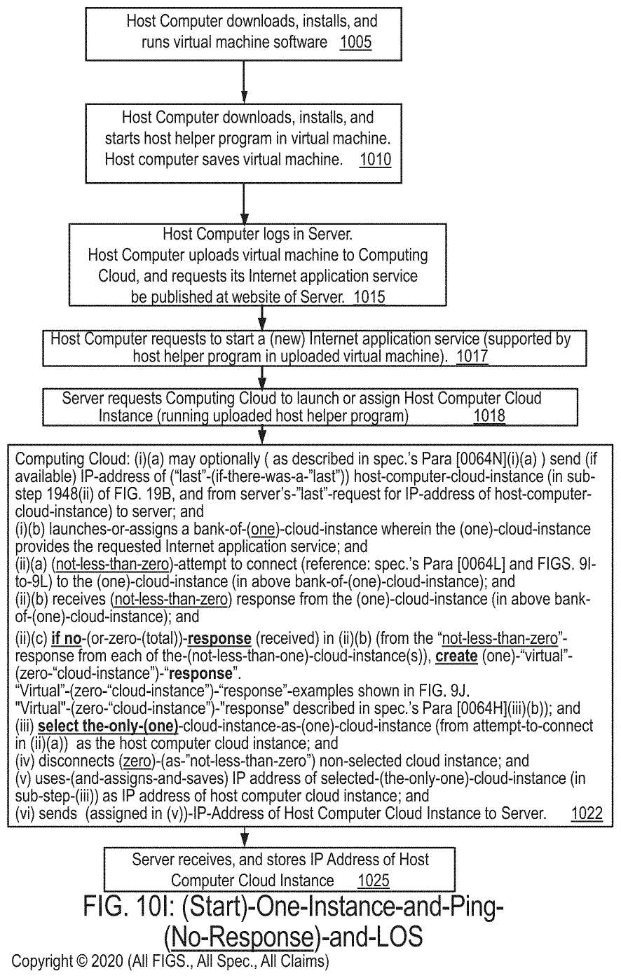

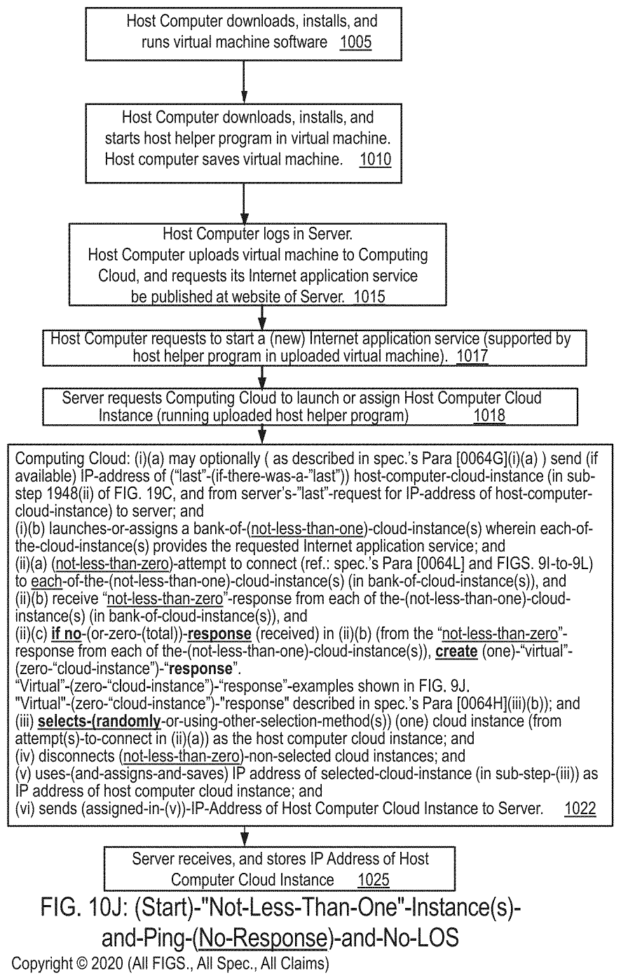

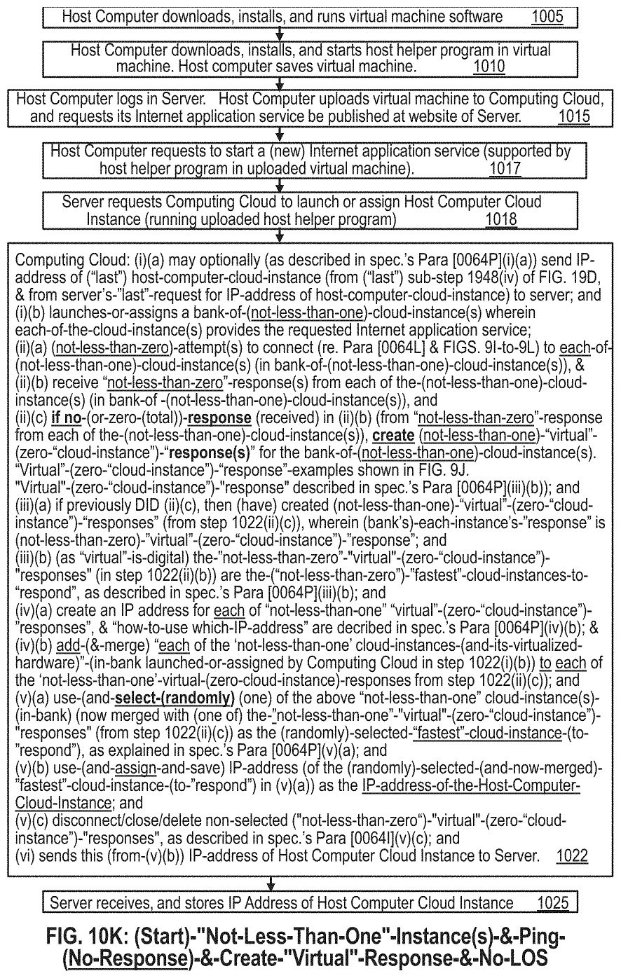

For example, the host computer 205 accesses the Internet application service website 212A and selects to act as a host computer 205 to start a new Internet application service. The server 222A requests a computing cloud 198 (e.g. in FIG. 9A) to launch-or-assign a cloud instance 205-C for the host computer 205. The computing cloud 198 launches-or-assigns a bank of cloud instances (each of which) offering the Internet application service. The computing cloud 198 attempts to connect to any available cloud instance (in the bank), and selects the fastest cloud instance to respond as the host computer cloud instance 205-C. The host computer cloud instance 205-C sends its IP address to the server 222A via a network connection 227. The server 222A stores the IP address of the host computer cloud instance 205-C. When a client computer 215 subsequently accesses the website 212A and selects to join the Internet application service hosted by the host computer 205, the server 222A sends to the client computer 215 the IP address of the host computer cloud instance 205-C via a network connection 230. The IP address of the host computer 205 is not needed to be sent to the client computer 215 to allow Internet application service, according to the current invention.

Important note: Host computer cloud instance 205-C (and/or host computer cloud instance 205n-C) may interchangeably-(in-many-places) use either 205-C and/or 205n-C (as generic-notations) to denote the (bank of one-or-more) host computer cloud instance (to allow easier/simpler-reading of the specification-and-FIGS in different contexts through-out this patent application). For example: 205-C in FIGS. 9A and 9B may use 205n-C instead (of using 205-C), etc.

Once the client computer 215 receives the IP address of the host computer cloud instance 205-C, it may send data directly to the host computer 205 via direct network connections 240, 245 using the host computer cloud instance 205-C. The term “direct,” “directly,” “direct connection” or “direct network connection” in the context of network connections is used herein to refer to network connections that do not go through the server 222A, but is not intended to mean that the connections do not involve any intermediary components such as switches or routers to facilitate conventional network connection. Moreover, the client computer 215 sends to the host computer cloud instance 205-C the IP address of the client computer 215 itself through the direct connection 245. In other words, while the IP address of the host computer cloud instance 205-C is sent to the client computer 215 through the server 222A via the indirect connections 227, 230, the IP address of the client computer 215 is sent to the host computer cloud instance 205-C via the direct connection 245 without passing through the server 222A. Thus, both host computer cloud instance 205-C, client computer 215 are able to obtain the other's IP address and create a direct network connection 245. Once both host computer cloud instance 205-C, client computer 215 have the other's IP address, from this point onwards the server 222A is not involved, and subsequent data exchange between the computers 205, 215 takes place via the direct network connections 240, 245 using the host computer cloud instance 205-C.

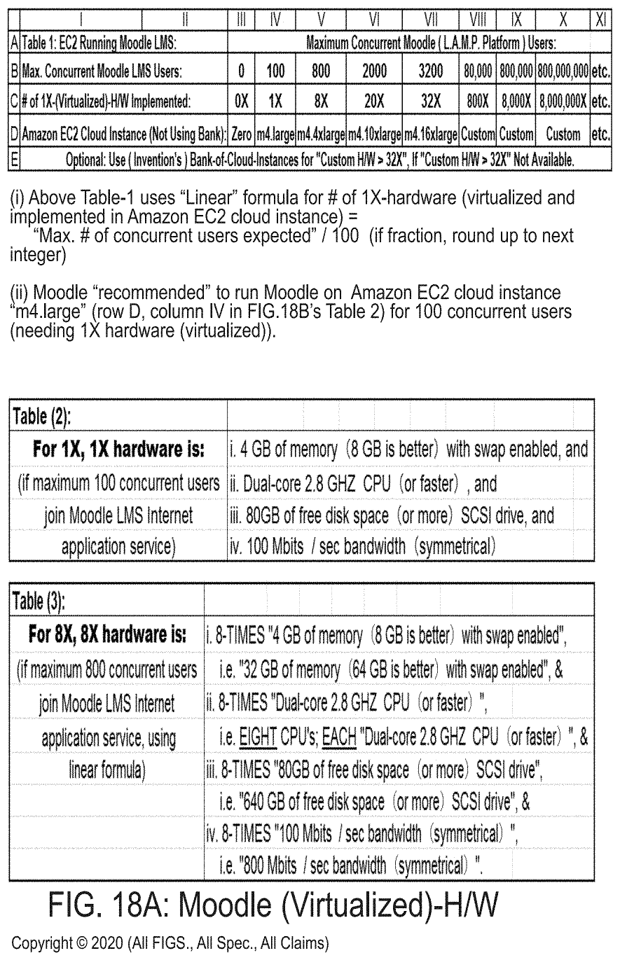

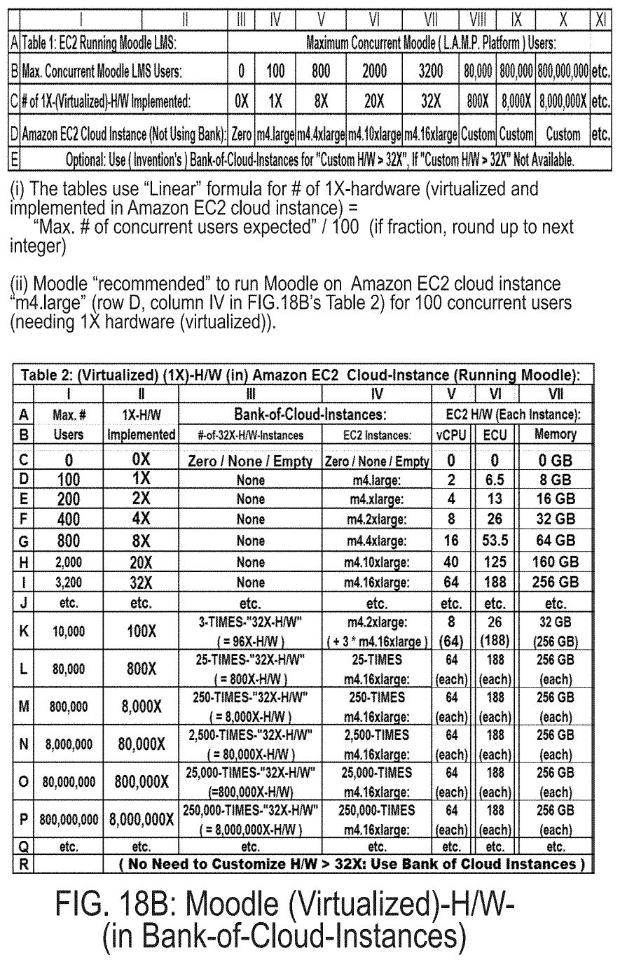

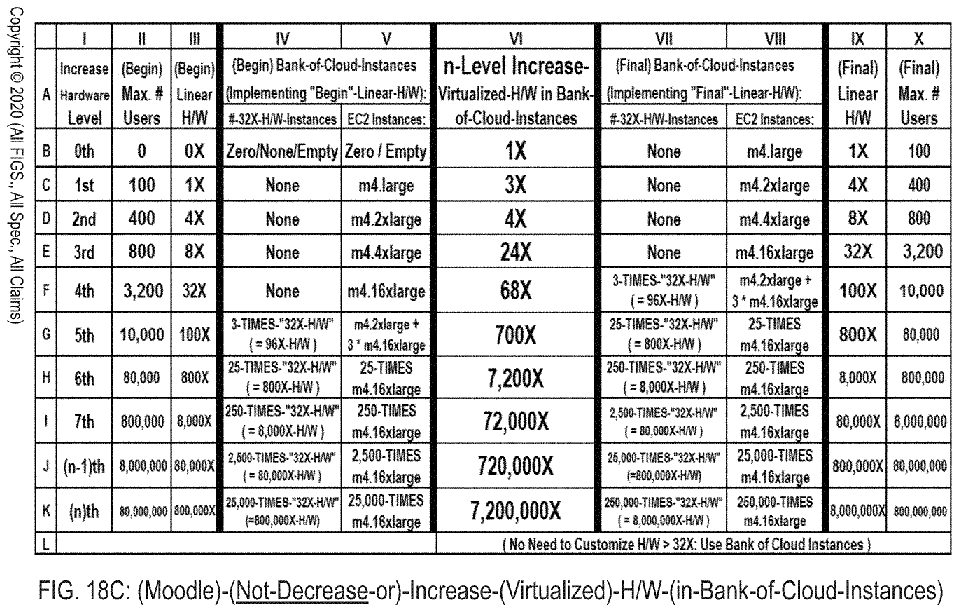

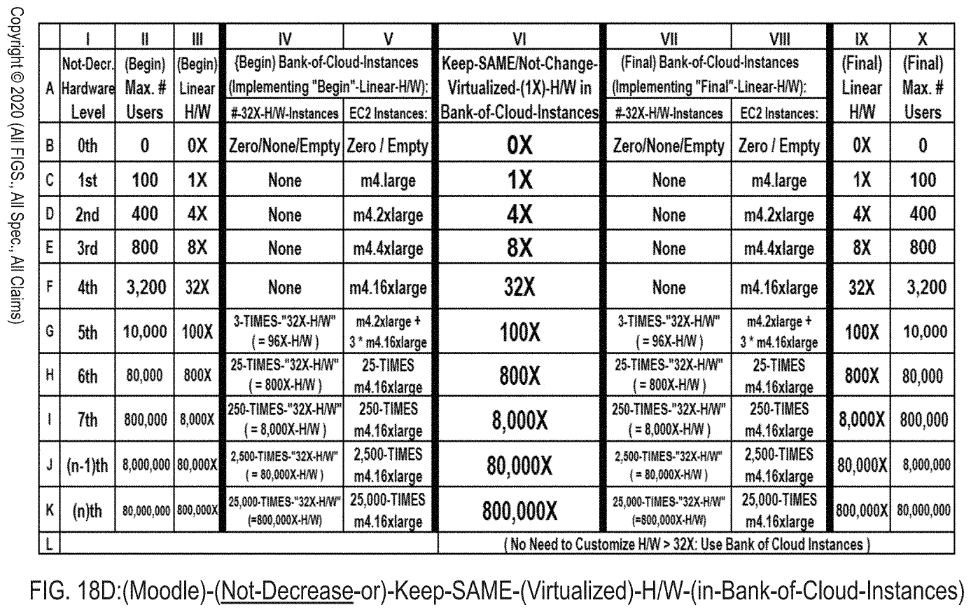

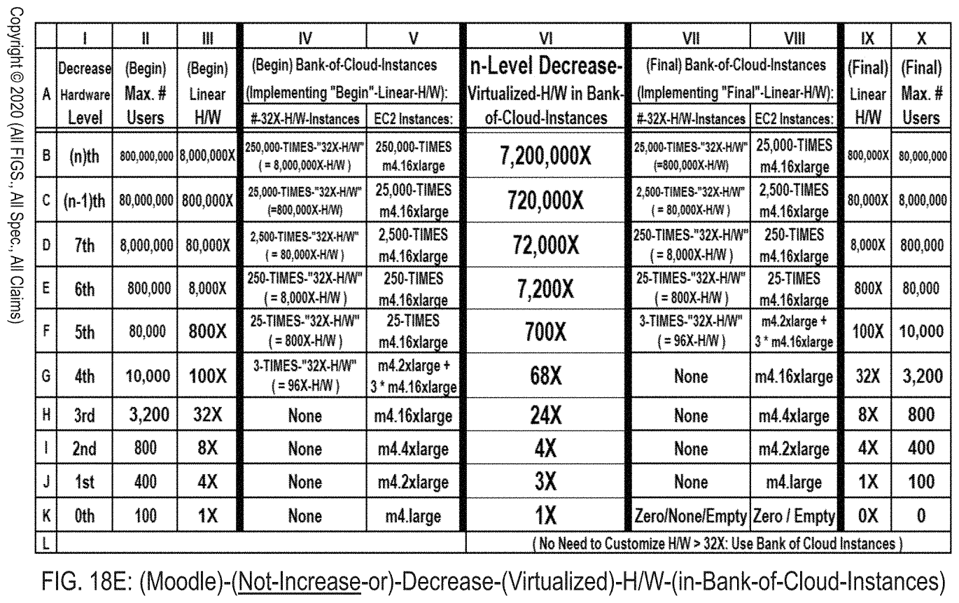

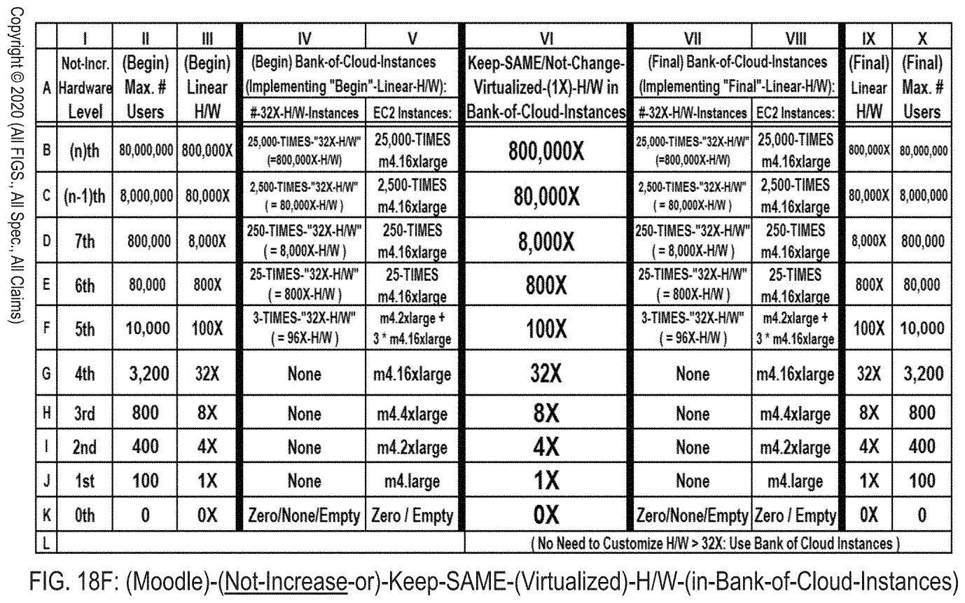

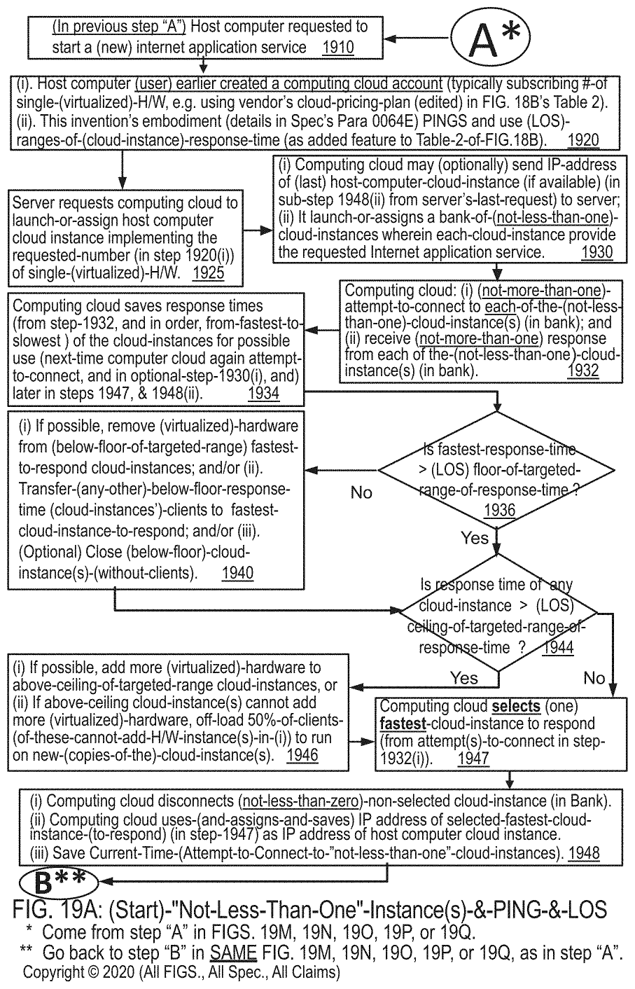

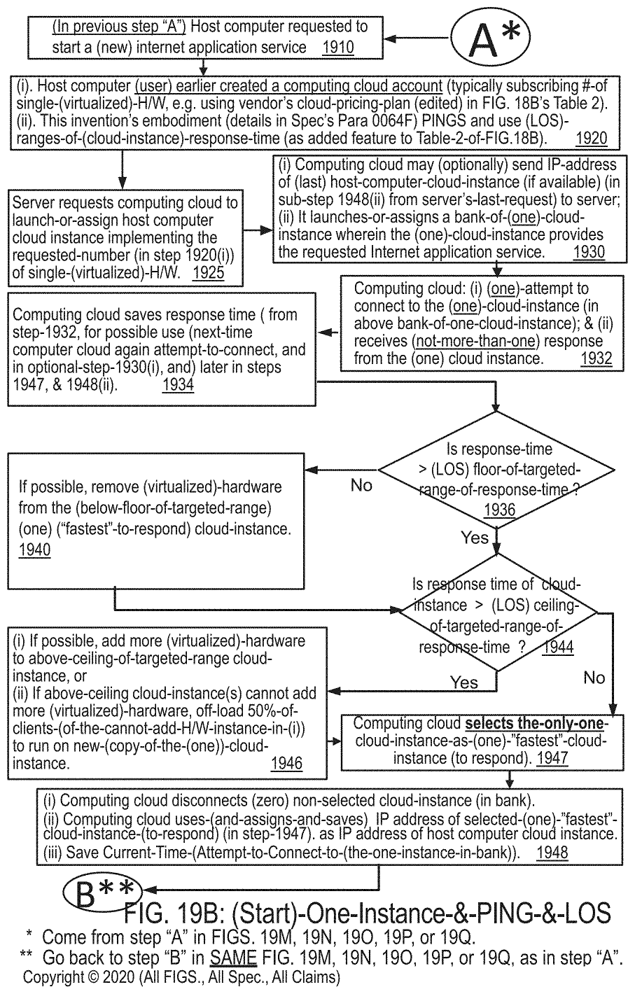

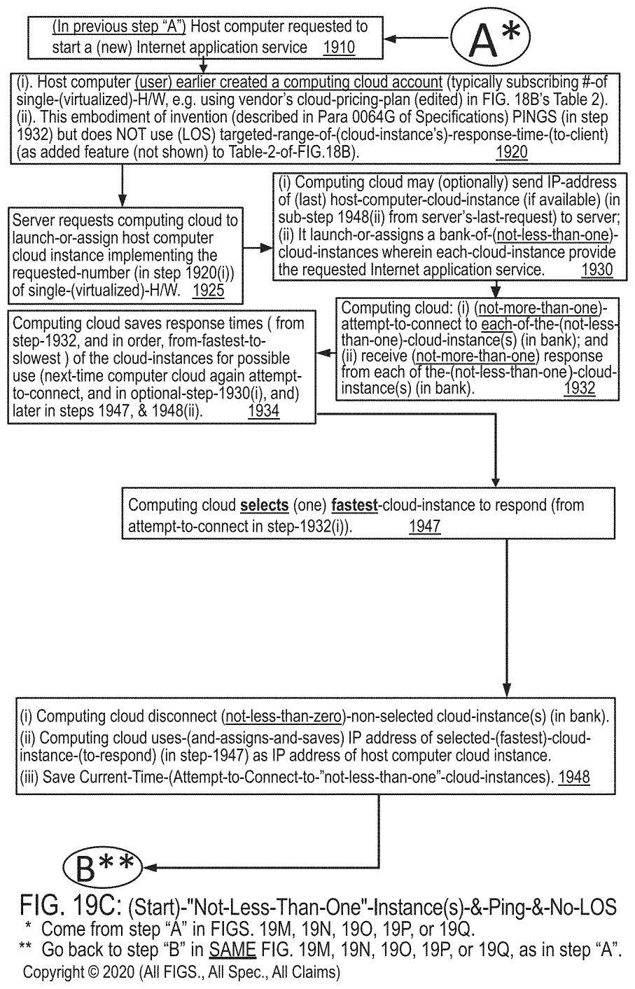

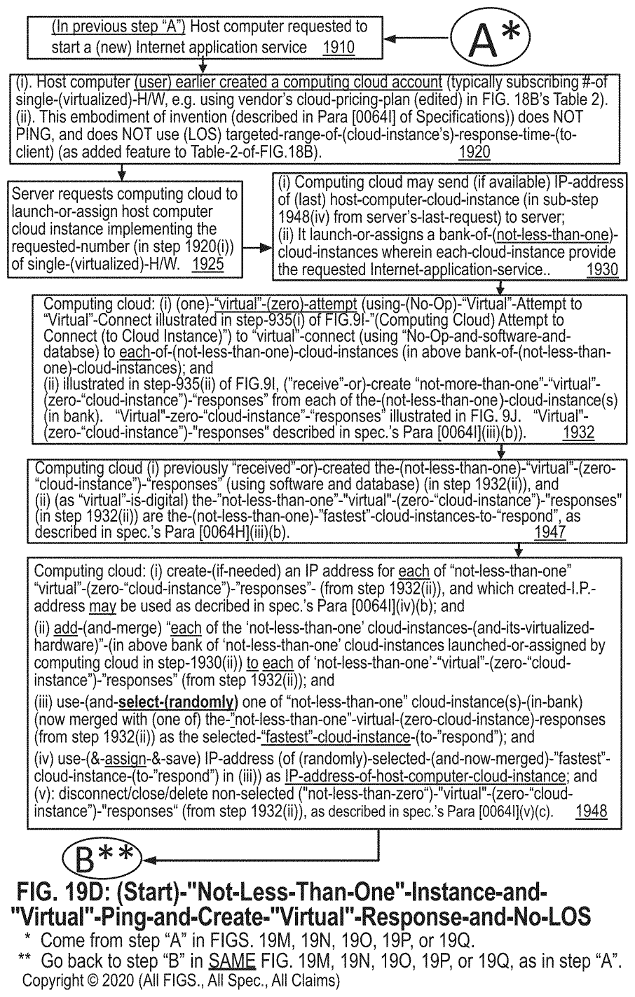

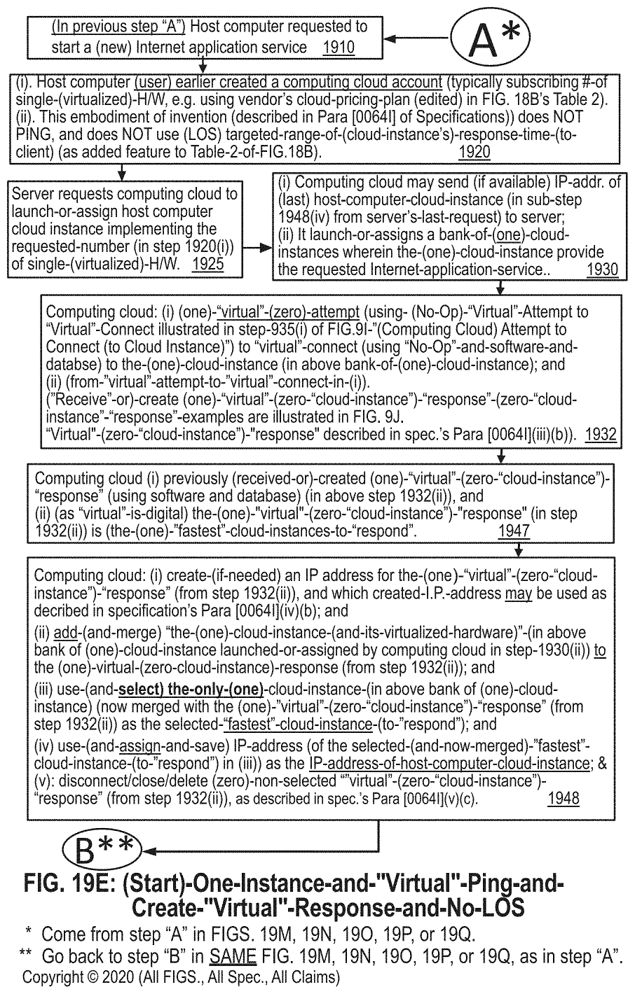

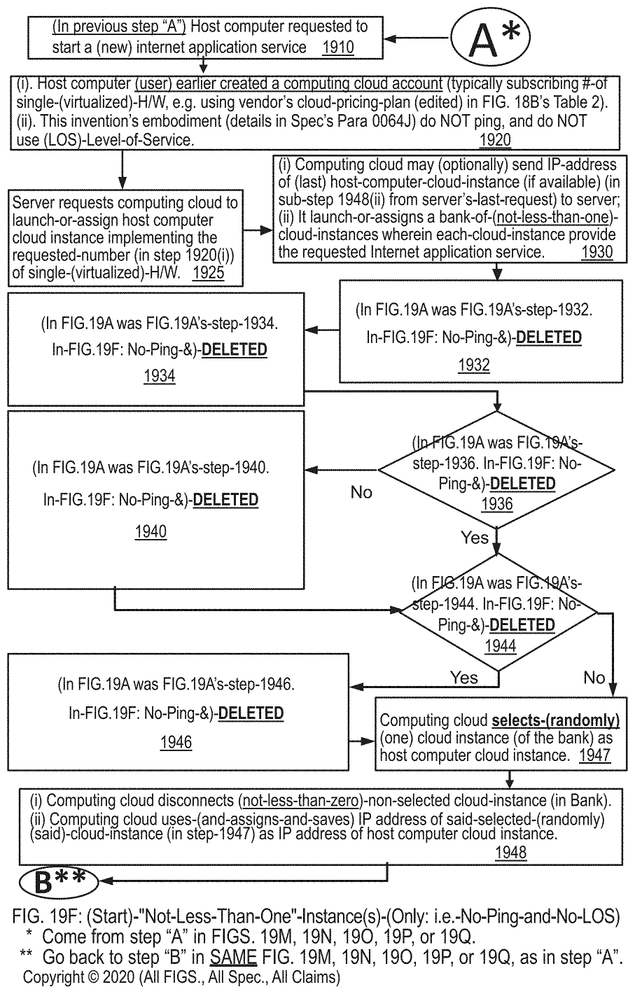

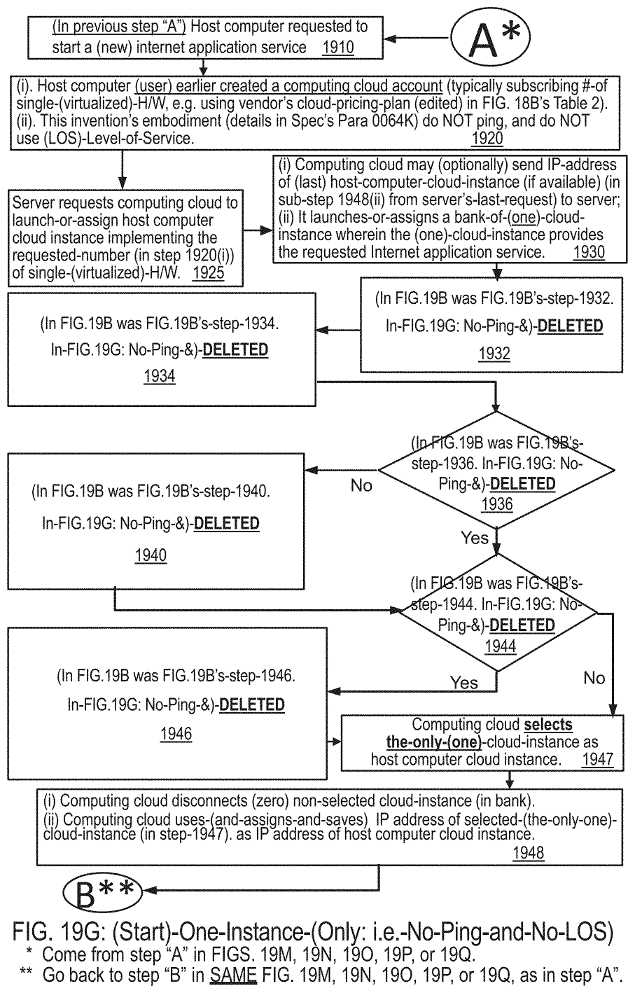

Please note that unlike the prior art (U.S. patent application Ser. No. 15/396,347) shown in FIG. 1, the direct network connections of FIG. 2A: (i) does not require that all data packets (of 400,000-(or-more) maximum concurrent users/clients) pass through one single host computer cloud instance 205-C; and (ii) does not require that today Amazon-(or-other-computing-cloud-vendors) have the technology (of 4,000X-(or-more) virtualized-hardware (in one cloud-instance)) to support 400,000-(or-more) maximum-concurrent-users (in FIG. 1's Table 1's columns X (from prior art of U.S. patent application Ser. No. 15/396,347)), and (iii) illustrate when-to-do increase-(or-decrease) virtualized-hardware of host-computer-cloud-instance 205-C, e.g. (illustrate)-need to increase-(or-decrease) virtualized-hardware) when host-computer-cloud-instance 205-C's response-time/Level-of-Service is outside the targeted-range (illustrated in FIG. 2A, Table 2, and especially rows-C-to-F and columns II-to-V); and (iv) There is “no need to (contact Amazon or cloud vendor to) ‘customize H/W>32X’”, because the invention uses “bank-of-cloud-instances” to “virtualize hardware>32X” (as illustrated in FIG. 2's Table-1's row-“F”-and-columns-“II”-to-“VII”, and in FIG. 18's Table-2's columns-“III”-and-“IV”); and (v) there is “no” maximum number of concurrent users, as the computing cloud may add more host computer cloud instances 205-C (to the bank of host computer cloud instances 205-C in FIG. 2A) to support increased number of users (illustrated by FIG. 2A's Table-1's rows-“C”-to-“E”-and-columns-“IV”-to-“VII”, and limited only by the physical hardware (located possibly in different geographical locations and located possibly globally, not shown) available for virtualization by the computing cloud.

Please note that the term “bank of cloud instances” (meaning “group of cloud instances”) allows easier understanding of how to work with one-or-more cloud-instances (offering the SAME-Internet-application-service of the SAME-host-computer-205). A “bank of cloud instances” (meaning “group of cloud instances”) may be implemented using software-and-database, just like any-other one-or-more cloud-instances (and offering the SAME-Internet-application-service of the SAME-host-computer-205).

Important note: Host computer cloud instance 205-C (and/or “bank of (one-or-more) cloud instances 205-C”) may interchangeably-(in-many-places) use both host computer cloud instance 205-C and/or “bank of (one-or-more) cloud instances 205-C” (as generic-notations) to denote host computer cloud instance 205-C (to allow easier/simpler-reading of the specification-and-FIGS in different contexts through-out this patent application). For example: “bank of (one-or-more) host computer cloud instances 205-C” in FIGS. 9A and 9B may use “host computer cloud instances 205-C” instead (of using “bank of (one-or-more) host computer cloud instances 205-C”), etc.

More examples of “bank of (one-or-more) cloud instances” (meaning “group of cloud instances”) are Alpha-205-C, Bravo-205-C, . . . etc. illustrated in FIGS. 9A-to-9B, and 9C's-columns-II-to-XIV.

“Banks of (one-or-more) cloud instances” (meaning “groups of cloud instances” like Alpha-205-C, Bravo-205-C, . . . etc.) may be implemented in different ways (not shown) using database and software.

When #-of-cloud-instances in a bank gets to be very large numbers (e.g. 10,000-to-25,000,000 in FIG. 2A's Table 1's column-VI), the bank-of-cloud-instances (meaning “group-of-cloud-instances”) may be conceptually/logically sub-divided into sub-banks/sub-groups (for easier understanding, not shown). For very large #-of-cloud-instances, the bank-of-cloud-instances (meaning “group-of-cloud-instances”) may also be physically-divided (when implemented using multiple computers, not shown) into sub-banks/sub-groups (possibly in different geographical locations and possibly globally).

FIG. 2B is a block diagram illustrating the hardware architecture of a computing device 201. The computing device 201 depicted in FIG. 2B may be either a host computer 205 or a client computer 215 in accordance with one embodiment of the present invention. In one embodiment, the computing device 201 is a general purpose personal computer including a processor 202, a memory 204, a storage module (e.g., hard disk drive) 206, a communication interface 208, an input device 211, and a display 214, all exchanging data with one another through a data bus 221. The memory 204 includes various application software such as a helper program 216 and a web browser 218. If the computing device 201 is a host computer 205, the helper program 216 is a host helper program 216-1. If the computing device 201 is a client computer 215, the helper program 216 is a client helper program 216-2. In some embodiments of the present invention, it is possible for a single computing device 201 to act as both a host computer 205 and a client computer 215 simultaneously, in which case both a host helper program 216-1 and a client helper program 216-2 may be included in the memory 204.

The processor 202 is a conventional processor or controller. The memory 204 is a conventional computing memory such as a random access memory (RAM). The storage module 206 is a conventional long term storage device, for example, a hard drive (e.g., magnetic hard drive) or a flash memory drive. The communication interface 208 may include one or more interfaces used to transmit and receive data over a network such as the Internet. The communication interface 208 may be an Internet interface, a serial interface, a parallel interface, a USB (Universal Serial Bus) interface, an Ethernet interface, a TI interface, a Bluetooth interface, a WiFi (e.g. IEEE 802.11) interface, or any other type of wired or wireless communication interface. The input device 211 may be any standard device which allows a user to interact with a computing device 201, such as a keyboard or a mouse. The display 214 may be an LCD or CRT computer monitor or any other device suitable for a computer display.

The web browser 218 is a software application executing on a processor 202 to allow the computing device 201 to display and interact with content accessed via the Internet. The web browser 218 may be any conventional web browser 218 such as Internet Explorer™ from Microsoft Corporation or Firefox™ from Mozilla.

The helper program 216 is a software application executing on a processor 202 within the computing device 201. Specifically, the helper program 216 is a software application designed to provide Internet application services such as website services according to embodiments of the present invention. In one embodiment, a helper program 216 executing on a computing device 201 acting as a host computer 205, referred to herein as a “host helper program 216-1,” is a Moodle LMS (or simply the popular L.A.M.P. platform) Internet application host application. In one embodiment, a helper program 216 executing on a computing device 201 acting as a client computer 215, referred to herein as a “client helper program 216-2,” is an Internet application client viewer application (which can be an Internet browser).

FIG. 2C is a block diagram illustrating a cloud instance 203, which is single hardware, e.g. computing device 201 in FIG. 2B, implemented into software and run on top of a single physical computer (as described in Para [0041B], and illustrated in FIG. 2E: Overview of Virtualization).

A “cloud instance” refers to a virtual machine instance from a public or private cloud network. In cloud instance computing, single hardware is implemented into software and run on top of single or multiple physical computers (as described in Para [0041B], and illustrated in FIG. 2E: Overview of Virtualization). Cloud instance computing is highly dynamic, enabling users not to worry about how many virtual machines can fit on a single hardware application without causing major slowdowns during peak hours. If performance maxes out, one can simply add more computers. Resources can be freely allocated to and from other computers by the software, enabling maximum utilization and helping to prevent crashes. If the virtual machine(s) grow beyond the limits of a single machine, cloud (instance) computing allows the cloud software to add cloud instances and/or computing clouds to run on multiple machines, whether temporarily or permanently. Cloud instance computing also reduces the downtime associated with servicing hardware. A virtual machine in the cloud can be easily moved from one physical machine to another without going down. The abstraction associated with the cloud allows hardware to seamlessly transfer all data from one point to another without the end-user having any idea that it happened. In summary, cloud instance computing is highly dynamic, can reassign resources as needed, and allows for the movement of virtual machines as they run in the cloud.

As an example of cloud instance, a commercial service, Amazon EC2 (Amazon Web Services Elastic Compute Cloud), provides a wide selection of instance types optimized to fit different use cases. Instance types comprise varying combinations of CPU, memory, storage, and networking capacity and give one the flexibility to choose the appropriate mix of resources for one's applications. Each instance type includes one or more instance sizes, allowing one to scale one's resources (described in Para [0035] to the requirements (e.g. virtualized-hardware/targeted-response-time/quality-of-service (QoS) requirements) of one's target workload.

Scaling (both scaling-up and scaling-down virtualized hardware) of one's (e.g. cloud-instance's and/or computing-cloud's virtualized-hardware) resources (to the requirements (e.g. virtualized-hardware/targeted-response-time/quality-of-service (QoS) requirements) of one's target workload (e.g. rows-B of Tables 1 of FIGS. 18B-and-31B for Moodle LMS software) and/or other requirements, e.g. cloud-instance's and/or computing-cloud's targeted-response-time/quality-of-service (QoS) requirements) are described through-out this invention, e.g. illustrated in FIGS. 18C-to-18F,28A-and-28B, 30A-to-30F, and 31C-to-31F, and (described) in the specification-paragraphs (not listed) describing the above FIGS./illustrations.

The cloud instance 203 depicted in FIG. 2C is a host computer cloud instance 205-C in accordance with one embodiment of the present invention. In one embodiment, the cloud instance 203 is a general purpose personal computer implemented into software and run on top of one-or-more computers.

In FIG. 2C, a general purpose personal computer, implemented into software and run on top of one-or-more computers, includes a processor 202, a memory 204, a storage module (e.g., hard disk drive) 206, a communication interface 208, an input device 211-1, and an output device 214-1, all exchanging data with one another through a data bus 221. The memory 204 includes various application software such as a helper program 216. If the general purpose personal computer (implemented into software and run on top of one-or-more computers) is a host computer 205, the helper program 216 is a host helper program 216-1. In some embodiments of the present invention, it is possible for a general purpose personal computer (implemented into software and run on top of one-or-more computers) to act as both a host computer 205 and a client computer 215 simultaneously, in which case both a host helper program 216-1 and a client computer program 216-2 may be included in the memory 204.

In FIG. 2C, the processor 202 is a conventional processor or controller. The memory 204 is a conventional computing memory such as a random access memory (RAM). The storage module 206 is a conventional long term storage device, for example, a hard drive (e.g., magnetic hard drive) or a flash memory drive. The communication interface 208 may include one or more interfaces used to transmit and receive data over a network such as the Internet. The communication interface 208 may be an Internet interface, a serial interface, a parallel interface, a USB (Universal Serial Bus) interface, an Ethernet interface, a T1 interface, a Bluetooth interface, a WiFi (e.g. IEEE 802.11) interface, or any other type of wired or wireless communication interface. The input device 211-1, if implemented into software, may be any standard device which allows a user to interact with the cloud instance 203. The output device 214-1, if implemented into software, may be any device suitable for a computer display.

In FIG. 2C, the web browser 218, if present, is a software application executing on a processor 202 to allow the general purpose personal computer (implemented into software and run on top of one-or-more computers) to display and interact with content accessed via the Internet. The web browser 218 may be any conventional web browser 218 such as Internet Explorer™ from Microsoft Corporation or Firefox™ from Mozilla.

In FIG. 2C, the helper program 216 is a software application executing on a processor 202 within a general purpose personal computer (implemented into software and run on top of one-or-more computers). Specifically, the helper program 216 is a software application designed to provide Internet application services such as website service according to embodiments of the present invention. In one embodiment, a helper program 216 executing on a general purpose personal computer (implemented into software and run on top of one-or-more computers) acting as a host computer 205, referred to herein as a “host helper program 216-1,” is a website service host application (e.g. using the popular L.A.M.P. platform). In one embodiment, a helper program 216 executing on a general purpose personal computer (implemented into software and run on top of one-or-more computers) acting as a client computer 215, referred to herein as a “client helper program 216-2,” is an Internet application client viewer application (which can be an Internet browser).

In one embodiment, the cloud instance 203 is a powerful general purpose computer meeting the hardware and bandwidth requirements specified by the host helper program 216-1. For example, if the host helper program 216-1 is Moodle LMS (using the popular L.A.M.P. platform) website host application, the hardware and bandwidth requirements (defined as 1X-(virtualized)-hardware below for this application, and in Para [0060] (lines 13-to-17) and in FIG. 18A's Table (2) for 100 concurrent users are:
Ubuntu 14.04 64-bit server (operating system)
4 GB of memory (8 GB is better) with swap enabled
Dual-core 2.8 GHz CPU (or faster)
80 GB of free disk space (or more) SCSI hard drive
100 Mbits/sec bandwidth (symmetrical).

FIG. 2D is a block diagram illustrating the hardware architecture of a server 222A. FIG. 2D is similar to FIG. 2B depicting the computing device 201, though the server 222A typically needs to support large numbers of host computers 205 and client computers 215, and hence is typically hugely more powerful and complex compared to a typical host computer 205 or a typical client computer 215. In one embodiment, the server 222A is a general purpose computer including a processor 202, a memory 204, a storage module (e.g., hard disk drive) 206, a communication interface 208, an input device 211, and a display 214, all exchanging data with one another through a data bus 221. The memory 204 includes server and website application software such as a web server (e.g. Apache HTTP server), and a database (e.g. MySQL).

FIG. 2E illustrates “Overview of Virtualization” (of hardware implemented in software):

Virtualization allows for the partitioning of physical resources into virtualized containers. These containers, more commonly referred to as virtual machines, are functionally nothing more than sets of files that represent virtual hardware, executing in the context of a hypervisor (illustrated in FIG. 2E). This virtual hardware provides a platform on which an operating system and applications can be installed and can be configured to provide almost any service that a physical server typically provides. These services include website, email, database, hosting, file and print, monitoring, management, and more. The virtualized environment consists of the underlying hardware, the hypervisor, the Virtual Machine Monitor (VMM), the virtual machines (VMs), and the operating systems and applications installed on these virtual machines.

Hypervisors are an important component of virtualized environments. Hypervisors are programs that allow multiple operating systems, known as guests, to run in virtual machines in an isolated fashion, and thus share a single physical machine.

A computing cloud with multiple cloud instances may run on one-or-more physical machines (not shown). For example, the popular Amazon computing cloud (with many, many millions users globally) would need to run on multiple physical machines (not shown), using Amazon's advanced hardware, software, architecture, etc. technologies.

(With technology advances in hardware, software, architecture, etc.) a cloud instance may run on multiple machines (not shown), if needed (e.g. for extremely large number of concurrent clients/users).

Computing cloud's (e.g. computing cloud 198 in FIG. 9A) cloud-instance's customer-price-plans and contracts (as of year 2019) typically refer-to (or “price-and-sell”) “fixed” (virtualized)-hardware, as illustrated in FIGS. 18B's-Table-2 (rows B-to-P, Columns V-to-VII) referring-to (or “pricing-and-selling”) vCPU, ECU, Memory, and Linux Usage (not shown) for varying-USS-per-hour for different Amazon EC2 cloud instances.

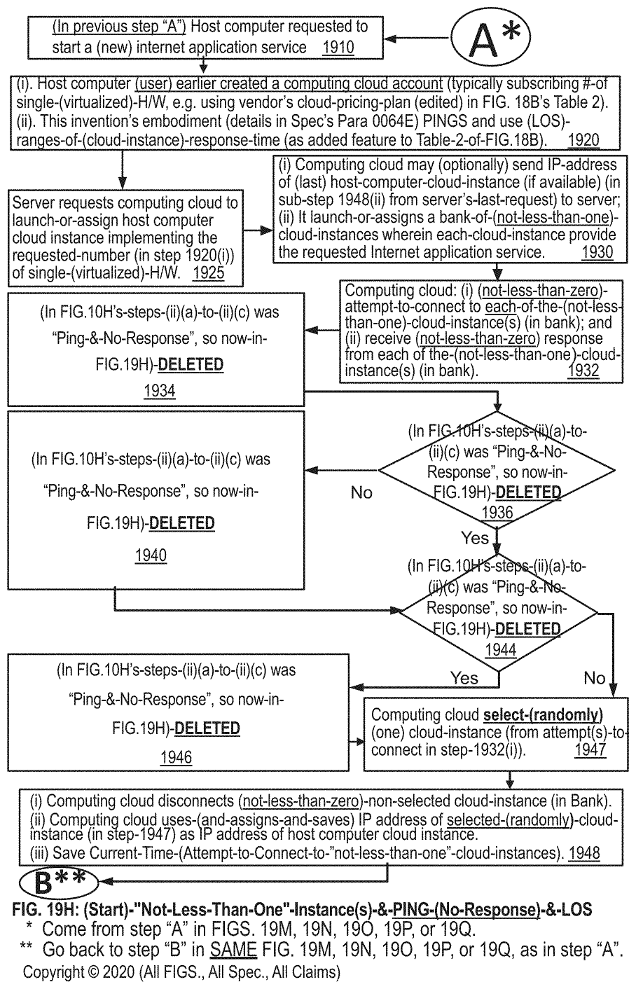

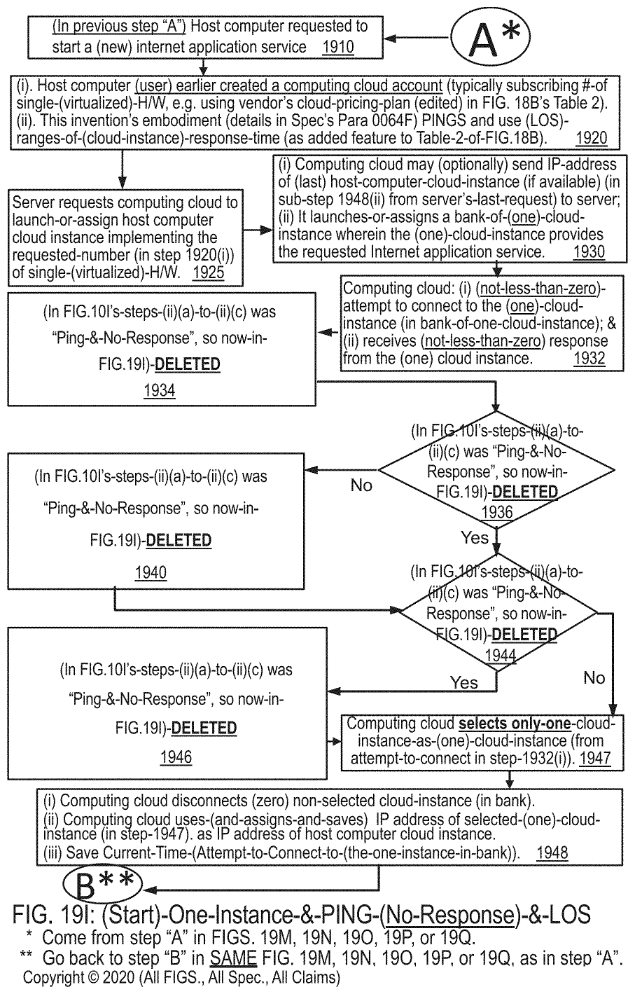

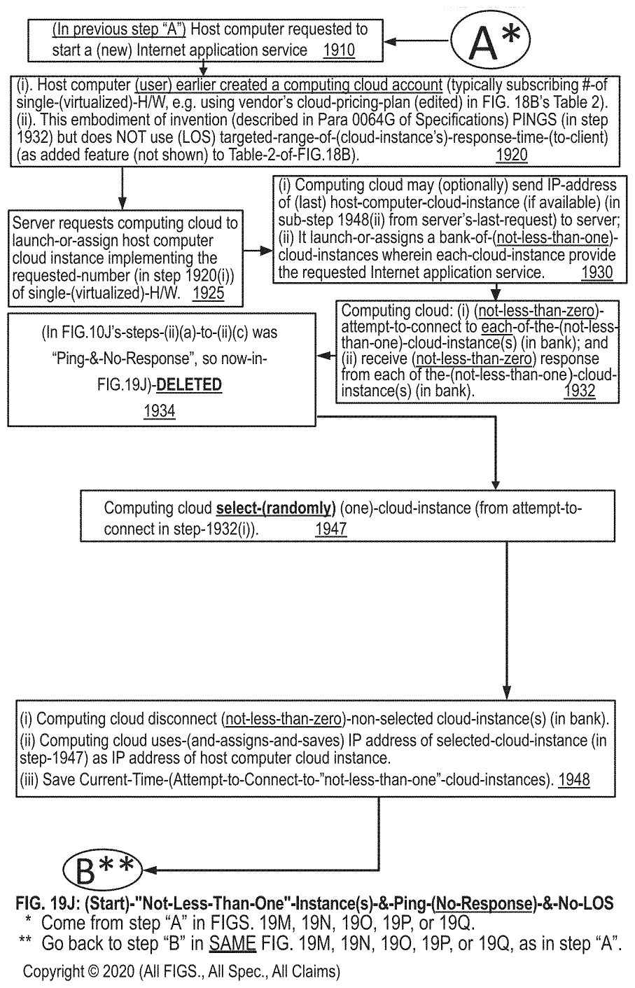

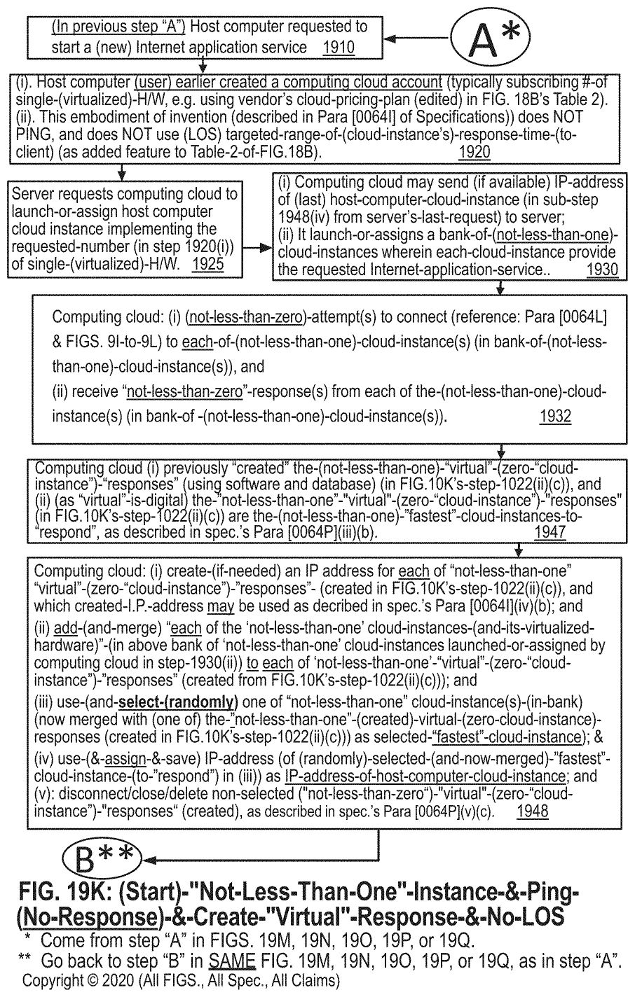

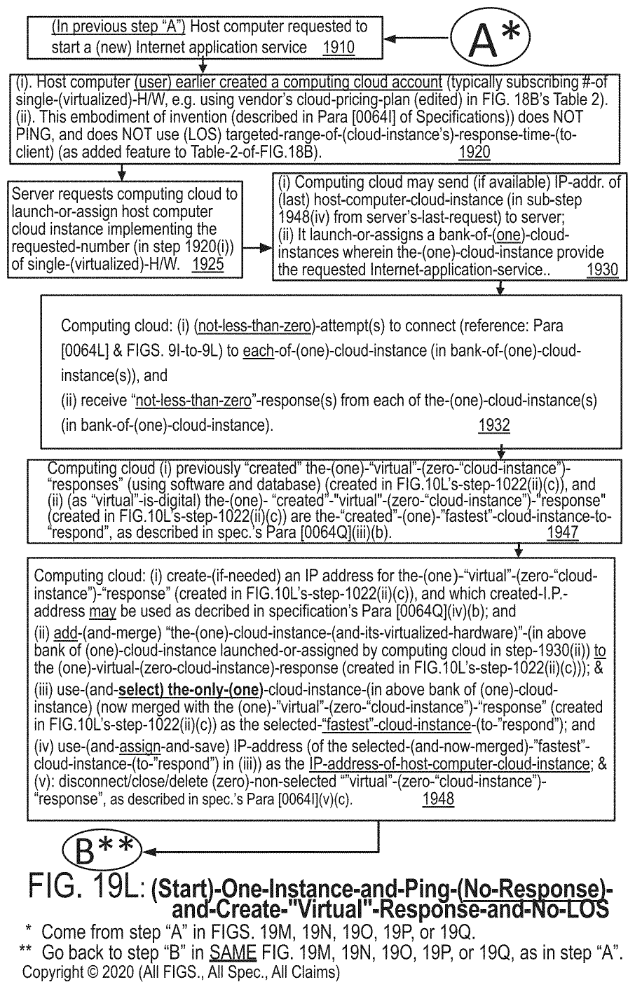

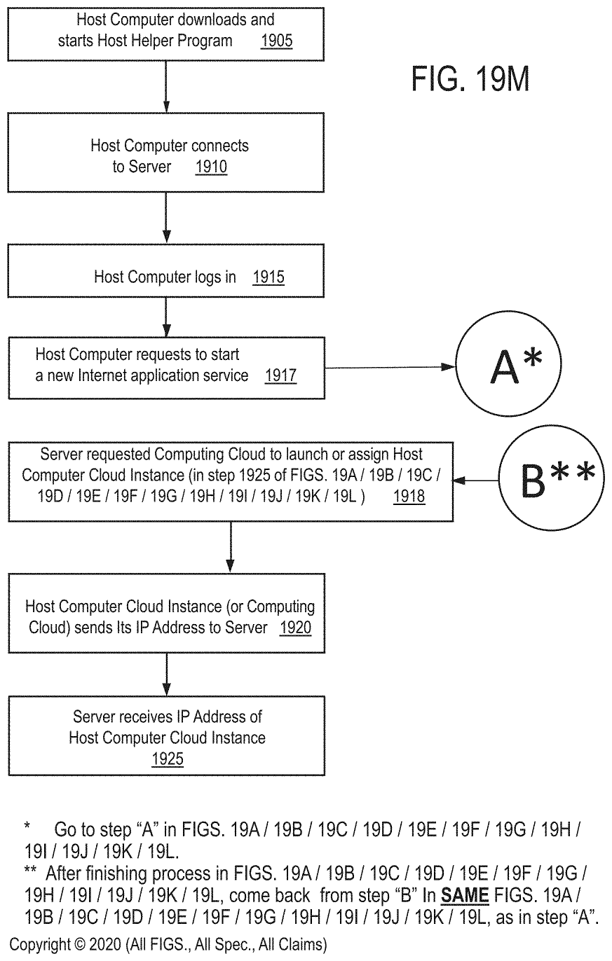

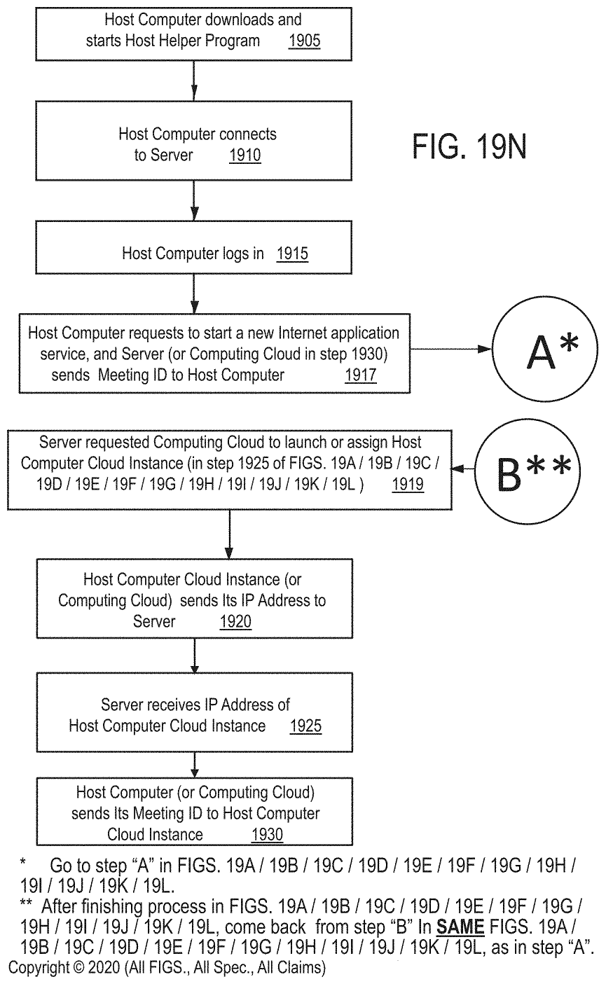

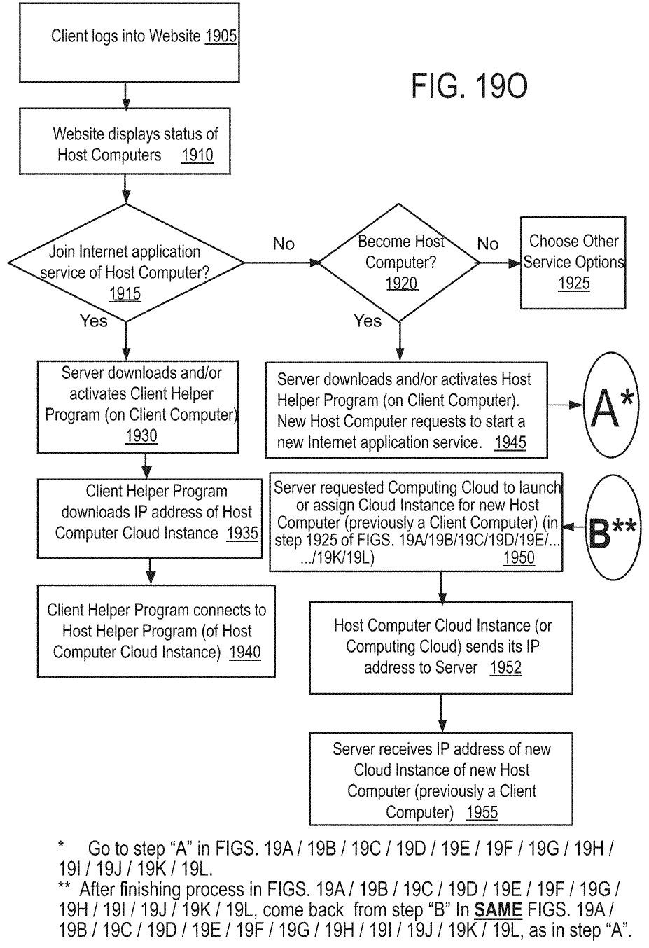

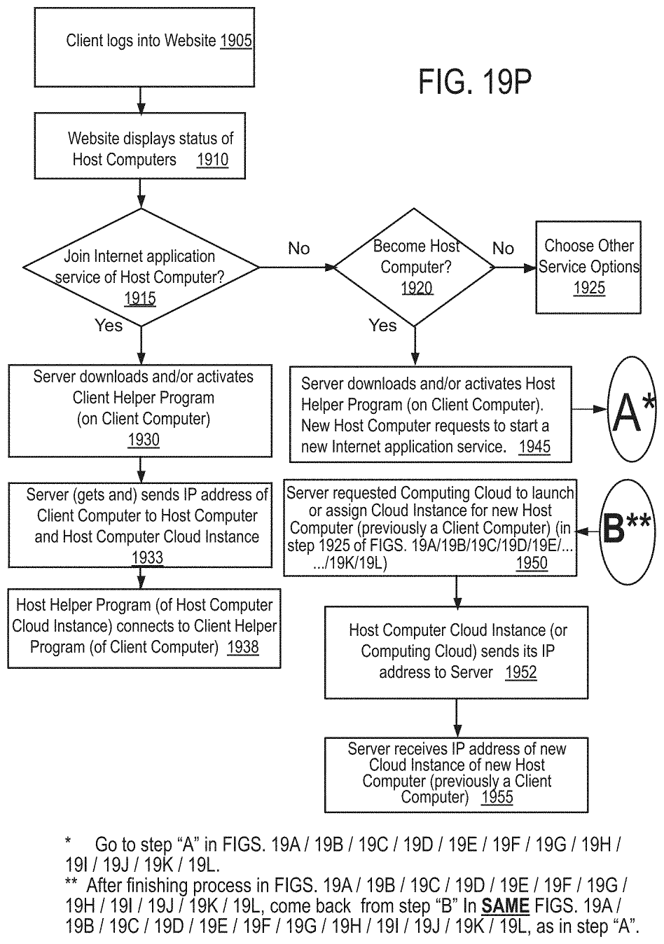

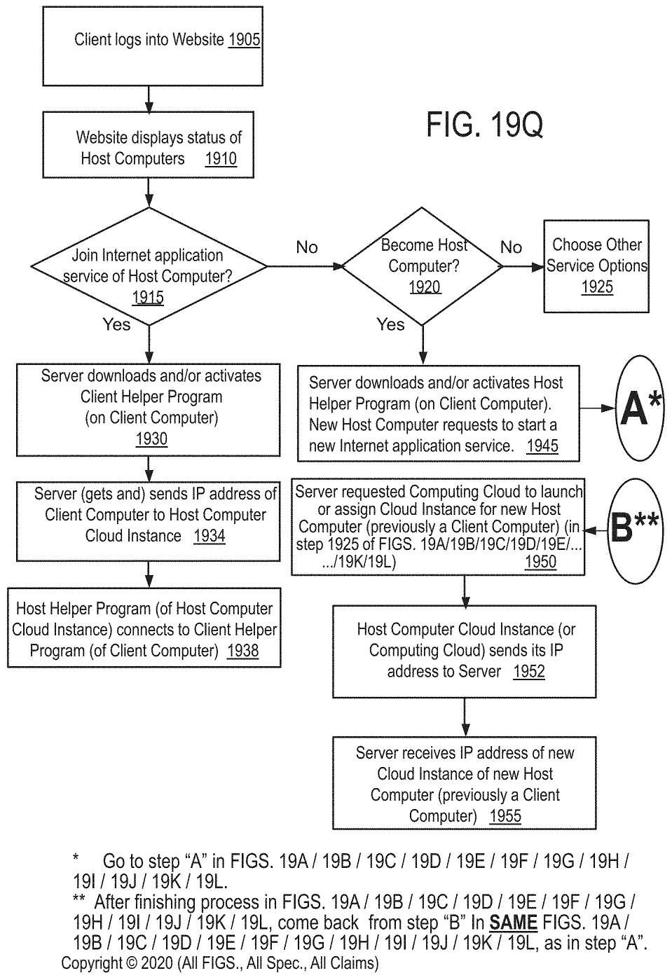

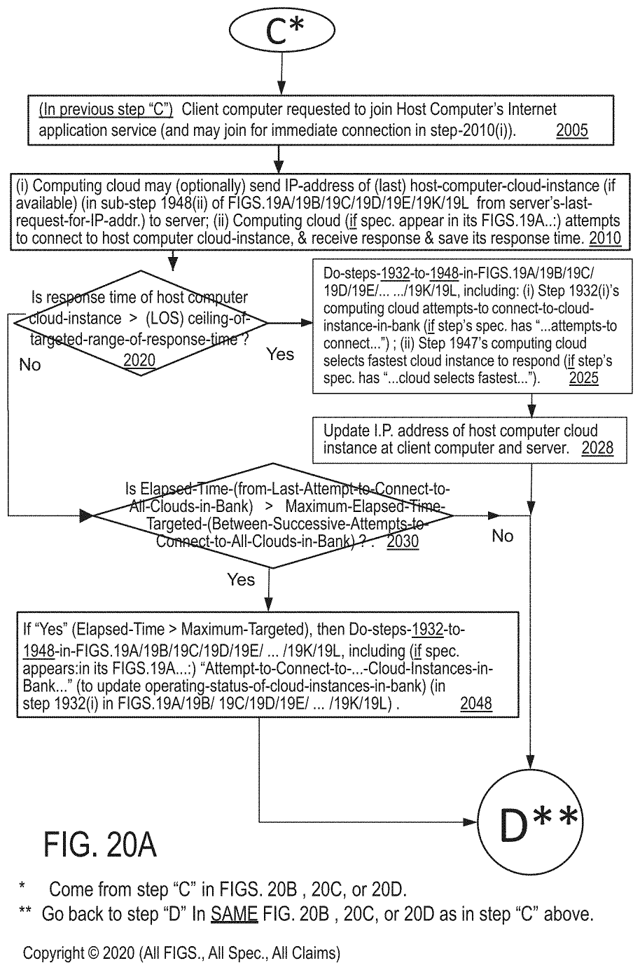

It is noted that computing cloud 198 may need (contractual/legal)-flexibility-(via-customer-cloud-instance-contract-modification-(not-shown))-in-customer-contract-terms-and-conditions for (customers' purchases of) its cloud instances to allow computing cloud 198 to (contractually/legally) increase virtualized-hardware (e.g. in FIG. 18C) or decrease (e.g. in FIG. 18E) virtualized-hardware (to a different virtualized-hardware-(than-originally)-contracted-for-(above, and illustrated in FIG. 19A step 1920) in its cloud instances, e.g. host computer cloud instance 205-C in FIGS. 9A-to-9B), as needed (e.g. in FIG. 19A, steps 1946(i) and 1940(i) respectively).

Important note: Host computer cloud instance 205-C (and/or host computer cloud instance 205n-C) may interchangeably-(in-many-places) use either 205-C and/or 205n-C (as generic-notations) to denote the (bank of one-or-more) host computer cloud instance (to allow easier/simpler-reading of the specification-and-FIGS in different contexts through-out this patent application). For example: 205-C in FIGS. 9A and 9B may use 205n-C instead (of using 205-C), etc.

Bank-of-(one-or-more)-host-computer-cloud-instances are further described in Para [0027A]-to-[0027D], and illustrated in FIGS. 2A, 9A-to-9B, and 9C's-columns-II-to-XIV.

### Process Considerations

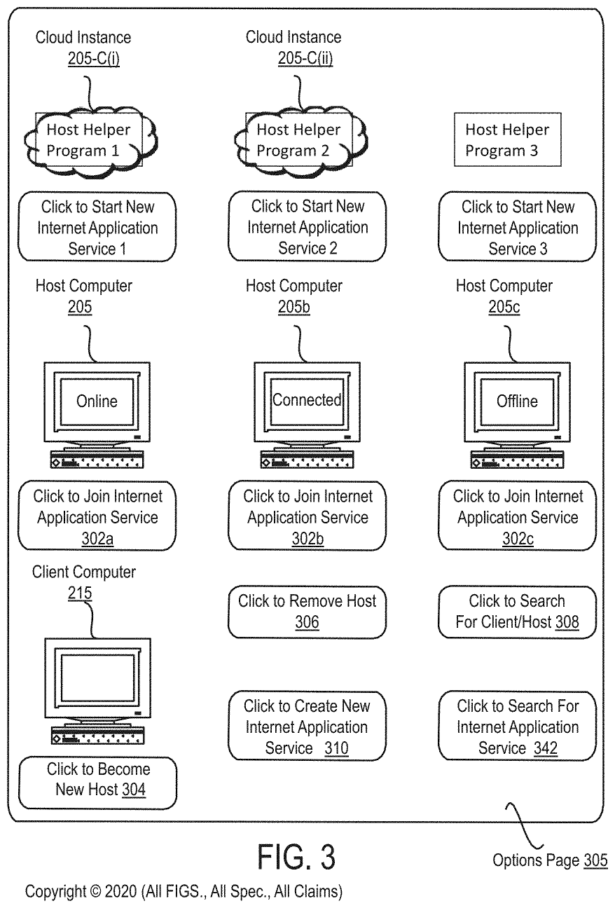

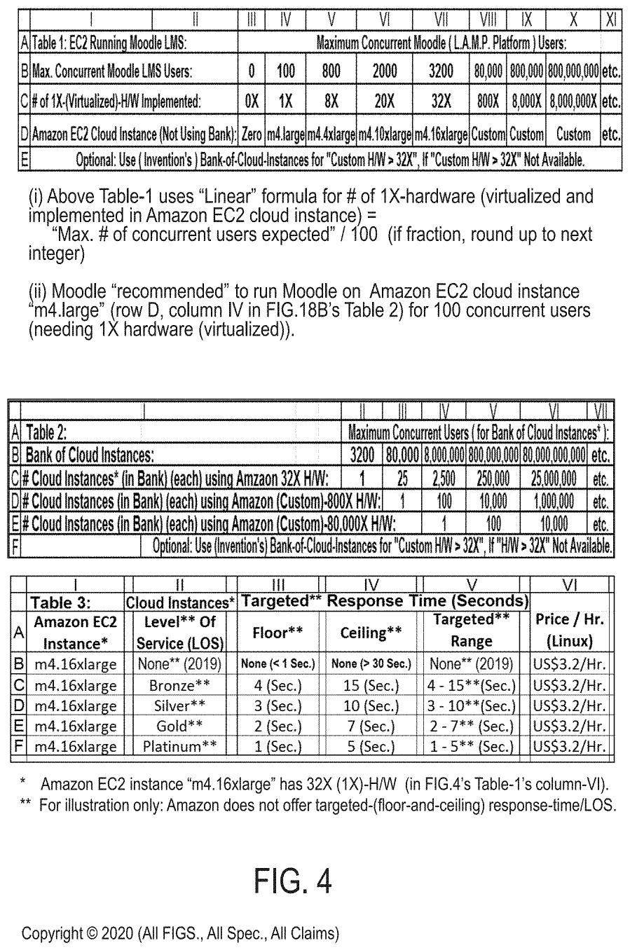

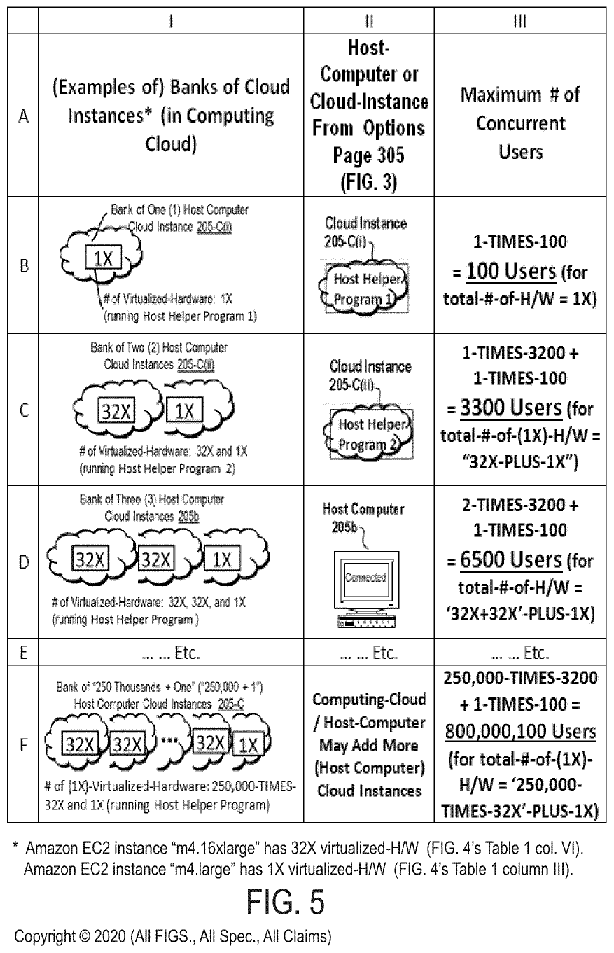

In one embodiment of the present invention, an (Internet application service) website 212A provides multiple web pages which allow a user to utilize the services of an (Internet application service) server 222A. When a user visits the website 212A via a web browser 218, the user may log into the website 212A by providing a username and an associated password in accordance with standard Internet techniques. After logging in, the user may select to use the services provided by the server 222A by interacting with an options page 305. FIG. 3 illustrates an options page 305 in accordance with one embodiment of the present invention. In one embodiment, an options page 305 comprises a file in PHP, ASPX, or HTML format.

The options page 305 provides selectable icons which correspond to services provided by the server 222A. In one embodiment, the options page 305 lists one or more host helper programs 216-1 that the user may click to request to start a new Internet application service (and becomes its host) through the direct network connections using cloud instance for Internet application service according to embodiments of the present invention. In another embodiment, the options page 305 lists one or more cloud instances 205-C (running respectively one or more host helper programs 216-1) that the user may click to request to start a new Internet application service (and becomes its host) through the direct network connections using cloud instance for multipoint meeting service according to embodiments of the present invention. In one embodiment, the options page 305 lists one or more host computers 205 that the user may request to join their Internet application services through the direct network connections using cloud instance for Internet application service according to embodiments of the present invention. Additionally, the options page 305 presents the status of the selectable host computers 205a, 205b, 205c (in FIG. 3). In one embodiment, a host computer may have a status of connected, online, or offline. A host computer 205c which is presently offline may not be joined in Internet application service. A host computer 205c may be offline because it does not have Internet connection or is not running. A host computer 205a that is “online” may be joined in Internet application service using the direct network connections using cloud instance for Internet application service according to embodiments of the present invention. A host computer 205b that is “connected” is already providing Internet application service using the direct network connections using cloud instance for Internet application service according to embodiments of the present invention. The user of a client computer 215 may select a host computer 205a, 205b that has a status of “online” or “connected” using the corresponding icon 302a, 302b to do Internet application service with the host computer 205a, 205b according to the direct network connections using cloud instance for Internet application service in accordance with various embodiments of the present invention.

Additionally, the user may select to provide other client computers 215 Internet application service with the user's computer by itself becoming a host computer 205, using icon 304. The user may also select to remove a host computer 205 from the list of accessible host computers 205 using icon 306, or select to search for a not-displayed host computer 205 using icon 308. Moreover, the user may select to create an event such as an Internet application session using icon 310. The options depicted in FIG. 3 and described above are provided for illustrative purposes only and are not intending to be limiting. Additional user-selectable options may be offered by an (Internet application) server 222A and/or presented on an options page 305 of an (Internet application) website 212A.

FIG. 4 shows:

(i) Table 1 illustrates maximum-users for different-#-of-(virtualized)-hardware-(in-cloud-instances). Table 1 is further described in Para [0045] below; and
(ii) Table 2: “Bank of Cloud Instances” (meaning “group of cloud instances”) illustrates maximum-users for different-banks-of-cloud-instances (meaning different-“groups-of-cloud-instances”) (using different #'s of (1X)-hardware): e.g. (using) 32X-(virtualized)-hardware-(in-row-C), (using) 800X-(virtualized)-hardware-(in-row-D), and (using) 80,000X-(virtualized)-hardware-(in-row-E) respectively. Table2 is further described in Para [0045A]-to-[0045D] below.

A bank of cloud instances is a group of cloud instances, and may be implemented using software-and-database just like other cloud instances or other group(s) of cloud instances. The term “bank of cloud instances” (meaning “group of cloud instances”) allows easier understanding of how to work with one-or-more cloud-instances (offering the SAME-Internet-application-service of the SAME-host-computer-205) in this invention; and

(iii) Table 3: “Cloud Instances' Targeted-Response-Times” illustrates examples of targeted response-times for cloud-instances-(of-32X-(virtualized)-hardware), using cloud instance for Internet application service in accordance with an embodiment of the present invention. Table 3 is further described in Para [0045E]-to-[0045G] below.

FIG. 4's Table 1 is same as FIG. 18A's Table 1, and relates:

(i) maximum-#-of-concurrent-users (in row B of FIG. 4's Table 1) to
(ii) #-of-(1X)-hardware-(in-Amazon-cloud-instance) (in row C of FIG. 4's Table 1).

Table-1's row C: “#-of-(1X)-hardware-(in-Amazon-cloud-instance)” uses and implements its footnote (i): “Linear” formula for “# of 1X-hardware (virtualized and implemented in Amazon EC2 cloud instance)”=“Max. # of concurrent users expected”/100 (if fraction, round up to next integer).

FIG. 4's Table-1's row-E-(and-column-II) indicates that (optionally) one may use (invention's) “bank-of-cloud-instances” (in FIG. 18B's Table-2's columns-III-and-IV) for custom-hardware (in Table-1's row-D-and-columns-VII-to-IX) greater-than 32X-(1X)-(virtualized)-hardware, if “custom-H/W>32X” is not available from Amazon.

FIG. 4's Table 1 is further described in Para [0060] and [0060A]-to-[0060F] below for FIG. 18A (which FIG. 18A's Table-1 is same as FIG. 4's Table-1).

Referring to FIG. 4's Table 2: “Bank of Cloud Instances”, Table 2 illustrates maximum-users for different-banks-of-cloud-instances (meaning different-“groups-of-cloud-instances”) (using different #'s of (1X)-hardware): 32X-(virtualized)-hardware-(in-row-C), 800X-(virtualized)-hardware-(in-row-D), and 80,000X-(virtualized)-hardware-(in-row-E) respectively.

A bank of cloud instances is a group of cloud instances, and may be implemented using software-and-database just like other cloud instances or other group(s) of cloud instances. The term “bank of cloud instances” (meaning “group of cloud instances”) allows easier understanding of how to work with one-or-more cloud-instances (offering the SAME-Internet-application-service of the SAME-host-computer-205) in this invention.

(i) As an example: for maximum-concurrent-users of 80,000 (row “B” and column “III”) for a bank-of-cloud-instances-(each-(of-which-cloud-instances)-using-Amazon's-32X-(virtualized)-hardware (row “C” and column “I”), #-of-cloud-instances-in-bank (row “C” and column “I”)=25 (row “C” and column “III”; and each-(of-which-25-cloud-instances)-using-Amazon's-32X-(virtualized)-hardware).
(ii) As another example using above-(i) of Para [0045A]: If Amazon's-800X-(virtualized)-hardware (row “D” and column “F”) were used in above-(i) of Para [0045A], the bank-(of-cloud-instances) would need only-one-(1)-cloud-instance-(in-bank) (row “D” and column “III”; and this-one-(i)-cloud-instance-using-Amazon's-800X-(virtualized)-hardware).

Please note that since 800X-(virtualized)-hardware is greater than 33X, so Amazon needs to be contacted to customize the 800X-(virtualized)-hardware (assuming that Amazon has the technology-(etc.) to offer 800X-(virtualized)-hardware-(cloud-instance) in 2019 (or later when it is needed).

Please note that the invention (using bank-of-25-cloud-instances) in above-(i) of Para [0045A] allows Amazon to support maximum-concurrent-users of 80,000 (rows “B”-and-“C”, and column “III”) without need to customize 800X-(virtualized)-hardware-(cloud-instance) in 2019.

(iii) As a further example for FIG. 4's Table-2: For maximum-concurrent-users (possibly non-human-users in Internet-of-Things (IoT)) of 80,000,000.000 (80-billions in row-“B”-and-column-“VI”) for a bank-of-cloud-instances-(each-(of-which-cloud-instances)-using-Amazon's-32X-(virtualized)-hardware (row “C” and column “I”), #-of-cloud-instances-in-bank (row “C” and column “I”)=25,000.000 (25-millions in row-“C” and column “VI”; and each-(of-which-25-millions-cloud-instances)-using-Amazon's-32X-(virtualized)-hardware (available in 2018)).
(iv) As another example using above-(iii) of Para [0045C]: if Amazon's-80,000X-(virtualized)-hardware-(row “E” and column “I”) were used in (iii) above, the bank would need only-10,000-(ten-thousands)-cloud-instance-(in-bank) (row “E” and column “VI”; and each-(of-which-10,000-cloud-instances)-cloud-instance-using-Amazon's-80,000X-(virtualized)-hardware).

Please note that since 80,000X-(virtualized)-hardware is greater than 33X, so Amazon needs to be contacted to customize the 80,000X-(virtualized)-hardware (assuming that Amazon has the technology-(etc.) to offer 80,000X-(virtualized)-hardware-(cloud-instance) in 2019 (or later when it is needed).

Please note that the invention (using bank-of-25-millions-cloud-instances) in above-(iii) of Para [0045A] allows Amazon (in 2019) to support maximum-concurrent-(including-non-human)-users of 80-billions (rows “B”-and-“C”, and column “III”) using Amazon's-2019's-technology: “32X-(virtualized)-hardware-(cloud-instances), without need to customize 80,000X-(virtualized)-hardware-(cloud-instances) in 2019 (which Amazon may not offer in 2019).

FIG. 4's Table-2's row-F-(and-column-II) indicates that (optionally) one may use (invention's) “bank-of-cloud-instances” (in FIG. 18B's Table-2's columns-III-and-IV) for custom-hardware (in FIG. 4's Table-1's row-D-and-columns-VII-to-IX) greater-than 32X-(1X)-(virtualized)-hardware, if “custom-H/W>32X” is not available from Amazon.

Referring to FIG. 4's Table 3, Table 3 illustrates (examples of) targeted-response-times (in the invention; e.g. floors and ceilings and targeted-ranges (in columns III-and-IV-and-V, and rows “A”-to-“F”) for response-times) for different levels-of-services (LOS): (i) None (2019) (in-row-“B”), (ii) Bronze (in-row-“C”), (iii) Silver (in-row-“D”), (iv) Gold (in-row-“E”), and (v) Platinum (in-row-“F”) respectively (for Amazon EC2 instance “m4.16xlarge”: 32X virtualized-hardware-(cloud-instance)), as follows:

(i) As an example: for levels-of-services (LOS): None (2019) (in Table-3's row-“B” and columns II-to-V), as Amazon has no levels-of-services (LOS) (floor and ceiling and targeted-range) targeted for its Amazon EC2 instances (e.g. “m4.16xlarge” in column-“I” of Table 3), so (for “m4.16xlarge”-cloud-instance):
Amazon's default floor-response-time would be (almost)-zero (or “None (<1 sec.)” in Table-3's row-“B”-and-column-“III”) if there is no-client-215/no-load (logged-in) to the (“m4.16xlarge”)-host-computer-cloud-instance-205-C (in FIG. 2A or FIG. 9A); and
Amazon's default ceiling-response-time would be (high-and)-has-no-maximum (or “None (>30 sec.)” in row-“B”-and-column-“IV” of Table-3). Please note that this no-maximum-(and-“ceiling>30-sec.”)-response-time would apply to each-and-every-client-215 in FIG. 2A.

Please note that when response-time is at “ceiling>30-sec.” (in row-“B”-and-column-“IV” of Table-3), many clients-215 would not wait, and may go to a competitor's-website, when too-many-clients-215/100%-(CPU)-load-on-virtualized-hardware/not-responsive-virtualized-hardware (logged-in) to the (“m4.16xlarge”)-host-computer-cloud-instance-205-C (in FIG. 2A or FIG. 9A). So targeted-(floor-and)-ceiling-(and-range-of)-response-times are critical to level-of-services (LOS) and satisfied/happy clients/customers; and
Amazon's default “targeted-range”-response-time would be none-(in-2019) (or “None (2019)” in row-“B”-and-column-“V” of Table-3).

Important note: Host computer cloud instance 205-C (and/or host computer cloud instance 205n-C) may interchangeably-(in-many-places) use either 205-C and/or 205n-C (as generic-notations) to denote the (bank of one-or-more) host computer cloud instance (to allow easier/simpler-reading of the specification-and-FIGS in different contexts through-out this patent application). For example: 205-C in FIGS. 9A and 9B may use 205n-C instead (of using 205-C), etc.

(ii) As a second example: for levels-of-services (LOS): Bronze-(LOS) (in FIG. 4's Table-3's row-“C” and columns II-to-V), floor-and-ceiling-and-“targeted-range” (targeted for response-time) for Amazon EC2 instance (for “m4.16xlarge”-cloud-instance) would be:
Bronze-(LOS) floor-response-time would be 4-sec. (in Table-3's row-“C”-and-column-“III”). If a cloud-instance has response-time-below-floor, the invention allows the not-needed-(“below-floor”) virtualized-hardware to be returned (as illustrated in step-1940 of FIG. 19A and described in Para [0126H] below) to the computing cloud 198 (in FIG. 9A).

Please note that the cloud-instance could get price-discounts-for-returned-“not-needed-(“below-floor”)-virtualized-hardware”; and
Bronze-(LOS) ceiling-response-time would be 15-sec. (in row-“C”-and-column-“IV” of Table-3). If a cloud-instance has response-time-above-ceiling, the invention allows options (including adding-virtualized-hardware to-the-cloud-instance) (as illustrated in step-1946 of FIG. 40A and described in Para [0126J]), so that its response-time returns to below-ceiling-(of-15-sec.); and
Bronze-(LOS) “targeted-range”-response-time would be 4-to-15-sec. in row-“C”-and-column-“V” of Table-3), and would be between its floor-and-ceiling-response-times (of 4-sec. and 15-sec. respectively).

The price/hour/client would be very cost-effective of 0.2-cent-to-0.75-cent (not shown) for Bronze level-of-service (LOS) for this invention, compared to Amazon price/hour/client of “0+”-cent-to-320-cents (not shown) for current Amazon default-no-level-of-service

(iii) As a third example: for levels-of-services (LOS): Platinum-(LOS) (in FIG. 4's Table-3's row-“F” and columns II-to-V), floor-and-ceiling-and-“targeted-range” (targeted for response-time) for Amazon EC2 instance (for “m4.16xlarge”-cloud-instance) would be:
Platinum-(LOS) floor-response-time would be 1-sec. (in Table-3's row-“F”-and-column-“III”). If a cloud-instance has response-time-below-floor, the invention allows the not-needed-(“below-floor”) virtualized-hardware to be returned (as illustrated in step-1940 of FIG. 19A and described in Para [0126H] below) to the computing cloud 198 (in FIG. 9A).

Please note that the cloud-instance could get price-discounts-for-returned-“not-needed-(“below-floor”)-virtualized-hardware”; and
Platinum-(LOS) ceiling-response-time would be 5-sec. (in row-“F”-and-column-“IV” of Table-3). If a cloud-instance has response-time-above-ceiling, the invention allows options (including adding-virtualized-hardware to-the-cloud-instance) (as illustrated in step-1946 of FIG. 19A and described in Para [0126J]), so that its response-time returns to below-ceiling-(of-5-sec.); and
Platinum-(LOS) “targeted-range”-response-time would be 1-to-5-sec. in row-“F”-and-column-“V” of Table-3), and would be between its floor-and-ceiling-response-times (of 1-sec. and 5-sec. respectively).

The price/hour/client would be very cost-effective of 0.6-cent-to-3-cent (illustrated in Para [0052K] and [0125K]) for Platinum level-of-service (LOS) for this invention, compared to Amazon price/hour/client of “0+”-cent-to-320-cents (not shown) for current Amazon default-no-level-of-service

FIG. 5 illustrates examples of banks-of-cloud-instances (meaning “groups-of-cloud-instances”, in column I), different host computers (from FIG. 3), and their maximum-#-of-concurrent-uses/clients (in column III) for Internet application services, in accordance with an embodiment of the present invention. FIG. 5 complements and illustrates FIG. 4's Table 1, and (FIG. 5's four examples) are further explained in Para [0046B]-(a)-to-(d) below.

A bank of cloud instances is a group of cloud instances, and may be implemented using software-and-database just like other cloud instances or other group(s) of cloud instances. The term “bank of cloud instances” (meaning “group of cloud instances”) allows easier understanding of how to work with one-or-more cloud-instances (offering the SAME-Internet-application-service of the SAME-host-computer-205) in this invention.

The word “group” may be used in lieu of the term “bank” throughout the specification and FIGS of this patent application. So a “bank of cloud instances” means and is SAME as a “group of cloud instances”.

Please note that the individual cloud instances in the SAME bank-of-cloud-instances (meaning SAME “group-of-cloud-instances”) may be different (Amazon EC2) (virtualized-hardware)-cloud-instances (and have different # of 1X-virtualized-hardware), as illustrated by FIG. 5's column-1, and by FIG.-9C's columns-“VII”-and-“VIII”.

Bank-of-(one-or-more)-host-computer-cloud-instances (meaning “group-of-(one-or-more)-host-computer-cloud-instances”) are further described in Para [0027A]-to-[0027D], and illustrated in FIGS. 2A, 9A-to-9B, and 9C's-columns-II-to-XIV.

(a) FIG. 5 complements and illustrates FIG. 4's Table 1, and (FIG. 5's four examples) are further explained in Para [0046B]-(a)-to-(d) below.

As an example, FIG. 5's row-“B” illustrates that a cloud instance (or a bank of one (1) cloud instance) (in FIG. 5's row-“B”-and-column-“I”) of 1X-(virtualized)-hardware has maximum # of concurrent users (in row-“B”-and-column-“III”) of “1-times-100=100 users”, which “100 users” is from FIG. 4's Table-1's row-“B”-and-column-“III”, or computed from “Linear” formula in FIG. 4's footnote (i):
“Linear” formula for # of 1X-hardware (virtualized and implemented in Amazon EC2 cloud instance)=“Max. # of concurrent users expected”/100 (if fraction, round up to next integer).

(b) As a second example, FIG. 5's row-“C” illustrates that a bank of two (2) cloud instances (meaning “a group of two cloud instances”) (in FIG. 5's row-“C”-and-column-“I”) of “32X-and-1X-(virtualized)-hardware respectively” has maximum # of concurrent users (in row-“C”-and-column-“III”) of “1-times-3200-users+1-times-100-users'=3300 users”, which “3200-users and 100-users” is from FIG. 4's Table-1's “row-‘B’ and columns-‘VI’-and-‘III’ respectively”, or computed from “Linear” formula in FIG. 4's footnote (i):
“Linear” formula for # of 1X-hardware (virtualized and implemented in Amazon EC2 cloud instance)=“Max. # of concurrent users expected”/100 (if fraction, round up to next integer).

(c) As a third example, FIG. 5's row-“D” illustrates that a bank of three (3) cloud instances (meaning “a group of three cloud instances”) (in FIG. 5's row-“D”-and-column-“I”) of “2-times-32X-PLUS-1X-(virtualized)-hardware respectively” has maximum # of concurrent users (in row-“D”-and-column-“III”) of “‘2-times-3200-users+1-times-100-users’=6500 users”, which “3200-users and 100-users” is from FIG. 4's Table-1's “row-‘B’ and columns-‘VI’-and-‘III’ respectively “, or computed from “Linear” formula in FIG. 4's footnote (i):
“Linear” formula for # of 1X-hardware (virtualized and implemented in Amazon EC2 cloud instance)=“Max. # of concurrent users expected”/100 (if fraction, round up to next integer).

(d) As a fourth example, FIG. 5's row-“F” illustrates that a bank of 250-thousands-and-one (250,001) cloud instances (meaning “a group of 250-thousands-and-one (250,001) cloud instances”) (in FIG. 5's row-“F”-and-column-””) of “250,000-times-32X-PLUS-1X-(virtualized)-hardware respectively” has maximum # of concurrent users (in row-“F”-and-column-“III”) of “‘250,000-times-3200-users+1-times-100-users’=800,000,100 users”, which “3200-users and 100-users” is from FIG. 4's Table-1's “row-‘B’ and columns-‘VI’-and-‘III’ respectively”, or computed from “Linear” formula in FIG. 4's footnote (i):
“Linear” formula for # of 1X-hardware (virtualized and implemented in Amazon EC2 cloud instance)=“Max. # of concurrent users expected”/100 (if fraction, round up to next integer).

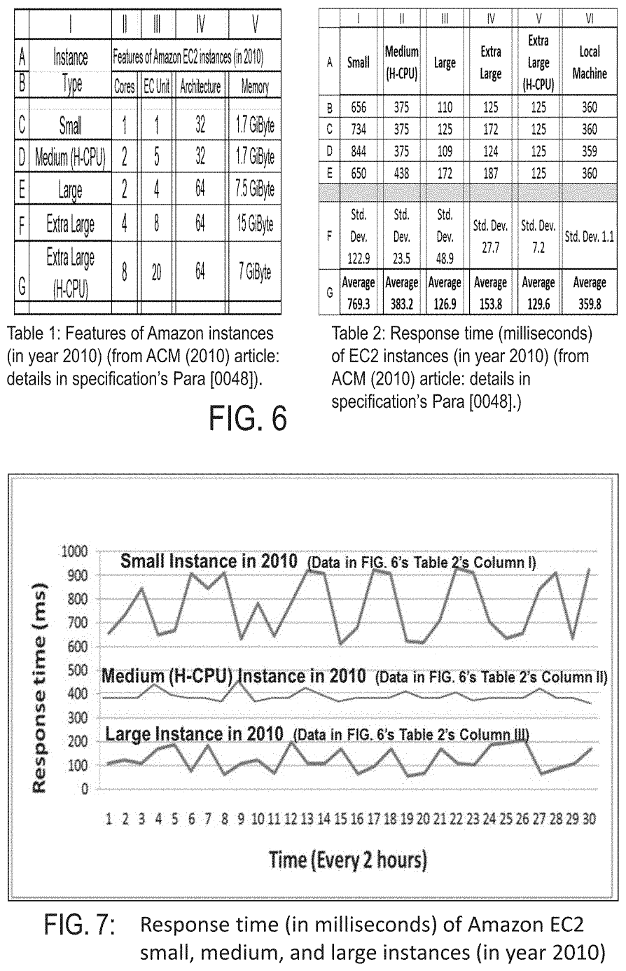

FIG. 6 shows two tables of features of Amazon EC2 cloud offering, and Amazon EC2 cloud-instance response-time in year 2010.

FIG. 6's Table 1 is “Features of Amazon EC2 instances (in year 2010)”, and FIG. 6's Table 2 is “Samples of response time of Amazon EC2 cloud-instance (in year 2010)”. Both Tables 1 and 2 are from page 3 of ACM (2010) article: “Response Time for Cloud Computing Providers” by Mohammed Alhamad, Tharam Dillon, et al, of Curtin Univ. of Technology (Australia), and published in year 2010 by Association for Computing Machinery (ACM), Inc. (in U.S.A.).

It is noted that from FIG. 6's Table-2's row-“G”-and-columns “I”-to-“III” that:

(i) the average response-time 0.3832 sec. (383.2 ms) of the medium (H-CPU) instances are less the average response-time 0.7693 sec. (769.3 ms) of the small instances, and
(ii) the average response-time 0.1269 sec. (126.9 ms) of the large instances are less the average response-time 0.3832 sec. (383.2 ms) of the medium (H-CPU) instances.

Above (i) and (ii) in Para [0047A] are logical that larger instances have faster response-time, as:
larger (i.e. higher-performance from more virtualized-hardware in) instances (illustrated by rows C-to-D (for small, medium (H-CPU), and large instance type respectively) of Table 1 of FIG. 6) are faster (illustrated by columns I-to-III (for small, medium (H-CPU), and large instance type respectively) of Table 2 of FIG. 6), and can respond faster (and have faster response-time) to clients (like a higher-performance PC would be faster in its PC-user-response-(time)).

It is also noted that (a) cloud instances in year 2018 (and beyond) are much more powerful than cloud instances in year 2010 (because of the annual exponential increase in both hardware-performance and network-bandwidth-performance), and (ii) cloud instances in 2018 (and beyond) would have response-time (much) less than 0.1269 second (126.9 ms) response-time in year 2010 (of large instance in column III of Table 2 of FIG. 6).

FIG. 7 shows charts of response-time (in milliseconds) of small, medium, and large instances (in year 2010) of Amazon EC2 cloud-instances:
using response-time data from FIG. 6's Table-2, and which (FIGS. 6's-and-7's data)
(FIGS. 6's-and-7's data) are from (above article's) Tables-1-and-2 and (above article's) FIGS. 3-to-5 (for small, medium (H-CPU), and large instances respectively) on pages 3-and-4 of above ACM (2010) article: “Response Time for Cloud Computing Providers” by Mohammed Alhamad, Tharam Dillon, et al, of Curtin Univ. of Technology (Australia), and published in year 2010 by Association for Computing Machinery (ACM), Inc. (in U.S.A.), which above-referenced ACM (2010) article is incorporated by reference herein in its entirety.

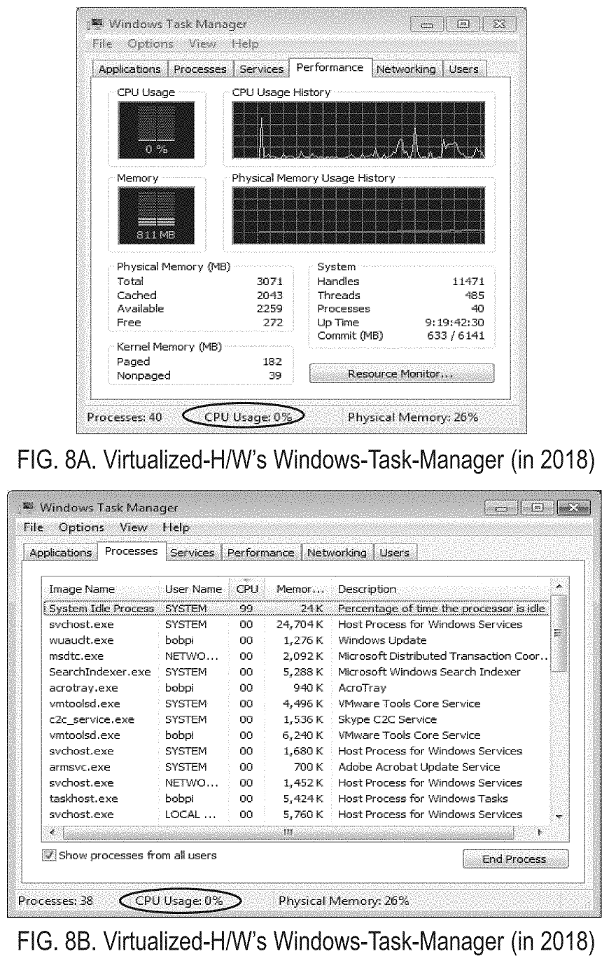

FIGS. 8A and 8B show Windows-task-managers (in 2018) of virtualized-hardware-(of-VMWare-virtual-machine-running-on-an-average-home-computer) having (almost)-zero-CPU-(hardware) usage (and with no client-load), which implies that cloud instances (with no client-load) in 2018 would have response-time (close-to)-zero-sec., or less than (0.1269 second (126.9 ms)) response-time in 2010 (in above ACM (2010) article in Para[0048]).

FIGS. 9A and 9B are block diagrams illustrating providing direct network connections using cloud instances (e.g. banks of host computer cloud instances 205-C for Internet application service between (one-or-more) client computer(s) 215 and a host computer 205 over a computer network, in accordance with an embodiment of the present invention.

FIG. 9B shows that the host computer 205 is not needed (to be connected-to-Internet-200) for Internet application service for the (one-or-more) client computer(s) 215 (after the service is setup in FIG. 9A).

FIG. 9C shows a table illustrating examples of a computing cloud 198 and multiple banks (e.g. Alpha-205-C, Bravo-205-C, Charlie-205-C, Delta-205-C, . . . , Mike-205-C in FIG. 9C's column-II) of host computer cloud instances 205-C on Internet 200, providing direct network connections using cloud instance for Internet application service over a computer network in accordance with an embodiment of the present invention. FIG. 9C is further described in Para [0052A]-to-[0052C] below.

FIGS. 9D-to-9F shows tables illustrating features of banks of host computer cloud instances 205-C used to provide direct network connections using cloud instances (in the banks of cloud instances) for Internet application service over a computer network in accordance with another embodiment of the present invention. FIGS. 9D-to-9F are further described in Para [0052D]-to-[0052G] below.

A bank of cloud instances is a group of cloud instances, and may be implemented using software-and-database just like other cloud instances or other group(s) of cloud instances. The term “bank of cloud instances” (meaning “group of cloud instances”) allows easier understanding of how to work with one-or-more cloud-instances (offering the SAME-Internet-application-service of the SAME-host-computer-205 (and/or of the SAME-host-computer-cloud-instance 205-C, e.g. in FIGS. 9A and 9B) in this invention application.

Please note that the individual cloud instances in the SAME bank-of-cloud-instances (meaning SAME “group-of-cloud-instances”) may be different (Amazon EC2) (virtualized-hardware)-cloud-instances (and have different # of (1X)-virtualized-hardware), as illustrated by FIG. 5's column-1, and by FIG.-9C's columns-“VII”-and-“VIII”.

Bank-of-(one-or-more)-host-computer-cloud-instances 205-C are further described in Para [0027A]-to-[0027D], and illustrated in FIG. 2A.

FIG. 9C shows a table illustrating examples of “banks of cloud instances” (meaning “groups of cloud instances” and implemented using software-and-database (not shown)) in following rows-of-the-table:
(i) “Alpha” bank of ten (10) cloud-instances in rows-“A1-to-A10”-and-columns-“I”-to “XV”-of-FIG-9C's-table; and
(ii) “Bravo” bank of four (4) cloud-instances in rows-“B1-to-B4”- and-columns-“I”-to “XV”-of-FIG-9C's-table; and
(iii) “Charlie” bank of one (1) cloud-instance in row-“C”- and-columns-“I”-to “XV”-of-FIG-9C's-table; and
(iv) “Delta” bank of one (1) cloud-instance in row-“D”- and-columns-“I”-to“XV”-of-FIG-9C's-table; and
(v) “Echo” bank of one (1) cloud-instance in row-“E”- and-columns-“I”-to“XV”-of-FIG-9C's-table; and
(vi) “Foxtrot” bank of one (1) cloud-instance in row-“F”- and-columns-“I”-to“XV”-of-FIG-9C's-table; and
(vii) “Golf” bank of three (3) cloud-instances in rows-“G1-to-G3”- and-columns-“I”-to “XV”-of-FIG-9C's-table; and
(viii) “Hotel” bank of three (3) cloud-instances in rows-“H1-to-H3”- and-columns-“I”-to “XV”-of-FIG-9C's-table; and
(ix) “India” bank of one (1) cloud-instance in row-“I”- and-columns-“I”-to “XV”-of-FIG-9C's-table; and
(x) “Juliette” bank of one (1) cloud-instance in row-“J”- and-columns-“I”-to “XV”-of-FIG-9C's-table; and
(xi) “Kilo” bank of one (1) cloud-instance in row-“K”- and-columns-“I”-to “XV”-of-FIG-9C's-table; and
(xii) “Lima” bank of one (1) cloud-instance in row-“L”- and-columns-“I”-to “XV”-of-FIG-9C's-table; and
(xiii) “Mike” bank of one (1) cloud-instance in row-“M”- and-columns-“I”-to “XV”-of-FIG-9C's-table.

Please note that the names for banks-of-cloud-instances: “Alpha”, “Bravo”, “Charlie”, . . . etc. are for easy references (and easier understanding) in this patent application and invention, and (the names) may not need to be implemented (in software-and-database).

The fifteen (15) columns of FIG. 9C's table illustrating examples of “banks of cloud instances” (meaning “groups of cloud instances”) in the table's rows are:

(i) Column-‘I’ (of FIG. FIG. 9C's table) is list of “Unique Public IP address” of the cloud-instance-(in-column-“IV”-in FIG. 9C) to access the Internet 200 (in FIG. 9A): e.g. 54.201.157.224, 54.201.157.225, . . . 54.68.74.224, . . . etc.; and
(ii) Column-“II” (of FIG. 9C's table) is list of “Banks of Host Computer Cloud Instances (Alpha, Bravo, . . . ) 205-C”: e.g. “Alpha” Bank of Host Computer Cloud Instances Alpha-205-C (in rows-“A1-to-A10”-and-column-“II”-of-FIG. 9C); “Bravo” Bank of Host Computer Cloud Instances Bravo-205-C (in rows-“B1-to-B4”-and-column-“II”-of-FIG. 9C): “Charlie” Bank of Host Computer Cloud Instance Charlie-205-C (in row-“C”-and-column-“II”-of-FIG. 9C); “Delta” Bank of Host Computer Cloud Instance Delta-205-C (in row-“D”-and-column-“II”-of-FIG. 9C): . . . etc.; and
(iii) Column-“III” (of FIG. 9C's table) is list of short-references to “Host Computer Cloud Instances (H.C.C.I.)”: e.g. a, b, c, d, e, f, g, h, i, j (in rows-“A1-to-A10”-and-column-“III”-of-FIG. 9C), k, l, m1, m2 (in rows-“B1-to-B4”-and-column-“III”-of-FIG. 9C): o (in row-“C”-and-column-“III”-of-FIG. 9C): p (in row-“D”-and-column-“III”-of-FIG. 9C): . . . etc.; and
(iv) Column-“IV” (of FIG. 9C's table) is list-of-names of “Host Computer Cloud Instances (H.C.C.I.)”: e.g. H.C.C.I. 205a-C, H.C.C.I. 205b-C, H.C.C.I. 205c-C, . . . H.C.C.I. 205j-C (in rows-“A1-to-A10”-and-column-“IV”-of-FIG. 9C); H.C.C.I. 205k-C, H.C.C.I. 205l-C, . . . H.C.C.I. 205m2-C (in rows-“B1-to-B4”-and-column-“IV”-of-FIG. 9C): . . . etc.; and
(v) (Now refer to FIG. 9H:) Column-“V” (for better readability) is shown in FIG. 9H, and not shown in FIG. 9C. FIG. 9H's Columns-“I”-to-“XI” are same as that for FIG. 9C (which does not show columns-“V”-&-“VI” (shown in FIG. 9H) for better readability):
Column-“V” (of FIG. 9H's table) is list of “(No-LOS)-EC2's-maximum-#-of-concurrent-users” (for each of the EC2-cloud-instances-and-(#-of)-hardware in columns-IV-and-VII-and-VIII): e.g. 3200, 3200, 3200, 3200, 2000, 800 . . . etc. (in rows-“A1”-to-“M”-and-column-“V”-of-FIG. 9H).

(FIG. 9H's table's) Column-“V”'s “(No-LOS)-EC2's-maximum-#-of-concurrent-users” is copied-(extracted/edited) (in one-to-one-“matching-EC2-instance”-correspondence) from (FIG. 18B's Table-2's) column-“I”-(“Max.-#-of-Users”), wherein:
(FIG. 18B's Table-2's)-column-“IV” 's EC2-instance's “Max.-#-of-Users”-(in column-“I” (of FIG. 18B's Table-2) is copied-(extracted/edited) (in one-to-one-“matching-EC2-instance”-correspondence) to (FIG. 9H's table's) Column-“V”'s “(No-LOS)-EC2's-maximum-#-of-concurrent-users”.
e.g. as a first example, (FIG. 18B's Table-2's)-column-“IV”-and-row-“I” 's EC2-instance-“m4.16xlarge”-(32X-(virtualized)-H/W-implemented)'s “Max.-#-of-Users”-(in column-“I”-and-row-“r” (of FIG. 18B's Table-2)-of-“3200”-(thirty-two-hundred) is copied-(extracted/edited) (in one-to-one-“matching-EC2-instance”-correspondence) to (FIG. 9H's table's) Column-“V”-and-row-“A1's “(No-LOS)-EC2's-maximum-#-of-concurrent-users”-of-“3200”-(thirty-two-hundred); and
as a second example, (FIG. 18B's Table-2's)-column-“IV”-and-row-C” 's EC2-instance-“Zero/Non/Empty”-(0X-(virtualized)-H/W-implemented)'s “Max.-#-of-Users”-(in column-“I”-and-row-“C” (of FIG. 18B's Table-2)-of-“0”-(zero) is copied-(extracted/edited) (in one-to-one-“matching-EC2-instance”-correspondence) to (FIG. 9H's table's) Column-“V”-and-row-“L”'s “(No-LOS)-EC2's-maximum-#-of-concurrent-users”-of-“0”-(zero); and
   (vi) (Still referring to FIG. 9H:) Column-“VI” (for better readability) is shown in FIG. 9H, and not shown in FIG. 9C. FIG. 9H's Columns-“I”-to-“XI” are same as that for FIG. 9C (which does not show columns-“V”-&-“VI” (shown in FIG. 9H) for better readability): Column-“VI” (of FIG. 9H's table) is (list of) “Host Helper Program 216-1” (software installed and running to provide Internet application services for Host Computer Cloud Instance (in column-“IV” of FIG. 9H or FIG. 9C): e.g. Moodle LMS. (in rows-“A1-to-A10”-and-column-“VI”-of-FIG. 9H), L.A.M.P. Platform (in rows-“B1-to-B4”-to-and-column-“VI”-of-FIG. 9H), . . . etc.; and
   (vii) (Now refer back to FIG. 9C:) Column-“VII” (of FIG. 9C's table) is (list of) “Amazon EC2 Cloud Instance” (used for Host Computer Cloud Instance (in column-“IV”): e.g. m4.16xlarge, m4.16xlarge, . . . m4.10xlarge, m4.4xlarge, . . . etc. (in rows-“A1”-to-“A10”-and-column-“VII”-of-FIG. 9C, . . . etc.); and
   (viii) Column-“VIII” (of FIG. 9C's table) is (list of) “# of (1X)-Virtualized-Hardware” (used for Host Computer Cloud Instance (in column-“IV”): e.g. 32, 32, 32, 32, 20, 8, 8, 1, 1, 1 (in rows-“A1”-to-“A10”-and-column-“VIII”-of-FIG. 9C); 32, 32, 8, 1 (in rows-“B1”-to-“B4”-and-column-“VIII”-of-FIG. 9C); . . . etc.; and
   (ix) Column-“IX” (of FIG. 9C's table) is (list of) “Level of Service (LOS)” (targeted for Host Computer Cloud Instance (in column-“IV”): e.g. Platinum, Platinum, Platinum, Platinum, Platinum, Platinum, Platinum, Platinum. Platinum, Platinum (in rows-“A1”-to-“A10”-and-column-“IX”-of-FIG. 9C); Gold, Gold, Gold, Gold (in rows-“B1”-to-“B4”-and-column-“LX”-of-FIG. 9C); . . . etc.

The five-(5)-columns-“X”-to-“XV” of FIG. 9C's table illustrating examples of “banks of cloud instances” (meaning “groups of cloud instances”) in the table's rows are: (i) Column-“X” (of FIG. 9C's table) is “Target-Floor Response Time (Sec.)” (for Host Computer Cloud Instance (in column-“IV”): e.g. 1, 1, 1, 1, 1, 1, 1, 1, 1, 1 (in rows-“A1”-to-“A10”-and-column-“X”-of-FIG. 9C); 2, 2, 2, 2 (in rows-“B1”-to-“B4”-and-column-“X”-of-FIG. 9C); . . . etc.; and

(v) Column-“XI” (of FIG. 9C's table) is “Target-Ceiling Response Time (Sec.)” (for Host Computer Cloud Instance (in column-“IV”): e.g. 5, 5, 5, 5, 5, 5, 5, 5, 5, 5 (in rows-“A1”-to-“A10”-and-column-“XI”-of-FIG. 9C); 7, 7, 7, 7 (in rows-“B1”-to-“B4”-and-column-“XI”-of-FIG. 9C); . . . etc.; and
(vi) Column-“XII” (of FIG. 9C's table) is “Last Ping Time (GMT)” (Greenwich Mean Time) (for Host Computer Cloud Instance (in column-“IV”): e.g. 10:12, 10:12, 10:12, 10:12, 10:12, 10:12, 10:12, 10:12, 10:12, 10:12 (in rows-“A1”-to-“A10”-and-column-“XII”-of-FIG. 9C); 18:26, 18:26, 18:26, 18:26 (in rows-“B1”-to-“B4”-and-column-“XII”-of-FIG. 9C); , . . . etc.; and
(vii) Column-“XIII” (of FIG. 9C's table) is “Max. Time Between Pings (Sec.)” (for Host Computer Cloud Instance (in column-“IV”): e.g. 60, 60, 60, 60, 60, 60, 60, 60, 60, 60 (in rows-“A1”-to-“A10”-and-column-“XII”-of-FIG. 9C); 120, 120, 120, 120 (in rows-“B1”-to-“B4”-and-column-“XIII”-of-FIG. 9C); , . . . etc.; and
(viii) Column-“XIV” (of FIG. 9C's table) is “Last Ping Response Time (Sec.)” (for Host Computer Cloud Instance (in column-“V”): e.g. 2.532, 1.028, 2.086, 3.143, 3.509, 1.761, 1.204, 2.895, 4.312, 2.237 (in rows-“A1”-to-“A10”-and-column-“XIV”-of-FIG. 9C); 5.385, 2.809, 3.347, 6.389 (in rows-“B1”-to-“B4”-and-column-“XIV”-of-FIG. 9C); , . . . etc.; and
(ix) Column-“XV” (of FIG. 9C's table) is “Ranking of Last Ping Response Time” (for Host Computer Cloud Instance (in column-“IV”): e.g. 6, 1, 4, 8, 9, 3, 2, 7, 10, 5 (in rows-“A1”-to-“A10”-and-column-“XV”-of-FIG. 9C); 3, 1, 2, 4 (in rows-“B1”-to-“B4”-and-column-“XV”-of-FIG. 9C); , . . . etc.

FIG. 9D's Table-1's rows-“A1”-to-“A10”-and-columns-“I”-to-“IV”-and-“VII”-to-“XV” (are copied-from-and-identical to FIG. 9C's table's rows-“A1”-to-“A10”-and-columns-“I”-to-“IV”-and-“VII”-to-“XV” respectively, and) illustrate “Previous-Ping-Results: Previous Ping-Response-Time (Sec.) (in column-XIV) & Previous Ping-Ranking (in column-XV):

(i) FIG. 9D's Table-1's column-“XII” shows that “Last Ping Time (GMT)” (in heading-of-column-“XII”) was at 10:12 GMT (Greenwich Mean Time) when:
Computing cloud 198 (in FIG. 9A) attempted to connect (e.g. in FIG. 19A step 1932) to any available cloud-instance in “Alpha” Bank-of-Host-Computer-Cloud-Instances (B.H.C.C.I.) (in rows-“A1”-to-“A10”-and-column-“IV”-of-FIG. 9D's-Table-1), which (“Alpha” bank's ten (10) host-computer-cloud-instances (HCCI)) are:
   which 10 HCCI-cloud-instances are) HCCI-205a-C, HCCI-205b-C, HCCI-205c-C, HCCI-205d-C, HCCI-205e-C, HCCI-205f-C, HCCI-205g-C, HCCI-205h-C, HCCI-205i-C, and HCCI-205j-C (in respectively rows-“A1”-to-“A10”-and-column-“IV” of FIG. 9D's Table-1); and
Computing cloud 198 (in FIG. 9A) received responses (e.g. in FIG. 19A step 1932) from the HCCI-cloud instances (in above “Alpha” bank's 10 HCCI-cloud-instances); and (ii) FIG. 9D's Table-1's column-“XIV” shows “Last Ping Response Time (Sec.)) (in heading-of-column-“XIV”) that computing cloud 198 saved (at 10:12-GMT) the HCCI cloud-response-times (in respectively rows-“A1”-to-“A10”-and-column-“XIV”-of-Table-1): respectively 2.532 sec., 1.028 sec., 2.086 sec., 3.143 sec., 3.509 sec., 1.761 sec., 1.204 sec., 2.895 sec., 4.312 sec., 2.237 sec.; and
   (iii) FIG. 9D's Table-1's column-“XV” shows “Ranking of Last Ping Response Time” (in heading-of-column-“XV”) that computing cloud 198 ranked (in order) from-fastest-to-slowest (at 10:12-GMT), and saved the ranking (in column-“XV”-of-Table-1 of FIG. 9D) of the last/previous-ping-response-times (at 10:12-GMT, and in column-“XIV”-of-Table-1) of the 10 HCCI-cloud-instances (in above “Alpha” bank): respectively 6, 1, 4, 8, 9, 3, 2, 7, 10, 5 (which ranking order would/could be used as the pinging-order when computing cloud 198 next-time (after 10:12-GMT) pings/attempts-to-connect (e.g. in FIG. 19A step 1932) to any available cloud-instance of the “Alpha” bank).

FIG. 9D's Table-2's columns-“XII”-and-“XIV”-and-“XV” (updated-(at-10:13-GMT) those columns-“XII”-and-“XIV”-and-“XV” of FIG. 9D's Table-1 and) illustrate “Updated-Ping-Results: Updated Ping-Response-Time (Sec.) (in column-XIV) & Updated Last-Ping-Ranking (in column-XV):

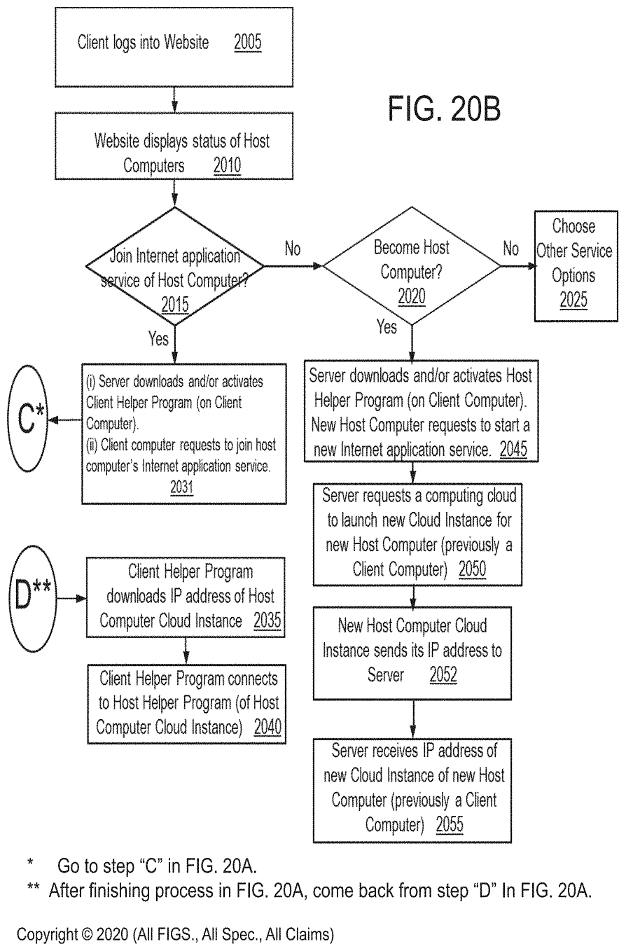

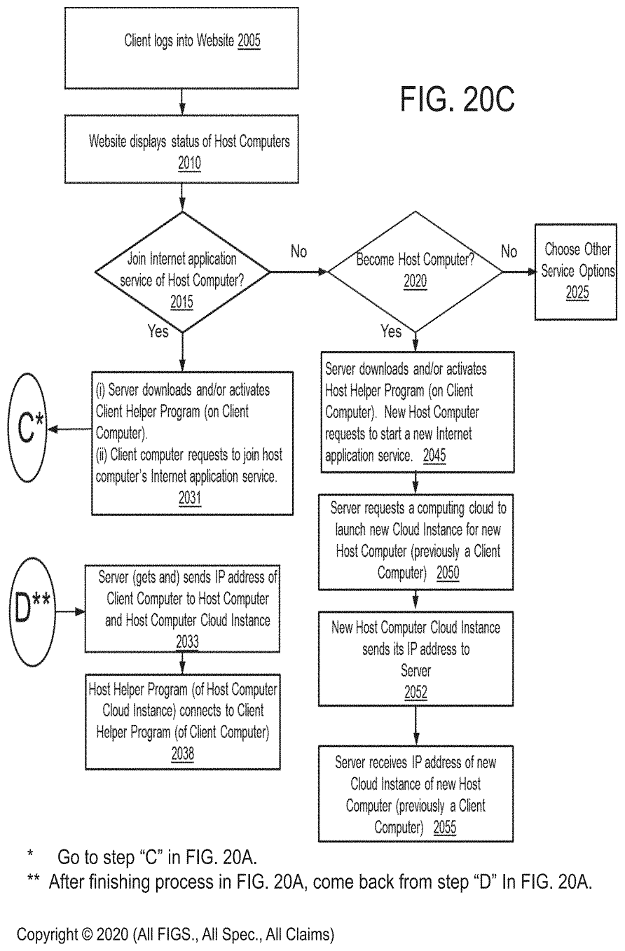

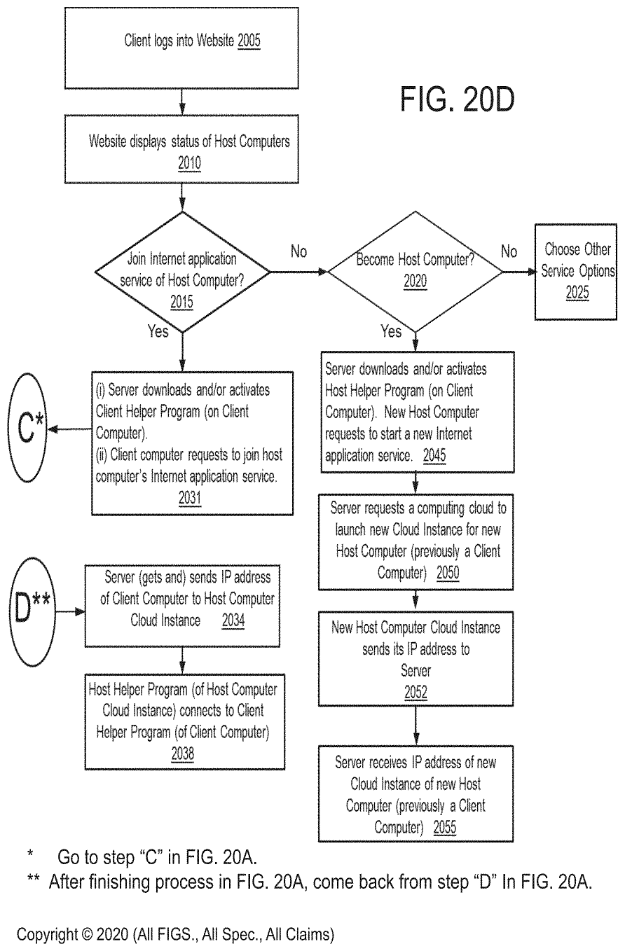

(i) FIG. 9D's Table-2's column-“XII” shows that (Updated-(at-10:13-GMT))-“Last Ping Time (GMT)) (in heading-of-column-“XII”) was (updated-to)-10:13-GMT (Greenwich Mean Time) when:
Computing cloud 198 (in FIG. 9A) at 10:13 GMT:
   (i)(a) in FIG. 20A step-2025: “Do-steps-192E-to-1948-in-FIGS. 19A/19B/19C/19D/19E-19F/19G/19H/19I/19J/19K/19L” (including (in FIGS. 19A's/19B's/19C's/ . . . /19K's/19L's-step-1932:) “Computing cloud 198 attempts-(if-spec.-appears-in FIGS. 19A's/19B's/19C's/ . . . /19K's/19L's-step-1932:)-to connect-to- . . . -cloud-instances (in bank- . . . ), and receives . . . responses from cloud instances (in FIGS. 19A's/19B's/19C's/ . . . /19K's/19L's-step-1932, if spec. appears in FIGS. 19A's/19B's/19C's/ . . . /19K's/19L's-step-1932)”); or
   (i)(b) in FIG. 20A step-2048: “If “Yes” (Elapsed-Time>Maximum-Targeted), then Do-steps-1932-to-1948-in-FIGS. 19A′19B/19C/ . . . /19K/19L, including (if spec. appears:in its FIGS. 19A's/19B's/19C's/ . . . /19K's/19L's-step-1932:) “Attempt-to-Connect-to- . . . -Cloud-Instance-in-Bank . . . ” (in FIGS. 19A's/19B's/19C's/ . . . /19K's/19L's-step-1932); or (i)(c) etc. (others not shown).
   (ii) FIG. 9D's Table-2's column-“XIV” shows (Updated-(at-10:13-GMT))-“Last Ping Response Time (Sec.)) (in heading-of-column-“XIV”) that computing cloud 198 saved (at 10:13-GMT) the HCCI cloud-response-times (in row-“A”-and-column-“XIV”-of-Table-2): 5.574 sec., 3.025 sec., 1.263 sec., 2.931 sec., etc.; and
   (iii) FIG. 9D's Table-2's column-“XV” shows (Updated-(at-10:13-GMT))-“Ranking of Last Ping Response Time” (in heading-of-column-“XV”) that computing cloud 198 ranked (in order) from-fastest-to-slowest (at 10:13-GMT), and saved the ranking (in column-“XV”-of-Table-2) of the (Updated-(at-10:13-GMT))-last-ping-response-times (at 10:13-GMT, and in column-“XIV”-of-Table-2) of the 10 HCCI-cloud-instances (in above “Alpha” bank): 8, 6, 1, 5, 4, 9, 7, 10, 3, 2 (which (updated-at-10:13-GMT) ranking-order would/could be used as the pinging-order when computing cloud 198 next-time (after 10:13-GMT) pings/attempts-to-connect (e.g. in FIG. 19A step 1932) to any available cloud-instance of the “Alpha” bank).

(FIG. 9E's Table-1 is identical to FIG. 9D's Table-2:) FIG. 9E's Table-1's columns-“XII”-and-“XIV”-and-“XV” (updated-(at-10:13-GMT) those columns-“XII”-and-“XIV”-and-“XV” of FIG. 9D's Table-1 and) illustrate (FIG. 9E's Table-1's) “Updated-(at-10:13-GMT) (CIRCLED)-Ping-Response-Time (circled for rows-“A1-and-A6-and-A8 in column-XIV) HIGHER-THAN (Targeted)-Ceilings-(in-column-XI-(of-5-sec.))”, and:
FIG. 9E's Table-2: “Updated (Circled)-Ping-Response-Time (column-XIV) HIGHER-THAN (Targeted)-Ceilings (column-XI)” IMPLIES: (a) Increase-(HCCI's)-H/W: or (b) Split-(HCCI's)-Clients-(Loads), and illustrated as follows:
   (i) (FIG. 9E's Table-1's row-A1's) H.C.C.I. 205a-C: “Updated (Circled)-Ping-Response-Time (=5.574 sec. in row-A1-and-column-XIV, and is) HIGHER-THAN (Targeted)-Ceilings (=5 sec. in column-XI, and)” IMPLIES (as illustrated in FIG.-19A's step-1946(ii):
   (ii) If above-ceiling cloud-instance(s) cannot add more (virtualized)-hardware, off-load 50%-of-clients-(of-these-cannot-add-H/W-instance(s)-in-(i)) to (run on) new-(copies-of-the)-cloud-instance(s)”): split-(in-Table-2)-(HCCI-205a-C's)-clients-(loads) (into 50%-for H.C.C.I.-“205a1-C” and 50%-for-H.C.C.I-“205a2-C”) as H.C.C.I. 205a-C cannot-increase its EC2-H/W (as it is already at 32-(max.#-of)-(1X)-H/W (for 2019's Amazon-EC2-cloud-instance-offerings in FIG. 18B's Table-2 rows “D”-to “I”)); and
   (ii) (FIG. 9E's Table-1's row-A6's) H.C.C.I. 205f-C: “Updated (Circled)-Ping-Response-Time (=6.052 sec. in row-A6-and-column-XIV, and is) HIGHER-THAN (Targeted)-Ceilings (=5 sec. in row-A6-and-column-XI, and)” IMPLIES (as illustrated in FIG.-19A's step-1946(i): “(i) If possible, add more (virtualized)-hardware to above-ceiling-of-targeted-range cloud-instances”): increase-(in-Table-2's-row-A6-and-column-VIII)-(HCCI-205f-C's)-H/W (to 20-(1X)-H/W (from 8-(1X)-H/W in Table-1) for HCCI-205f-C); and
   (iii) (FIG. 9E's Table-1's row-A8's) H.C.C.I. 205h-C: “Updated Ping-Response-Time (=7.055 sec. in in row-A8-and-column-XIV, and is) HIGHER-THAN (Targeted)-Ceilings (=5 sec. in column-XI, and)” IMPLIES (as illustrated in FIG.-19A's step-1946(i): “(i) If possible, add more (virtualized)-hardware to above-ceiling-of-targeted-range cloud-instances”): increase-(in-Table-2's-row-A8-and-column-VIII)-(HCCI-205h-C's)-H/W (to 2-(1X)-H/W (from 1-(1X)-H/W) for HCCI-205h-C).

(FIG. 9F's Table-1 is identical to FIG. 9D's Table-2:) FIG. 9F's Table-1's columns-“XII”-and-“XIV”-and-“XV” (updated-(at-10:13-GMT) those columns-“XII”-and-“XIV”-and-“XV” of FIG. 9D's Table-1 and) illustrate (FIG. 9F's Table-1's) “Updated-(at-10:13-GMT) (CIRCLED)-Ping-Response-Time (circled for rows-“A3-and-A10”-and-column-XIV) LOWER-THAN (Targeted)-Floors-(in column-X)”, and:
FIG. 9F's Table-2: “Updated Ping-Response-Time (column-XIV) LOWER-THAN (Targeted)-Floors (column-X)” IMPLIES: (a) Decrease-(HCCI's)-H/W; or (b) Merge-(HCCI's)-Clients-(Loads), and illustrated as follows:
   (i) (FIG. 9F's Table-1's row-A3's) H.C.C.I. 205c-C: “Updated (CIRCLED)-Ping-Response-Time (=0.063 sec. in row-“A3”-and-column-XIV, and is) LOWER-THAN (Targeted)-Floor (=1 sec. in row-A3-and-column-X, and)” IMPLIES (as illustrated in FIG.-19A's step-1940(i): “(i) If possible, remove (virtualized)-hardware from (below-floor-of-targeted-range) fastest-to-respond cloud-instances”): remove-(in-Table-2's-row-A3-and-column-VIII)-(HCCI-205c-C's)-H/W (to 20-(1X)-H/W (from 32-(1X)-H/W) for HCCI-205c-C); and
   (ii) (FIG. 9F's Table-1's row-A10's) H.C.C.I. 205j-C: “Updated (CIRCLED)-Ping-Response-Time (=0.098 sec. in row-“A10”-and-column-XIV, and is) LOWER-THAN (Targeted)-Floor (=1 sec. in row-A10-and-column-X, and)” IMPLIES (as illustrated in FIG.-19A's step-1940(ii)-&-(iii): “(ii). Transfer-(any-other)-below-floor-response-time (cloud-instances')-clients to fastest-cloud-instance-to-respond; and/or (iii). (Optional) Merge/Close (below-floor)-cloud-instance(s)-(without-clients)”): merge/close-(in-Table-2's-row-A10)-HCCI-205j-C-(cloud-instance) (and transfer HCCI-205j-C's-clients to (fastest-cloud-instance-to-respond)-HCCI-205c-C).

(For-(LOS)-#-of-users:) FIG. 9G's columns-I-to-IV-and-VII-to-XI are copied-from/same-as FIG. 9C's table's columns-I-to-IV-and-VII-to-XI-respectively, and:

(i) Floor-#-of-users-(for-LOS) (for banks-of-cloud-instances) are shown in FIG. 9G's column-XVI, and equal-to:
(Floor-#-of-users-(for-LOS)=) “Target-Floor-Response-Time” (in column-X) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (see note-in-(iii) below):
   (i)(a). As-an-example, for row-Aa's H.C.C.I. 205a-C, Floor-#-of-users-(for-LOS)=1-sec. (which is its “Target-Floor-Response-Time” (in column-X) TIMES 32 (which is its #-of-virtualized-hardware (in column-VIII)) TIMES 100-users-(per-1X-H/W) (from Linear-formula from FIG. 18B's Table-1) DIVIDED-by-30 (assuming its 100%-load has 30-sec.-response-time (see note-in-(iii) below)
   =1*32*100/30=106 (in column-XVI of row-Aa's H.C.C.I. 205a-C); and
   (i)(b). As-another-example, for row-B3's H.C.C.I. 205m1-C, Floor-#-of-users-(for-LOS)=2-sec. (which is its “Target-Floor-Response-Time” (in column-X-and-row-B3) TIMES 8 (which is its #-of-(1X)-virtualized-hardware (in column-VIII-and-row-B3)) TIMES 100-users-(per-1X-H/W) (from Linear-formula from FIG. 18B's Table-1) DIVIDED-by-30 (assuming its 100%-load has 30-sec.-response-time (see note-in-(iii) below))
   =2*8*100/30=54 (in column-XVI of row-B3 for H.C.C.I. 205m1-C); and
      (ii) Ceiling-#-of-users-(for-LOS) (for banks-of-cloud-instances) are shown in FIG. 9G's column-XVII, and equal-to:
(Ceiling-#-of-users-(for-LOS)=) “Target-Ceiling-Response-Time” (in column-XI) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (see note below)):
   (ii)(a). As-an-example, for row-A1's H.C.C.I. 205a-C, Ceiling-#-of-users-(for-LOS)=5-sec. (which is its “Target-Ceiling-Response-Time” (in column-XI-and-row-A1) TIMES 32 (which is its #-of-virtualized-hardware (in column-VIII-and-row-A1)) TIMES 100-users-(per-1X-H/W) (from Linear-formula from FIG. 18B's Table-1) DIVIDED-by-30 (assuming its 100%-load has 30-sec.-response-time (see note-in-(iii) below))
   =5*32*100/30=533 (in column-XVII of row-Aa's H.C.C.I. 205a-C); and
   (ii)(b). As-another-example, for row-B3's H.C.C.I. 205m1-C, Ceiling-#-of-users-(for-LOS)=7-sec. (which is its “Target-Ceiling-Response-Time” (in column-X-and-row-B3) TIMES 8 (which is its #-of-(1X)-virtualized-hardware (in column-VIII-and-row-B3)) TIMES 100-users-(per-1X-H/W) (from Linear-formula from FIG. 18B's Table-1) DIVIDED-by-30 (assuming its 100%-load has 30-sec.-response-time (see note-in-(iii) below))
=7*8*100/30=187 (in column-XVII of row-B3 for H.C.C.I. 205m1-C).

(iii) Note: (iii)(a) (Assumption of “100%-load (for LOS) has 30-sec.-response-time” is that) for level-of-service (LOS) management, typical computing-cloud-management may decide (in a management-decision on offering level-of-service (LOS)) that (in a highly competitive Internet market) a typical client would only (want-to)-wait (max.-time of up-to)-30-seconds for use of their Internet-application-services (e.g. webpage-(and-response) from websites they-(as-clients) are visiting); and

(iii)(b) A typical client would likely NOT-use the Internet-application-service (e.g. not-use-the-slow-website, and switch-to-visit another website) if wait-time/response-time/level-of-service (LOS) is more than 30-sec.; and
(iii)(c) Hence, (the assumption is that) for level-of-service (LOS) management, because of
(iii)(a)-and-(iii)(b) above, computing-cloud-management may decide-and-plan NOT-to-exceed-30-sec.-response-time in their (LOS)-cloud-instances, and would STOP-adding-clients-and-loads to a (LOS)-cloud-instance when its-response-time reaches 30-sec. (which would be 100%-load for the (LOS)-cloud-instance, and which “100%-load would have 30-sec.-response-time).
(iii)(d) Please note that the invention-(and-(pending)-patent) would-NOT-(and-does-NOT) depend on the assumption that “100%-load-of-(LOS)-cloud-instance would/may have 30-sec.-response-time”, which is used (in this patent-application) only to allow readers (easier)-to understand-(and-appreciate) how level-of-service (LOS) may relate to max.-#-of-clients-(and-load) (supported) on a (LOS)-cloud-instance.

(For (LOS)-Load-%-(of-H/W):) FIG. 9G's columns-I-to-IV-and-VII-to-XI are copied-from/same-as FIG. 9C's table's columns-I-to-IV-and-VII-to-XI-respectively, and:

(i) Floor-Load-%-(of-hardware)-(for-LOS) (for banks-of-cloud-instances) are shown in FIG. 9G's column-XVIII, and equal-to:
(Floor-Load-%-(of-hardware)-(for-LOS)=) “Target-Floor-Response-Time” (in column-X) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (which is explained in note-in-Para[0052H](iii) above)):
   (i)(a). As-an-example, for row-A1's H.C.C.I. 205a-C, Floor-Load-%-(of-hardware)-(for-LOS)=1-sec. (which is its “Target-Floor-Response-Time” (in column-X-and-row-A1) DIVIDED-by-30 (assuming its 100%-load has 30-sec.-response-time (which is explained in note-in-Para[0052H](iii) above))
   =1/30=3.3% (in column-XVIII of row-A1's H.C.C.I. 205a-C); and
   (i)(b). As-another-example, for row-B3's H.C.C.I. 205m1-C. Floor-Load-%-(of-hardware)-(for-LOS)=2-sec. (which is its “Target-Floor-Response-Time” (in column-X-and-row-B3) DIVIDED-by-30 (assuming its 100%-load has 30-sec.-response-time (which is explained in note-in-Para[0052H](iii) above))
   =2/30=6.7% (in column-XVIII of row-B3 for H.C.C.I. 205m1-C); and
      (ii) Ceiling-Load-%-(of-hardware)-(for-LOS) (for banks-of-cloud-instances) are shown in FIG. 9G's column-XIX, and equal-to:
(Ceiling-Load-%-(of-hardware)-(for-LOS)=) “Target-Ceiling-Response-Time” (in column-XI) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (which is explained in note-in-Para[0052H](iii) above)); and
   (ii)(a). As-an-example, for row-A1's H.C.C.I. 205a-C, Ceiling-Load-%-(of-hardware)-(for-LOS)=5-sec. (which is its “Target-Ceiling-Response-Time” (in column-XI-and-row-A1) DIVIDED-by-30 (assuming its 100%-load has 30-sec.-response-time (which is explained in note-in-Para[0052H](iii) above))
   =5/30=16.7% (in column-XIX of row-A1's H.C.C.I. 205a-C); and
   (ii)(b). As-another-example, for row-B3's H.C.C.I. 205m1-C, Ceiling-Load-%-(of-hardware)-(for-LOS)=7-sec. (which is its “Target-Ceiling-Response-Time” (in column-XI-and-row-A1) DIVIDED-by-30 (assuming its 100%-load has 30-sec.-response-time (which is explained in note-in-Para[0052H](iii) above))
   =7/30=23.3% (in column-XIX of row-B3 for H.C.C.I. 205m1-C).

(For (LOS)-Price/Hour/User in 2019 in U.S.:) FIG. 9G's columns-I-to-IV-and-VII-to-XI are copied-from/same-as FIG. 9C's table's columns-I-to-IV-and-VII-to-XI-respectively, and:

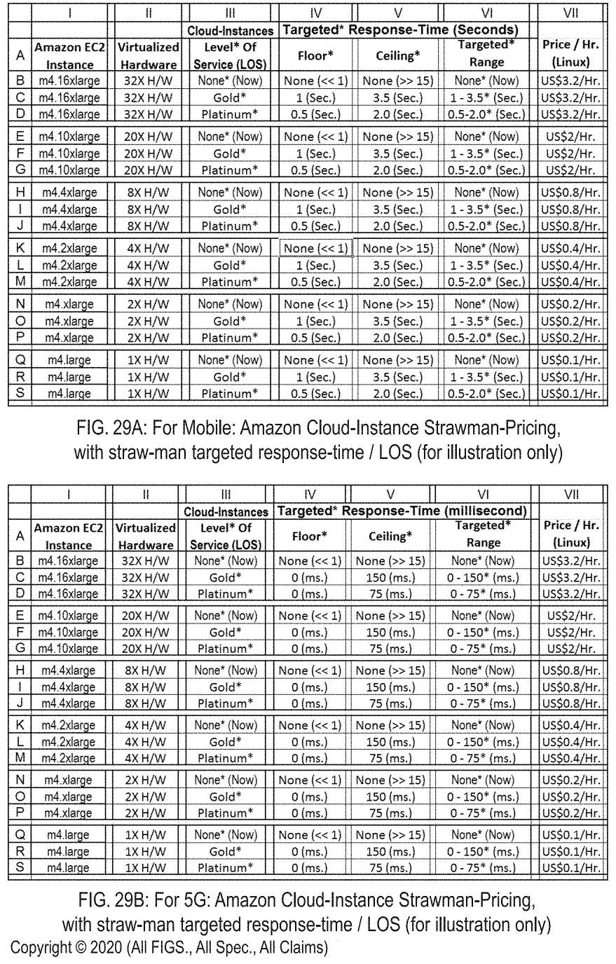

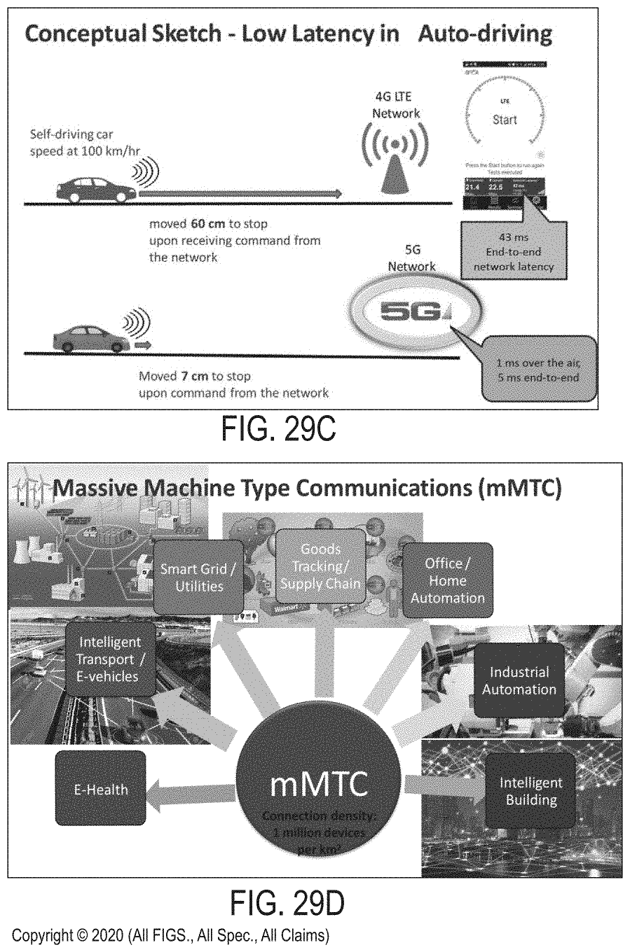

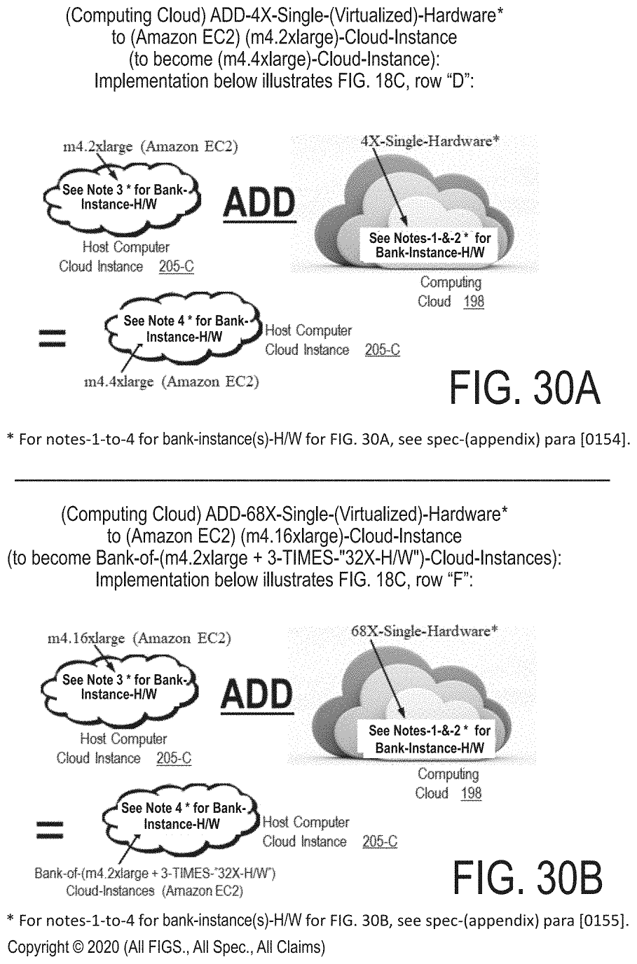

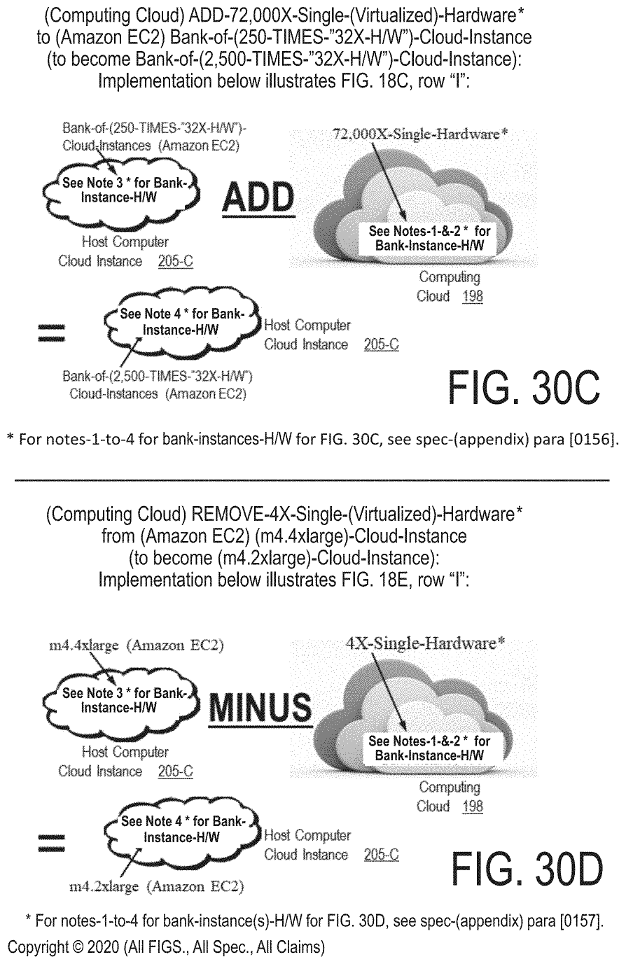

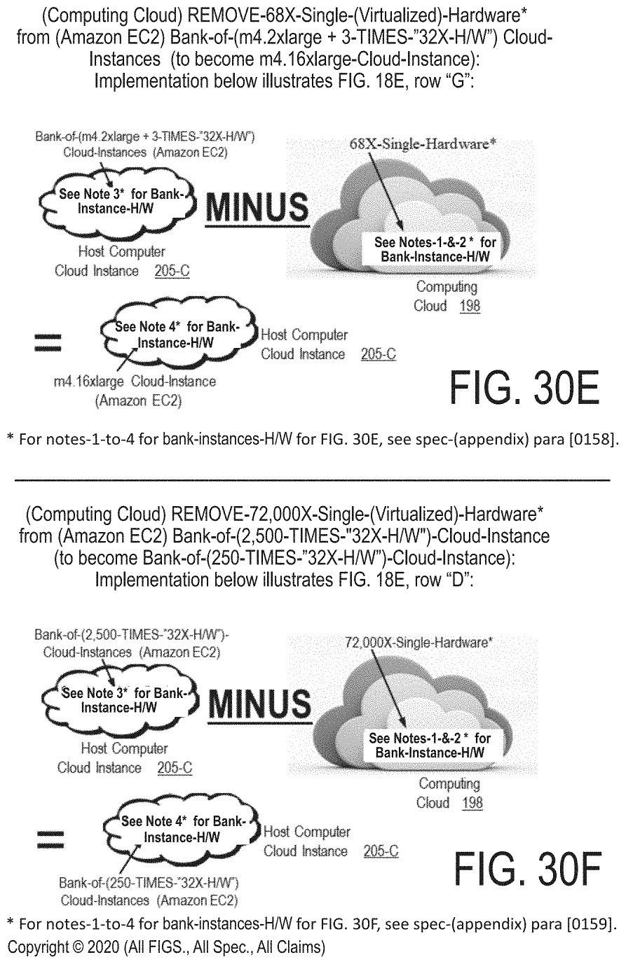

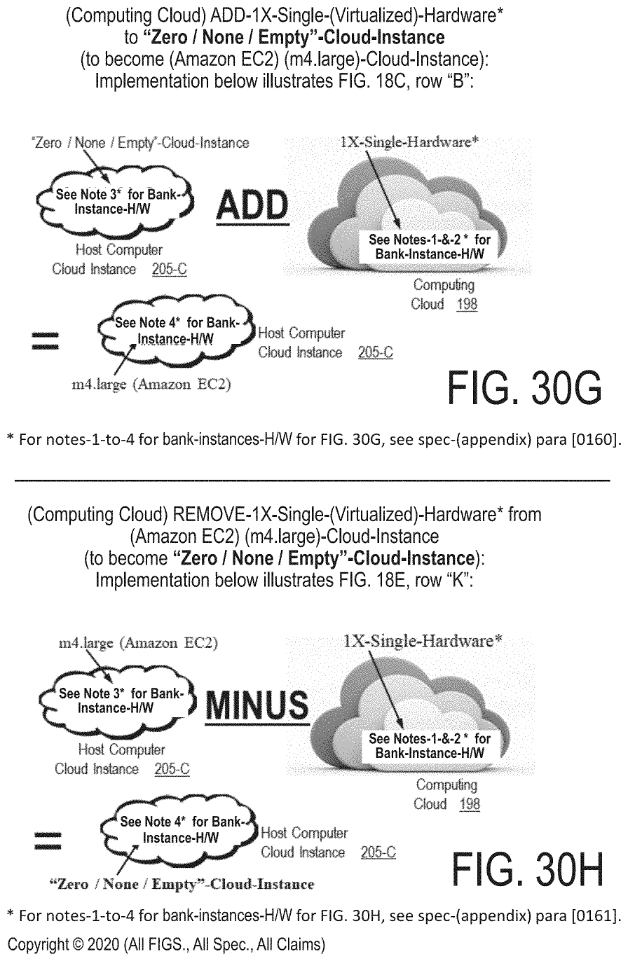

(i) Floor-Price/Hour/User-(for-LOS) (for banks-of-cloud-instances) are shown in FIG. 9G's column-XX, and equal-to:
(Floor-Price/Hour/User-(for-LOS)=) “Price/Hour (from FIG. 29A's column-VII) of H.C.C.I.'s-EC2-Instance (in column-VII)” DIVIDED-by-H.C.C.I.'s-“Floor-#-of-users” (in column-XVI):
   (i)(a). As-an-example, for row-A1's H.C.C.I. 205a-C, Floor-Price/Hour/User-(for-LOS)=US$3.2-per-Hour (which ($3.2/Hr.) is price/hour (for “m4.16xlarge”-Instance in FIG. 29A's row-D-and-column-VII, and) for H.C.C.I.-205a-C's Amazon-EC2-“m4.16xlarge”-Instance in FIG. 9G's column-VII-and-row-A1) DIVIDED-by-106 (which is row-A1's H.C.C.I.-205a-C's “Floor-#-of-users” in column-XVI-and-row-A1)
   =US$3.2/Hr./106=3 US-cent/Hr.(in column-XX of row-A1's H.C.C.I. 205a-C); and
   (i)(b). As-another-example, for row-B3's H.C.C.I. 205m1-C, Floor-Price/Hour/User-(for-LOS)=US$0.8-per-Hour (which ($0.8/Hr.) is price/hour (for “m4.4xlarge”-Instance in FIG. 29A's row-J-and-column-VII, and) for H.C.C.I.-205m3-C's Amazon-EC2-“m4.4xlarge”-Instance in FIG. 9G's column-VII-and-row-B3) DIVIDED-by-54 (which is row-B3's H.C.C.I.-205m1-C's “Floor-#-of-users” in column-XVI-and-row-B3)
      =US$0.8/Hr./54=1.5 US-cent/Hr. (in column-XX of row-B3's H.C.C.I. 205m1-C); and
      (ii) Ceiling-Price/Hour/User-(for-LOS) (for banks-of-cloud-instances) are shown in FIG. 9G's column-XX, and equal-to:
(Ceiling-Price/Hour/User-(for-LOS)=) “Price/Hour (from FIG. 29A's column-VII) of H.C.C.I.'s-EC2-Instance (in column-VII)” DIVIDED-by-H.C.C.I.'s-“Ceiling-#-of-users” (in column-XVII):
   (ii)(a). As-an-example, for row-A1's H.C.C.I. 205a-C, Ceiling-Price/Hour/User-(for-LOS)=US$3.2-per-Hour (which ($3.2/Hr.) is price/hour (for “m4.16xlarge”-Instance in FIG. 29A's row-D-and-column-VII, and) for H.C.C.I.-205a-C's Amazon-EC2-“m4.16xlarge”-Instance in FIG. 9G's column-VII-and-row-A1) DIVIDED-by-533 (which is row-A1's H.C.C.I.-205a-C's “Ceiling-#-of-users” in column-XVII-and-row-A1)
   =US$3.2/Hr./533=0.6 cent/Hr. (in column-XXI of row-A1's H.C.C.I. 205a-C); and
   (ii)(b). As-another-example, for row-B3's H.C.C.I. 205m1-C, Ceiling-Price/Hour/User-(for-LOS)=US$0.8-per-Hour (which ($0.8/Hr.) is price/hour (for “m4.4xlarge”-Instance in FIG. 29A's row-J-and-column-VII, and) for H.C.C.I.-205m1-C's Amazon-EC2-“m4.4xlarge”-Instance in FIG. 9G's column-VII-and-row-B3) DIVIDED-by-187 (which is row-B3's H.C.C.I.-205m1-C's “Ceiling-#-of-users” in column-XVII-and-row-B3)
      =US$0.8/Hr./187=0.43 cent/Hr. (in column-XXI of row-B3's H.C.C.I. 205m1-C).

Please note that the (LOS)-price/hour/user is extremely cost-effective to provide excellent (platinum-to-bronze)-level-of-service (of one's Internet application, e.g. one's Internet-website) to users/prospective-customers visiting one's website (and to avoid them to go to one's competitor's website (with one-click!)). For example:
platinum-level-of-service-(LOS) (with highest price/hour/user) is only 0.6-US-cent/hour/user (for ceiling-response-time-(of-5-sec.) in column-XXI-and-rows-“A1-to-A10” in FIG. 9G) to 3-US-cent/hour//user (for floor-response-time-(of-1-sec.) in column-XX-and-rows-“A1-to-A10” in FIG. 9G), which:
0.6-US-cent/hour/user to 3-US-cent/hour/user is extremely cost-effective to provide best (platinum)-level-of-service-(of-1-sec.-to-5-sec.-response-time) (of one's Internet application) to users/prospective-customers visiting one's website (and to avoid them to go to one's competitor's website (with one-click!)).

### Direct Network Connections Using Bank of (One-or-More) Cloud Instances for Internet Application Services

The present invention also relates to creating direct network connections for Internet application services within computer networks. More specifically, the present invention also relates to creating direct network connections for Internet application services between computers using bank of (one-or-more) cloud instances via the Internet.

Direct network connections using bank of (one-or-more) cloud instances for Internet application service is provided between two or more computers on a network to facilitate a wide variety of activities, including website service (e.g. Amazon.com), database service, business software service (e.g. Oracle Database, Adobe Media Server, etc.), desktop applications service (e.g. Microsoft Office, CorelDRAW, etc.), software infrastructure service (e.g. Cisco Cloud Services Router. LAMP Stack, etc.), developer tools service (e.g. Bitnami Cloud Hosting, etc.), etc. A first computer sends a request to publish and/or start an Internet application service to a server. The server requests a computing cloud to launch-or-assign a cloud instance for the first computer. The first computer cloud instance is communicatively coupled to the first computer. The first computer cloud instance (or the computing cloud) sends its connection information to the server. The server receives the connection information for the first computer cloud instance. A second computer may make a request to the server to join the Internet application service of the first computer. The server sends to the second computer the connection information it has received and stored for the first computer cloud instance. The second computer uses the connection information for the first computer cloud instance to send to the first computer cloud instance connection information for the second computer via direct network connection. From this point on, the first computer cloud instance and the second computer exchange data for the Internet application service via a direct network connection, independently of the server and independent of the first computer. The first computer is only needed to request the server to publish and/or start the Internet application service, and is not needed for the data exchange between the first computer cloud instance and the second computer.

The current invention on using bank of (one-or-more) cloud instances for Internet application services is described in detail below.

FIG. 9A illustrates a direct network connection using bank of (one-or-more) cloud instances which facilitates providing Internet application service between a (bank of one-or-more) host computer cloud instance 205-C and multiple client computers 215 in accordance with still another embodiment of the present invention. The embodiment illustrated by FIG. 9A is adapted from FIG. 2A, and comprises a host computer 205, multiple client computers 215a, 215b, . . . 215n, and a server 222A hosting a website 212A. In the direct network connection using a bank of (one-or-more) cloud instances providing Internet application service depicted in FIG. 9B, the client computers 215a, 215b, . . . 215n are able to join the Internet application service of the bank of (one-or-more) host computer cloud instances 205-C via the direct network connection 245, and the host computer 205 is not needed.

In one embodiment, providing Internet application service is facilitated using a process similar to that described in reference to the embodiment of FIG. 9A. The computers 205, 215a, 215b, . . . 215n are each individually connected to the Internet 200, and a primary purpose of the server 222A is to provide the IP address of the (bank of one-or-more) host computer cloud instance 205-C to the client computers 215a, 215b, . . . 215n. The host computer 205 accesses the website 212A and requests to publish and/or start an Internet application service. The server 222A requests a computing cloud (e.g. computing cloud 198 in FIG. 9A) to launch-or-assign a (bank of one-or-more) host meeting cloud instance 205-C, which (or the computing cloud 198) sends its IP address to the server 222A via a network connection 227. The server 222A receives the IP address of the host computer cloud instance 205-C. The server 222A also sends, via a network connection 227, the IP address of the host computer 205 to the host computer cloud instances 205-C, which is communicatively coupled to its host computer 205 via the direct connection 240. When the client computers 215a, 215b, . . . 215n subsequently accesses the website 212A to request joining the Internet application service of the host computer 205, the server 222A sends to the client computers 215a, 215b, . . . 215n the IP address of the host computer cloud instance 205-C via a network connection 230.

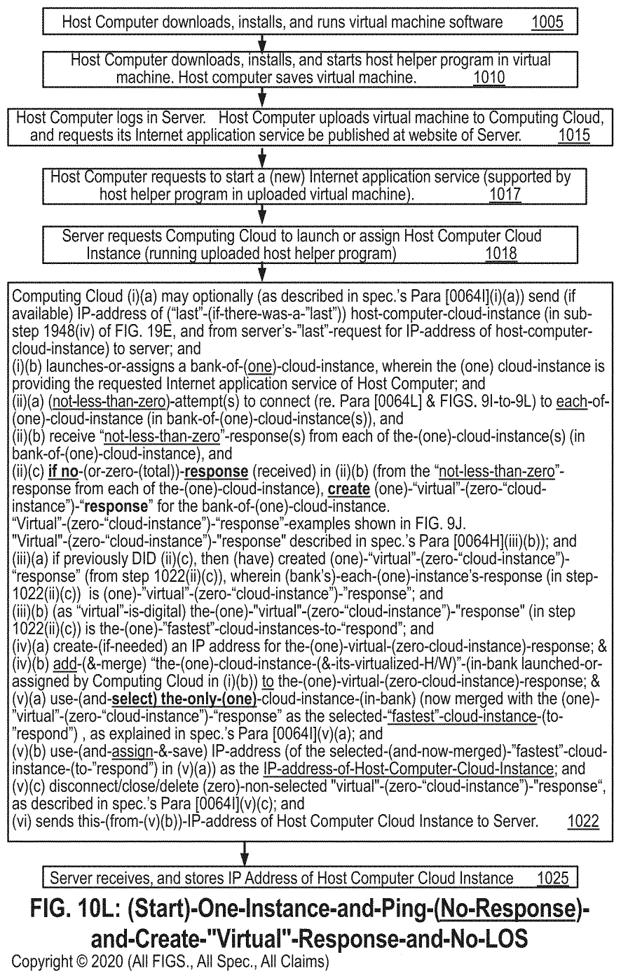

Please also note that the “publishing”-(in above Para [0058] lines 6-7, and in-step-1015 of FIGS. 10A/10B/10C/10D/10E below)-recipients (of the host helper program 216-1, and/or the Internet application service) may-be-(or-are) any-(and-all) Internet-user(s) (which visit website 212A in FIG. 9A, and/or options page 305 in FIG. 3):
i.e. the “publishing”-recipients may-be-(or-are) “any-and-all Internet-user(s)” (which visit website 212A in FIG. 9A, and/or options page 305 in FIG. 3, and which) may be any host computer(s) (e.g. host computer 205, 205a. 205b, 205c, etc., and other host computer(s) not shown), and (may be) any client computer(s) (e.g. client computer 215, 215a, 215b, . . . 215n, etc., and other client computer(s) not shown).

Please note that (for “server-222A-and-website-212A” and computing-cloud-198 in FIG. 9A):

(a) “server-222A-and-website-212A” may be a-server-and-a-website of-(and-provided-by) computing-cloud-198-(vendor), i.e. ONE-single-company providing “server-222A-and-website-212A” and computing-cloud-198):

(a)(i). Example: Amazon-cloud-marketplace has its-Amazon's-“server-222A-and-website-212A (in FIG. 9A)” to allow (an Amazon's customer's/third-party-seller's) host computer 205 to “access the website 212A and requests to publish and/or start an Internet application service” (in above Para [0058] lines 6-7, and in step 1015 of FIGS. 10A/10B/10C/10D/10E below) (using Amazon's-computing-cloud-198 (in FIG. 9A)).
(a)(ii). Amazon-cloud-marketplace is a “digital catalog that makes it easy for third-party sellers to offer software, data, and other products” to Amazon customers using (Amazon's)-computing-cloud-198, and allows (an Amazon's third-party seller's) host computer 205 to (upload-and)-publish-(third-party)-seller's-(“host helper program 216-1”-which-is-third-party-seller's)-“software, data, and other products”, e.g. 7000+ products in operating systems, business applications, infrastructure software, machine learning, etc. (in Amazon-cloud-marketplace).

(Amazon's third-party-seller's) host computer 205 would (in above Para [0058] lines 6-7, and in step 1015 of FIGS. 10A/10B/10C/10D/10E below) “upload its virtual machine (with installed host helper program 216-1) to (Amazon's)-computing-cloud, and requests its-(third-party-seller's) (host helper program 216-1, and/or) Internet application service be published at Amazon's-(cloud-marketplace's)-server-222A-and-website-212A” (in FIG. 9A).

(b) Alternatively, “server-222A-and-website-212A” and “computing-cloud-198” may be provided by TWO-(or-more-(not-shown)) companies:
“server-222A-and-website-212A” (e.g. providing Internet-website-service) may be: (i) from a G2000 (Global 2000) company, or from an Internet-(application)-service-(provider)-company, etc., and (ii) using computing-cloud-198 from a-SECOND-“OUTSIDE”-computing-cloud-198-vendor (e.g. Amazon, Google, Microsoft, etc.):
Example: For a G2000 company's (Internet)-website-(service) using computing-cloud-198, the G2000 company may operate its server-222A-and-website-212A (in FIG. 9A, as its “provider-(or-operator)”), but the G2000 company may purchase computing-cloud-198-(service) from (“OUTSIDE”-vendor)-Amazon-(or-Google-or-Microsoft).

Once the client computers 215a, 215b, . . . 215n have the IP address of the host computer cloud instance 205-C, it may send data directly to the host computer cloud instance 205-C via the direct network connection 245. In particular, the client computers 215a, 215b . . . 215n may send to the host computer cloud instance 205-C the IP address of the client computers 215a, 215b, . . . 215n themselves via the direct network connection 245. Thus, both host computer cloud instance 205-C, and client computers 215a, 215b, . . . 215n are able to obtain one another's IP addresses and create a direct network connection 245. From this point onwards the server 222A need not be involved, and all subsequent data exchange related to the client computers 215a, 215b, . . . 215n joining the Internet application service of the (bank of one-or-more) host computer cloud instances 205-C may take place via the direct network connection 245, and the host computer 205 is not needed; and the indirect network connection 225 (though shown) may be disconnected in FIG. 9B.

Important note: Host computer cloud instance 205-C (and/or host computer cloud instance 205n-C) may interchangeably-(in-many-places) use either 205-C and/or 205n-C (as generic-notations) to denote the (bank of one-or-more) host computer cloud instance (to allow easier/simpler-reading of the specification-and-FIGS in different contexts through-out this patent application). For example: 205-C in FIGS. 9A and 9B may use 205n-C instead (of using 205-C), etc.

Bank-of-(one-or-more)-host-computer-cloud-instances 205-C are further described in Para [0027A]-to-[0027D], and illustrated in FIGS. 2A, 9A-to-9B, and 9C's-columns-II-to-XIV.

In additional embodiment of the present invention, the direct network connections using bank of (one-or-more) cloud instances illustrated in FIG. 9A and the accompanying methods described herein are as illustrated in FIG. 9A. In one embodiment illustrated in FIG. 9A, the host computer cloud instance 205-C is single-hardware-(in-FIG. 18A's-Table(1)'s-row-“B”-and-column-“III”)-implemented-into-software running on top of a single physical computer (as described in Para [0041B], and illustrated in FIG. 2E: Overview of Virtualization); and the single hardware is a powerful general purpose computer meeting the hardware and bandwidth requirements specified by the host helper program 216-1 for the Internet application service. For example, if the host helper program 216-1 is the Moodle learning management system Internet application (from the Australian company Moodle Pty Ltd.), the hardware and bandwidth requirements for 100 concurrent users are:
Ubuntu 14.04 64-bit server (operating system)
4 GB of memory (8 GB is better) with swap enabled
Dual-core 2.8 GHz CPU (or faster)
80 GB of free disk space (or more) SCSI hard drive
100 Mbits/sec bandwidth (symmetrical).

As illustration of the Moodle Internet application service's virtualized-hardware, FIG. 18A shows tables of number of (virtualized)-hardware (implemented in host computer cloud instance 205-C) for maximum Moodle users from 100 to 800,000,000, if host helper program is Moodle learning management system Internet application. FIG. 18A allows the server 222A (and/or computing cloud 198 in FIG. 9A) dynamically or via prior-planning to have the needed bandwidth and computing resources for the (bank of one-or-more) host computer cloud instances 205-C, when varying numbers (from one to 800,000,000) of the client computers 215 are joining the Moodle learning management system Internet application hosted by the host computer 205, as explained below.

It is noted that in scaling-up to support 100+ client computers 215 (to join the Moodle learning management system hosted by the host computer 205, in addition to number of hardware, needed bandwidth and other computing resources,) the software (e.g. Moodle) must support (and should be tested, if possible, to support) the higher number of 100+ client computers 215.

Moodle is deployed on and uses web server such as Apache HTTP Server (which is very popular and has many many millions of users), and data management system such as MySQL (which is vey popular and has very many millions of users).

As illustrated in Tables (1) and (2) (of FIG. 18A), the host computer cloud instance 205-C (in FIG. 9A) would implement (virtualize) above (Para [0060]) single hardware (1X) in software and run on top of a single physical computer (as described in Para [0041B], and illustrated in FIG. 2E: Overview of Virtualization), for maximum users of 100 (including host computer 205 (in FIG. 9A)). When the host computer 205 (in FIG. 9A) requests (in to start a new Internet application service, the server 222A (in FIG. 9A) requests a computing cloud 198 to launch-or-assign the (bank of one-or-more) host computer cloud instance 205-C (in FIG. 9A).

Moodle recommended to run Moodle on Amazon EC2 cloud instance “m4.large” (row D, column IV in Table 2 in FIG. 18B) for 100 concurrent users (needing 1X hardware (virtualized) in Para [0060]).

An example of implementing (virtualizing) above (Para [0060]) single hardware (1X) using Amazon EC2 (Amazon Web Services Elastic Compute Cloud (Para [0035])) cloud instance: “m4.large” is shown in FIG. 18B:

(a)) in FIG. 18B: Table 1, column III, row D; and

### (b) in FIG. 18B: Table 2, row D:

100 (maximum users): 1X (single-hardware implemented): m4.large (Amazon EC2 cloud instance);
EC2 (Virtualized)-H/W (Each Instance) (for General Purpose—Current Generation): 2 (vCPU); 6.5 (ECU); 8 Gigabyte (Memory).

FIG. 18A: “Table 1, row C for 1X-to-8,000,000X single-hardware” (for virtualized-hardware implemented in the (bank of one-or-more) host computer cloud instance 205-C) illustrates that as number-of-attendees increases from 100 concurrent users (row B and column III) to 800,000,000 concurrent users (row B and column X), the number of (1X)-virtualized-hardware needs to increase from 1X (row C and column III) to 8,000,000X (row C and column X) respectively:
“Linear” formula for # of (1X)-hardware (implemented in bank of (one-or-more) cloud instances=“Maximum # of concurrent users expected”/100.

FIG. 18A: “Table 1, row C for 1X-to-8,000,000X single-(1X)-hardware” and above “Linear” formula illustrate that the number of (1X)-hardware implemented (as virtualized-hardware in the bank of (one-or-more) host computer cloud instances 205-C) needs to increase from 1X (for 100 concurrent users) to 8,000,000X (for 800,000,000 concurrent users), as the number-of-concurrent users increases beyond 100 concurrent users (to 800,000,000 concurrent users, in FIG. 18A: “Table 1, row B for 100-to-800,000,000 concurrent-users”),

More-(virtualized)-hardware-(in host computer cloud instance 205-C) means higher-QoS (quality of service) for users (of client computers 215).

FIG. 18A: “Table 1, (reverse of) row C for 1X-to-8,000,000X single-(1X)-hardware” and above “Linear” formula also illustrate/imply the reverse that (when 800,000,000-concurrent-clients decrease-in-number) the number of (1X)-hardware implemented (as (1X)-virtualized-hardware in the (bank of one-or-more) host computer cloud instance 205-C) may decrease from 8,000,000X (for peak load 800,000,000 client computers 215) to (possibly as low as) 1X (for 100 client computers 215), as the number-of-concurrent-clients decreases from 800,000,000 concurrent-clients (to (possibly-less-than) 100 concurrent-clients over time (of days, weeks, or months, or year(s)), in FIG. 18A: “Table 1, (reverse of) row B for 100-to-800,000,000 concurrent-clients”),

Less-(virtualized)-hardware-(in host computer cloud instance 205-C) means the not-needed (virtualized)-hardware (in the (bank of one-or-more) host computer cloud instances 205-C) can be returned to the computing cloud 198 (in FIG. 9A), when concurrent-clients leave the Moodle MLS application service.

More illustrations of implementing FIG. 18A: “Table 1, row C: 1X-to-8,000,000X single-(1X)-hardware” using Amazon EC2 (Amazon Web Services Elastic Compute Cloud (Para [0035])) cloud instances: “m4.large, m4.xlarge, m4.2xlarge, m4.4xlarge, m4.10xlarge, m4.16xlarge, etc.” is shown in FIG. 18B's Table 2:

### (i) in FIG. 18B: Table 2, row E:

200 (maximum users); 2X (single-hardware implemented); m4.xlarge (Amazon EC2 cloud instance):
General Purpose—Current Generation: 4 (vCPU); 13 (ECU); 16 Gigabyte (Memory): US$0.2/hour (Linux Usage).

### (ii) in FIG. 18B: Table 2, row F:

400 (maximum users); 4X (single-hardware implemented): m4.2xlarge (Amazon EC2 cloud instance);
General Purpose—Current Generation: 8 (vCPU); 26 (ECU); 32 Gigabyte (Memory): US$0.4/hour (Linux Usage).
   (iii) in FIG. 18B: Table 2, row G:
800 (maximum users); 8X (single-hardware implemented); m4.4xlarge (Amazon EC2 cloud instance);
General Purpose—Current Generation: 16 (vCPU); 53.5 (ECU); 64 Gigabyte (Memory); US$0.8/hour (Linux Usage).

### (iv) in FIG. 18B: Table 2, row H:

2,000 (maximum users); 20X (single-hardware implemented): m4.10xlarge (Amazon EC2 cloud instance);
General Purpose—Current Generation: 40 (vCPU); 124.5 (ECU); 160 Gigabyte (Memory): US$2/hour (Linux Usage).

### (v) in FIG. 18B: Table 2, row I:

3,200 (maximum users); 32X (single-hardware implemented): m4.16xlarge (Amazon EC2 cloud instance):
General Purpose—Current Generation: 64 (vCPU); 188 (ECU): 256 Gigabyte (Memory); US$3.2/hour (Linux Usage).

### (vi) in FIG. 18B: Table 2, row J:

10,000 (maximum users); 100X (single-(1X)-hardware implemented);
bank-of-cloud-instances (row B, columns-III-and-IV): m4.2xlarge+3*m4.16xlarge (at row J, column IV) (=4X-H/W+96X-HW=100X-H/W);
EC2 (1X)-H/W: (for m4.2xlarge): 8 (vCPU): 26 (ECU): 32 Gigabyte (Memory); (for m4.16xlarge): 64 (vCPU); 188 (ECU): 256 Gigabyte (Memory);
Please note: No need to customize (1X)-H/W>32X: use bank-of-cloud-instances (FIG. 18B's Table 2's columns III-and-IV).
   (vii) in FIG. 18B: Table 2, row K:
80,000 (maximum users): 800X (single-(1X)-hardware implemented);
bank-of-cloud-instances (row B, columns-III-and-IV): 25*m4.16xlarge (at row K, column IV) (=25-times-“32X-H/W”=800X-H/W (at row K, column-III)):
EC2 (1X)-H/W (each instance): (for m4.16xlarge): 64 (vCPU): 188 (ECU): 256 Gigabyte (Memory);
Please note: No need to customize (1X)-H/W>32X: use bank-of-cloud-instances (meaning use “group-of-cloud-instances”) (FIG. 18B's Table 2's columns Ill-and-IV).
   (vii) in FIG. 18B: Table 2, row L:
800,000 (maximum users): 8,000X (single-(1X)-hardware implemented):
bank-of-cloud-instances (row B, columns-III-and-IV): 250*m4.16xlarge (at row L, column IV) (=250-times-“32X-H/W”=8.000X-H/W (at row L, column-III)):
EC2 (1X)-H/W (each instance): (for m4.16xlarge): 64 (vCPU); 188 (ECU); 256 Gigabyte (Memory);
Please note: No need to customize (1X)-H/W>32X: use bank-of-cloud-instances (meaning use “group-of-cloud-instances”) (FIG. 18B's Table 2's columns III-and-IV).
   (viii) in FIG. 18B: Table 2, row M:
8,000,000 (maximum users/clients): 80,000X (single-(1X)-hardware implemented);
bank-of-cloud-instances (row B, columns-III-and-IV): 2,500*m4.16xlarge (at row M, column IV) (=2,500-times-“32X-H/W”=80.000X-H/W (at row M, column-III));
EC2 (1X)-H/W (each instance): (for m4.16xlarge): 64 (vCPU); 188 (ECU); 256 Gigabyte (Memory);
Please note: No need to customize (1X)-H/W>32X: use bank-of-cloud-instances (meaning use “group-of-cloud-instances”) (FIG. 18B's Table 2's columns III-and-IV).

### (ix) in FIG. 18B: Table 2, row N:

80,000,000 (maximum users/clients); 800,000X (single-(1X)-hardware implemented);
bank-of-cloud-instances (row B, columns-III-and-IV): 25,000*m4.16xlarge (at row N, column IV) (=25,000-times-“32X-H/W”=800,000X-H/W (at row L, column-III));
EC2 (1X)-H/W (each instance): (for m4.16xlarge): 64 (vCPU); 188 (ECU): 256 Gigabyte (Memory);
Please note: No need to customize (1X)-H/W>32X: use bank-of-cloud-instances (meaning use “group-of-cloud-instances”) (FIG. 18B's Table 2's columns III-and-IV).

### (x) in FIG. 18B: Table 2, row O:

800,000,000 (maximum users/clients); 8,000,000X (single-(1X)-hardware implemented);
bank-of-cloud-instances (row B, columns-III-and-IV): 250,000*m4.16xlarge (at row O, column IV) (=250,000-times-“32X-H/W”=8,000,000X-H/W (at row O, column-III));
EC2 (1X)-H/W (each instance): (for m4.16xlarge): 64 (vCPU); 188 (ECU); 256 Gigabyte (Memory);
Please note: No need to customize (1X)-H/W>32X: use bank-of-cloud-instances (meaning use “group-of-cloud-instances”) (FIG. 18B's Table 2's columns III-and-IV).
   (xi) in FIG. 18B: Table 2. AFTER-row P: No need to customize (1X)-H/W>32X: use bank-of-cloud-instances (meaning use “group-of-cloud-instances”) (at FIG. 18B's Table 2's columns III-and-IV), as:
Amazon currently (in 2019) only offers in “General Purpose—Current Generation” (Amazon EC2) maximum-of-32X-single-(1X)-virtualized-hardware in m4.16xlarge (Amazon EC2 cloud instance).
   (x) It is noted in scaling-up to support very large number (e.g. 3,200+) client computers 215 (to join the Internet application service hosted by the host computer 205, in addition to number of hardware, needed bandwidth and other computing resources, the software (e.g. Moodle) must support (and should be tested, if possible, to support) the very large number (e.g. 3,200+) client computers.

Bank-of-(one-or-more)-host-computer-cloud-instances are further described in Para [0027A]-to-[0027D], and illustrated in FIGS. 2A, 9A-to-9B, and 9C's-columns-II-to-XIV.

FIG. 18C illustrates n-level (not-decrease-or)-increase-virtualized-(1X)-hardware in cloud-instance (running Moodle LMS, and using linear formula hardware) in the following columns:

(i) Column-I (of FIG. 18C) illustrates (not-decrease-or)-increase hardware levels of 1st-level, 2nd-level . . . , etc., nth-level (in rows “B”, “C”, . . . “J” respectively of column-I of FIG. 18C).
(ii) Column-II (of FIG. 18C) illustrates (begin)-maximum-#-of-users of 100, 200, . . . , etc., 80-millions (in rows “B”, “C”, . . . “J” respectively of column-II of FIG. 18C (for their respective increase-hardware-levels in column-I of FIG. 18C).
(iii) Column-III (of FIG. 18C) illustrates (begin)-#-of-(1X)-hardware of 1X, 4X, . . . , etc., 800,000X (in rows “B”, “C”, . . . “J” respectively of column-III of FIG. 18C (for their respective (begin)-maximum-#-of-users in column-II of FIG. 18C).
(iv) Columns-IV-and-V (of FIG. 18C) illustrates (begin)-EC2-cloud-instances-(implementing-“begin”-(1X)-HAW) of m4.large, m4.2xlarge, . . . , etc., 25,000-TIMES-m4.16xlarge (in rows “B”, “C”, . . . ‘J’ respectively of column-V of FIG. 18C (for their respective (begin)-#-of-(1X)-hardware in column-III of FIG. 18C).
(v) Column-VI (of FIG. 18C) illustrates n-level-increase-(1X)-H/W-in-(bank-of)-cloud-instances of 3X, 4X, . . . , etc., 7,200,000X (in rows “B”, “C”, . . . “J” respectively of column-VI of FIG. 18C (for their respective increase-hardware-level in column-I of FIG. 18C).
(vi) Columns-VII-and-VIII (of FIG. 18C) illustrates (final)-EC2-cloud-instances-(implementing-“final”-(1X)-H/W) of m4.2xlarge, m4.4xlarge, . . . etc., 250,000-TIMES-m4.16xlarge (in rows “B”, “C”, . . . “J” respectively of column-VIII of FIG. 18C (for their respective (final)-#-of-(1X)-hardware in column-IX of FIG. 18C).
(vii) Column-IX (of FIG. 18C) illustrates (final)-#-of-(1X)-hardware of 4X, 8X, . . . etc., 8,000,000X (in rows “B”, “C”, . . . “J” respectively of column-IX of FIG. 18C (for their respective (final)-maximum-#-of-users in column-X of FIG. 18C).
(viii) Column-X (of FIG. 18C) illustrates (final)-maximum-#-of-users of 400, 800, . . . , etc., 800-millions (in rows “B”, “C”, . . . “J” respectively of column-IX of FIG. 18C (for their respective (final)-#-of-(1X)-hardware in column-IX of FIG. 18C).
(i) In FIG. 18C, please note that “not-decrease”-virtualized-(1X)-hardware in cloud-instance means-(and-its-implementation-may-use): (a) “(not-decrease-or)-increase”-virtualized-(1X)-hardware (illustrated in FIG. 18C), and/or (b) “(not-decrease-or)-keep-SAME/not-change”-virtualized-(1X)-hardware (illustrated in FIG. 18D).

Increase-(#-of-1X)-single-(virtualized)-hardware-(in-FIG.-18C's-column-VI=column-LX-(of-FIG.-18C) MINUS column-III-(of-FIG.-18C)) is defined-as-equal-to (computing cloud's (IX)-virtualized-hardware of) “(Final)-Amazon-EC2-Cloud-Instance(s)-(in-Column-VIII-(of-FIG.-18C))” MINUS “(Begin)-Amazon-EC2-Cloud-Instance-(in-Column-V-(of-FIG.-18C))”.

(ii) Implementation illustrations of rows “C”, “E”, and “H”, of FIG. 18C are in FIGS. 30A, 30B, and 30C respectively: other FIG. 18C's rows may be similarly illustrated (not shown):
FIG. 30A illustrates: (computing cloud 198) add-4X-single-(virtualized)-hardware to (Amazon EC2) “m4.2xlarge”-cloud-instance to become “m4.4xlarge”-cloud-instance. The implementation illustrates FIG. 18C, row “C”. More description of the implementation are in FIG. 30A's notes-1-and-2.
FIG. 30B illustrates: (computing cloud 198) add-68X-single-(virtualized)-hardware to (Amazon EC2) “m4.16xlarge”-cloud-instance to become “bank-of-(m4.2xlarge+3-TIMES-“32X-H/W”)-cloud-instances”.

The implementation illustrates FIG. 18C, row “E”. More description of the implementation are in FIG. 30B's notes-1-and-2.
FIG. 30C illustrates: (computing cloud 198) add-72,000X-single-(virtualized)-hardware to (Amazon EC2) “bank-of-(250-TIMES-‘32X-H/W’)-cloud-instances” to become “bank-of-(2,500-TIMES-‘32X-H/W’)-cloud-instances”.

The implementation illustrates FIG. 18C, row “H”. More description of the implementation are in FIG. 30C's notes-1-and-2.

(iii) Computing cloud 198 may also (like in FIG. 18C) n-level increase-virtualized-(1X)-hardware in cloud-instance by using FIG. 19A's steps 1944-and-1946 (over time upto-days/weeks/months/year(s)), as follows:
FIG. 19A's step 1944: “Is response time of any cloud-instance>ceiling-of-targeted-range-of-response-time ?”;
(If “Yes” to FIG. 19A's step 1944, then do:) FIG. 19A's step 1946(i): If possible, add more (virtualized)-hardware to above-ceiling-of-targeted-range cloud-instances, or
(If “Yes” to FIG. 19A's step 1944, do:) FIG. 19A's step 1946(ii): If above-ceiling cloud-instance(s) cannot add more (virtualized)-hardware, off-load 50%-of-clients-(of-these-cannot-add-H/W-instance(s)-in-(i)) to (run on) new-cloud-instance(s).

More-(virtualized)-hardware-(in host computer cloud instance 205-C) means quicker-response-time/higher-QoS-(quality of service) for users (of client computers 215).

FIG. 18D illustrates n-level (not-decrease-or)-keep-SAME/not-change-virtualized-(1X)-hardware in cloud-instance (running Moodle LMS, and using linear formula hardware) in the following columns:

(i) Column-I (of FIG. 18D) illustrates (not-decrease-or)-keep-SAME/not-change hardware levels of 1st-level, 2nd-level, . . . , etc., nth-level (in rows “B”, “C”, . . . “J” respectively of column-I of FIG. 18D).
(ii) Column-II (of FIG. 18D) illustrates (begin)-maximum-#-of-users of 100, 200, . . . , etc., 80-millions (in rows “B”, “C”, . . . “J” respectively of column-II of FIG. 18D (for their respective keep-SAME/not-change-hardware-levels in column-I of FIG. 18D).
(iii) Column-III (of FIG. 18D) illustrates (begin)-#-of-(1X)-hardware of 1X, 4X, . . . , etc., 800,000X (in rows “B”, “C”, . . . “F” respectively of column-III of FIG. 18D (for their respective (begin)-maximum-#-of-users in column-II of FIG. 18D).
(iv) Columns-IV-and-V (of FIG. 18D) illustrates (begin)-EC2-cloud-instances-(implementing-“begin”-(1X)-H/W) of m4.large, m4.2xlarge, . . . , etc., 25,000-TIMES-m4.16xlarge (in rows “B”, “C”, . . . “J” respectively of column-V of FIG. 18D (for their respective (begin)-#-of-(1X)-hardware in column-III of FIG. 18D).
(v) Column-VI (of FIG. 18D) illustrates (n-level)-keep-SAME/not-change-(1X)-H/W-in-(bank-of)-cloud-instances of 1X, 4X, . . . , etc., 800,000X (in rows “B”, “C”, . . . “J” respectively of column-VI of FIG. 18D (for their respective keep-SAME/not-change-hardware-level in column-I of FIG. 18D).
(vi) Columns-VII-and-VIII (of FIG. 18D) illustrates (final)-EC2-cloud-instances-(implementing-“final”-(1X)-H/W) of m4.large, m4.2xlarge, . . . etc., 25,000-TIMES-m4.16xlarge (in rows “B”, “C”, . . . “J” respectively of column-VIII of FIG. 18D (for their respective (final)-#-of-(1X)-hardware in column-IX of FIG. 18D).
(vii) Column-IX (of FIG. 18D) illustrates (final)-#-of-(1X)-hardware of 1X, 4X, . . . etc., 800,000X (in rows “B”, “C”, . . . “J” respectively of column-IX of FIG. 18D (for their respective (final)-maximum-#-of-users in column-X of FIG. 18D).
(viii) Column-X (of FIG. 18D) illustrates (final)-maximum-#-of-users of 100, 400, . . . , etc., 80-millions (in rows “B”, “C”, . . . “J” respectively of column-X of FIG. 18D (for their respective (final)-#-of-(1X)-hardware in column-IX of FIG. 18D).

In FIGS. 18C-and-18D, please note that “not-decrease”-virtualized-(1X)-hardware in cloud-instance means-(and-its-implementations-illustrated-in-FIGS. 18C-and-18D-may-use): (i) “(not-decrease-or)-increase”-virtualized-(1X)-hardware (illustrated in FIG. 18C), and/or (ii) “(not-decrease-or)-keen-SAME/not-change”-virtualized-(1X)-hardware (illustrated in FIG. 18D).

(Not-decrease-or)-Keep-SAME/Not-Change-(Virtualized)-(1X)-Hardware-(in-Cloud-Instance) means SAME-QoS for users (of client computers 215).

FIG. 18D illustrates (not-decrease-or)-keep-SAME/not-change-virtualized-(1X)-hardware), and complements FIG. 18C, which illustrates (not-decrease-or)-increase-(virtualized)-(1X)-H/W.

FIG. 18E illustrates n-level (not-increase-or)-decrease-virtualized-(1X)-hardware in cloud-instance (running Moodle LMS, and using linear formula hardware) in the following columns:

(i) Column-I (of FIG. 18E) illustrates (not-increase-or)-decrease hardware levels of nth-level, (n−1)th-level, . . . , etc., 1st-level (in rows “B”, “C”, . . . “J” respectively of column-I of FIG. 18E).
(ii) Column-II (of FIG. 18E) illustrates (begin)-maximum-#-of-users of 800-millions, 80-millions, . . . , etc., 400 (in rows “B”, “C”, . . . “J” respectively of column-II of FIG. 18E (for their respective decrease-hardware-levels in column-I of FIG. 18E).
(iii) Column-III (of FIG. 18E) illustrates (begin)-#-of-(1X)-hardware of 8,000,000X, 800,000X, . . . , etc., 4X (in rows “B”, “C”, . . . “J” respectively of column-III of FIG. 18E (for their respective (begin)-maximum-#-of-users in column-II of FIG. 18E).
(iv) Columns-IV-and-V (of FIG. 18E) illustrates (begin)-EC2-cloud-instances-(implementing-“begin”-(1X)-H/W) of 250,000-TIMES-m4.16xlarge, 25,000-TIMES-m4.16xlarge, . . . , etc., m4.2xlarge (in rows “B”, “C”, . . . “J” respectively of column-V of FIG. 18E (for their respective (begin)-#-of-(1X)-hardware in column-III of FIG. 18E).
(v) Column-VT (of FIG. 18E) illustrates n-level-decrease-(1X)-H/W-in-(bank-of)-cloud-instances of 7,200,000X, 720,000X, . . . , etc., 3X (in rows “B”, “C”, . . . “J” respectively of column-VI of FIG. 18E (for their respective decrease-hardware-level in column-I of FIG. 18E).
(vi) Columns-VII-and-VIII (of FIG. 18E) illustrates (final)-EC2-cloud-instances-(implementing-“final”-virtualized-(1X)-hardware) of 25,000-TIMES-m4.16xlarge, 2,500-TIMES-m4.16xlarge . . . etc., m4.large (in rows “B”, “C”, . . . “J” respectively of column-VIII of FIG. 18E (for their respective (final)-#-of-(1X)-hardware in column-IX of FIG. 18E).
(vii) Column-IX (of FIG. 18E) illustrates (final)-#-of-(1X)-hardware of 800,000X, 80,000X, . . . etc., 1X (in rows “B”, “C”, . . . “J” respectively of column-IX of FIG. 18E (for their respective (final)-maximum-#-of-users in column-X of FIG. 18E).
(viii) Column-X (of FIG. 18E) illustrates (final)-maximum-#-of-users of 80-millions, 8-millions, . . . , etc., 100 (in rows “B”, “C”, . . . “J” respectively of column-IX of FIG. 18E (for their respective (final)-#-of-(TX)-hardware in column-IX of FIG. 18E).
(i) In FIGS. 18E-and-18F, please note that “not-increase”-virtualized-(1X)-hardware in cloud-instance means-(and-its-implementation-illustrated-in-FIGS. 18E-and-18F-may-use): (i) “(not-increase-or)-decrease”-virtualized-(1X)-hardware (illustrated in FIG. 18E), and/or (ii) “(not-increase-or)-keep-SAME/not-change”-virtualized-(X)-hardware (illustrated in FIG. 18F).

Decrease-(#-of-1X)-single-(virtualized)-hardware-(in-FIG.-18E's-column-VI=column-IX-(of-FIG.-18E) MINUS column-III-(of-FIG.-18E)) is defined-as-equal-to (computing cloud's (1X)-virtualized-hardware of) “(Final)-Amazon-EC2-Cloud-Instance(s)-(in-Column-VIII-(of-FIG.-18E))” MINUS “(Begin)-Amazon-EC2-Cloud-Instance-(in-Column-V-(of-FIG.-18E))”.

(ii) Implementation illustrations of rows “I”, “G”, and “D” of FIG. 18E are in FIGS. 30D, 30E and 30F respectively; other FIG. 18E's rows may be similarly illustrated (not shown):
FIG. 30D illustrates: (computing cloud 198) remove-4X-single-(virtualized)-hardware from (Amazon EC2) “m4.4xlarge”-cloud-instance to become “m4.2xlarge”-cloud-Instance. The implementation illustrates FIG. 18E, row “I”. More description of the implementation are in FIG. 30D's notes-1-and-2.
FIG. 30E illustrates: (computing cloud 198) remove-68X-single-(virtualized)-hardware from (Amazon EC2) bank-of-(m4.2xlarge+3-TIMES-‘32X-H/W’)-cloud-instances to become “m4.16xlarge”-cloud-instance.

The implementation illustrates FIG. 18E, row “G”. More description of the implementation are in FIG. 30E's notes-1-and-2.
FIG. 30F illustrates: (computing cloud 198) remove-72,000X-single-(virtualized)-hardware from (Amazon EC2) bank-of-(2,500-TIMES-‘32X-H/W’)-cloud-instances to become bank-of-(250-TIMES-‘32X-H/W’-cloud-instances.

The implementation illustrates FIG. 18E, row “D”. More description of the implementation are in FIG. 30F's notes-1-and-2.

(iii) Computing cloud 198 may also (like in FIG. 18E) n-level decrease-virtualized-(1X)-hardware in cloud-instance by using FIG. 19A's steps 1936-and-1940 (over time upto-days/weeks/months/year(s)), as follows:
FIG. 19A's step 1936: “Is fastest-response-time>floor-of-targeted-range-of-response-time ?”;
(If “Yes” to FIG. 19A's step 1936, then do:) FIG. 19A's step 1940(i) If possible, remove (virtualized)-hardware from (below-floor-of-targeted-range) fastest-to-respond cloud-instances; and/or
(If “Yes” to FIG. 19A's step 1936, then do:) FIG. 19A's step 1940(ii) Transfer-(any-other)-below-floor-response-time (cloud-instances')-clients to fastest-cloud-instance-to-respond: and/or
(If “Yes” to FIG. 19A's step 1936, then do:) FIG. 19A's step 1940(iii) (Optional) Close (below-floor)-cloud-instance(s)-(without-clients).

Less-(virtualized)-hardware-(in host computer cloud instance 205-C) means the not-needed (virtualized)-hardware (in the host computer cloud instance 205-C) can be returned to the computing cloud 198, when client-computers 215 leave Moodle (and/or L.A.M.P. platform) application service.

Bank-of-(one-or-more)-host-computer-cloud-instances are further described in Para [0027A]-to-[0027D], and illustrated in FIGS. 2A, 9A-to-9B, and 9C's-columns-II-to-XIV.

In FIGS. 18E-and-18F, please note that “not-increase”-virtualized-(1X)-hardware in cloud-instance means-(and-its-implementation-illustrated-in-FIGS. 18E-and-18F-may-use): (i) “(not-increase-or)-decrease”-virtualized-(1X)-hardware (illustrated in FIG. 18E), and/or (ii) “(not-increase-or)-keep-SAME/not-change”-virtualized-(1X)-hardware (illustrated in FIG. 18F).

(Not-increase-or)-Keep-SAME/Not-Change-(Virtualized)-(1X)-Hardware-(in-Cloud-Instance) means SAME-QoS for users (of client computers 215).

FIG. 18F illustrates (not-increase-or)-keep-SAME/not-change-virtualized-(1X)-hardware), and complements FIG. 18E, which illustrates (not-increase-or)-decrease-(virtualized)-(1X)-H/W.

Computing cloud's (e.g. computing cloud 198 in FIG. 9B) cloud-instance's customer-price-plans and contracts (as of year 2018) typically refer-to (or “price-and-sell”) “fixed” (virtualized)-hardware, as illustrated in FIG. 18B's Tables-2 (rows B-to-O, Columns IV-to-VII) referring-to (or “pricing-and-selling”) vCPU, ECU. Memory, and Linux Usage (not shown) for varying-US$-per-hour (not shown) for different Amazon EC2 cloud instances.

It is noted that computing cloud 198 may need (contractual/legal)-flexibility-(via-customer-cloud-instance-contract-modification-(not-shown))-in-customer-contract-terms-and-conditions for (customers' purchases of) its cloud instances to allow computing cloud 198 to (contractually/legally) increase virtualized-hardware (e.g. in FIG. 18C) or decrease (e.g. in FIG. 18D) virtualized-hardware (to a different virtualized-hardware-(than-originally)-contracted-for-(above, and illustrated in FIG. 19A step 1920) in its cloud instances, e.g. host computer cloud instance 205-C in FIG. 9B) as needed, as illustrated in following examples:

(a)(i) (when) computing cloud 198 detects (virtualized)-hardware-usage (in its cloud instances, e.g. host computer cloud instance 205-C in FIG. 9B) increase (significantly) or decrease (significantly); (a)(ii) (then) computing cloud 198 may (need above contractual/legal-flexibility to) increase virtualized-hardware (e.g. in FIG. 18C) or decrease (e.g. in FIG. 18D) virtualized-hardware, as illustrated in FIG. 19A's steps-1944-and-1946, and steps-1936-and-1940 respectively; or

(b)(i) (when) number of client computers 215 (connected to cloud instances, e.g. host computer cloud instance 205-C in FIG. 9B) increase (significantly) or decrease (significantly): (b)(ii) (then) computing cloud 198 may (need above contractual/legal-flexibility to) increase virtualized-hardware (e.g. in FIG. 18C) or decrease (e.g. in FIG. 18D) virtualized-hardware, as illustrated in FIG. 19A's steps-1944-and-1946, and steps-1936-and-1940 respectively: or

(c)(i) (when) computing cloud 198 detects (QoS-(as-defined-by-computing-cloud-198)) quality-of-service (in its cloud instances, e.g. host computer cloud instance 205-C in FIG. 9B) being-poorer-(significantly, e.g. in FIG. 19A's step 1944) or being-better-(significantly, e.g. in FIG. 19A's step 1936): (c)(i) (then) computing cloud 198 may (need above contractual/legal-flexibility to) increase-(virtualized)-hardware (e.g. in FIG. 18C) or decrease-(virtualized)-hardware (e.g. in FIG. 18D) respectively (to a different virtualized-hardware-(than-originally)-contracted-for-(above, and illustrated in FIG. 19A step 1920) in its cloud instances).

Bank-of-(one-or-more)-host-computer-cloud-instances are further described in Para [0027A]-to-[0027D], and illustrated in FIGS. 2A, 9A-to-9B, and 9C's-columns-II-to-XIV.

Please note that since a cloud vendor may use different hardware and (software)-virtualization (than those used by Amazon's EC2), a cloud vendor:
may use (for its cloud instance) substantially-equivalent-(to-Amazon's vCPU/ECU/Memory EC2 H/W in FIG. 18B's Table-2's columns-“V”-to-“VII”)-virtualized-H/W,
to implement #-of-(1X)-H/W (in FIG. 18B's Table-2's column-“II” and/or in “Linear formula” in FIG. 18B's Table-1's note (i)) in invention's specifications.
to support-(by-its-cloud-instance)-substantially-equivalent max.-#-of-concurrent-users (in FIG. 18B's Table-2's column-“I”) in one's Internet application service.

For example. Microsoft may use its Microsoft Azure Cloud Services (General Purpose—For websites, small-to-medium databases, and other everyday applications) to do above (Microsoft's implementation not shown), especially since Microsoft is highly competitive to Amazon (and Microsoft would offer highly competitive and comparable computing cloud offerings to Amazon's).

Similarly, Google may use its Google Cloud (Standard machine types) to do above (Google's implementation not shown), especially since Google is also highly competitive to Amazon (and Google would also offer highly competitive and comparable computing cloud offerings to Amazon's).

Process Considerations

In one embodiment of the present invention, a website 212A provides multiple web pages which allow a user to utilize the services of a server 222A. When a user visits the website 212A via a web browser 218, the user may log into the website 212A by providing a username and an associated password in accordance with standard Internet techniques. After logging in, the user may select to use the services provided by the server 222A by interacting with an options page 305. FIG. 3 illustrates an options page 305 in accordance with one embodiment of the present invention. In one embodiment, an options page 305 comprises a file in PHP, ASPX, or HTML format.

The options page 305 provides selectable icons which correspond to services provided by the server 222A. In one embodiment, the options page 305 lists one or more host helper programs 216-1 that the user may click to request to start a new Internet application service through the direct network connections using (bank of one-or-more) cloud instance(s) for Internet application service according to embodiments of the present invention. In another embodiment, the options page 305 lists one or more cloud instances 205-C (running respectively one or more host helper programs 216-1) that the user may click to request to start a new Internet application service through the direct network connections using cloud instance for Internet application service according to embodiments of the present invention. In one embodiment, the options page 305 lists one or more host computers 205 that the user may request to join their Internet application service through the direct network connections using cloud instance for Internet application service according to embodiments of the present invention. Additionally, the options page 305 presents the status of the selectable host computers 205a, 205b, 205c. In one embodiment, a host computer may have a status of connected, online, or offline. A host computer 205c may be offline because it does not have Internet connection or is not running. A host computer 205a that is “online” may be joined in Internet application service using the direct network connections using cloud instance for Internet application service according to embodiments of the present invention. A host computer 205b that is “connected” is already doing Internet application service using the direct network connections using cloud instance for Internet application service according to embodiments of the present invention. The user of a client computer 215 may select a host computer 205a, 205b that has a status of “online” or “connected” using the corresponding icon 4302a. 4302b to join their Internet application services with the host computer 205a, 205b according to the direct network connections using cloud instance for Internet application service in accordance with various embodiments of the present invention.

Additionally, the user may select to provide other client computers 215 Internet application service with the user's computer by itself becoming a host computer 205, using icon 4304. The user may also select to remove a host computer 205 from the list of accessible host computers 205 using icon 4306, or select to search for a not-displayed host computer 205 using icon 4308. Moreover, the user may select to create or search an event such as a Internet application service session using icon 4342. The options depicted in FIG. 3 and described above are provided for illustrative purposes only and are not intending to be limiting. Additional user-selectable options may be offered by a server 222A and/or presented on an options page 305 of a website 212A.

FIGS. 10A/10B/10C/10D/10E/10F/10G/10H/10I/10J/10K/10L presents flowcharts of a process performed by a host computer 205 to provide direct network connections between (bank of one-or-more) cloud instance and computers over a computer network in accordance with an embodiment of the present invention. First, the host computer 205 downloads, installs, and runs 1005 (in FIGS. 10A/10B/10C/10D/10E/10F/10G/10H/10I/10J/10K/10L) virtual machine software. In one embodiment, the virtual machine software is VMWARE player or workstation described above. Next, the host computer 205 downloads, installs, and starts host helper program 216-1, e.g. Moodle learning management system Internet application (from the Australian company Moodle Pty Ltd.) described above, in its installed virtual machine. FIG. 9A illustrates in one embodiment the host helper program 216-1 (optionally) running in installed virtual machine (virtual machine not shown) operating in the host computer 205. The host computer 205 saves 1010 (in FIGS. 10A/10B/10C/10D/ . . . /10J/10K/10L) the virtual machine (with its installed host helper program 216-1) in the host computer 205.

Note that FIG. 9A illustrates the host helper program 216-1 (optionally) running in installed virtual machine (virtual machine not shown in FIG. 9A) operating in the host computer 205 in FIG. 9A. The host helper program 216-1 may run in the host computer 205 (e.g. in FIG. 2A, and in other FIGS. and invention embodiments), which are different than FIG. 9A which illustrates the host helper program 216-1 (optionally) running in installed virtual machine (virtual machine not shown in FIG. 9A) operating in the host computer 205 in FIG. 9A.

The host computer 205 next logs-in 1015 (in FIGS. 10A/10B/10C/10D . . . 10K/10L) to a server 222A of a computing cloud 198, e.g. Amazon.com computing cloud, in FIG. 9A. The host computer 205 uploads 1015 (in FIGS. 10A/10B/10C/10D/ . . . /10J/10K/10L) its saved virtual machine (with its installed host helper program 216-1) to the computing cloud 198, and requests the Internet application service provided by its installed host helper program 216-1 be published 1015 (in FIGS. 10A/10B/10C/10D/ . . . /10I/10K/10L), e.g. via an options page 305 illustrated in FIG. 3. This host computer 205 or other host computer 205 may then visit options page 305 (of a website 212A hosted by the server 222A) to request to start 1017 (in FIGS. 10A/10B/10C/10D/ . . . /10J/10K/10L) a new Internet application service (provided by the host helper program 216-1 in uploaded virtual machine, e.g. Moodle learning management system Internet application (from the Australian company Moodle Pty Ltd.).

The server 222A requests 1018 (in FIGS. 10A/10B/10C/10D/ . . . /10J/10K/10L) the computing cloud 198 (in FIG. 9B) to launch-or-assign 1018 (in FIGS. 10A/10B/10C/10D/ . . . /10J/10K/10L)host computer cloud instance 205-C (operating a copy of the uploaded virtual machine running installed host helper program 216-1 in uploaded virtual machine). The host computer cloud instance 205-C (or computing cloud 198 in FIGS. 9A and 9B)) sends 1022(vi) (in FIGS. 10A/10B/10C/10D/ . . . /10J/10K/10L and in respectively (five)-Paras [0064E]-to-[0064I] below) its IP address to the server 222A, which receives-and-stores 1025 in FIGS. 10A/10B/10C/10D . . . /10J/10K/10L.

The five Paras “[0064E](i)(a)-to-(vi)”-to-“[0064I](i)(a)-to-(vi)” in following-pages refer-to and describe (for specification-of-illustration-of) respectively (embodiments of the invention) (step-1022](i)(a)-to-(vi)-of)-FIGS. 10A/10B/10C/10D/10E/10F/10G/10H/10I/10J/10K/10L and FIGS. 19A/19B/19C/19D/19E/19F/19G/19H/19I/19J/19K/19L.

The five Paragraphs “[0064E](i)(a)-to-(vi)”-to-“[0064I](i)(a)-to-(vi)” in following-pages refer-to and describe (for specifications-of-illustrations-of) respectively (embodiments of the invention) (step(s)-1022(i)(a)-to-(vi)-of)-FIGS. 10A/10B/10C/10D/10E/10F/10G/10H/10I/10J/10K/10L and (steps-1910-to-1948-of)-FIGS. 19A/19B/19C/19D/19E/19F/19G/19H/19I/19J/19K/19L.

FIGS. 10A/10B/10C/10D/10E/10F/10G/10H/10I/10J/10K/10L and FIGS. 19A/19B/19C/19D/19E/19F/19G/19H/19I/19J/19K/19L are (illustrations of embodiments of the invention):
FIGS. 10A-and-19A: (Start)-“Not-Less-Than-One”-Instance(s) and Ping and LOS (Level-of-Service):
FIGS. 10B-and-19B: (Start)-One-Instance and Ping and LOS (Level-of-Service);
FIGS. 10C-and-19C: (Start)-“Not-Less-Than-One”-Instance(s) and Ping and No-LOS (Level-of-Service);
FIGS. 10D-and-19D: (Start)-“Not-Less-Than-One”-Instance(s) and “Virtual”-Ping and Create-“Virtual”-Response and No-LOS (Level-of-Service);
FIGS. 10E-and-19E: (Start)-One-Instance and “Virtual”-Ping and Create-“Virtual”-Response and No-LOS (Level-of-Service).
FIGS. 10F-and-19F: (Start)-“Not-Less-Than-One”-Instance(s) (Only)
FIGS. 10G-and-19G: (Start)-One-Instance (Only)
FIGS. 10H-and-19H: (Start)-“Not-Less-Than-One”-Instance(s) and Ping-(No-Response) and LOS
FIGS. 10I-and-19I: (Start)-One-Instance and Ping-(No-Response) and LOS
FIGS. 10J-and-19J: (Start)-“Not-Less-Than-One”-Instance(s) and Ping-(No-Response) and No-LOS
FIGS. 10K-and-19K: (Start)-“Not-Less-Than-One”-Instance(s) and Ping-(No-Response) and Create-“Virtual”-Response and No-LOS
FIGS. 10L-and-19L: (Start)-One-Instance and Ping-(No-Response) and Create-“Virtual”-Response and No-LOS

Para [0064E](i)(a)-to-(vi) here refers-to FIGS. 10A and 19A (for illustrations of an embodiment of the invention) and describes (for specification):
(step-1022(i)(a)-to-(vi)-of)-“FIG. 10A: (Start)-‘Not-Less-Than-One’-Instance(s)-and-PING-and-LOS”, and
(steps 1930, 1932, 1947, and 1948 of)-“FIG. 19A: Start-‘Not-Less-Than-One’-Instance(s)-&-PING-&-LOS”.

In FIG. 10A's step 1022(i)(a)-to-(vi), the computing cloud 198:

i)(a) follows below and specifies FIG. 10A-step-1022(i)(a): (If computing cloud 198 previously processed FIGS.-10A-and-19A, when the (SAME)-host-computer-205-(and-the-(SAME)-server-222A) requested the-(SAME)-Internet-application-service (e.g. website services of Global 2000 companies, and others) as in FIG. 19A's-steps-1910-and-1920-and-1925, computing cloud 198) may (optionally in step 1022(i)(a)-of-FIG. 10A and/or step 1930(i)-of-FIG. 19A) send (if available) (previous/last)-IP-address of (previous/last) host-computer-cloud-instance 205-C (from (previous/last-processing-of) sub-step-1948(ii)-of-FIG. 19A, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) follows below and specifies FIG. 10A-step-1022(i)(b):
(Computing cloud 198 in step-1022(i)(b)-of-FIG. 10A) launches-or-assigns (e.g. in FIG. 19A's step-1930(ii)) a bank-of-(not-less-than-one)-cloud-instance(s) wherein each-of-the-(not-less-than-one)-cloud-instance(s) provides the requested Internet application service.

For example, in Para [0052A], including FIG. 9C's rows-=“A-to-A10” (“Alpha” bank of ten (10) cloud-instances) and rows-“B1-to-B4” (“Bravo” bank of four (4) cloud-instances), and (for each bank) columns-“I”-to “XV”-of-FIG-9C's-table), wherein each-of-the-cloud-instances-(in-each-(the-same)-bank) provides the requested Internet application service (e.g. requested-Internet-application-service-(for-the-(same)-bank) “Moodle LMS” and “L.A.M.P. Platform” respectively in FIG. 9H's column-VI for the banks-of-cloud-instances in FIG. 9H's rows-“A1-to-A10” (“Alpha” bank) and rows-“B1-to-B4” (“Bravo” bank); and

(ii)(a)-to-(ii)(c) follows below and specifies FIG. 10A-(sub)-steps-1022(ii)(a)-to-(ii)(c): Please reference: “(Computing Cloud) Attempt to Connect (to Cloud Instance)” in FIGS. 9I-to-9K and described in Para [0064L]:
(ii)(a) (Computing cloud 198 in step-1022(ii)(a)-of-FIG. 10A) (not-more-than-one)-attempt to connect (e.g. in FIG. 19A's step-1932(i)) to each-of-the-(not-less-than-one)-cloud-instance(s) (in above bank-of-(not-less-than-one)-cloud-instance(s) (meaning above “group-of-cloud-instance(s)”)).

Please note that Para [0064E](ii)(a)'s “(not-more-than-one)-attempt to connect” allows “(zero)-attempt to connect”, as “zero” is (also) “(not-more-than-one)”.

(ii)(b) (Computing cloud 198 in step-1022(ii)(b)-of-FIG. 10A) receive “not-more-than-one”-response from each of the-(not-less-than-one)-cloud-instance(s) (in bank-of-(not-less-than-one)-cloud-instance(s)).

Please note that Para [0064E](ii)(b)'s receive-“not-more-than-one”-response allows receive-“zero”-response, as “zero” is (also) “(not-more-than-one)”.

Please note that Para [0064E](ii)(b)'s “receive-“not-more-than-one”-response-( . . . )-from-each-of-the-(not-less-than-one)-cloud-instance(s)” allows “receive-“zero”-response-( . . . )-from-each-of-the-(not-less-than-one)-cloud-instance(s)” (i.e. allows zero-(total)-response), as “zero”-from-each-(cloud instance) is (STILL) “zero”-(total-response.

(ii)(c) Please reference: “(Computing Cloud) Attempt to Connect (to Cloud Instance)” in FIGS. 9I-to-9K and described in Para [0064L]:
(ii)(c) (Computing cloud 198 in step-1022(ii)(c)-of-FIG. 10A) if no-(or-zero-(total))-response (received) in (ii)(b) (from the “not-less-than-zero”-response(s) from the-(not-less-than-one)-cloud-instance(s)), create (one)-“virtual”-(zero-“cloud-instance”)-“response”-(zero-“cloud-instance”-“response”-examples are shown in FIG. 9J-(&-9I), & “virtual”-(zero-“cloud-instance”)-“response” described in spec.'s Para [0064H](iii)(b)); and

Please note that if no-(or-zero-(total))-response (received) in Para [0064E](ii)(b) (i.e. if “receive-“zero”-response-( . . . )-from-ach-of-the-(not-less-than-one)-cloud-instance(s)”), then:
Para [0064E](ii)(c) allows (computing cloud 198 to) create (one)-“virtual”-(zero-“cloud-instance”)-“response”.

Please note that with the (creation of) (one)-“virtual”-(zero-“cloud-instance”)-“response”, (to allow host-computer-cloud-instance 205-C still can be selected (to provide the requested Internet application service requested by host-computer-205) AND its I.P. address sent to the server 222A), FIG. 10A-(step-1022) can import-and-use FIG. 10H's-sub-steps(iii)-to-(vi) (replacing-and-NOT-use its-own-FIG. 10A's-sub-steps(iii)-to-(vi)):
(FIG. 10H's-sub-steps(iii)-to-(vi) copied/duplicated below:)
   (Beginning of FIG. 10H's-sub-steps(iii)-to-(vi))
   “(iii) selects-(randomly-or-using-other-selection-method(s)) (one) cloud instance (from attempt(s)-to-connect in (ii)(a)) as the host computer cloud instance; and
   (iv) disconnects (not-less-than-zero)-non-selected cloud instances; and
   (v) uses-(and-assigns-and-saves) IP address of selected-(randomly)-cloud-instance (in sub-step-(iii)) as IP address of host computer cloud instance; and
   (vi) sends (assigned-in-(v))-IP-Address of Host Computer Cloud Instance to Server.” (End of FIG. 10H's-sub-steps(iii)-to-(vi))

Similarly, Para [0064E](iii)-to-(vi) would import-and-use spec.'s Para [0064M](iii)-to-(vi) (REPLACING-and-NOT-use its-own-spec.-Para [0064E](iii)-to-(vi)):
which Para [0064E](iii)-to-(vi) would-be-REPLACED by Para [0064M](iii)-to-(vi) (so that Para [0064M](iii)-to-(vi) can be-spec.-for-(and-match)-FIG. 10H's-sub-steps(iii)-to-(vi) above).

Above embodiment of the invention combining FIG. 10A's-(sub)-step-1022-(i)(a)-to-(ii)(c) with FIG. 10H's-(sub)-step-1022-(iii)-to-(vi), AN combining Para [0064E](i)(a)-to-(ii)(c) with Para [0064M](iii)-to-(vi) allow implementation (using cloud instance and an embodiment of the invention) of a computing cloud (vendor's cloud-offering) price plan (e.g. FIG. 18B's (unedited-and-original-Amazon-EC2-price-plan-(not-shown)) Table-2).

Please note (for Para [0064E](ii)(a)-to-(ii)(c)] that (computing cloud 198) “not-more-than-one-attempt to connect” (illustrated in FIG. 19A's step-1932(i) and FIG. 10A's step 1022(ii)(a), and described in Para [0064E](ii)(a)) include-and-may-(also)-be:
zero-(or-not)-attempt to connect (since zero is (also) “not-more-than-one) (illustrated in FIGS. 19D's-and-19E's step(s)-1932(i) and FIGS. 10D's-and-10E's step(s) 1022(ii)(a), and described in Paras [0064H](ii)(a)-and-[0064I](ii)(a) respectively), and/or
one-attempt to connect (since one is (also) “not-more-than-one) (illustrated in FIG. 19B's step-1932(i) and FIG. 10B's step 1022(ii)(a), and described in Para [0064F](ii)(a)).

Please also note that the invention also works for “two-(or-more)-attempts to connect” (not shown):
e.g. two-attempts to connect (since two is “two-(or-more)”), as second-attempt may be insurance/back-up attempt to connect (e.g. for a lossy network).
   (iii) follows below and specifies FIG. 10A-step-1022(iii): (Computing cloud 198 in step-1022(iii)-of-FIG. 10A) selects (one) fastest cloud instance to respond (e.g. in FIG. 19A's step-1947) as the host computer cloud instance; and
   (iv) follows below and specifies FIG. 10A-step-1022(iv): (Computing cloud 198 in step-1022(iv)-of-FIG. 10A) disconnects (e.g. in FIG. 19A's step-1948(i)) (not-less-than-zero) non-selected cloud instance(s) (in bank); and
   (v) follows below and specifies FIG. 10A-step-1022(v):
   (Computing cloud 198 in step-1022(v)-of-FIG. 10A and in FIG. 19A's step 1948(ii)) uses-(and-assigns-and-saves) IP address of selected-(not-more-than-one)-“fastest”-cloud-instance-(to-respond) (in sub-step-1022(iii)) as IP address of host computer cloud instance 205-C.

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) follows below and specifies FIG. 10A-step-1022(vi):
(In step-1022(vi)-of-FIG. 10A) computing cloud 198 (or host computer cloud instance 205-C) sends 1022(vi) (in FIG. 10A) this (assigned-in-sub-step-1022(v)) IP address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10A's step-1022, or on options page 305 in FIG. 3) using the process described in FIG. 11A, 11B, 11C, 13A, 13B, or 13C below.

Para [0064F](i)(a)-to-(vi) here (for FIGS.-10B-and-19B for illustrations of another embodiment of the invention) is (originated-and)-edited-(and-derived) from Para [0064E](i)(a)-to-(vi), and refers-to and describes (for specification):
(step-1022-of)-“FIG. 10B: (Start)-One-Instance and Ping and LOS (Level-of-Service)”, and
(steps 1930, 1932, 1947, and 1948 of)-“FIG. 19B: (Start)-One-Instance and PING and LOS (Level-of-Service)”.

In FIG. 10B's step 1022, the computing cloud 198:

(i)(a) follows below and specifies FIG. 10B-step-1022(i)(a):
(If computing cloud 198 previously processed FIGS.-10B-and-19B, when the (SAME)-host-computer-205-(and-the-(SAME)-server-222A) requested the-(SAME)-Internet-application-service (e.g. for website services of G2000 companies, and others) as in FIG. 19B's-steps-1910-and-1920-and-1925, computing cloud 198) may (optionally in step 1022(i)(a)-of-FIG. 10B and/or step 1930(i)-of-FIG. 19B) send (if available) (previous/last)-IP-address of (previous/last) host-computer-cloud-instance 205-C (from (previous/last-processing-of) sub-step-1948(ii)-of-FIG. 19B, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) follows below and specifies FIG. 10B-step-1022(i)(b):
(Computing cloud 198 in step-1022(i)(b)-of-FIG. 10B) launches-or-assigns (e.g. in FIG. 19B's step-1930(ii)) a bank-of-one-cloud-instance wherein the (one)-cloud-instance provides the requested Internet application service.

For example, in Para [0052A](iii)-to(vi), and FIG. 9C's rows-“C-to-F”: “Charlie”, “Delta”, “Echo” and “Foxtrot” bank(s) of one (1) cloud-instance in respectively rows-“C-to-F”-and-columns-“I”-to “XV”-of-FIG-9C's-table), wherein each-of-the-one-cloud-instance (in “Charlie”, “Delta”. “Echo” and “Foxtrot” bank(s)) provide the requested Internet application service (e.g. requested-Internet-application-service “L.A.M.P. Platform” in FIG. 9H's column-VI (for the (“Charlie”, “Delta”. “Echo” and “Foxtrot”) bank(s)-of-cloud-instances in FIG. 9H's rows-“C-to-F”); and

Please note that FIG. 10B's step 1022(i)(b)'s above spec. Para [0064F](i)(b)'s “(computing cloud 198 . . . ) launches-or-assigns ( . . . ) a bank-of-one-cloud-instance wherein the (one)-cloud-instance provides the requested Internet application service” is (originated-and)-edited-(and-derived) from:
Para [0064E](i)(b)'s “(computing cloud 198 . . . ) launches-or-assigns ( . . . ) a bank-of-(not-less-than-one)-cloud-instance(s) wherein each-of-the-(not-less-than-one)-cloud-instance(s) provides the requested Internet application service”, as:
one cloud instance is (also) a bank of one cloud instance, and
a bank of one cloud instance is (also) a bank of not-less-than-one cloud instance, as one is (also) not-less-than-one; and
(one)-cloud-instance is also (each-of-the)-(one)-cloud-instance, which is also each-of-the-(not-less-than-one)-cloud-instance(s), as (one) is also (not-less-than-one).
   (ii)(a)-to-(ii)(c) follows below and specifies FIG. 10B-steps-1022(ii)(a)-to-(ii)(c): Please reference: “(Computing Cloud) Attempt to Connect (to Cloud Instance)” in FIGS. 9I-to-9K and described in Para [0064L]:
   (ii)(a) (Computing cloud 198 in step-1022(ii)(a)-of-FIG. 10B) (one)-attempt to connect (in FIG. 19B's step-1932(i)) to the (one)-cloud-instance (in above bank-of-(one)-cloud-instance, e.g. in FIG. 9C's rows-“C-to-F”: (“Charlie”. “Delta”, “Echo” or “Foxtrot”) banks-of-(one)-cloud-instance); and
   (ii)(b) (Computing cloud 198 in step-1022(ii)(b)-of-FIG. 10B) receive “not-more-than-one”-response from the-(one)-cloud-instance (in above bank-of-(one)-cloud-instance), e.g. Ping-response illustrated in FIG. 9K. Other examples of (received)-last-(ping)-response-times in FIG. 9C's rows-“C-to-F”-and-column-XIV (for FIG. 9C's rows-“C-to-F”: “Charlie”, “Delta”, “Echo” and “Foxtrot” banks)) from the-(one)-cloud-instance in “Charlie”, “Delta”, “Echo” and “Foxtrot” banks; and
   (ii)(c) Please reference: “(Computing Cloud) Attempt to Connect (to Cloud Instance)” in FIGS. 9I-to-9K and described in Para [0064L]:
   (ii)(c) (Computing cloud 198 in step-1022(ii)(c)-of-FIG. 10B) if no-(or-zero-(total))-response (received) in (ii)(b) (from the “not-more-than-one”-response from each of the-(not-less-than-one)-cloud-instance(s)), create (one)-“virtual”-(zero-“cloud-instance”)-“response”. “Virtual”-(zero-“cloud-instance”)-“response”-examples shown in FIG. 9J. “Virtual”-(zero-“cloud-instance”)-“response” described in Para [0064H](iii)(b)); and

Please note that FIG. 10B's step 1022(ii)(a)-and-(ii)(b)-and-(ii)(c)'s above spec.'s “(computing cloud 198) (one)-attempt to connect (e.g. in FIG. 19B's step-1932) to the-(one)-cloud-instance (in above . . . banks-of-cloud-instance), and receives (one) response . . . from the-(one)-cloud-instance” is (originated-and)-edited-(and-derived) from:
Para [0064E] (ii)(a)-and-(ii)(b)-and-(ii)(c)'s “(computing cloud 198) (not-more-than-one)-attempt to connect (e.g. in FIG. 19A's step-1932) to each-of-the-(not-less-than-one)-cloud-instance(s) (in above bank-of-cloud-instance(s) (meaning above “group-of-cloud-instance(s)”)), and receives (not-more-than-one)-response from each-of-the-(not-less-than-one)-cloud-instance(s) (in above bank-of-cloud-instance(s))”, as:
(one)-attempt-to-connect is (also) (not-more-than-one)-attempt to connect, as one is (also) not-more-than-one; and
the-(one)-cloud-instance is (also) each-of-the-(one)-cloud-instance, which is (also) each-of-the-(not-less-than-one)-cloud-instance(s), as one is (also) not-less-than-one; and
receives “one”-response is (also) receives “not-more-than-one”-response, as one is (also) not-more-than-one.

Please note that “not-more-than-one-attempt to connect” (illustrated in FIG. 19A's step-1932(i) and FIG. 10A's step 1022(ii)(a), and described in Para [0064E](ii)(a)) include-and-may-(also)-be:
zero-(or-not)-attempt to connect (since zero is (also) “not-more-than-one) (illustrated in FIGS. 19D's-and-19E's step(s)-1932(i) and FIGS. 10D's-and-10E's step(s) 1022(ii)(a), and described in Paras [0064H](ii)(a)-and-[0064I](ii)(a) respectively); and/or
one-attempt to connect (since one is (also) “not-more-than-one) (illustrated in FIG. 19B's step-1932(i) and FIG. 10B's step 1022(ii)(a), and described in Para [0064F](ii)(a)). Please also note that the invention also works for “two-(or-more)-attempts to connect” (not shown):
e.g. two-attempts to connect (since two is “two-(or-more)”), as second-attempt may be insurance/back-up attempt to connect (e.g. for a lossy network).
   (iii) follows below and specifies FIG. 10B-step-1022(iii):
   (Computing cloud 198 in step-1022(iii)-of-FIG. 10B) selects the-only-(one)-cloud-instance-as-(one or not-less-than-one)-“fastest”-cloud-instance (to respond) (e.g. in FIG. 19B's step-1947) as host computer cloud instance 205-C.

Please note that FIG. 10B's step 1022(iii)'s above spec. Para [0064F](iii)'s “(Computing cloud 198 in step-1022(iii)-of-FIG. 10B) selects the-only-(one)-cloud-instance-as-(one or not-less-than-one)-“fastest”-cloud-instance (to respond) (e.g. in FIG. 19B's step-1947) as host computer cloud instance 205-C” is (originated-and)-edited-(and-derived) from:
Para [0064E](iii)'s “(Computing cloud 198 in step-1022(iii)-of-FIG. 10A) selects (one or not-less-than-one) fastest-cloud-instance to respond (e.g. in FIG. 19A's step-1947) as the host computer cloud instance 205-C”, as:
“the-only-one” is (also) “one”, which is (also) (one or not-less-than-one).
   (iv) follows below and specifies FIG. 10B-step-1022(iv): (Computing cloud 198 in step-1022(iv)-of-FIG. 10B) disconnects (e.g. in FIG. 19B's step-1948(i)) (zero)-(as-“not-less-than-zero”) non-selected cloud instance, which: (step-1022(iv)-in-FIG. 10B) may be implemented (not shown) by software and database.

Please note that FIG. 10B's step 1022(iv)'s above spec. Para [0064F](iv)'s “(Computing cloud 198 in step-1022(iv)-of-FIG. 10B) disconnects (e.g. in FIG. 19B's step-1948(i)) (zero)-non-selected cloud instance” is (originated-and)-edited-(and-derived) from:
Para [0064E](iv)'s “(Computing cloud 198 in step-1022(iv)-of-FIG. 10A) disconnects (e.g. in FIG. 19A's step-1948(i)) (not-less-than-zero) non-selected cloud instance(s)”, as:
(zero)-non-selected cloud-instance is (also) (not-less-than-zero)-non-selected cloud-instance, as (zero) is (also) (not-less-than-zero).
   (v) follows below and specifies FIG. 10B-step-1022(v):
   (Computing cloud 198 in step-1022(v)-of-FIG. 10B and in FIG. 19B's step 1948(ii)) uses-(and-assigns-and-saves) IP address of selected-(the-only-one)-“fastest”-cloud-instance-(to-respond) (in sub-step-(iii)) as IP address of host computer cloud instance 205-C.

Please note that FIG. 10B's step 1022(v)'s above spec. Para [0064F](v)'s “(Computing cloud 198 in step-1022(v)-of-FIG. 10B and in FIG. 19B's step 1948(ii)) uses-(and-assigns-and-saves) IP address of selected-(the-only-one)-“fastest”-cloud-instance-(to-respond) (in sub-step-(iii)) as IP address of host computer cloud instance 205-C” is (originated-and)-edited-(and-derived) from:
Para [0064E](v)'s “(Computing cloud 198 in step-1022(v)-of-FIG. 10A and in FIG. 19A's step 1948(ii)) uses-(and-assigns-and-saves) IP address of selected-(not-more-than-one)-“fastest”-cloud-instance-(to-respond) (in sub-step-1022(iii)) as IP address of host computer cloud instance 205-C”, as:
(the-only-one)-“fastest”-cloud-instance is (also) (not-more-than-one)-“fastest”-cloud-instance, as (one) is (also) (not-more-than-one).

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) follows below and specifies FIG. 10B-step-1022(vi):
(in step-1022(vi)-of-FIG. 10B) computing cloud 198 (or host computer cloud instance 205-C) sends (assigned in Para [0064F](v))-IP-address of host computer cloud instance 205-C to the server 222A.

Bank-of-(one-or-more)-host-computer-cloud-instances are further described in Para [0027A]-to-[0027D], and illustrated in FIGS. 2A, 9A-and-9B, and 9C's-columns-II-to-XIV.

A client computer 215 in FIG. 9B may join the started Internet application service above (in/after FIG. 10B's step-1022, or on options page 305 in FIG. 3) using the process described in FIG. 11A, 11B, 11C, 13A, 13B, or 13C below.

Para [0064G](i)(a)-to-(vi) here (for FIGS.-10C-and-19C for illustrations of another further embodiment of the invention) is (originated-and)-edited-(and-derived) from Para [0064E](i)(a)-to-(vi), and refers-to and describes (for specification):
(step-1022-of)-“FIG. 10C: (Start)-“Not-Less-Than-One”-Instance(s) and Ping and No-LOS (Level-of-Service)”, and
(steps 1930, 1932, 1947, and 1948 of)-“FIG. 19C: (Start)-“Not-Less-Than-One”-Instance(s) and Ping and No-LOS (Level-of-Service)”.

In FIG. 10C's step 1022, the computing cloud 198:

(i)(a) (If computing cloud 198 previously processed FIGS.-10C-and-19C, when the (SAME)-host-computer-205-(and-the-(SAME)-server-222A) requested the-(SAME)-Internet-application-service (e.g. for website services of G2000 companies, and others) as in FIG. 19C's-steps-1910-and-1920-and-1925, computing cloud 198) may (optionally in step 1022(i)(a)-of-FIG. 10C and/or step 1930(i)-of-FIG. 19C) send (if available) (previous/last)-IP-address of (previous/last) host-computer-cloud-instance 205-C (from (previous/last-processing-of) sub-step-1948(ii)-of-FIG. 19C, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instantaneous)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

((i)(b) (computing cloud 198 in step-1022(i)(b)-of-FIG. 10C) launches-or-assigns (e.g. in FIG. 19C's step-1930(ii)) a bank-of-not-less-than-one-cloud-instance(s) wherein each-of-the-(not-less-than-one)-cloud-instance(s) provides the requested Internet application service.

For example, in Para [0052A](vii), and FIG. 9C's rows-“G1-to-G3”-(for-“Golf”-bank) of three (3) cloud-instances-in-the-bank, wherein each-of-the-three-cloud-instances-(of-the-bank) (of “Golf” bank) provide the requested Internet application service (e.g. requested-Internet-application-service “Moodle LMS” in FIG. 9H's column-VI (for the (“Golf”) bank-of-cloud-instances in FIG. 9H's rows-“G1-to-G3”, and Please note that FIG. 10C's step 1022(i)(b)'s above spec. Para [0064G](i)(b)'s “(computing cloud 198 . . . ) launches-or-assigns ( . . . ) a bank-of-not-less-than-one-cloud-instance(s) wherein each-of-the-(not-less-than-one)-cloud-instance(s) provides the requested Internet application service” is (originated-and)-edited-(and-derived) from:
Para [0064E](i)(b)'s “(computing cloud 198 . . . ) launches-or-assigns ( . . . ) a bank-of-(not-less-than-one)-cloud-instance(s) wherein each-of-the-(not-less-than-one)-cloud-instance(s) provides the requested Internet application service”.
   (ii)(a)-to-(ii)(c) follows below and specifies FIG. 10C-(sub)-1022(ii)(a)-to-(ii)(c): Please reference: “(Computing Cloud) Attempt to Connect (to Cloud Instance)” in FIGS. 9I-to-9K and described in Para [0064L]:
   (ii)(a) (computing cloud 198 in step-1022(ii)(a)-of-FIG. 10C) (not-more-than-one) attempt to connect (reference Para [0064L] and FIGS. 9I-to-9K) (e.g. in FIG. 19A's step-1932(i)) to each-of-the-(not-less-than-one)-cloud-instance(s) (in above bank-of-(not-less-than-one)-cloud-instance(s) (e.g. in above “Golf” bank-of-cloud-instance(s)).

Please note that FIG. 10C's step 1022(ii)(a)'s above spec. Para [0064G](ii)(a)'s “(not-more-than-one)-attempt to connect ( . . . ) to each-of-the-(not-less-than-one)-cloud-instance(s) (in above bank-of-(not-less-than-one)-cloud-instance(s)” is (originated-and)-edited-(and-derived) from:
Para [0064G](ii)(a)'s “(not-more-than-one)-attempt to connect ( . . . ) to each-of-the-(not-less-than-one)-cloud-instance(s) (in above bank-of-(not-less-than-one)-cloud-instance(s))”.

Please note that Para [0064G](ii)(a)'s “(not-more-than-one)-attempt to connect” allows “(zero)-attempt to connect”, as “zero” is (also) “(not-more-than-one)”.

(ii)(b) receive “not-more-than-one”-response (e.g. received-at-last-ping-response-time in FIG. 9C's rows-“Ga-to-G3”-(of-“Golf” bank)-and-column-XIV) from each-of-the-(not-less-than-one)-cloud-instance(s) (in above bank-of-cloud-instances) (e.g. in “Golf” bank).

Please note that FIG. 10C's step 1022(ii)(b)'s above spec. Para [0064G](ii)(b)'s “ . . . ‘receive “not-more-than-one”-response . . . from each-of-the-(not-less-than-one)-cloud-instance(s) (in . . . bank-of-cloud-instances) ( . . . in . . . bank)” is (originated-and)-edited-(and-derived) from:
Para [0064E](ii)(b)'s “receive “not-more-than-one”-response from each of the-(not-less-than-one)-cloud-instance(s) (in bank-of-(not-less-than-one)-cloud-instance(s)) (in bank . . . )”.

Please note that Para [0064G](ii)(b)'s receive-“not-more-than-one”-response allows receive-“zero”-response, as “zero” is (also) “(not-more-than-one)”.

Please note that Para [0064G](ii)(b)'s “receive-“not-more-than-one”-response-( . . . )-from-each-of-the-(not-less-than-one)-cloud-instance(s)” allows “receive-“zero”-response-( . . . )-from-inch-of-the-(not-less-than-one)-cloud-instance(s)” (or allows zero-(total)-response), as “zero”-from-each-(cloud instance) is (STILL) “zero”-(total)-response.

(ii)(c) Please reference: “(Computing Cloud) Attempt to Connect (to Cloud Instance)” in FIGS. 9I-to-9K and described in Para [0064L]:
(ii)(c) (Computing cloud 198 in step-1022(ii)(c)-of-FIG. 10C) if no-(or-zero-(total))-response (received) in (ii)(b) (from the “not-more-than-one”-response from each of the-(not-less-than-one)-cloud-instance(s)), create (one)-“virtual”-(zero-“cloud-instance”)-“response”. “Virtual”-(zero-“cloud-instance”)-“response”-examples shown in FIG. 9J. “Virtual”-(zero-“cloud-instance”)-“response” described in Para [0(64H](iii)(b)).

Please note that if no-(or-zero-(total))-response (received) in Para [0064G](ii)(b) (e.g. if Para [0064G](ii)(b) “receive-“zero”-response-( . . . )-from-each-of-the-(not-less-than-one)-cloud-instance(s)”), then:
Para [0064G](ii)(c) allows (computing cloud 198 to) crate (one)-“virtual”-(zero-“cloud-instance”)-“response”.

Please note that with the (creation of) (one)-“virtual”-(zero-“cloud-instance”)-“response”, (to allow host-computer-cloud-instance 205-C still can be selected (to provide the requested Internet application service requested by host-computer-205) AND its I.P. address sent to the server 222A), FIG. 10C-(step-1022) can import-and-use FIG. 10H's-sub-steps(iii)-to-(vi) (replacing-and-NOT-use its-own-FIG. 10C's-sub-steps(iii)-to-(vi)):
(FIG. 10H's-sub-steps(iii)-to-(vi) copied/duplicated below:)

(Beginning of FIG. 10H's-sub-steps(iii)-to-(vi))

“(iii) selects-(randomly-or-using-other-selection-method(s)) (one) cloud instance (from attempt(s)-to-connect in (ii)(a)) as the host computer cloud instance; and
(iv) disconnects (not-less-than-zero)-non-selected cloud instances; and
(v) uses-(and-assigns-and-saves) IP address of selected-(randomly)-cloud-instance (in sub-step-(iii)) as IP address of host computer cloud instance; and
(vi) sends (assigned-in-(v))-IP-Address of Host Computer Cloud Instance to Server.” (End of FIG. 10H's-sub-steps(iii)-to-(vi))

Similarly, Para [0064G](iii)-to-(vi) would import-and-use spec.'s Para [0064M](iii)-to-(vi) (REPLACING-and-NOT-use its-own-spec.-Para [0064G](iii)-to-(vi)):
which Para [0064G](iii)-to-(vi) would-be-REPLACED by Para [0064M](iii)-to-(vi) (so that Para [0064M](iii)-to-(vi) can be-spec.-for-(and-match)-FIG. 10H's-sub-steps(iii)-to-(vi) above).

Above embodiment of the invention combining FIG. 10C's-(sub)-step-1022-(i)(a)-to-(ii)(c) with FIG. 10H's-(sub)-step-1022-(iii)-to-(vi), AND combining Para [0064G](i)(a)-to-(ii)(c) with Para [0064M](iii)-to-(vi) allow implementation (using cloud instance and an embodiment of the invention) of a computing cloud (vendor's cloud-offering) price plan (e.g. FIG. 18B's (unedited-and-original-Amazon-EC2-price-plan-(not-shown)) Table-2). Please note that “not-more-than-one-attempt to connect” (illustrated in FIG. 19C's step-1932(i) and FIG. 10C's step 1022(ii)(a), and described in Para [0064G](ii)(a)) include-and-may-(also)-be:
zero-(or-not)-attempt to connect (since zero is (also) “not-more-than-one) (illustrated in FIGS. 19D's-and-19E's step(s)-1932(i) and FIGS. 10D's-and-10E's step(s) 1022(ii)(a), and described in Paras [0064H](ii)(a)-and-[0064I](ii)(a) respectively); and/or
one-attempt to connect (since one is (also) “not-more-than-one) (illustrated in FIG. 19B's step-1932(i) and FIG. 10B's step 1022(ii)(a), and described in Para [0064F](ii)(a)). Please also note that the invention also works for “two-(or-more)-attempts to connect” (not shown):
e.g. two-attempts to connect (since two is “two-(or-more)”), as second-attempt may be insurance/back-up attempt to connect (e.g. for a lossy network).
   (iii) (Computing cloud 198 in step-1022(iii)-of-FIG. 10C) selects (one or not-less-than-one) fastest cloud instance to respond (e.g. in FIG. 19C's step-1947) as host computer cloud instance 205-C.

Please note that FIG. 10C's step 1022(iii)'s above spec. Para [0064G](iii)'s “(Computing cloud 198 . . . ) selects (one or not-less-than-one) fastest cloud instance to respond ( . . . ) as host computer cloud instance 205-C” is (originated-and)-edited-(and-derived) from:
Para [0064E](iii)'s “(computing cloud 198 . . . ) selects (one or not-less-than-one) fastest cloud instance to respond ( . . . ) as host computer cloud instance 205-C”.
   (iv) (Computing cloud 198 in step-1022(iv)-of-FIG. 10C) disconnects (e.g. in FIG. 19C's step-1948(i)) (not-less-than-zero)-non-selected cloud instance(s) (in bank).

Please note that FIG. 10C's step 1022(iv)'s above spec. Para [0064G](iv)'s “(Computing cloud 198 . . . ) disconnects ( . . . ) (not-less-than-zero)-non-selected cloud instance(s) (in bank)” is (originated-and)-edited-(and-derived) from:
Para [0064E](iv)'s “(computing cloud 198 . . . ) disconnects ( . . . ) (not-less-than-zero) non-selected cloud instance(s) (in bank)”.
   (v) (Computing cloud 198 in step-1022(v)-of-FIG. 10C and in FIG. 19C's step 1948(ii)) uses-(and-assigns-and-saves) IP address of selected-fastest-cloud-instance-(to-respond) (in sub-step-1022(iii)) as IP address of host computer cloud instance 205-C.

Please note that FIG. 10C's step 1022(v)'s above spec. Para [0064G](v)'s “(Computing cloud 198 . . . ) uses-(and-assigns-and-saves) IP address of selected-fastest-cloud-instance-(to-respond) ( . . . ) as IP address of host computer cloud instance 205-C” is (originated-and)-edited-(and-derived) from:
Para [0064E](v)'s “(computing cloud 198 . . . ) uses-(and-assigns-and-saves) IP address of selected-(not-more-than-one)-“fastest”-cloud-instance-(to-respond) ( . . . ) as IP address of host computer cloud instance 205-C”.

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) (in step-1022(vi)-of-FIG. 10C) computing cloud 198 (or host computer cloud instance 205-C) sends 1022(vi) (in FIG. 10C) this (assigned-in-(v)) IP address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10C's step-1022, or on options page 305 in FIG. 3) using the process described in FIG. 11A, 11B, 11C, 13A, 13B, or 13C below.

Para [0064H](i)(a)-to-(vi) here (for FIGS.-10D-and-19D for illustrations of an embodiment of the invention) is (originated-and)-edited-(and-derived) from Para [0064E](i)(a)-to-(vi), and refers-to and describes (for specification):
(step-1022-of)-“FIG. 10D: (Start)-“Not-Less-Than-One”-Instance(s) and No-Ping and No-LOS (Level-of-Service)”, and
(steps 1930, 1932, 1947, and 1948 of)-“19D: (Start)-“Not-Less-Than-One”-Instance(s) and No-PING and No-LOS (Level-of-Service)”.

In FIG. 10D's (sub)-steps-“1022(i)(a)”-to-“1022(vi)”, the computing cloud 198:

(i)(a) (computing cloud 198 in (sub)-steps-1022(i)(a)-and-(i)(b)-of-FIG. 10D:)

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(a) (If computing cloud 198 previously processed FIGS.-10D-and-19D, when the (SAME)-host-computer-205-(and-the-(SAME)-server-222A) requested the-(SAME)-Internet-application-service (e.g. website services of G2000 companies, and others) as in FIG. 19D's-steps-1910-and-1920-and-1925, computing cloud 198) may (optionally in step1930(i)-of-FIG. 19D) send (if available) (previous/last)-IP-address of (previous/last) host-computer-cloud-instance 205-C (from (previous/last-processing-of) sub-step-1948(iv)-of-FIG. 19D, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.
   (i)(b) (computing cloud 198 in step-1022(i)(b)-of-FIG. 10D) launches-or-assigns (e.g. in FIG. 19D's step-1930(ii)) a bank-of-(not-less-than-one)-cloud-instance(s) (e.g. examples in Para [0052A](viii)-to-(xi), and FIG. 9C's rows-“H1-to-H3”-(for-“Hotel”-bank)-and-rows-“I”-“J”-“K”-(for-“India”-“Juliette”-“Kilo”-banks) of cloud-instances, wherein each-of-the-cloud-instance(s)-(of-the-banks) (e.g. above “Hotel”, “India”, “Juliette”, and “Kilo” banks), provide the requested Internet application service (e.g. requested-Internet-application-service “Moodle LMS” and “L.A.M.P. Platform” respectively in FIG. 9H's column-VI (for the (“Hotel”, “India”, “Juliette”, and “Kilo”) banks-of-cloud-instances in FIG. 9H's rows-“H1-to-H3”-and-rows-“I”-“J”-“K” respectively).

Please note that FIG. 10D's step 1022(i)(b)'s above spec. Para [0064H](i)(b)'s “(computing cloud 198 . . . ) launches-or-assigns ( . . . ) a bank-of-not-less-than-one-cloud-instance” is (originated-and)-edited-(and-derived) from:
Para [0064E](i)(b)'s “(computing cloud 198 . . . ) launches-or-assigns ( . . . ) a bank-of-(not-less-than-one)-cloud-instance(s) wherein each-of-the-(not-less-than-one)-cloud-instance(s) provides the requested Internet application service”.
   (ii)(a) (computing cloud 198 in step-1022(ii)(a)-and-(ii)(b)-and-(ii)(c)-of-FIG. 10D:) Please reference: “(Computing Cloud) Attempt to Connect (to Cloud Instance)” in FIGS. 9I-to-9K and described in Para [0064L]:
   (ii)(a) (one)-“virtual”-(zero)-attempt (using-(No-Op)-“Virtual”-Attempt to “Virtual”-Connect illustrated in step-935(i) of FIG. 9I-“(Computing Cloud) Attempt to Connect (to Cloud Instance)”) to “virtual”-connect (using “No-Op-and-software-and-database) to each-of-(not-less-than-one)-cloud-instances (in above bank-of-(not-less-than-one)-cloud-instances).

Please note that FIG. 10D's step 1022(ii)(a)'s above spec. Para [0064H](ii)(a)'s “(one)-“virtual”-(zero)-attempt ( . . . ) to “virtual”-connect ( . . . ) to each-of-(not-less-than-one)-cloud-instances (in above bank-of-(not-less-than-one)-cloud-instances)” is (originated-and)-edited-(and-derived) from:
Para [0064E](ii)(a)'s “(not-more-than-one)-attempt to connect ( . . . ) to each-of-the-(not-less-than-one)-cloud-instance(s) (in above bank-of-(not-less-than-one)-cloud-instance(s))”, as:
(one)-“virtual”-(zero)-attempt is (also) (not-more-than-one)-attempt as “one” is (also) “not-more-than-one”, and as
“virtual”-(zero)-attempt” is “virtual-attempt” which “virtual-attempt” is digital-“attempt”, and which (digital-“attempt”) is-(also) “attempt”.
   (ii)(b) (Please reference: “(Computing Cloud) Attempt to Connect (to Cloud Instance)” in FIGS. 9I-to-9K and described in Para [0064L]:)
   Illustrated in step-935(ii) of FIG. 9I, (“receive”-or)-create “not-less-than-one”-“virtual”-(zero-“cloud-instance”)-“responses”-(zero-“cloud-instance”-“responses”-examples are illustrated in FIG. 9J, and “virtual”-(zero-“cloud-instance”)-“responses” described in spec.s Para [0064H](iii)(b)) (from the-‘not-less-than-one’-cloud-instances-(in-bank)).

Please note that cloud-instances(-in-bank)'s-responses (in FIG. 10D step 1022(ii)(b)) are “virtual”-(zero-“cloud-instance”)-“responses”, which may be implemented using software-and-database (examples illustrated in FIG. 9H's rows-“L”-and-“M” for “Lima”-and “Mike” banks respectively of “Zero/None/Empty” cloud-instances (in column-“VI”-and-rows-“L”-and-“M” of FIG. 9H), and implementing “Zero/None/Empty” cloud-instance (from FIG. 18B's Table 2's row-C) with “0X-(‘zero’-X)-(virtualized)-H/W”-(“0-vCPU” and “0-ECU” and “0-GB” from columns-V-to-VII respectively of row-C of FIG. 18B's Table 2). More specification-(and-implementation of a feature of an embodiment of the invention) of “virtual”-(zero-“cloud-instance”)-“responses” are in Para [0064H](iii)(b) below.

Please note that FIG. 10D's step 1022(ii)(b)'s above spec. Para [0064H](ii)(b)'s “ . . . ‘receive’-or-create ‘not-less-than-one’-‘virtual’-(zero-‘cloud-instance’)-‘responses’-( . . . ) (from the-‘not-less-than-one’-cloud-instances-(in-bank)) is (originated-and)-edited-(and-derived) from:
Para [0064E](ii)(b)'s “receive “not-less-than-zero”-response(s) from the-(not-less-than-one)-cloud-instance(s) (in bank . . . )”, as:
‘not-less-than-one’-‘virtual’-(zero-‘cloud-instance’)-‘responses’ are (also) responses, and
‘receive’-or-create is (also or (substantially)-equivalent-to) ‘receive’.

Please note that “not-more-than-one-attempt to connect” (illustrated in FIG. 19A's step-1932(i) and FIG. 10A's step 1022(ii)(a), and described in Para [0064E](ii))(a) include-and-may-(also)-be:
zero-(or-not)-attempt to connect (since zero is (also) “not-more-than-one) (illustrated in FIGS. 19D's-and-19E's step(s)-1932(i) and FIGS. 10D's-and-10E's step(s) 1022(ii)(a), and described in Paras [0064H](ii)(a)-and-[0064I](ii)(a) respectively), and/or
one-attempt to connect (since one is (also) “not-more-than-one) (illustrated in FIG. 19B's step-1932(i) and FIG. 10B's step 1022(ii)(a), and described in Para [0064F](ii)(a)).

Please also note that the invention also works for “two-(or-more)-attempts to connect” (not shown):
e.g. two-attempts to connect (since two is “two-(or-more)”), as second-attempt may be insurance/back-up attempt to connect (e.g. for a lossy network).
   (ii)(c) (computing cloud 198 in step-1022(ii)(c)-of-FIG. 10D:) Please reference: “(Computing Cloud) Attempt to Connect (to Cloud Instance)” in FIGS. 9I-to-9K and described in Para [0064L]:
   (ii)(c) Please reference: “(Computing Cloud) Attempt to Connect (to Cloud Instance)” in FIGS. 9I-to-9K and described in Para [0064L]:
   (ii)(c) (Computing cloud 198) if no-(or-zero-total)-response (received) in (ii)(b) (from “not-less-than-zero”-responses from the-(not-less-than-one)-cloud-instance), crag (one)-“virtual”-(zero-“cloud-instance”)-“response”-(zero-“cloud-instance”-“response”-examples are shown in FIGS. 9J-(and-9I), and “virtual”-(zero-“cloud-instance”)-“response” described in spec.'s Para [0064H](iii)(b)).
   (iii)(a) (computing cloud 198 in step-1022(iii)(a)-and-(iii)(b)-of-FIG. 10D:)
   (iii)(a) (computing cloud 198) previously (received-or)-created (not-less-than-one)-“virtual”-(zero-“cloud-instance”)-“responses” (from step 1022(ii)(b)), wherein (bank's)-each-instance's-response (in steps-1022(ii)(b)) is (not-more-than-one)-“virtual”-(zero-“cloud-instance”)-“response”.

Please note that Para [0064H](iii)(a)-and-(iii)(b) are more specification of “virtual”-(zero-“cloud-instance”)-“responses” in Para [0064H](ii)(c), which (Para [0064H](ii)(c)) is (originated-and)-edited-(and-derived) from Para [0064E](ii)(c).

(iii)(b) (as “virtual”-is-digital) the-“not-less-than-one”-“virtual”-(zero-“cloud-instance”)-“responses” (in step 1022(ii)(b)-and-(ii)(c)) are the-(not-less-than-one)-(equally)-“fastest”-cloud-instances-to-“respond” (e.g. in FIG. 19D's step-1947(ii)), as:
“virtual”-(zero-“cloud-instance”)-“responses” (in FIG. 10D steps 1022(ii)(b)-and-(ii)(c)) are zero-(and-no-(and-empty))-cloud-instances, which may be implemented using software-and-database (e.g. (generic-examples (NOT (specifically) as responses to the bank-of-cloud-instance(s) launched in (i)(b)) illustrated in FIG. 9H's rows-“L”-and-“M” for “Lima”-and-“Mike” banks of “Zero/None/Empty” cloud-instances (in column-“VII”-and-rows-“L”-and-“M” of FIG. 9H), as copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

and implementing “Zero/None/Empty” cloud-instance (from FIG. 18B's Table 2's row-C) with “0X-(virtualized)-H/W”-(“0-vCPU” and “0-ECU” and “0-GB” from columns-V-to-VII respectively of row-C of FIG. 18B's Table 2) with FIG. 18B's Table 2's row-C (copied-and)-illustrated below:

TABLE 2
(Virtualized) (1X)-H/W (in) Amazon EC2 Cloud-Instance (Running Moodle):

| | I | II | III | IV | V | VI | VII |
|---|---|---|---|---|---|---|---|
| A | Max. # | 1X-H/W | Bank-of-Cloud-Instances: | | EC2 H/W (Each Instance): | | |
| B | Users | Implemented | #-of-32X-H/W-Instances | EC2 Instances: | vCPU | ECU | Memory |
| C | 0 | 0X | Zero/None/Empty | Zero/None/Empty | 0 | 0 | 0 GB |

hence, (FIG. 10D's step-1022(iii(b)'s and FIG. 19D's step-1947(ii)'s “virtual”-(zero-“cloud-instance”)-“responses” (with implementation using software and database) would be very fast and “(equally)-fastest-cloud-instances-to-‘respond’”.
   (iv)(a) (computing cloud 198 in (sub)-step(s)-1022(iv)(a)-and-(iv)(b)-of-FIG. 10D, and in FIG. 19D's (sub)-step(s) 1948(i)-and-(ii):)
   (iv)(a) (in FIG. 10D's (sub)-step-1022(iv)(a) and in FIG. 19D's (sub)-step 1948(i):) (computing cloud 198) create-(if-needed) an IP address for each of “not-less-than-one” “virtual”-(zero-“cloud-instance”)-“responses”, and “how-to-use which-IP-address” are described in spec.'s Para [0064I](iv)(b); and
   (iv)(b) (in FIG. 10D's (sub)-step-1022(iv)(b) and in FIG. 19D's (sub)-step 1948(ii):) (computing cloud 198) add-(&-merge) “each of the ‘not-less-than-one’ cloud-instances-(and-its-virtualized-hardware)”-(in-bank launched-or-assigned by computing cloud 198 in step 1022(i)(b) above) to each of the ‘not-less-than-one’-“virtual”-(zero-cloud-instance)-“responses” from step 1022(ii)(b)); and
if a/any cloud-instance of the bank already has an I.P. address (previously assigned by the computing cloud 198, e.g. if the cloud instance is providing the requested-Internet-application-service to a client computer), the-(“a/any”) cloud-instance of the bank may keep its I.P. address (in the merged-cloud-instance, and does not need-to-change-to the created I.P. address in above step-1022(iv)(a) in FIG. 10D); and/or
if another/any-other cloud-instance of the bank does not have an I.P. address (possibly assigned by the computing cloud 198), the-(“another/any-other”) cloud-instance of the bank may use the created I.P. address in step-1022(iv)(a) above); and
computing cloud 198 may decide on other method(s) of deciding the I.P. address of the merged-cloud-instance; and
   (v)(a) (computing cloud 198 in (sub)-steps-1022(v)(a)-and-(v)(b)-and-(v)(c)-of-FIG. 10D, and in FIG. 19D's (sub)-step(s) 1948(iii)-and-(iv)-and-(v):)
   (v)(a) (in FIG. 10D's (sub)-step-1022(v)(a) and in FIG. 19D's (sub)-step-1948(iii):) use-(and-select-(randomly-or-using-any-other-method)) one of the above “not-less-than-one” cloud-instance(s)-(in-bank) (now merged with (one of) the-“not-less-than-one”-“virtual”-(zero-“cloud-instance”)-“responses” (from step 1022(ii)(b)) as the (randomly-or-using-any-other-method)-selected-“fastest”-cloud-instance-(to-“respond”); and
since selected cloud-instance-(in-bank) (and (bank's)-cloud-instances) is/are also (equally)-“fastest”-cloud-instance(s)-to-respond from (sub)-step-1022(iii)(b) in FIG. 10D, the selected-cloud-instance-(in-bank) also is/become the selected “fastest”-cloud-instance-(to-respond); and
   (v)(b) (in FIG. 10D's (sub)-step-1022(v)(b) and in FIG. 19D's (sub)-step 1948(iv):) use-(and-assign-and-save) the IP-address (of the (randomly)-selected-(and-now-merged)-“fastest”-cloud-instance-(to-“respond”) in (v)(a)) as the IP-address-of-the-host-computer-cloud-instance 205-C; and
   (v)(c) (in FIG. 10D's (sub)-step-1022(v)(c) and in FIG. 19D's (sub)-step 1948(v):) disconnect/close/delete non-selected (“not-less-than-zero”)-“virtual”-(zero-“cloud-instance”)-“responses”, disconnect/close/delete (not-less-than-zero)-non-selected “zero-(and-no-(and-empty))-cloud-instance(-in-bank)'s-responses”
   (which “virtual”-(zero-“cloud-instance”)-“responses” are from (iii)(a)-and-(iii)(b) above), and which “disconnect/close/delete” may be performed using software-and-database to reverse/delete the implementation-((generic)-example-described-in-(iii)(b)) of “virtual”-(zero-“cloud-instance”)-“responses” by reversing/deleting-the-implementation (e.g. reverse/delete-the-implementation-((generic)-example) (illustrated below): i.e. reverse/delete implementation-(generic-examples (NOT (specifically) as “virtual”-(zero-“cloud-instance”)-“responses” to bank(s)-of-cloud-instance(s) in (i)(b)) in “FIG. 9H's row-“L”-and-“M” for “Lima”-and-“Mike” bank of “Zero/None/Empty” cloud-instance”, and copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

which implementation-((generic)-example) above is (described-in-(iii)(b)-and)-illustrated above in FIG. 9H's row-“L”-and-“M” for “Lima”-and-“Mike” bank of “Zero/None/Empty” cloud-instances (in column-“VII”-and-rows-“L”-and-“M” of FIG. 9H), and implementing “Zero/None/Empty” cloud-instances (from FIG. 18B's Table 2's row-C) with “0X-(virtualized)-H/W”-(“0-vCPU” and “0-ECU” and “0-GB” from columns-V-to-VII respectively of row-C of FIG. 18B's Table 2).

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) (in step-1022(vi)-of-FIG. 10D) computing cloud 198 (or host computer cloud instance 205-C) sends 1022(vi) (in FIG. 10D) this (assigned-in-(v)(b)) IP-address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10D's step-1022, or on options page 305 in FIG. 3) using the process described in FIG. 11A, 11B, 11C, 13A, 13B, or 13C below.

Para [0064I](i)(a)-to-(vi) here (for FIGS.-10E-and-19E for illustrations of another embodiment of the invention) is (originated-and)-edited-(and-derived) from Para [0064E](i)(a)-to-(vi), and refers-to and describes (for specification):
(step-1022-of)-“FIG. 10E: (Start)-One-Instance and No-Ping and No-LOS (Level-of-Service)”, and
(steps 1930, 1932, 1947, and 1948 of)-“FIG. 19E: (Start)-One-Instance and No-PING and No-LOS (Level-of-Service)”.

In FIG. 10E's (sub)-steps-“1022(i)(a)”-to-“1022(vi)”, the computing cloud 198:

(i)(a) (computing cloud 198 in step-1022(i)(a)-and-(i)(b)-of-FIG. 10E:)
(i)(a) (If computing cloud 198 previously processed FIGS.-10E-and-19E, when the (SAME)-host-computer-205-(and-the-(SAME)-server-222A) requested the-(SAME)-Internet-application-service (e.g. website services of Global 2000 companies, and others) as in FIG. 19E's-steps-1910-and-1920-and-1925, computing cloud 198) may (optionally in step1930(i)-of-FIG. 19E) send (if available) (previous/last)-IP-address of (previous/last) host-computer-cloud-instance 205-C (from (previous/last-processing-of) sub-step-1948(iv)-of-FIG. 19E, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) launches-or-assigns (e.g. in FIG. 19E's step-1930(ii)) a bank-of-=li-cloud-instance (e.g. (launches-or-assigns) any-ONE-of-the-three-banks-of-one-cloud-instance examples in Para [0052A](ix)-to-(xi), and FIG. 9H's (one-of)-rows-“I”-“J”-“K”-(for-“India”-“Juliette”-“Kilo”-banks) of one-cloud-instance, wherein the-one-cloud-instance-(of-the-banks) (e.g. (one-of) above “India”, “Juliette”, and “Kilo” banks) is providing the requested Internet application service (e.g. requested-Internet-application-service “L.A.M.P. Platform” in FIG. 9H's column-VI (for the (one-of) “India”, “Juliette”, and “Kilo”) bank-of-one-cloud-instance in FIG. 9H's (one-of)-row-“I”-or-“J”-or-“K” respectively).

Please note that FIG. 10E's step 1022(i)(b)'s above spec. Para [0064I](i)(b)'s “(computing cloud 198) launches-or-assigns (e.g. in FIG. 19E's step-1930(ii)) a bank-of-one-cloud-instance” is (originated-and)-edited-(and-derived) from:
Para [0064E](i)(b)'s “(computing cloud 198) launches-or-assigns (e.g. in FIG. 19A's step-1930(ii)) a bank-of-(not-less-than-one)-cloud-instances”, as:
one cloud instance is-(also) a group-(bank) of one cloud instance, and
a bank of one cloud instance is (also) a bank of not-less-than-one cloud instance s(in Para [0064E](i)(b)), as “one” is (also) “not-less-than-one”.
   (ii)(a) (computing cloud 198 in steps-1022(ii)(a)-and-(ii)(b)-and-(ii)(c)-of-FIG. 10E:) Please reference: “(Computing Cloud) Attempt to Connect (to Cloud Instance)” in FIGS. 9I-to-9K and described in Para [0064L]:
   (ii)(a) (computing cloud 198) (one)-“virtual”-(zero)-attempt (using-(No-Op)-“Virtual”-Attempt to “Virtual”-Connect illustrated in step-935(i) of FIG. 9I-“(Computing Cloud) Attempt to Connect (to Cloud Instance)”) to “virtual”-connect (using “No-Op”-and-software-and-database) to the-(one)-cloud-instance (in above bank-of-(one)-cloud-instance).

Please note that FIG. 10E's step 1022(ii)(a)'s above spec. Para [0064I](ii)(a): “(computing cloud 198) (one)-“virtual”-(zero)-attempt (using-(No-Op)-“Virtual”-Attempt to “Virtual”-Connect illustrated in step-935(i) of FIG. 9I-“(Computing Cloud) Attempt to Connect (to Cloud Instance)”) to “virtual”-connect (using “No-Op”-and-software-and-database) to the-(one)-cloud-instance (in above bank-of-(one)-cloud-instance)” is (originated-and)-edited-(and-derived) from:
Para [0064E](ii)(a)'s “(Computing cloud 198 . . . ) (not-more-than-one)-attempt to connect (reference Para [0064L] & FIGS. 9I-to-9K) to ah-of-(not-less-than-one)-cloud-instance(s) (in bank-of-(not-less-than-one)-cloud-instance(s)), as:
(one)-“virtual”-(zero)-attempt is (also) “attempt” (because “virtual”-attempt is (digital)-attempt), and
“one” is (also) “not-more-than-one” (in Para [0064E](ii)(a)).
   (ii)(b) illustrated in step-935(ii) of FIG. 9I, (“receive”-or)-create (one)-“virtual”-(zero-“cloud-instance”)-“response”-(zero-“cloud-instance”-“response”-examples are illustrated in FIG. 9J, and “virtual”-(zero-“cloud-instance”)-“response” described Para [0064H](iii)(b)).

Please note that cloud-instances(-in-bank)'s-responses (in FIG. 10E step 1022(ii)(b)) are “virtual”-(zero-“cloud-instance”)-“responses”, which may be implemented using software-and-database (examples illustrated in FIG. 9H's rows-“L”-and-“M” for “Lima”-and “Mike” banks respectively of “Zero/None/Empty” cloud-instances (in column-“V”-and-rows-“L”-and-“M” of FIG. 9H), and implementing “Zero/None/Empty” cloud-instance (from FIG. 18B's Table 2's row-C) with “0X-(‘zero’-X)-(virtualized)-H/W”-(“0-vCPU” and “0-ECU” and “0-GB” from columns-V-to-VII respectively of row-C of FIG. 18B's Table 2). More specification-(and-implementation of a feature of an embodiment of the invention) of “virtual”-(zero-“cloud-instance”)-“responses” are in Para [0064H](iii)(b) above.

Please note that FIG. 10E's step 1022(ii)(b)'s above spec. Para [0064I](ii)(b)'s “ . . . ‘receive’-or-create (one)-“virtual”-(zero-‘cloud-instance’)-‘response’-( . . . )” is (originated-and)-edited-(and-derived) from:
Para [0064E](ii)(b)'s “receive “not-less-than-zero”-response(s) from the-(not-less-than-one)-cloud-instance(s) (in bank . . . )”, as:
(one)-‘virtual’-(zero-‘cloud-instance’)-‘response’ is (also) response.

Please note that)-‘virtual’-(zero-‘cloud-instance’)-‘response (in FIG. 10E step 1022(ii)(b)) are “virtual”-(zero-“cloud-instance”)-“responses”, which may be implemented using software-and-database (examples illustrated in FIG. 9H's rows-“L”-and-“M” for “Lima”-and “Mike” banks respectively of “Zero/None/Empty” cloud-instances (in column-“VI”-and-rows-“L”-and-“M” of FIG. 9H), and implementing “Zero/None/Empty” cloud-instance (from FIG. 18B's Table 2's row-C) with “0X-(‘zero’-X)-(virtualized)-H/W”-(“0-vCPU” and “0-ECU” and “0-GB” from columns-V-to-VII respectively of row-C of FIG. 18B's Table 2). More specification-(and-implementation of a feature of an embodiment of the invention) of “virtual”-(zero-“cloud-instance”)-“responses” are in Para [0064H](iii)(b) below.

Please note that FIG. 10E's step 1022(ii)(b)'s above spec. Para [0064I](ii)(b)'s . . . ‘receive’-or-create (one)-‘virtual’-(zero-‘cloud-instance’)-‘response’-( . . . ) (from the-(one)-cloud-instance-(in-bank)) is (originated-and)-edited-(and-derived) from:
Para [0064E](ii)(b)'s “receive “not-less-than-zero”-response(s) from the-(not-less-than-one)-cloud-instance(s) (in bank . . . )”, as:
(one)-‘virtual’-(zero-‘cloud-instance’)-‘response’ is (also) response, and
“one” is (also) “not-less-than-one”.
   (ii)(c) (computing cloud 198 in step-1022(ii)(c)-of-FIG. 10E:) Please reference: “(Computing Cloud) Attempt to Connect (to Cloud Instance)” in FIGS. 9I-to-9K and described in Para [0064L]:
   (ii)(c) (Computing cloud 198) if no-(or-zero-(total))-“response” (received) in (ii)(b) (from “not-less-than-zero”-responses from the-(not-less-than-one)-cloud-instance), create (one)-“virtual”-(zero-“cloud-instance”)-“response”-(zero-“cloud-instance”-“response”-examples are shown in FIGS. 9J-(and-9I), and “virtual”-(zero-=“cloud-instance”)-“response” described in spec.'s Para [0064H](iii)(b)).

Please note that the-“virtual”-(zero-“cloud-instance”)-“response” (in FIG. 10E step 1022(ii)(b)) is zero-(and-no-(and-empty))-cloud-instance, which may be implemented using software-and-database (e.g. (which software-and-database implementation)-illustrated by FIG. 9H's (implementing)-(any-ONE-of-the-two)-rows-“L”-and-“M” for (one-of)-“Lima”-and “Mike” banks respectively of “Zero/None/Empty” cloud-instances (in column-“VI”-and-(one-of)-rows-“L”-and-“M” of FIG. 9H), and implementing “Zero/None/Empty” cloud-instance (from FIG. 18B's Table 2's row-C) with “0X-(‘zero’-X)-(virtualized)-H/W”-(“0-vCPU” and “0-ECU” and “0-GB” from columns-V-to-VII respectively of row-C of FIG. 18B's Table 2).

Please note that FIG. 10E's step 1022(ii)(a)'s-and-(ii)(b)'s above specs. Para [0064I](ii)(a)-and-(ii)(b) are (originated-and)-edited-(and-derived) from Para [0064E](ii)(a)-and-(ii)(b).

Please note that “not-more-than-one-attempt to connect” (illustrated in FIG. 19A's step-1932 and FIG. 10A's step 1022(ii), and described in Para [0064E](ii)) include-and-may-(also)-be:
zero-(or-not)-attempt to connect (since zero is (also) “not-more-than-one) (illustrated in FIGS. 19D's-and-19E's step(s)-1932(i) and FIGS. 10D's-and-10E's step(s) 1022(ii)(a), and described in Paras [0064H](ii)(a)-and-[0064I](ii)(a) respectively), and/or
one-attempt to connect (since one is (also) “not-more-than-one) (illustrated in FIG. 19B's step-1932(i) and FIG. 10B's step 1022(ii)(a), and described in Para [0064F](ii)).

Please also note that the invention also works for “two-(or-more)-attempts to connect” (not shown):
e.g. two-attempts to connect (since two is two-(or-more)”), as second-attempt may be insurance/back-up attempt to connect (e.g. for a lossy network).
   (iii)(a)-and-(iii)(b) (computing cloud 198 in step-1022(iii)(a)-and-(iii)(b)-of-FIG. 10E:)
   (iii)(a) previously (received-or)-created (one)-“virtual”-(zero-“cloud-instance”)-“response” (from step 1022(ii)(b)), wherein (bank's)-(one)-instance's-response (in step-1022(ii)(b)) is (one)-“virtual”-(zero-“cloud-instance”)-“response”.
   (iii)(b) (as “virtual”-is-digital) the-(one)-“virtual”-(zero-“cloud-instance”)-“response” (in step 1022(ii)(b)) is (also) the-(one)-“fastest”-cloud-instances-to-“respond”, as:
“virtual” is (using)-digital (and very fast, and almost-instant using software-and-database); and
   which (the-(one)-“virtual”-(zero-“cloud-instance”)-“response”) may be implemented using software-and-database, e.g. illustrated by any-ONE-of-the-two-banks-of-one-cloud-instance in FIG. 9H's (one-of)-row-“L”-or-“M” for (one-of)-“Lima”-or“Mike” bank of “Zero/None/Empty” cloud-instance (in column-“VII”-and-(one-of)-row-“L”-or-“M” of FIG. 9H), as copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

and implementing “Zero/None/Empty” cloud-instance (e.g. from FIG. 18B's Table 2's row-C) with “0X-(‘zero’-X)-(virtualized)-H/W”-(“0-vCPU” and “0-ECU” and “0-GB” from columns-V-to-VII respectively of row-C of FIG. 18B's Table 2) illustrated below:

TABLE 2
(Virtualized) (1X)-H/W (in) Amazon EC2 Cloud-Instance (Running Moodle):

| | I | II | III | IV | V | VI | VII |
|---|---|---|---|---|---|---|---|
| A | Max. # | 1X-H/W | Bank-of-Cloud-Instances: | | EC2 H/W (Each Instance): | | |
| B | Users | Implemented | #-of-32X-H/W-Instances | EC2 Instances: | vCPU | ECU | Memory |
| C | 0 | 0X | Zero/None/Empty | Zero/None/Empty | 0 | 0 | 0 GB |

hence, (FIG. 10E's steps 1022(ii)(b)'s the-(one)-“virtual”-(zero-“cloud-instance”)-“response” (with implementation using software and database) would be very fast (and almost-instant using software-and-database).
   (iv)(a)-and-(iv)(b) (computing cloud 198 in steps-1022(iv)(a)-and-(iv)b)-of-FIG. 10E, and in FIG. 19E's (sub)-step(s) 1948(i)-and-(ii):)
   (iv)(a) (in FIG. 10E's (sub)-step-1022(iv)(a) and in FIG. 19E's (sub)-step 1948(i):) (computing cloud 198) create-(if-needed) an IP address for the-(one)-“virtual”-(zero-“cloud-instance”)-“response” (received/created in FIG. 10E's step 1022(ii)(b)), and which created-I.P.-address M& be used in Para [0064I](iv)(b) below.
   (iv)(b) (in FIG. 10E's step-1022(iv)(b) and in FIG. 19E's step 1948(ii):) (computing cloud 198) add-(and-merge) “the-(one)-cloud-instance-(and-its-virtualized-hardware)”-(in above bank-of-(one)-cloud-instance launched-or-assigned by computing cloud 198 in FIG. 10E's step-1022(i)(b)) to the-(one)-“virtual”-(zero-“cloud-instance”)-“response” (received/created in FIG. 10E's step 1022(ii)(b)), and
if the (one) cloud-instance (of the above bank-of-(one)-cloud-instance) already has an I.P. address (previously assigned by the computing cloud 198, e.g. if the cloud instance is providing the requested-Internet-application-service to a client computer), the (one) cloud-instance of the bank may keep its I.P. address (in the merged-cloud-instance, and does not need-to-change-to the created I.P. address in step-1022(iv)(a) of FIG. 10E); and/or
if the (one) cloud-instance of the bank does not have an I.P. address (possibly assigned by the computing cloud 198), the (one) cloud-instance of the bank may use the created I.P. address in step-1022(iv)(a) of FIG. 10E); and
computing cloud 198 may decide on other method(s) of deciding the I.P. address of the merged-cloud-instance in step-1022(iv)(b) of FIG. 10E.
   (iv)(b) (spec. for FIG. 10E's step-1022(iv)(b) and FIG. 19E's step 1948(ii)) on “add-(and-merge) ‘the-(one)-cloud-instance-(and-its-virtualized-hardware)’-(in-bank) to ‘the-(one)-(virtual)-zero-cloud-instance-(response)’ allows:
the merged-‘the-(one)-cloud-instance-(in-bank) to be BOTH “providing said Internet application service” (as it has/includes/merged “the-(one)-cloud-instance-(in-bank)”, and is (also) “the-(one)-‘fastest’-cloud-instance-to-“respond” (as it also has/includes/merged “the-(one)-(virtual)-zero-cloud-instance-(response)” (created by software-and-database and is very fast as explained in Para [0064I](III)(b)).
   (v)(a) (computing cloud 198 in steps-1022(v)(a)-and-(v)(b)-of-FIG. 10E, and in FIG. 19E's step(s) 1948(iii)-and-(iv):)
   (v)(a) (in FIG. 10E's step-1022(v)(a) and in FIG. 19E's step 1948(iii):) use-(and-“select”) above the-(one)-cloud-instance-(in-above-bank-of-(one)-cloud-instance) (now merged with the (one)-“virtual”-(zero-“cloud-instance”)-“response”) as the selected-“fastest”-cloud-instance(to-“respond”), as:
the-(one)-“virtual”-(zero-“cloud-instance”)-“response” is (also) the-(one)-“fastest”-cloud-instance-to-“respond”, as “virtual” is (using)-digital (and very fast, and almost-instant using software-and-database).
   (v)(b) (in FIG. 10E's step-1022(v)(b) and in FIG. 19E's step 1948(iv):) use-(and-assign-and-save) the IP-address (of the selected-(and-now-merged)-“fastest”-cloud-instance-(to-“respond”) in FIG. 10E's step-1022(v)(a)) as the IP-address-of-host-computer-cloud-instance 205-C and:
the IP-address (of the selected-(and-now-merged)-“fastest”-cloud-instance-(to-“respond”) is now (assigned-to-be) the IP address of the host computer cloud instance 205-C (providing said Internet application service of said one of the first computers) requested by the server.
   (v)(c) (in FIG. 10E's step-1022(v)(c) and in FIG. 19E's step 1948(v):) disconnect/close/delete (zero)-non-selected “virtual”-(zero-“cloud-instance”)-“response” (which “virtual”-(zero-“cloud-instance”)-“response” is from (iii)(a)-and-(iii)(b) above), and which (disconnect/close/delete) may be implemented using software-and-database to reverse/close/delete the implementation-(example-described-in-Para-[0064I](iii)(b)) of “virtual”-(zero-“cloud-instance”)-“response” by reversing/closing/deleting-the-implementation (e.g. reverse/close/delete-the-implementation-(example) (illustrated below): e.g. reverse/close/delete implementation-(example) in “FIG. 9H's (one-of)-row-“L”-or-“M” for (one-of)-“Lima”-or-“Mike” bank of “Zero/None/Empty” cloud-instance”, and copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

which implementation-(example) above is (described-in-Para-[0064I](iii)(b)-and)-illustrated above in FIG. 9H's (one-of)-row-“L”-or-“M” for (one-of)-“Lima”-or-“Mike” bank of “Zero/None/Empty” cloud-instance (in column-“VII”-and-(one-of)-row-“L”-or-“M” of FIG. 9H), and implementing “Zero/None/Empty” cloud-instance (from FIG. 18B's Table 2's row-C) with “0X-(virtualized)-H/W”-(“0-vCPU” and “0-ECU” and “0-GB” from columns-V-to-VII respectively of row-C of FIG. 18B's Table 2).

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) (in step-1022(vi)-of-FIG. 10E) computing cloud 198 (or host computer cloud instance 205-C) sends (in step-1022(vi) in FIG. 10E) this (assigned in Para [0064I](v)(b)) IP-address of host computer cloud instance 205-C to the server 222A.

Bank-of-(one)-host-computer-cloud-instance are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10E's step-1022, or on options page 305 in FIG. 3) using the process described in FIG. 11A, 11B, 11C, 13A, 13B, or 13C below.

Para [0064J](i)(a)-to-(vi) here (for FIGS.-10F-and-19K for illustrations of another embodiment of the invention), and refers-to and describes (for specification):
(step-1022-of)-“FIG. 10F: (Start)-‘Not-Less-Than-One’-Instance(s)”, and
(steps 1930, 1947, and 1948 of)-“FIG. 19K: (Start)-‘Not-Less-Than-One’-Instance(s)”.

In FIG. 10F's step 1022, the computing cloud 198:

i)(a) follows below and specifies FIG. 10F-step-1022(i)(a):
(If computing cloud 198 previously processed FIGS.-10F-and-19K, when the (SAME)-host-computer-205-(and-the-(SAME)-server-222A) requested the-(SAME)-Internet-application-service (e.g. website services of G2000 companies, and others) as in FIG. 19K's-steps-1910-and-1920-and-1925, computing cloud 198) may (optionally in step 1022(i)(a)-of-FIG. 10F and/or step1930(i)-of-FIG. 19K) send (if available) (previous/last)-IP-address of (previous/last) host-computer-cloud-instance 205-C (from (previous/last-processing-of) sub-step-1948(ii)-of-FIG. 19K, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) follows below and specifies FIG. 10F-step-1022(i)(b): (Computing cloud 198 in step-1022(i)(b)-of-FIG. 10F) launches-or-assigns (e.g. in FIG. 19K's step-1930(ii)) a bank-of-not-less-than-one-cloud-instance(s) (e.g. examples in Para [0052A](viii)-to-(xi), and FIG. 9C's rows-“H1-to-H3”-(for-“Hotel”-bank)-and-rows-“I”-“J”-“K”-(for-“India”-“Juliette”-“Kilo”-banks) of cloud-instances, wherein each-of-the-cloud-instance(s)-(of-the-banks) (e.g. above “Hotel”, “India”, “Juliette”, and “Kilo” banks) provide the requested Internet application service (e.g. requested-Internet-application-service “Moodle LMS” and “L.A.M.P. Platform” respectively in FIG. 9H's column-VI (for the (“Hotel”, “India”, “Juliette”, and “Kilo”) banks-of-cloud-instances in FIG. 9H's rows-“H1-to-H3”-and-row s-“I”-“J”-“K” respectively).

Please note that the “bank-of-(not-less-than-one)-cloud-instance(s)” (in step-1022(i(b)-of-FIG. 10F) would support “3,200”-to-“80-billions-(80,000,000,000)” maximum concurrent-users/clients-215 (in FIG. 9A) in FIG. 4's Table-2's rows-“B”-and-“C” (which (above “3,200”-to-“80-billions” maximum users) is explained in Para [0045A]-and-[0045B]-and-[0045C]) in an embodiment of the invention, (if “not-less-than-one” is from-1-to-25,000,000, and cloud instance is using Amazon EC2's “m4.16xlarge”-(virtualized)-hardware-(cloud-instance) (in step-1022(i)(b)-of-FIG. 10F)).

(ii)(a)-to-(ii)(c) DELETED
(ii)(a) DELETED
(ii)(b) DELETED
(ii)(c) DELETED
(iii) follows below and specifies FIG. 10F-step-1022(iii):
(Computing cloud 198 in step-1022(iii)-of-FIG. 10F) selects-(randomly-or-using-other-selection-method(s)) (one or not-less-than-one) cloud-instance (e.g. in FIG. 19K's step-1947) as the host computer cloud instance 205-C; and
(iv) follows below and specifies FIG. 10F-step-1022(iv): (Computing cloud 198 in step-1022(iv)-of-FIG. 10F) disconnects (e.g. in FIG. 19K's step-1948(i)) (not-less-than-zero) non-selected cloud instance(s) (in bank); and
(v) follows below and specifies FIG. 10F-step-1022(v): (Computing cloud 198 in step-1022(v)-of-FIG. 10F and in FIG. 19K's step 1948(ii)) uses-(and-assigns-and-saves) IP address of selected-(one or not-less-than-one)-cloud-instance (in sub-step-1022(iii)) as IP address of host computer cloud instance 205-C.

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) follows below and specifies FIG. 10F-step-1022(vi):
(In step-1022(vi)-of-FIG. 10F) computing cloud 198 (or host computer cloud instance 205-C) sends 1022(vi) (in FIG. 10F) this (assigned-in-sub-step-1022(v)) IP address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIGS. 9A-and/or-9B may join the started Internet application service above (in FIG. 10F's step-1022, or on options page 305 in FIG. 3) using the process described in FIG. 11A, 11B, 11C, 13A, 13B, or 13C below.

Para [0064K](i)(a)-to-(vi) here (for FIGS.-10G-and-19L for illustrations of another embodiment of the invention) is (originated-and)-edited-(and-derived) from Para [0064J](i)(a)-to-(vi), and refers-to and describes (for specification):
(step-1022-of)-“FIG. 10G: (Start)-One-Instance”, and
(steps 1930, 1947, and 1948 of)-“FIG. 19L: (Start)-One-Instance”.

In FIG. 10G's step 1022, the computing cloud 198 (in FIGS. 9A-and-9B):

(i)(a) follows below and specifies FIG. 10G-step-1022(i)(a):
(if computing cloud 198 previously processed FIGS.-10G-and-19L, when the (SAME)-host-computer-205-(and-the-(SAME)-server-222A) requested the-(SAME)-Internet-application-service (e.g. for website services of Global 2000 companies, and others) as in FIG. 19L's-steps-1910-and-1920-and-1925, computing cloud 198) may (optionally in step 1022(i)(a)-of-FIG. 10G and/or step1930(i)-of-FIG. 19L) send (if available) (previous/last)-IP-address of (previous/last) host-computer-cloud-instance 205-C (from (previous/last-processing-of) sub-step-1948(ii)-of-FIG. 19L, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) launches-or-assigns (e.g. in FIG. 19L's step-1930(ii)) a bank-of-one-cloud-instance (e.g. (launches-or-assigns) any-ONE-of-the-three-banks-of-one-cloud-instance examples in Para [0052A](ix)-to-(xi), and FIG. 9H's (one-of)-rows-“I”-“J”-“K”-(for-“India”-“Juliette”-“Kilo”-banks) of one-cloud-instance, wherein the-one-cloud-instance-(of-the-banks) (e.g. (one-of) above “India”, “Juliette”, and “Kilo” banks) provide the requested Internet application service (e.g. requested-Internet-application-service “L.A.M.P. Platform” in FIG. 9H's column-VI (for the (one-of) “India”, “Juliette”, and “Kilo”) bank-of-one-cloud-instance in FIG. 9H's (one-of)-row-“I”-or-“J”-or-“K” respectively).

Please note that FIG. 10G's step 1022(i)(b)'s above spec. Para [0064K](i)(b)'s “(computing cloud 198) launches-or-assigns (e.g. in FIG. 19L's step-1930(ii)) a bank-of-one-cloud-instance” is (originated-and)-edited-(and-derived) from:
Para [0064J](i)(b)'s “(computing cloud 198) launches-or-assigns (e.g. in FIG. 19K's step-1930(ii)) a bank-of-(not-less-than-one)-cloud-instances”, as:
one cloud instance is-(also) a group-(bank) of one cloud instance, and
a group of one cloud instance is (also) a group of not-less-than-one cloud instance (in Para [0064J](i)(b)), as “one” is (also) “not-less-than-one”.
   (ii)(a)-and-(ii)(b)-and(ii)(c) DELETED
   (iii) follows below and specifies FIG. 10G-step-1022(iii):
   (Computing cloud 198 in step-1022(iii)-of-FIG. 10G) selects the-only-one-cloud-instance (e.g. in FIG. 19L's step-1947) as the host computer cloud instance 205-C.

Please note that FIG. 10G's step 1022(iii)'s above spec. Para [0064K](iii)'s “(Computing cloud 198 in step-1022(iii)-of-FIG. 10G) selects (the-only-one-cloud-instance (e.g. in FIG. 19L's step-1947) as the host computer cloud instance 205-C” is (originated-and)-edited-(and-derived) from:
Para [0064J](iii)'s “(Computing cloud 198 in step-1022(iii)-of-FIG. 10F) selects-(randomly-or-using-other-selection-method(s)) (one or not-less-than-one) cloud-instance” (e.g. in FIG. 19K's step-1947) as the host computer cloud instance 205-C as:
“the-only-one” is (also) “one”, which is (also) (one or not-less-than-one); and
   (iv) follows below and specifies FIG. 10G-step-1022(iv):
   (Computing cloud 198 in step-1022(iv)-of-FIG. 10G) disconnects (e.g. in FIG. 19L's step-1948(i)) (zero)-non-selected cloud instance, which:
(step-1022(iv)-in-FIG. 10G) may be implemented (not shown) by software and database.

Please note that FIG. 10G's step 1022(iv)'s above spec. Para [0064K](iv)'s “(Computing cloud 198 in step-1022(iv)-of-FIG. 10G) disconnects (e.g. in FIG. 19L's step-1948(i)) (zero)-non-selected cloud instance” is (originated-and)-edited-(and-derived) from:
Para [0064J](iv)'s “(Computing cloud 198 in step-1022(iv)-of-FIG. 10A) disconnects (e.g. in FIG. 19A's step-1948(i)) (not-less-than-zero) non-selected cloud instances”, as:
(zero)-non-selected cloud-instance is (also) (not-less-than-zero)-non-selected cloud-instance, as (zero) is (also) (not-less-than-zero).
   (v) follows below and specifies FIG. 10G-step-1022(v):
   (Computing cloud 198 in step-1022(v)-of-FIG. 10G and in FIG. 19L's step 1948(ii)) uses-(and-assigns-and-saves) IP address of selected-(the-only-one)-cloud-instance (in sub-step-1022(iii)) as IP address of host computer cloud instance.

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

Please note that FIG. 10G's step 1022(v)'s above spec. Para [0064K](v)'s “(Computing cloud 198 in step-1022(v)-of-FIG. 10G and in FIG. 19L's step 1948(ii)) uses-(and-assigns-and-saves) IP address of selected-(the-only-one)-cloud-instance (in sub-step-1022(iii)) as IP address of host computer cloud instance 205-C” is (originated-and)-edited-(and-derived) from:
Para [0064J](v)'s “(Computing cloud 198 in step-1022(v)-of-FIG. 10F and in FIG. 19K's step 1948(ii)) uses-(and-assigns-and-saves) IP address of selected-(randomly-or-using-other-selection-method(s))-cloud-instance (in sub-step-1022(iii)) as IP address of host computer cloud instance 205-C”.
   (vi) follows below and specifies FIG. 10G-step-1022(vi):
   (In step-1022(vi)-of-FIG. 10G) computing cloud 198 (or host computer cloud instance 205-C) sends (in step-1022(vi) of FIG. 10G) this (assigned-in-sub-step-1022(v))-IP-address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIGS. 9A-and/or-9B may join the started Internet application service above (in FIG. 10G's step-1022, or on options page 305 in FIG. 3) using the process described in FIG. 11A, 11B, 11C, 13A, 13B, or 13C below.

Please refer now to FIGS. 9I-to-9K which flow-chart (in FIG. 9I) illustrates how “(computing cloud 198) may attempt to connect (to cloud instance(s), e.g. host computer cloud instance(s) 205-C in FIGS. 9A-and-9B)” using “Virtual”-Attempt to “Virtual”-“Connect” (in “steps-918-and-935”-in-FIG. 9I, and FIG. 9J), and/or using “Attempt using Ping (to Connect)” (in “steps-920-and-928”-in-FIG. 9I, and FIG. 9K):
In steps-918-and-935 of FIG. 9I, (using “No-Op” and software and database) (computing cloud 198) “virtual”-attempts to “virtual”-connect, and receives “virtual”-(zero-“cloud-instance”)-“response” (two zero-“cloud-instance”-“response”-examples are illustrated in FIG. 9J, and (“virtual”)-zero-“cloud-instance”-(“response”) described in Para [0064H](iii)(b)) (and which FIG. 9J below is copied from rows-“L”-and-“M” of FIG. 9H).

No-op may be used to implement “virtual-attempts to virtual-connect” (and “(receive”-or)-create virtual-(zero-cloud-instance)-response) in an embodiment of the invention, as follows (in (A)-and-(B)):

(A). As illustrated in step-935(i) of FIG. 9I: “(ii) (No-Op)-‘Virtual’-Attempt to ‘Virtual’-Connect”, (as an example) computing cloud 198 uses-(executes) no-op to “virtual-attempt to virtual-connect” an host computer cloud instance 205-C in FIGS. 9A-and-9B.

Please note that a no-op, for no operation, is a computer instruction that takes up a small amount of space but specifies no operation. The computer processor simply moves to the next sequential instruction. The no-op is included in most assembler languages.

(B). As illustrated in step-935(ii) of FIG. 9I: “(ii) (‘Receive’-or)-Create ‘Virtual’-(zero-‘cloud-instance’)-‘Response’-(examples in FIG. 9J)”, (as an example) computing cloud 198 (in next-step AFTER no-op in (A) above) creates ‘virtual’-(zero-‘cloud-instance’)-‘response’. ‘Virtual’-(zero-‘cloud-instance’)-‘responses’ examples are shown in FIG. 9J, and (‘virtual’)-zero-‘cloud-instance’-(‘responses’) (and implementation) are described Para [0064H](iii)(b). Computing cloud 198 would keep track of the ‘virtual’-(zero-‘cloud-instance’)-‘responses’ (in (B) and FIG. 9J) to the “virtual-attempt to virtual-connect” (“no-op” in (A) above and FIG. 9I), so that the (‘virtual’)-zero-‘cloud-instance’-(‘responses’) may be properly processed later in an embodiment of the invention.

(“Attempt using Ping (to Connect)”) In steps-920-and-928 of FIG. 9I, (computing cloud 198) attempts to ping-(to-connect to cloud instance(s), e.g. host computer cloud instance(s) 205-C in FIGS. 9A-and-9B), and receives-responses-(e.g. (i). messages-in-step-928(i)-of-FIG. 9I: (ii). No-(ping)-response would (have an embodiment of the invention to) create “Virtual”-(zero-“cloud-instance”) “Response” in step-935(ii)-of-FIG. 9I; (iii). others (not shown); (iv). etc.). A ping example is shown in FIG. 9K. Step-925-of-FIG. 9I is “Other Attempt-to-Connect Options (not shown)”.

Please note that Ping is a computer network administration software utility used to test the reachability of a host on an Internet Protocol network. It is available for virtually all operating systems that have networking capability, including most embedded network administration software.

Ping may be used to implement “attempt using ping (to connect cloud instance)” (and receives-responses-(message, etc.)) in an embodiment of the invention, as follows (in (C)-and-(D)):

(C). “Attempt using ping (to connect cloud instance)”: As illustrated in step-920 of FIG. 9I: “Attempt using Ping (to Connect)”, (as an example) computing cloud 198 uses-(executes) ping-(software) to “attempt using ping (to connect)” an host computer cloud instance 205-C in FIGS. 9A-and-9B. In the ping-example in FIG. 9K (copied/duplicated) below, computing cloud 198 would use ping-(software) to attempt-to-ping-to-connect (to a host computer cloud instance (simulation) 205-C in FIGS. 9A-and-9B), and tested the reachability of a host computer cloud instance 205-C (at I.P. address: 195.201.179.80) on the Internet (an Internet Protocol network) by “pinging 195.201.179.80 with 32 bytes of data” (which texts are copied from the ping-example in FIG. 9K).

(Please note that Ping is a computer network administration software utility used to test the reachability of a host on an Internet Protocol network. It is available for virtually all operating systems that have networking capability, including most embedded network administration software.)

(D). “Receives-responses-(message, etc.)”: As illustrated in step-928 of FIG. 9I: “Receives-responses-(message, etc.)”, (as an example) computing cloud 198 would (in “next-step”-AFTER-(using)-ping to “attempt to connect to a host” in (C) above) receive-(message)-responses. In the ping-example in FIG. 9K, computing cloud 198 would via ping-(software) receive-(message)-responses-back in FIG. 9K (text-copied-below).

Text of “FIG. 9K: Ping-(Response) Example” is copied below for easy reference:
“C:\Users\bobpi>ping 195.201.179.80
   Pinging 195.201.179.80 with 32 bytes of data:
   Reply from 195.201.179.80: bytes=32 time=190 ms TTL=128
   Reply from 195.201.179.80: bytes=32 time=192 ms TTL=128
   Reply from 195.201.179.80: bytes=32 time=187 ms TTL=128
   Reply from 195.201.179.80: bytes=32 time=187 ms TTL=128
   Ping statistics for 195.201.179.80:
   Packets: Sent=4, Received=4, Lost=0 (0% loss),
   Approximate round trip times in milli-seconds:
   Minimum=187 ms, Maximum=192 ms, Average=189 ms”

(In the ping-example in FIG. 9K's text above) computing cloud 198 would via ping-(software) receive-(message)-responses-back:
“Reply from 195.201.179.80: bytes=32 time=190 ms TTL=128
   . . . . . . . . . . . . . . . . . .
Reply from 195.201.179.80: bytes=32 time 187 ms TTL=128
Ping statistics for 195.201.179.80:
   Packets: Sent=4, Received=4, Lost=0 (0% loss)
Approximate round trip times in milli-seconds:
Minimum=187 ms, Maximum=192 ms, Average=189 ms”

The ping-(response)-example (in FIG. 9K) has 0% packet-loss; but network (and Internet) can have (data)-packet losses. FIG. 9L illustrates 100% “packet-loss” (when a ping's request-“timed-out” four-times (when there is no-(FIG. 9K's)-“reply”) over-elapsed-time of ˜20-sec. in the ping-test in “FIG. 9L: Ping-Time-Out Example”).

Text of “FIG. 9L: Ping-Time-Out Example” is copied below for easy reference:
“C:\Users\bobpi>ping 192.168.39.1
Pinging 192.168.39.1 with 32 bytes of data:
Request timed out.
Request timed out.
Request timed out.
Request timed out.
Ping statistics for 192.168.39.1:
Packets: Sent=4, Received=0, Lost=4 (100% loss).”

In step-928(ii)-of-FIG. 9I, (computing cloud 198 in) “no-(ping)-response-(100%-packet-loss) create-(after a-“wait-time”-(for-ping-response-in-FIG. 9K-or-in-step-928(i)-in-FIG. 9I-or-by-default-in-the-ping-software-or)-determined-by-computing-cloud-198) “virtual”-(zero-“cloud-instance”)-“response” in step-935(ii)-of-FIG. 9I. An “virtual”-(zero-“cloud-instance”)-“response” example is in FIG. 9J. (“Virtual”)-zero-“cloud-instance”-(“response”) description and implementation are detailed in Para [0064H](iii)(b).

Please note that computing cloud 198 would “wait” (in step-928(i)-of-FIG. 9I) for (the cloud instance's) ping-(or-other-attempt(s)-to-connect)-response(s)) BEFORE it (in step-928(ii)-of-FIG. 9I) would (decide that there is “no-(ping)-response, and) create “virtual”-response in step-935(ii). The “wait-time” would typically be (much)-more than the (if-available-LOS's) targeted-ceiling-response-time(s) (which examples in FIG. 2A's Table-2's column-“IV”-(of-“5-sec.”-to-“15-sec.”). For “virtual-attempt-(to-virtual-connect” (in steps-918-and 935) there is no-need to wait (for any ping-response, as there is/was no-ping-(and-no-ping-response)).

Computing cloud 198 would additionally process the (message, etc.)-responses, e.g. if the host computer cloud instance 205-C is providing the requested Internet application service (published by the website-212A (in FIGS. 9A-and-9B)), the computing cloud 198 would/may update the host-computer-cloud-instance 205-C's last-ping-response-time (which would be average round-trip-time 189 ms in FIG. 9K) in column-XVI of FIG. 9C, so that the “received-responses-(messages, etc.)” may be properly processed later in an embodiment of the invention.

Para [0064M](i)(a)-to-(vi) here (for FIGS.-10H-and-19H for illustrations of another further embodiment of the invention) is (originated-and)-edited-(and-derived) from Para [0064E](i)(a)-to-(vi) (for FIGS.-10A-and-19A), and refers-to and describes (for specification):
(step-1022-of)-“FIG. 10H: (Start)-“Not-Less-Than-One”-Instance(s)-and-Ping-(NL Response)-and-LOS (Level-of-Service)”, and
(steps 1930, 1932, 1947, and 1948 of)-“FIG. 19H: (Start)-“Not-Less-Than-One”-Instance(s)-and-Ping-(No-Response)-and-LOS (Level-of-Service)”.

Para [0064M] uses much of Para [0064E](i)(a)-to-(vi) (which are incorporated herein by reference): as key differences of FIG. 10H (from FIG. 10A) are:
ping-and-no-response-(in-FIG. 10H's-sub-step-1022(ii)(b)), resulting in
(in)-FIG. 10H's-sub-step-1022(iii)'s-“selects-(randomly . . . ) (one) ( . . . ) cloud instance ( . . . ) as the host computer cloud instance”.

In FIG. 10H's step 1022(i)(a)-to-(vi), the computing cloud 198:

(i)(a) (is copied almost 100% from [0064E](i)(a), and) follows below and specifies FIG. 10H-step-1022(i)(a):
(If computing cloud 198 previously processed FIGS.-10H-and-19H, when the (SAME)-host-computer-205-(and-the-(SAME)-server-222A) requested the-(SAME)-Internet-application-service (e.g. website services of Global 2000 companies, and others) as in FIG. 19H's-steps-1910-and-1920-and-1925, computing cloud 198) may (optionally in step 1022(i)(a)-of-FIG. 10H and/or step1930(i)-of-FIG. 19H) send (if available) (previous/last)-IP-address of (previous/last) host-computer-cloud-instance 205-C (from (previous/last-processing-of) sub-step-1948(ii)-of-FIG. 19H, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) (texts are almost 100% from [0064E](i)(b), and) follows below and specifies FIG. 10H-step-1022(i)(b):
(Computing cloud 198 in step-1022(i)(b)-of-FIG. 10H) launches-or-assigns (e.g. in FIG. 19H's step-1930(ii)) a bank-of-(not-less-than-one)-cloud-instance(s) wherein each-of-the-(not-less-than-one)-cloud-instance(s) provides the requested Internet application service.
(ii)(a)-to-(ii)(c) follows below and specifies FIG. 10H-(sub)-steps-1022(ii)(a)-to-(ii)(c): Please reference: “(Computing Cloud) Attempt to Connect (to Cloud Instance)” in FIGS. 9I-to-9K and described in Para [0064L]:
(ii)(a) (is edited from [0064E](ii)(a):) (Computing cloud 198 in step-1022(ii)(a)-of-FIG. 10H) (not-less-than-zero)-attempt(s) to connect (reference: Para [0064L] and FIGS. 9I-to-9L) (e.g. in FIG. 19H's step-1932(i)) to each-of-(not-less-than-one)-cloud-instance(s) (in above bank-of-(not-less-than-one)-cloud-instance(s)) (meaning above “group-of-cloud-instance(s)”)).

Para [0064M](ii)(a)'s “(not-less-than-zero)-attempt(s) to connect” is edited/changed-from para [0064E](ii)(a)'s “(not-more-than-one)-attempt to connect”, so that zero-attempt and “more-than-one”-attempts (e.g. for lossy networks) are included for an embodiment of the invention.

Please note that “(not-less-than-zero)-attempt(s) to connect” includes “zero-attempt to connect”, as “zero” is (also) “not-less-than-zero”.

(ii)(b) (is edited from [0064E](ii)(b):) (Computing cloud 198 in step-1022(ii)(b)-of-FIG. 10H) receive “not-less-than-zero”-response(s) from the-(not-less-than-one)-cloud-instance(s) (in above bank-of-cloud-instance(s)).

Para [0064M](ii)(b)'s “(not-less-than-zero)-response(s)” is edited/changed-from para [0064E](ii)(b)'s “(not-more-than-one)-response”, so that zero-response and more-than-one response can be included for an embodiment of the invention.

Please note that “(not-less-than-zero)”-response(s) includes “zero”-response, as “zero” is (also) “not-less-than-zero”.

(ii)(c) Please reference: “(Computing Cloud) Attempt to Connect (to Cloud Instance)” in FIGS. 9I-to-9K and described in Para [0064L]:
(ii)(c) (Texts are almost 100% from [0064E](ii)(c):) (Computing cloud 198 in step-1022(ii)(c)-of-FIG. 10H) info-(or-zero-(total))-response (received) in (ii)(b) (from the “not-less-than-zero”-response(s) from the-(not-less-than-one)-cloud-instance(s)), create (one)-“virtual”-(zero-“cloud-instance”)-“response”-(zero-“cloud-instance”-“response”-examples are shown in FIG. 9J-(&-9I), & “virtual”-(zero-“cloud-instance”)-“response” described in spec.'s Para [0064H](iii)(b))
(iii) (is edited from [0064E](iii) and) follows below and specifies FIG. 10H-step-1022(iii): (Computing cloud 198 in step-1022(iii)-of-FIG. 10H) selects-randomly-or-using-other-selection-method(s)) (one) cloud instance (from attempt(s)-to-connect in (ii)(a)) (e.g. in FIG. 19H's step-1947) as the host computer cloud instance 205-C.

Para [0064M](iii)'s “selects-(randomly . . . ) (one) cloud instance” is edited/changed-from para [0064E](iii)'s “selects (one) fastest-cloud-instance to respond”, so that (one) cloud instance can be selected (as the host computer cloud instance 205-C) if (ii)(b) has zero-response (for (ii)(b)'s (not-less-than-zero)-response) for an embodiment of the invention.

(iv) follows below and specifies FIG. 10H-step-1022(iv):
(Computing cloud 198 in step-1022(iv)-of-FIG. 10H) disconnects (e.g. in FIG. 19H's step-1948(i)) (not-less-than-zero) non-selected cloud instance(s) (in bank); and
(v) follows below and specifies FIG. 10M-step-1022(v):
(Computing cloud 198 in step-1022(v)-of-FIG. 10H and in FIG. 19H's step 1948(ii)) uses-(and-assigns-and-saves) IP address of selected-(randomly)-cloud-instance (in sub-step-1022(iii)) as IP address of host computer cloud instance 205-C.

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) follows below and specifies FIG. 10H-step-1022(vi):
(In step-1022(vi)-of-FIG. 10H) computing cloud 198 (or host computer cloud instance 205-C) sends 1022(vi) (in FIG. 10H) this (assigned-in-sub-step-1022(v)) IP address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10A's step-1022, or on options page 305 in FIG. 3) using the process described in FIG. 11A, 11B, 11C, 13A, 13B, or 13C below.

Para [0064N](i)(a)-to-(vi) here (for FIGS.-10I-and-19I for illustrations of another embodiment of the invention) is (originated-and)-edited-(and-derived) from Para [0064F](i)(a)-to-(vi), and refers-to and describes (for specification):
(step-1022-of)-“FIG. 10I: (Start)-One-Instance-and-Ping-(No-Response)-and-LOS (Level-of-Service)”, and
(steps 1930, 1932, 1947, and 1948 of)-“FIG. 19B: (Start)-One-Instance-and-Ping-(No-Response)-and-LOS (Level-of-Service)”.

Para [0064N] uses much of Para [0064F](i)(a)-to-(vi) (which are incorporated herein by reference): as key differences of FIG. 10I (from FIG. 10B) are:
ping-and-no-response-(in-FIG. 10I's-sub-step-1022(ii)(b)), resulting in
(in)-FIG. 10I's-sub-step-1022(iii)'s-“selects-(randomly . . . ) (one) ( . . . ) cloud instance ( . . . ) as the host computer cloud instance”.

In FIG. 10N's step 1022, the computing cloud 198:

(i)(a) (is copied almost 100% from [0064F](i)(a), and) follows below and specifies FIG. 10I-step-1022(i)(a):
(If computing cloud 198 previously processed FIGS.-10I-and-19I, when the (SAME)-host-computer-205-(and-the-(SAME)-server-222A) requested the-(SAME)-Internet-application-service (e.g. for website services of Global 2000 companies, and others) as in FIG. 19I's-steps-1910-and-1920-and-1925, computing cloud 198) may (optionally in step 1022(i)(a)-of-FIG. 10I and/or step1930(i)-of-FIG. 19I) send (if available) (previous-last)-IP-address of (previous/last) host-computer-cloud-instance 205-C (from (previous/last-processing-of) sub-step-1948(ii)-of-FIG. 19I, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) (texts are almost 100% from [0064F](i)(b), and) follows below and specifies FIG. 10I-step-1022(i)(b):
(Computing cloud 198 in step-1022(i)(b)-of-FIG. 10I) launches-or-assigns (e.g. in FIG. 19I's step-1930(ii)) a bank-of-one-cloud-instance wherein the (one)-cloud-instance provides the requested Internet application service.
(ii)(a)-to-(ii)(c) follows below and specifies FIG. 10I-steps-1022(ii)(a)-to-(ii)(c): Please reference: “(Computing Cloud) Attempt to Connect (to Cloud Instance)” in FIGS. 9I-to-9K and described in Para [0064L]:
(ii)(a) (is edited from [0064F](ii)(a):) (Computing cloud 198 in step-1022(ii)(a)-of-FIG. 10I) (not-less-than-zero)-attempt to connect (reference: spec.'s Para [0064L] and FIGS. 9I-to-9L) (e.g. in FIG. 19I's step-1932(i)) to the (one)-cloud-instance (in above bank-of-(one)-cloud-instance).

Para [0064N](ii)(a)'s “(not-less-than-zero)-attempt(s) to connect” is edited/changed-from para [0064F](ii)(a)'s “(n&)-attempt to connect”, so that zero-attempt and “more-than-one”-attempts (e.g. for lossy networks) are included for an embodiment of the invention.

Please note that “(not-less-than-zero)-attempt(s) to connect” includes “zero-attempt to connect”, as “zero” is (also) “not-less-than-zero”.

(ii)(b) (is edited from [0064F](ii)(b):) (Computing cloud 198 in step-1022(ii)(b)-of-FIG. 10I) receives (not-less-than-zero) response from the (one)-cloud-instance (in above bank-of-(one)-cloud-instance).

Para [0064N](ii)(b)'s “(not-less-than-zero)-response(s)” is edited/changed-from para [0064F](ii)(b)'s “(not-more-than-one)-response”, so that zero-response and more-than-one responses are included for an embodiment of the invention.

Please note that “(not-less-than-zero)”-response(s) includes “zero”-response, as “zero” is (also) “not-less-than-zero”.

(ii)(c) (Texts are almost 100% from Para [0064F](ii)(c):) (Computing cloud 198 in step-1022(ii)(c)-of-FIG. 10I) in-(or-zero-(total))-response (received) in (ii)(b) (from the “not-less-than-zero”-response from each of the-(not-less-than-one)-cloud-instance(s)), create (one)-“virtual”-(zero-“cloud-instance”)-“response”.
“Virtual”-(zero-“cloud-instance”)-“response”-examples shown in FIG. 9J. “Virtual”-(zero-“cloud-instance”)-“response” described in spec.'s Para [0064H](iii)(b)).
(iii) (is edited from [0064F](iii) and) follows below and specifies FIG. 10I-step-1022(iii):
(Computing cloud 198 in step-1022(iii)-of-FIG. 10B) select the-only-(one)-cloud-instance-as-(one)-cloud-instance (from attempt-to-connect in (ii)(a)) (e.g. in FIG. 19I's step-1947) as host computer cloud instance 205-C (providing the requested Internet application service).
(iv) follows below and specifies FIG. 10I-step-1022(iv):
(Computing cloud 198 in step-1022(iv)-of-FIG. 10I) disconnects (e.g. in FIG. 19I's step-1948(i)) (zero) non-selected cloud instance, which:
(step-1022(iv)-in-FIG. 10I) may be implemented (not shown) by software and database.
   (v) follows below and specifies FIG. 10I-step-1022(v):
   (Computing cloud 198 in step-1022(v)-of-FIG. 10I and in FIG. 19I's step 1948(ii)) uses-(and-assigns-and-saves) IP address of selected-(the-only-one)-cloud-instance (in sub-step-(iii)) as IP address of host computer cloud instance 205-C.

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) follows below and specifies FIG. 10I-step-1022(vi):
(In step-1022(vi)-of-FIG. 10I) computing cloud 198 (or host computer cloud instance 205-C) sends (assigned in Para [0064I](v))-IP-address of host computer cloud instance 205-C to the server 222A.

Bank-of-(one-or-more)-host-computer-cloud-instances are further described in Para [0027A]-to-[0027D], and illustrated in FIGS. 2A, 9A-and-9B, and 9C's-columns-II-to-XIV.

A client computer 215 in FIG. 9B may join the started Internet application service above (in/after FIG. 10I's step-1022, or on options page 305 in FIG. 3) using the process described in FIG. 11A, 11B, IC, 13A, 13B, or 13C below.

Para [0064O](i)(a)-to-(vi) here (for FIGS.-10J-and-19J for illustrations of another embodiment of the invention) is (originated-and)-edited-(and-derived) from Para [0064O](i)(a)-to-(vi), and refers-to and describes (for specification):
(step-1022-of)-“FIG. 10J: (Start)-“Not-Less-Than-One”-Instance(s) and Ping-(No Response) and No-LOS (Level-of-Service)”, and
(steps 1930, 1932, 1947, and 1948 of)-“FIG. 19J: (Start)-“Not-Less-Than-One”-Instance(s) and Ping-(No-Response) and No-LOS (Level-of-Service)”.

Para [0064P] uses much of Para [0064G](i)(a)-to-(vi) (which are incorporated herein by reference): as key differences of FIG. 10J (from FIG. 10C) are:
ping-and-no-response-(in-FIG. 10J's-sub-step-1022(ii)(b)), resulting in
(in)-FIG. 10J's-sub-step-1022(iii)'s-“selects-(randomly . . . ) (one) ( . . . ) cloud instance ( . . . ) as the host computer cloud instance”.

In FIG. 10J's step 1022, the computing cloud 198:

(i)(a) (is copied almost 100% from [0064G](i)(a), and) follows below and specifies FIG. 10J-step-1022(i)(a):
(If computing cloud 198 previously processed FIGS.-10J-and-19J, when the (SAME)-host-computer-205-(and-the-(SAME)-server-222A) requested the-(SAME)-Internet-application-service (e.g. for website services of Global 2000 companies, and others) as in FIG. 19J's-steps-1910-and-1920-and-1925, computing cloud 198) may (optionally in step 1022(i)(a)-of-FIG. 10J and/or step1930(i)-of-FIG. 19J) send (if available) (previous/last)-IP-address of (previous/last) host-computer-cloud-instance 205-C (from (previous/last-processing-of) sub-step-1948(ii)-of-FIG. 19J, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instantaneous)-response to the host-computer-205's-(and-server-222A's) (new)-request for (SAME)-Internet-application-service.

Please note that the server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

((i)(b) (texts are almost 100% from [0064g](i)(b), and) follows below and specifies FIG. 10J-step-1022(i)(b):
(computing cloud 198 in step-1022(i)(b)-of-FIG. 10J) launches-or-assigns (e.g. in FIG. 19J's step-1930(ii)) a bank-of-not-less-than-one-cloud-instance(s) wherein each-of-the-(not-less-than-one)-cloud-instance(s) provides the requested Internet application service.
(ii)(a)-to-(ii)(c) follows below and specifies FIG. 10J-(sub)-1022(ii)(a)-to-(ii)(c): Please reference: “(Computing Cloud) Attempt to Connect (to Cloud Instance)” in FIGS. 9I-to-9K and described in Para [0064L]:
(ii)(a) (is edited from [0064G](ii)(a):) (computing cloud 198 in step-1022(ii)(a)-of-FIG. 10J) not-less-than-zero) attempt to connect (reference: spec.'s Para [0064L] and FIGS. 9I-to-9L) (e.g. in FIG. 19J's step-1932(i)) to each-of-the-(not-less-than-one)-cloud-instance(s) (in above bank-of-(not-less-than-one)-cloud-instance(s).

Para [0064O](ii)(a)'s “(not-less-than-zero)-attempt to connect” is edited/changed-from para [0064G](ii)(a)'s “(not-more-than-one)-attempt to connect”, so that zero-attempt and “more-than-one”-attempts (e.g. for lossy networks) are included for an embodiment of the invention.

Please note that “(not-less-than-zero)-attempt to connect” includes “zero-attempt to connect”, as “zero” is (also) “not-less-than-zero”.

(ii)(b) receive “not-less-than-zero”-response from each of the-(not-less-than-one)-cloud-instance(s) (in bank-of-cloud-instance(s)).

Para [0064O](ii)(b)'s “(not-less-than-zero)-response” is edited/changed-from para [0064E](ii)(b)'s “(not-more-than-one)-response”, so that zero-response and more-than-one response can be included for an embodiment of the invention.

Please note that “(not-less-than-zero)”-response includes “zero”-response, as “zero” is (also) “not-less-than-zero”.

(ii)(c) Please reference: “(Computing Cloud) Attempt to Connect (to Cloud Instance)” in FIGS. 9I-to-9K and described in Para [0064L]:
(ii)(c) (Computing cloud 198 in step-1022(ii)(c)-of-FIG. 10J) if no-(or-zero-(total))-response (received) in Para [0064O](ii)(b) (from the “not-less-than-zero”-response from each of the-(not-less-than-one)-cloud-instance(s)), create (one)-“virtual”-(zero-“cloud-instance”)-“response”.
“Virtual”-(zero-“cloud-instance”)-“response”-examples shown in FIG. 9J.
“Virtual”-(zero-“cloud-instance”)-“response” described in spec.'s Para [0064H](iii)(b)).
(iii) (is edited from [0064G](iii) and) follows below and specifies FIG. 10J-step-1022(iii): (Computing cloud 198 in step-1022(iii)-of-FIG. 10J) selects-(randomly-or-using-other-selection-method(s)) (one) cloud instance (from attempt(s)-to-connect in (ii)(a)) (e.g. in FIG. 19C's step-1947) as the host computer cloud instance 205-C.

Please note that Para [0064O](iii)'s “selects-(randomly . . . ) (one) cloud instance” is edited/changed-from para [0064G](iii)'s “selects (one) fastest-cloud-instance to respond”, so that (one) cloud instance can be selected (as the host computer cloud instance 205-C) if [0064O](ii)(b) has zero-response (for [0064O](ii)(b)'s (not-less-than-zero)-response) for an embodiment of the invention.

(iv) (Computing cloud 198 in step-1022(iv)-of-FIG. 10J) disconnects (e.g. in FIG. 19J's step-1948(i)) (not-less-than-zero)-non-selected cloud instance(s) (in bank).
(v) (Computing cloud 198 in step-1022(v)-of-FIG. 10J and in FIG. 19J's step 1948(ii)) uses-(and-assigns-and-saves) IP address of selected-cloud-instance (in [0064O](iii)) as IP address of host computer cloud instance 205-C.

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of uses(and-assigns-and-saves) IP address of selected-(not-more-than-one)-“fastest”-cloud-instance-(to-respond)” above).

(vi) (in step-1022(vi)-of-FIG. 10J) computing cloud 198 (or host computer cloud instance 205-C) sends 1022(vi) (in FIG. 10J) this (assigned-in-[0064O](v)) IP address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10J's step-1022, or on options page 305 in FIG. 3) using the process described in FIG. 11A, 11B, 11C, 13A, 13B, or 13C below.

Para [0064P](i)(a)-to-(vi) here (for FIGS.-10K-and-19K for illustrations of an embodiment of the invention) is (originated-and)-edited-(and-derived) from Para [0064H1](i)(a)-to-(vi), and refers-to and describes (for specification):
(step-1022-of)-“FIG. 10K: (Start)-“Not-Less-Than-One”-Instance(s) and Ping-(No-Response) and Create-“Virtual”-Response and No-LOS (Level-of-Service)”, and
(steps 1930, 1932, 1947, and 1948 of)-“FIG. 19D: (Start)-“Not-Less-Than-One”-Instance(s) and Ping-(No-Response) and Create-“Virtual”-Response and No-LOS (Level-of-Service)”.

Para [0064P] uses much of Para [0064H](i)(a)-to-(vi) (which are incorporated herein by reference): as key differences of FIG. 10K (from FIG. 10D) are:
ping-and-no-response-(in-FIG. 10K's-step-1022(ii)(b)), resulting in
create “virtual”-(zero-“cloud-instance”)-“response(s)” in-FIG. 10K's-step-1022(ii)(c),
“selects-(randomly) (one) merged-(in-(iv)(b))-cloud-instance(s) as host computer cloud instance (in-FIG. 10K's-step-1022(v)(a)).

In FIG. 10K's steps-“1022(i)(a)”-to-“1022(vi)”, the computing cloud 198:

(i)(a) (is copied almost 100% from [0064H](i)(a):) (computing cloud 198 in steps-1022(i)(a)-and-(i)(b)-of-FIG. 10K:)
(i)(a) (If computing cloud 198 previously processed FIGS.-10K-and-19K, when the (SAME)-host-computer-205-(and-the-(SAME)-server-222A) requested the-(SAME)-Internet-application-service (e.g. website services of Global 2000 companies, and others) as in FIG. 19K's-steps-1910-and-1920-and-1925, computing cloud 198) may (optionally in step1930(i)-of-FIG. 19K) send (if available) (previous/last)-IP-address of (previous/last) host-computer-cloud-instance 205-C (from (previous/last-processing-of) sub-step-1948(iv)-of-FIG. 19K, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that the server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) (texts are almost 100% from [0064H](i)(b):) (Computing cloud 198 in step-1022(i)(b)-of-FIG. 10K) launches-or-assigns (e.g. in FIG. 19K's step-1930(ii)) a bank-of-(not-less-than-one)-cloud-instance(s) wherein each-of-the-(not-less-than-one)-cloud-instance(s) provides the requested Internet application service.
(ii)(a) Please reference: “(Computing Cloud) Attempt to Connect (to Cloud Instance)” in FIGS. 9I-to-9K and described in Para [0064L]:
(ii)(a) (not-less-than-zero)-attempt(s) to connect (reference: Para [0064L] and FIGS. 9I-to-9L) to each-of-(not-less-than-one)-cloud-instance(s) (in bank-of-(not-less-than-one)-cloud-instance(s)).

Please note that “(not-less-than-zero)-attempt(s) to connect” includes “zero-attempt to connect”, as “zero” is (also) “not-less-than-zero”.

(ii)(b) (Please reference: “(Computing Cloud) Attempt to Connect (to Cloud Instance)” in FIGS. 9I-to-9K and described in Para [0064L]:)
(ii)(b) receive “not-less-than-zero”-response(s) from each of the-(not-less-than-one)-cloud-instance(s) (in bank-of-(not-less-than-one)-cloud-instance(s)).

Please note that “(not-less-than-zero)”-response(s) includes “zero”-response, as “zero” is (also) “not-less-than-zero”.

(ii)(c) Please reference: “(Computing Cloud) Attempt to Connect (to Cloud Instance)” in FIGS. 9I-to-9K and described in Para [0064L]:
(ii)(c) (Computing cloud 198) if no-(or-zero-(total))-response (received) in (ii)(b) (from “not-less-than-zero”-response from each of the-(not-less-than-one)-cloud-instance(s)), create (not-less-than-one)-“virtual”-(zero-“cloud-instance”)-“response(s)” for the bank-of-(not-less-than-one)-cloud-instance(s).
“Virtual”-(zero-“cloud-instance”)-“response”-examples shown in FIG. 9J.
“Virtual”-(zero-“cloud-instance”)-“response” described in Para [0064H](iii)(b)).
(iii)(a) (computing cloud 198 in step-1022(iii)(a)-and-(iii)(b)-of-FIG. 10K:)
(iii)(a) (computing cloud 198) if previously DID [0064P](ii)(c), then (have) create (not-less-than-one)-“virtual”-(zero-“cloud-instance”)-“responses” (from FIG. 10K'S-step-1022(ii)(c)), wherein (bank's)-each-instance's-“response” is (not-less-than-zero)-“virtual”-(zero-“cloud-instance”)-“response”.

Please note that Para [0064P](iii)(b) are more specification of “virtual”-(zero-“cloud-instance”)-“responses” in Para [0064P](ii)(c).

(iii)(b) (as “virtual”-is-digital) the-“not-less-than-one”-“virtual”-(zero-“cloud-instance”)-“responses” (created in FIG. 10K'S-step-1022(ii)(c)) are the-(not-less-than-one)-(equally)-“fastest”-cloud-instances-to-“respond” (e.g. in FIG. 19K's step-1947(ii)), as:
“virtual”-(zero-“cloud-instance”)-“responses” (created in FIG. 10K's-step-1022(ii)(c)) are zero-(and-no-(and-empty))-cloud-instances, which may be implemented using software-and-database (e.g. (generic-examples (NOT (specifically) as responses to the bank-of-cloud-instance(s) launched in FIG. 10K's-step-1022(i)(b)) illustrated in FIG. 9H's rows-“L”-and-“M” for “Lima”-and-“Mike” banks of “Zero/None/Empty” cloud-instances (in column-“VII”-and-rows-“L”-and-“M” of FIG. 9H), as copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

and implementing “Zero/None/Empty” cloud-instance (from FIG. 18B's Table 2's row-C) with “0X-(virtualized)-H/W”-(“0-vCPU” and “0-ECU” and “0-GB” from columns-V-to-VII respectively of row-C of FIG. 18B's Table 2) with FIG. 18B's Table 2's row-C (copied-and)-illustrated below:

TABLE 2
(Virtualized) (1X)-H/W (in) Amazon EC2 Cloud-Instance (Running Moodle):

| | I | II | III | IV | V | VI | VII |
|---|---|---|---|---|---|---|---|
| A | Max. # | 1X-H/W | Bank-of-Cloud-Instances: | | EC2 H/W (Each Instance): | | |
| B | Users | Implemented | #-of-32X-H/W-Instances | EC2 Instances: | vCPU | ECU | Memory |
| C | 0 | 0X | Zero/None/Empty | Zero/None/Empty | 0 | 0 | 0 GB |

hence, FIG. 10K's step-1022(ii)(c)'s and FIG. 19D's step-1947(ii)'s (created)-“virtual”-(zero-“cloud-instance”)-“responses” (with implementation using software and database) would be very fast (and could be fraction-of-a-second or almost-“instant” using computing cloud's huge and very-extremely-powerful data-center computers) and (equally)-fastest-cloud-instances-to-“respond”.
   (iv)(a) (computing cloud 198 in step(s)-1022(iv)(a)-and-(iv)(b)-of-FIG. 10K, and in FIG. 19K's step(s) 1948(i)-and-(ii):)
   (iv)(a) (in FIG. 10K's step-1022(iv)(a) and in FIG. 19K's step 1948(i):) (computing cloud 198) create an IP address for each of “not-less-than-one” (created-in-FIG. 10K's step-1022(ii)(c))-“virtual”-(zero-‘cloud-instance’)-“responses”, and “how-to-use which-IP-address” are described in Para [0064P](iv)(b); and
   (iv)(b) (in FIG. 10K's step-1022(iv)(b) and in FIG. 19K's step 1948(ii):) (computing cloud 198) ad-(and-merge) “each of the ‘not-less-than-one’ cloud-instances-(and-its-virtualized-hardware)”-(in-bank launched-or-assigned by computing cloud 198 in step 1022(i)(b) above) to each of the “not-less-than-one”-“virtual”-(zero-“cloud-instance”)-“responses” (created) from step-1022(ii)(c)); and
if another/any-other cloud-instance of the bank already has an I.P. address (previously assigned by the computing cloud 198, e.g. if the cloud instance is providing the requested-Internet-application-service to a client computer), the-(“a/any”) cloud-instance of the bank may keep its I.P. address (in the merged-cloud-instance, and does not need-to-change-to the created I.P. address in above step-1022(iv)(a) in FIG. 10K): and/or
if another/any-other cloud-instance of the bank does not have an I.P. address (possibly assigned by the computing cloud 198), the-(“another/any-other”) cloud-instance of the bank may use the created I.P. address in step-1022(iv)(a) above); and
computing cloud 198 may decide on other method(s) of deciding the I.P. address of the merged-cloud-instance; and
   (v)(a) (computing cloud 198 in (sub)-steps-1022(v)(a)-and-(v)(b)-and-(v)(c)-of-FIG. 10K, and in FIG. 19K's (sub)-step(s) 1948(iii)-and-(iv)-and-(v):)
   (v)(a) (in FIG. 10K's (sub)-step-1022(v)(a) and in FIG. 19K's (sub)-step-1948(iii):) use-(and-select-(randomly-or-using-any-other-method)) one of the above “not-less-than-one” cloud-instance(s)-(in-bank) (now merged with (one of) the-“not-less-than-one”-(created)-“virtual”-(zero-“cloud-instance”)-“responses” (created from FIG. 10K's-step 1022(ii)(c)) as the (randomly-or-using-any-other-method)-selected-“fastest”-cloud-instance-(to-“respond”); and
since selected cloud-instance-(in-bank) (and (bank's)-cloud-instances) is/are also (equally)-“fastest”-cloud-instance(s)-to-respond from (sub)-step-1022(iii)(b) in FIG. 10K, the selected-cloud-instance-(in-bank) also is/become the selected “fastest”-cloud-instance-(to-“respond”); and
   (v)(b) (in FIG. 10K's (sub)-step-1022(v)(b) and in FIG. 19K's (sub)-step 1948(iv):) use-(and-assign-and-save) the IP-address (of the (randomly)-selected-(and-now-merged)-“fastest”-cloud-instance-(to-“respond”) in (v)(a)) as the IP-address-of-the-host-computer-cloud-instance 205-C; and
   (v)(c) (in FIG. 10K's (sub)-step-1022(v)(c) and in FIG. 19K's (sub)-step 1948(v):) disconnect/close/delete non-selected (“not-less-than-zero”)-“virtual”-(zero-“cloud-instance”)-“responses”, (which “virtual”-(zero-“cloud-instance”)-“responses” are from [0064P](iii)(a)-and-(iii)(b) above), and which “disconnect/close/delete” may be performed using software-and-database to reverse/delete the implementation-((generic)-example-described-in-[0064P](iii)(b)) of “virtual”-(zero-“cloud-instance”)-“responses” by reversing/deleting-the-implementation (e.g. reverse/delete-the-implementation-((generic)-example) (illustrated below): i.e. reverse/delete implementation-(generic-examples (NOT (specifically) as (created)-“virtual”-(zero-“cloud-instance”)-“responses” (to bank(s)-of-cloud-instance(s) launched in [0064P](i)(b)) in “FIG. 9H's row-“L”-and-“M” for “Lima”-and-“Mike” bank of “Zero/None/Empty” cloud-instance”, and copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

which implementation-((generic)-example) above is (described-in-(iii)(b)-and)-illustrated above in FIG. 9H's row-“L”-and-“M” for “Lima”-and-“Mike” bank(s) of “Zero/None/Empty” cloud-instance(s) (in column-“VII”-and-rows-“L”-and-“M” of FIG. 9H), and implementing “Zero/None/Empty” cloud-instances (from FIG. 18B's Table 2's row-C) with “0X-(virtualized)-H/W”-(“0-vCPU” and “0-ECU” and “0-GB” from columns-V-to-VII respectively of row-C of FIG. 18B's Table 2).

Please note that (for its own reasons, e.g. for operational reasons) the computing cloud 198 may create-and-assign-and-save a(n) (possibly new) IP address to the selected-(not-more-than-one)-“fastest”-cloud-instance-(to-respond) as IP address of host computer cloud instance 205-C (instead of “uses-(and-assigns-and-saves) IP address of selected-(not-more-than-one)-“fastest”-cloud-instance-(to-respond)” above).

(vi) (in step-1022(vi)-of-FIG. 10K) computing cloud 198 (or host computer cloud instance 205-C) sends 1022(vi) (in FIG. 10K) this (assigned-in-[0064P](v)(b)) IP-address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10D's step-1022, or on options page 305 in FIG. 3) using the process described in FIG. 11A, 11B, 11C, 13A, 13B, or 13C below.

Para [0064Q](i)(a)-to-(vi) here (for FIGS.-10K-and-19K for illustrations of an embodiment of the invention) is (originated-and)-edited-(and-derived) from Para [0064P](i)(a)-to-(vi), and refers-to and describes (for specification):
(step-1022-of)-“FIG. 10L: (Start)-“One”-Instance and Ping-(No-Response) and Create-“Virtual”-Response and No-LOS (Level-of-Service)”, and
(steps 1930, 1932, 1947, and 1948 of)-“FIG. 19D: (Start)-“One”-Instance and Ping-(No-Response) and Create-“Virtual”-Response and No-LOS (Level-of-Service)”.

Para [0064Q] uses much of Para [0064P](i)(a)-to-(vi) (which are incorporated herein by reference): as key differences of FIGS. 10L-and-19L (from FIGS. 10K-and-19K) are:
FIGS. 10L-and-19L: (Start)-“One”-Instance, while
FIGS. 10K-and-19K: (Start)-“Not-Less-Than-One”-Instance(s).

In FIG. 10L's steps-“1022(i)(a)”-to-“1022(vi)”, the computing cloud 198:

(i)(a) (is copied almost 100% from [0064P](i)(a):) (computing cloud 198 in steps-1022(i)(a)-and-(i)(b)-of-FIG. 10L:)
(i)(a) (If computing cloud 198 previously processed FIGS.-10L-and-19L, when the (SAME)-host-computer-205-(and-the-(SAME)-server-222A) requested the-(SAME)-Internet-application-service (e.g. website services of Global 2000 companies, and others) as in FIG. 19L's-steps-1910-and-1920-and-1925, computing cloud 198) may (optionally in step1930(i)-of-FIG. 19L) send (if available) (previous/last)-IP-address of (previous/last) host-computer-cloud-instance 205-C (from (previous/last-processing-of) sub-step-1948(iv)-of-FIG. 19L, and from (server-222A's)-previous/last-request for IP-address-of-host-computer-cloud-instance 205-C) to (be sent to) server 222A:
which (sending (previous/last)-IP-address of (previous/last) host-computer-cloud-instance 205-C would allow prompt-(almost-instant)-response to the host-computer-205's-(and-server-222A's) (new)-request for (SAME)-Internet-application-service.

Please note that the server 222A may be a server of the computing cloud 198, or may be a server of Global 2000 (or other) companies. An example of (a human operator of) a host computer 205 may be an employee-or-agent (e.g. web-master or developer) of Global 2000 (or other) companies's website(s).

(i)(b) (texts are almost 100% from [0064P](i)(b):) (Computing cloud 198 in step-1022(i)(b)-of-FIG. 10L) launches-or-assigns (e.g. in FIG. 19L's step-1930(ii)) a bank-of-(one)-cloud-instance wherein each-of-the-(one)-cloud-instance provides the requested Internet application service.
(ii)(a) Please reference: “(Computing Cloud) Attempt to Connect (to Cloud Instance)” in FIGS. 9I-to-9K and described in Para [0064L]:
(ii)(a) (not-less-than-zero)-attempt(s) to connect (reference: Para [0064L] and FIGS. 9I-to-9L) to each-of-(one)-cloud-instance (in bank-of-(one)-cloud-instance).

Please note that “(not-less-than-zero)-attempt(s) to connect” includes “zero-attempt to connect”, as “zero” is (also) “not-less-than-zero”.

(ii)(b) (Please reference: “(Computing Cloud) Attempt to Connect (to Cloud Instance)” in FIGS. 9I-to-9K and described in Para [0064L]:)
(ii)(b) receive “not-less-than-zero”-response(s) from each of the-(one)-cloud-instance (in bank-of-(one)-cloud-instance).

Please note that “(not-less-than-zero)”-response(s) includes “zero”-response, as “zero” is (also) “not-less-than-zero”.

(ii)(c) Please reference: “(Computing Cloud) Attempt to Connect (to Cloud Instance)” in FIGS. 9I-to-9K and described in Para [0064L]:
(ii)(c) (Computing cloud 198) if no-(or-zero-(total))-response (received) in (ii)(b) (from “not-less-than-zero”-response from each of the-(one)-cloud-instance), create (on)-“virtual”-(zero-“cloud-instance”)-“response” for the bank-of-(n)-cloud-instance. “Virtual”-(zero-“cloud-instance”)-“response”-examples shown in FIG. 9J. “Virtual”-(zero-“cloud-instance”)-“response” described in Para [0064Q](iii)(b)).
(iii)(a) (computing cloud 198 in step-1022(iii)(a)-and-(iii)(b)-of-FIG. 10L:)
(iii)(a) (computing cloud 198) if previously DID [0064Q](ii)(c), then (have) created (one)-“virtual”-(zero-“cloud-instance”)-“response” (from FIG. 10L's-step-1022(ii)(c)), wherein (bank's)-each-instance's-“response” is (not-less-than-zero)-“virtual”-(zero-“cloud-instance”)-“response”.

Please note that (for Para [0064Q](iii)(b)) more specification of “virtual”-(zero-“cloud-instance”)-“response” are in Para [0064Q](ii)(c).

(iii)b) (as “virtual”-is-digital) the-“one”-“virtual”-(zero-“cloud-instance”)-“response” (created in FIG. 10L's-step-1022(ii)(c)) are the-(one)-(equally)-“fastest”-cloud-instances-to-“respond” (e.g. in FIG. 19L's step-1947(ii)), as:
“virtual”-(zero-“cloud-instance”)-“response(s)” (created in FIG. 10L's-step-1022(ii)(c)) are zero-(and-no-(and-empty))-cloud-instance(s), which may be implemented using software-and-database (e.g. (generic-examples (NOT (specifically) as responses to the bank-of-cloud-instance(s) launched in FIG. 10L's-step-1022(i)(b)) illustrated in FIG. 9H's rows-“L”-and-“M” for “Lima”-and-“Mike” banks of “Zero/None/Empty” cloud-instances (in column-“VII”-and-rows-“L”-and-“M” of FIG. 9H), as copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

and implementing “Zero/None/Empty” cloud-instance (from FIG. 18B's Table 2's row-C) with “0X-(virtualized)-H/W”-(“0-vCPU” and “0-ECU” and “0-GB” from columns-V-to-VII respectively of row-C of FIG. 18B's Table 2) with FIG. 18B's Table 2's row-C (copied-and)-illustrated below:

TABLE 2
(Virtualized) (1X)-H/W (in) Amazon EC2 Cloud-Instance (Running Moddle):

| | I | II | III | IV | V | VI | VII |
|---|---|---|---|---|---|---|---|
| A | Max. # | 1X-H/W | Bank-of-Cloud-Instances: | | EC2 H/W (Each Instance): | | |
| B | Users | Implemented | #-of-32X-H/W-Instances | EC2 Instances: | vCPU | ECU | Memory |
| C | 0 | 0X | Zero/None/Empty | Zero/None/Empty | 0 | 0 | 0 GB |

hence, FIG. 10L's step-1022(ii)(c)'s and FIG. 19D's step-1947(ii)'s (created)-“virtual”-(zero-“cloud-instance”)-“responses” (with implementation using software and database) would be very fast (and could be fraction-of-a-second or almost-“instant” using computing cloud's huge and very-extremely-powerful data-center computers) and (equally)-fastest-cloud-instances-to-“respond”.
   (iv)(a) (in FIG. 10L's step-1022(iv)(a) and in FIG. 19L's step 1948(i):) (computing cloud 198) create an IP address for each of “one” (created-in-FIG. 10L's step-1022(ii)(c))-“virtual”-(zero-“cloud-instance”)-“response”, and “how-to-use which-IP-address” are described in Para [0064Q](iv)b); and
   (iv)(b) (in FIG. 10K's step-1022(iv)(b) and in FIG. 19K's step 1948(ii):) (computing cloud 198) add-(and-merge) “each of the ‘one’ cloud-instance-(and-its-virtualized-hardware)”-(in-bank launched-or-assigned by computing cloud 198 in step 1022(i)(b) above) to each of the “one”-“virtual”-(zero-“cloud-instance”)-“response” (created) from step-1022(ii)(c)); and
if another/any-other cloud-instance of the bank already has an I.P. address (previously assigned by the computing cloud 198, e.g. if the cloud instance is providing the requested-Internet-application-service to a client computer), the-(“a/any”) cloud-instance of the bank may keep its I.P. address (in the merged-cloud-instance, and does not need-to-change-to the created I.P. address in above step-1022(iv)(a) in FIG. 10L): and/or
if another/any-other cloud-instance of the bank does not have an I.P. address (possibly assigned by the computing cloud 198), the-(“another/any-other”) cloud-instance of the bank may use the created I.P. address in step-1022(iv)(a) above); and
computing cloud 198 may decide on other method(s) of deciding the I.P. address of the merged-cloud-instance; and
   (v)(a) (computing cloud 198 in (sub)-steps-1022(v)(a)-and-(v)(b)-and-(v)(c)-of-FIG. 10L, and in FIG. 19L's (sub)-step(s) 1948(iii)-and-(iv)-and-(v):)
   (v)(a) (in FIG. 10L's (sub)-step-1022(v)(a) and in FIG. 19L's (sub)-step-1948(iii):) use-(and-select-(randomly-or-using-any-other-method)) one of the above “one” cloud-instance-(in-bank) (now merged with the-“one”-(created)-“virtual”-(zero-“cloud-instance”)-“response” (created from FIG. 10L's-step 1022(ii)(c)) as the (randomly-or-using-any-other-method)-selected-“fastest”-cloud-instance-(to-“respond”); and
since selected cloud-instance-(in-bank) (and (bank's)-cloud-instances) is/are also (equally)-“fastest”-cloud-instance(s)-to-respond from (sub)-step-1022(iii)(b) in FIG. 10L, the selected-cloud-instance-(in-bank) also is/become the selected “fastest”-cloud-instance-(to-“respond”); and
   (v)(b) (in FIG. 10L's (sub)-step-1022(v)(b) and in FIG. 19L's (sub)-step 1948(iv):) use-(and-assign-and-save) the IP-address (of the (randomly)-selected-(and-now-merged)-“fastest”-cloud-instance-(to-“respond”) in (v)(a)) as the IP-address-of-the-host-computer-cloud-instance 205-C; and
   (v)(c) (in FIG. 10L's (sub)-step-022(v)(c) and in FIG. 19L's (sub)-step-1948(v):) disconnect/close/delete non-selected (“not-less-than-zero”)-“virtual”-(zero-“cloud-instance”)-“response(s)”, (which “virtual”-(zero-“cloud-instance”)-“response(s)” are from [0064Q](iii)(a)-and-(iii)(b) above), and which “disconnect/close/delete” may be performed using software-and-database to reverse/delete the implementation-((generic)-example-described-in-[0064Q](iii)(b)) of “virtual”-(zero-“cloud-instance”)-“response(s)” by reversing/deleting-the-implementation (e.g. reverse/delete-the-implementation-((generic)-example) (illustrated below): i.e. reverse/delete implementation-(generic-examples (NOT (specifically) as (created)-“virtual”-(zero-“cloud-instance”)-“response(s)” (to bank(s)-of-cloud-instance(s) launched in [0064Q](i)(b)) in “FIG. 9H's row-“L”-and-“M” for “Lima”-and-“Mike” bank of “Zero/None/Empty” cloud-instance”, and copied-and-illustrated below:

| | I | II | III | IV | V |
|---|---|---|---|---|---|
| | (Public Network) | (Alpha, Bravo, Charlie, . . .) | H. | (Public Network) | “No-LOS”- |
| | Unique | Bank(s) of Host Computer | C. | Host Computer | EC2's-Max.-#- |
| | Public | Cloud Instances (B.H.C.C.I) | C. | Cloud Instance | of-Concurrent- |
| | IP address | (Alpha, Bravo, . . .) 205-C | I. | (H.C.C.I.) | Users |
| L | 54.68.74.232 | (B.H.C.C.I) Lima-205-C | z | H.C.C.I 205z-C | 0 |
| M | 54.68.74.233 | (B.H.C.C.I) Mike-205-C | aa | H.C.C.I 205aa-C | 0 |

| | | | VIII | | X | XI |
|---|---|---|---|---|---|---|
| | VI | | Amazon | IX | Target- | Target- |
| | Host Helper | VII | EC2's # of | Level-of- | Floor- | Ceiling- |
| | Program | Amazon EC2 | Virtualized | Service | Response- | Response- |
| | 215-1 | Cloud Instance | Hardware | (LOS) | Time (Sec.) | Time (Sec.) |
| L | None | Zero/None/Empty | 0 | None | None (Zero) | None (>30) |
| M | None | Zero/None/Empty | 0 | None | None (Zero) | None (>30) |

which implementation-((generic)-example) above is (described-in-(iii)(b)-and)-illustrated above in FIG. 9H's row-“L”-and-“M” for “Lima”-and-“Mike” bank(s) of “Zero/None/Empty” cloud-instance(s) (in column-“VII”-and-rows-“L”-and-“M” of FIG. 9H), and implementing “Zero/None/Empty” cloud-instances (from FIG. 18B's Table 2's row-C) with “0X-(virtualized)-H/W”-(“0-vCPU” and “0-ECU” and “0-GB” from columns-V-to-VII respectively of row-C of FIG. 18B's Table 2); and
(vi) (in step-1022(vi)-of-FIG. 10L) computing cloud 198 (or host computer cloud instance 205-C) sends 1022(vi) (in FIG. 10L) this (assigned-in-[0064Q](v)(b)) IP-address of host computer cloud instance 205-C to the server 222A.

Bank-of-(one-or-more)-host-computer-cloud-instances are further described in Para [0027A]-to-[0027D], and illustrated in FIGS. 2A, 9A-to-9B, and 9C's-columns-II-to-XIV.

A client computer 215 in FIG. 9B may join the started Internet application service above (in FIG. 10D's step-1022, or on options page 305 in FIG. 3) using the process described in FIG. 11A, 11B, 11C, 13A, 13B, or 13C below.

Referring now to FIG. 1I A, a process corresponding to a direct network connections using cloud instance for providing Internet application service between a networked cloud instance and a networked computer is presented. The process illustrated in FIG. 11A corresponds to a direct network connections architecture including a host computer 205, a host computer cloud instance 205-C, a client computer 215 executing a client web browser 218, and a server 222A hosting a website 212A (FIG. 9A). When the client computer 215 accesses the website 212A via the client web browser 218, the server 222A sends 1125 a log-in form to the client web browser 218. In one embodiment, the log-in form comprises a web page file in PHP, ASPX, or HTML format. The client web browser 218 then displays 1130 the log-in form (not shown herein). Once the log-in form is completed, client web browser 218 returns 1135 the completed log-in form to the server 222A.

In one embodiment, the return 1135 of the completed log-in form causes the server 222A to execute 1140 a designated common gateway interface (CGI) script. In one embodiment, the CGI script may include commands implemented in the PERL programming language which cause the server 222A to send 1145 an options page 305 (FIG. 3) to the client web browser 218. The client web browser 218 then displays 1150 the options page 305, allowing an option to be selected. As explained above, the user of the client computer 215 may select the icon 302a to join the Internet application service of the host computer 205 or other icons for other options (e.g. those icons on options page 305 in FIG. 3). The user selection is then sent 1155 to the server 222A. Based on the selection, an ActiveX control is downloaded 1160 to the client web browser 218 from the server 222A.

If the selection is to join Internet application service of a host computer 205, an ActiveX control will be downloaded 1160 to: (i) download 1165 a client helper program 216-2 to the client computer 215, (ii) download 1170 the IP address of the host computer cloud instance 205-C to the client computer 215, and (iii) using the downloaded 1170 IP address of the host computer cloud instance 205-C, connect a client helper program 216-2 on the client computer 215 to a host helper program 216-1 on the host computer cloud instance 205-C. Connecting the two host/client helper programs 216-1, 216-2 includes the client computer 215 sending 1175 the IP address of the client computer 215 to the host computer cloud instance 205-C. Once the helper program 216-2 on the client computer 215 and the helper program 216-1 on the host computer cloud instance 205-C are connected, data may be exchanged 1180 directly between the host computer cloud instance 205-C and the client computer 215 via the direct connection 245, without any data passing through the server 222A The host computer 205 is not needed for the data exchange 1180.

Please note: data exchange 1180 (in FIG. 11A and) FIG. 9B illustrate that after the Internet application services are started 1017 (in FIG. 10A), and after the server 222A receives 1025 (in FIG. 10A) the IP address of the host computer cloud instances 205-C (in FIG. 9B), the host computer 205 (in FIG. 9B) is not needed to be communicatively linked 240 with the host computer cloud instance 205-C or linked 225 with the server 222A respectively (for the client computers 215, 215a . . . , 215n (in FIG. 9B) to use the Internet application services of the host computer cloud instances 205-C). Please further note: communication links 225, 240 appear in FIG. 9A, and do not appear in FIG. 9B.

Thus, in accordance with embodiments of the present invention, FIGS. 9A, 9B, 10A, 11A, and 13A above illustrate creating direct network connections for Internet application service between the client computer 215, 215n (in FIG. 9B respectively) and the host computer cloud instance 205-C (in FIG. 9B respectively) via the Internet (including how to start the host computer cloud instance 205-C in FIG. 9B).

Bank-of-(one-or-more)-host-computer-cloud-instances are further described in Para [0027A]-to-[0027D], and illustrated in FIGS. 2A, 9A-to-9B, and 9C's-columns-II-to-XIV.

In some embodiments, rather than downloading 1165 a client helper program 216-2 to the client computer 215, 215n, the downloaded 1160 ActiveX control may activate a client helper program 216-2 already present on the client computer 215, 215n (not shown herein). In some embodiments, the client helper program 216-2 is an Internet browser such as Internet Explorer or Firefox.

In another embodiment, if the selection is to become a new host, a process slightly different from that depicted in FIG. 11A takes place. Specifically, upon receiving the client computer 215, 215n request to become a new host, the server 222A requests a computing cloud (e.g. computing cloud 198 in FIG. 9B) to launch-or-assign (not shown) a host computer cloud instance 205-C, 205a-C for the client computer 215, 215n. An ActiveX control is downloaded 1160 to download (not shown) a host helper program 216-1 to the client computer 215, 215n. At this point, the client computer 215, 215n is now also acting as a host computer 205, 205a. Accordingly, the IP address of the client's host computer cloud instance 205-C, 205a-C is sent (not shown) to the server 222A. The server 222A receives (not shown) the IP address of the client's host computer cloud instance 205-C, 205a-C so that it may later be provided to other client computers 215a, 215b, . . . etc. which request it. The server 222A also sends (not shown) the IP address of the client computer 215, 215n (now a new host computer 205, 205a) to the client's host computer cloud instance 205-C, 205a-C, which is communicatively coupled (not shown) to the client computer 215, 215n (now the new host computer 205, 205a) via a direct connection.

It is noted that the IP address of the client computer 215, 215n may be sent to the host computer 205, 205a and/or the host computer cloud instance 205-C, 205a-C using indirect connection 225, 230, or indirect connection 227, 230 (instead of using direct network connection 240, 245 in FIG. 9A) in further embodiments of the current invention.

In an embodiment of the current invention illustrated in FIG. 11B, which FIG. 11B is similar to FIG. 11A, but in FIG. 11B the server 222A sends 1167 (using indirect connection 225, 230 in FIG. 9A) the IP address of the client computer 215, 215n to the host computer 205, 205a, which is communicatively coupled to the host computer cloud instance 205-C, 205a-C. The host computer cloud instance 205-C, 205a-C therefore also gets 1168 the IP address of the client computer 215, 215n. The host computer cloud instance 205-C, 205a-C then sends 1173 the host computer cloud instance IP address to the client computer 215, 215n. Direct data exchange 1180 can then occur, using direct network connection 245 in FIG. 9B, between the client computer 215, 215n and the host computer cloud instance 205-C, 205a-C, and without going through the server 222A. The host computer 205 (in FIG. 9B) is not needed for the direct data exchange 1180 (in FIG. 11B).

In another embodiment of the current invention illustrated in FIG. 11C, which FIG. 11C is similar to FIG. 11A, but in FIG. 1I C the server 222A sends 1169 (using indirect connection 227, 230 in FIG. 9A) the IP address of the client computer 215, 215n to the host computer cloud instance 205-C, 205a-C which may be (but not required in FIGS. 9B and 11C to be) communicatively coupled to the host computer 205. The host computer cloud instance 205-C, 205a-C then sends 1173 the host computer cloud instance 205-C, 205a-C IP address to the client computer 215, 215n. Direct data exchange 1180 can then occur, using direct network connection 245 in FIG. 9B, between the client computer 215, 215n and the host computer cloud instance 205-C, 205a-C, and without going through the server 222A. The host computer 205 (in FIG. 9B) is not needed for the direct data exchange 1180 (in FIG. 11C).

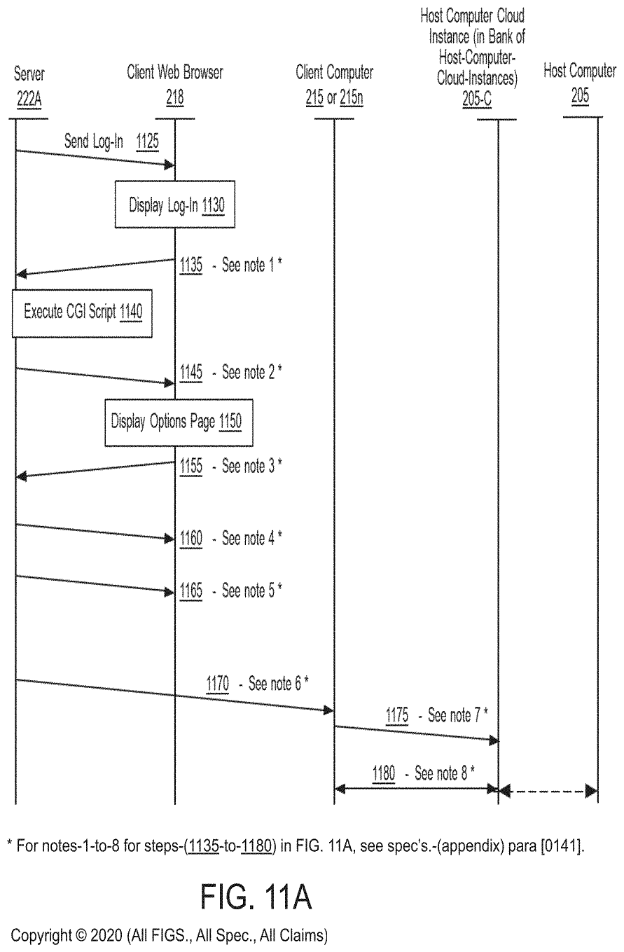

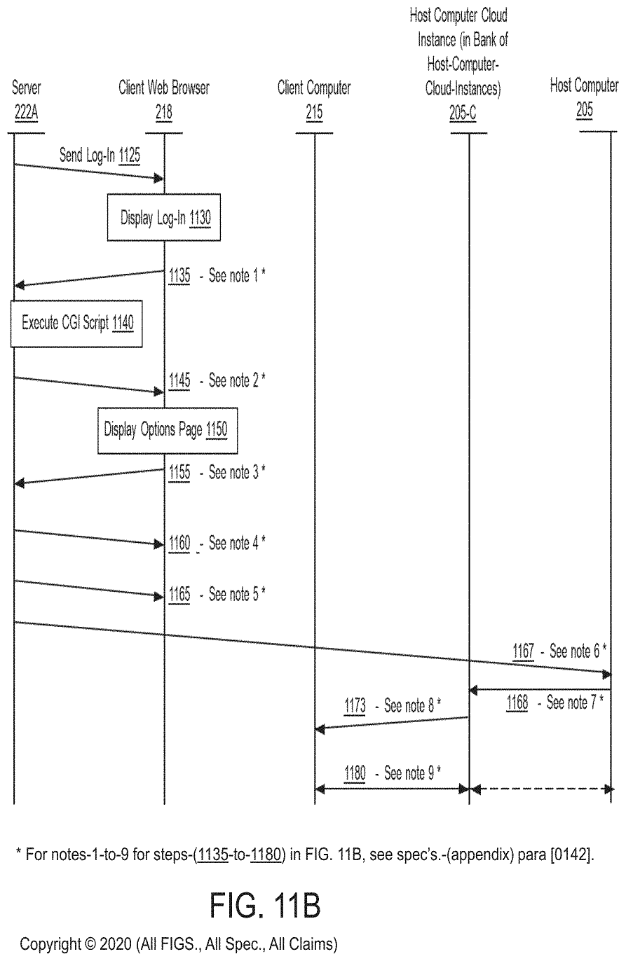

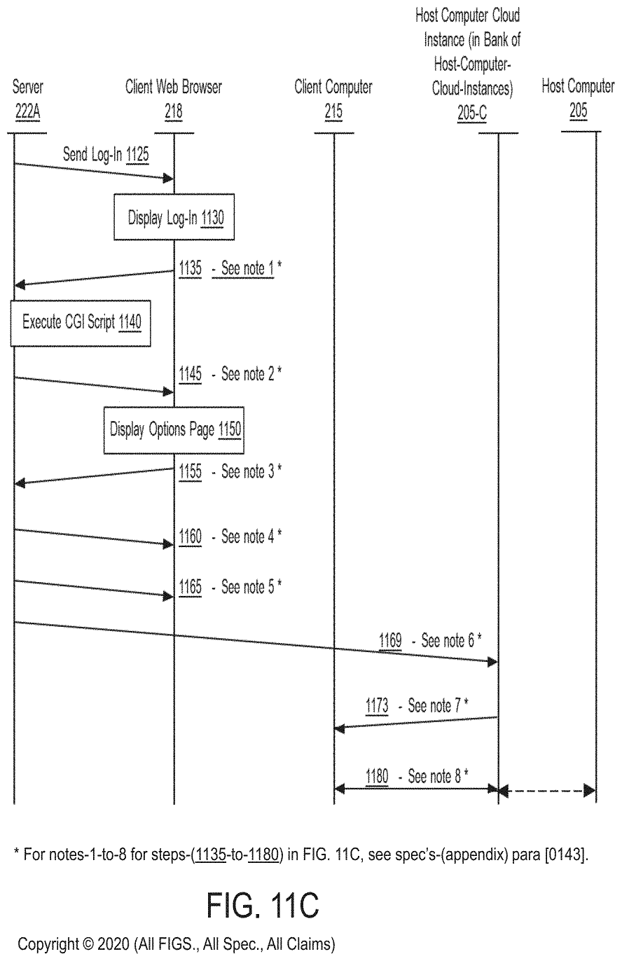

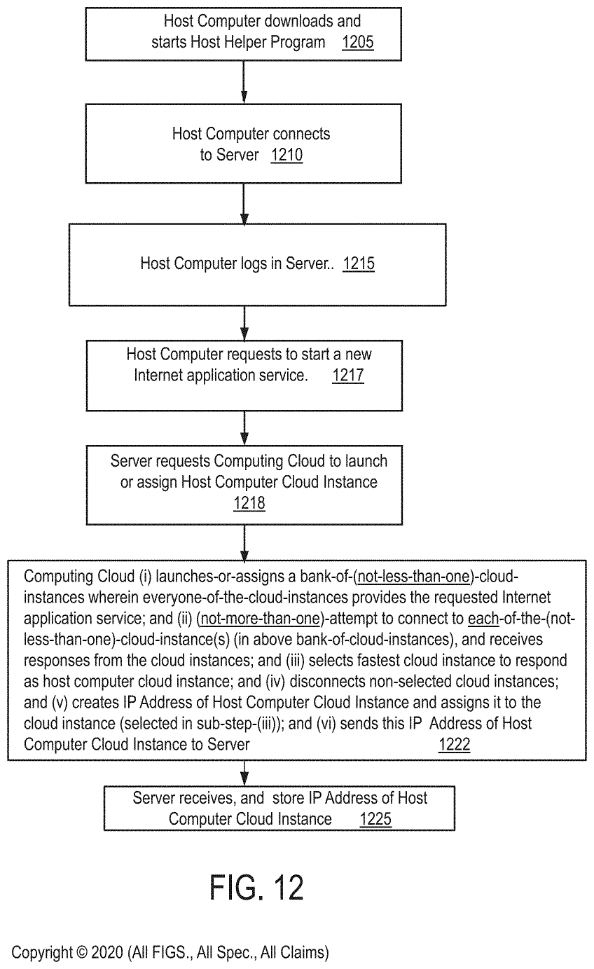

FIG. 12 presents a flowchart of a process performed by host computer 205, 205a (host computer 205a is similar to host computer 205, but host computer 205a is not shown) to provide direct network connections between cloud instance and computers over a computer network in accordance with an embodiment of the present invention. First, the host computer 205, 205a downloads and starts 1205 the host helper program 216-1. In one embodiment, the host helper program 216-1 is the Moodle learning management system (running on Linux-Apache-MySQL-PHP solution stack) Internet application (from the Australian company Moodle Pty Ltd.). The host computer 205, 205a then connects 1210 to a server 222A.

Once the host computer 205, 205a is connected 1210 to the server 222A, the host computer 205, 205a logs in 1215 to a website 212A hosted by the server 222A. The host computer 205, 205a requests to start a new Internet application service in step 1217. The server 222A then requests a computing cloud 198 (in FIG. 9B) to launch-or-assign a host computer cloud instance 205-C, 205a-C for the host computer 205, 205a in step 1218. The host computer cloud instance 205-C, 205a-C sends its IP address in step 1220 to the server 222A, which receives it and store it in step 1225 for later distribution to client computer 215, 215n.

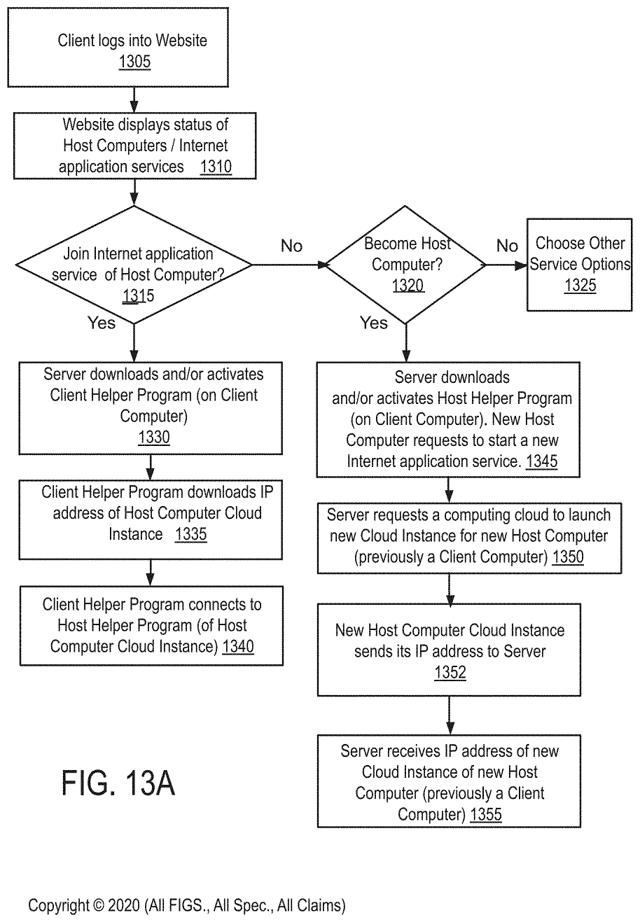

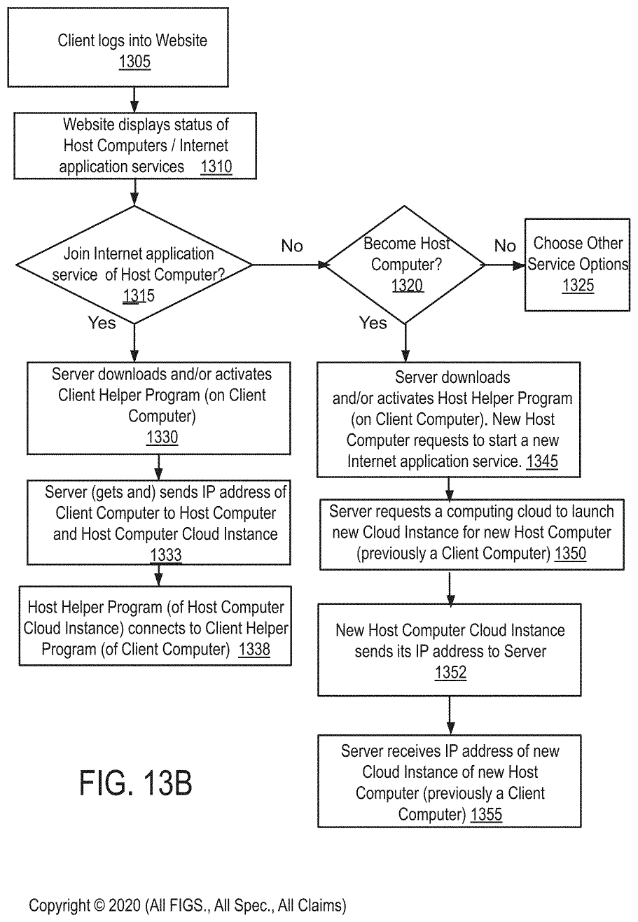

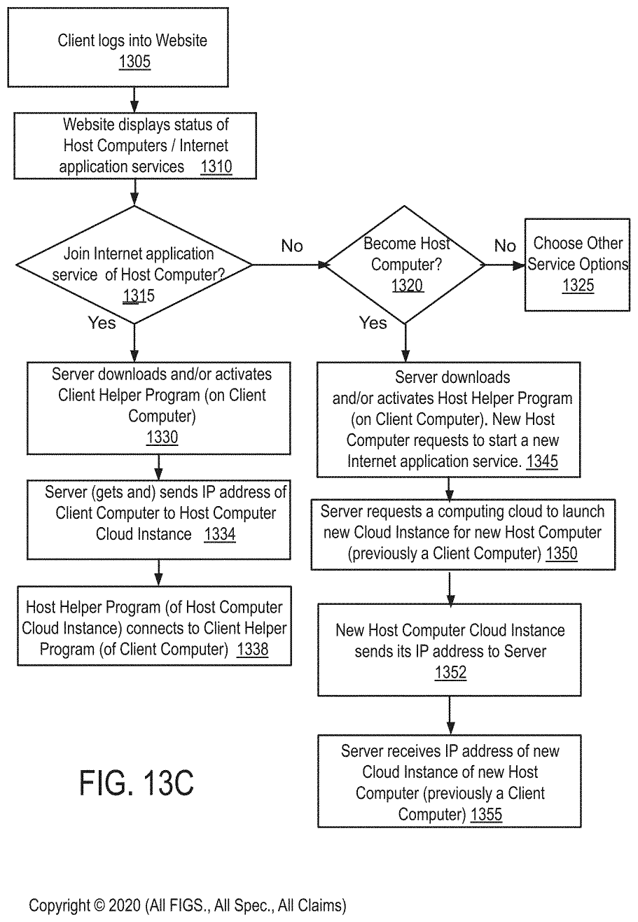

FIG. 13A presents a flowchart of a process performed by a client computer 215, 215n to provide direct network connections between cloud instance and computers over a computer network in accordance with an embodiment of the present invention. The client computer 215, 215n logs in 1305 to a website 212A hosted by a server 222A. The website 212A then displays 1310 the status of one or more host computers 205, 205a. In one embodiment, the status of one or more host computers 205, 205a are displayed on an options page 305 such as that depicted in FIG. 3.

If the client computer 215, 215n selects to join the Internet application service of a host computer 205, 205a at step 1315, the server 222A downloads and/or activates 1330 a client helper program 216-2 on the client computer 215, 215n. The client computer 215, 215n then requests (not shown) to join the Internet application of host computer 205, 205a. The client helper program 216-2 then downloads 1335 (from the server 222A) the IP address of the selected host computer cloud instance 205-C, 205a-C. Using the downloaded 1335 IP address of the host computer cloud instance 205-C, 205a-C, the client helper program 216-2 connects 1340 to a host helper program 216-1 on the host computer cloud instance 205-C, 205a-C. Further data exchange 1180 (in FIG. 11A) for Internet application service between the host computer cloud instance 205-C, 205a-C and the client computer 215, 215n occurs via the direct connection 245 (FIG. 9A) using the two host/client helper programs 216-1, 216-2, without going through the server 222A. The host computer 205, 205a is not needed (illustrated in FIG. 9B) for data exchange 1180 (in FIG. 11A).

If the client computer 215 selects to become a host computer 205 (step 1315—No and step 1320—Yes in FIG. 13A), the server 222A downloads and/or activates 1345 a host helper program 216-1 on the client computer 215, 215n. The new host helper program 216-1 requests 1345 to start a new Internet application service. The server 222A also requests a computing cloud 198 (in FIG. 9B) to launch-or-assign 1350 a host computer cloud instance 205-C, 205a-C for the new host computer 205, 205a (previously a client computer 215, 215n). The host computer cloud instance 205-C, 205a-C then sends 1352 its IP address to the server 222A, where it is received 1355 for future distribution to one or more other client computers 215a, 215b, . . . etc.

Finally, the user may choose 1325 other service options other than joining Internet application service of a host computer or becoming a host computer (step 1315-No, and step 1320-No).

In some cases, a host computer 205 may have a dynamic IP address, complicating the creation of a direct network connection using cloud instance. For example, the host computer 205, 205a may be coupled to the Internet through an Internet service provider (“ISP”). Often, an ISP has a limited number of Internet connections and therefore a limited number of IP addresses it may allocate at any one time. Thus, when a host computer 205, 205a connects to the Internet through an ISP, it is dynamically assigned a new IP address each time it connects. The present invention solves the problem of dynamic IP address and sends (to the server 222A) the host computer cloud instance 205-C, 205a-C IP address each time a host computer cloud instance 205-C, 205a-C is launched-or-assigned by the computing cloud 198 upon a request by the server 222A.

It is noted that the IP address of the client computer 215, 215n may be sent to the host computer 205, 205a and/or the host computer cloud instance 205-C, 205a-C using indirect connection 225, 230, or indirect connection 227, 230 (instead of using direct network connection 240, 245 in FIG. 9A) in further embodiments of the current invention.

In an embodiment of the current invention illustrated in FIG. 13B, which FIG. 13B is similar to FIG. 13A, but in FIG. 13B the server 222A (gets 1305 and) sends 1333 (using indirect connection 225, 230 in FIG. 9A) the IP address of the client computer 215, 215n to the host computer 205, 205a and the host computer cloud instance 205-C. 205a-C, which are communicatively coupled to each other. The host helper program 216-1 (of the host computer cloud instance 205-C, 205a-C) then connects 1338 to the client helper program 216-2 (of the client computer 215, 215n). Direct data exchange 1180 in FIG. 11B can then occur, using direct network connection 245 in FIG. 9B, between the client computer 215n and the host computer cloud instance 205a-C, and without going through the server 222A. The host computer 205, 205a (in FIG. 9B) is not needed for direct data exchange 1180 (in FIG. 11B).

In another embodiment of the current invention illustrated in FIG. 13C, which FIG. 13C is similar to FIG. 13A, but in FIG. 13C the server 222A (gets 1305 and) sends 1334 (using indirect connection 227, 230 in FIG. 9A) the IP address of the client computer 215, 215n to the host computer cloud instance 205-C, 205a-C, which may be (but not required in FIGS. 9B and 13C to be) communicatively coupled to the host computer 205, 205a. The host helper program 216-1 (of the host computer cloud instance 205-C, 205a-C) then connects 1338 to the client helper program 216-2 (of the client computer 215, 215n). Direct data exchange 1180 in FIG. 11C can then occur, using direct network connection 245 in FIG. 9B, between the client computer 215, 215n and the host computer 205, 205a, using the host computer cloud instance 205-C, 205a-C, and without going through the server 222A. The host computer 205, 205a (in FIG. 9B respectively) is not needed for direct data exchange 1180 (in FIG. 11C).

### Private Network Considerations (Adapted for Internet Application Service)

A host computer 205 may reside on a private network (e.g., an internal network for a company or organization). The Internet Assigned Numbers Authority (“IANA”) allocates a designated set of IP addresses for private networks, and routers on the Internet are configured to discard any data packets associated with IP addresses from that designated set. Private networks typically include a computer network security barrier, commonly called a “firewall,” to prevent unauthorized intrusion into the private network. As such, the IP address of a host computer 205 on a private network is not unique (i.e., other computers on private networks elsewhere globally may have the same IP address) and not accessible from the public Internet.

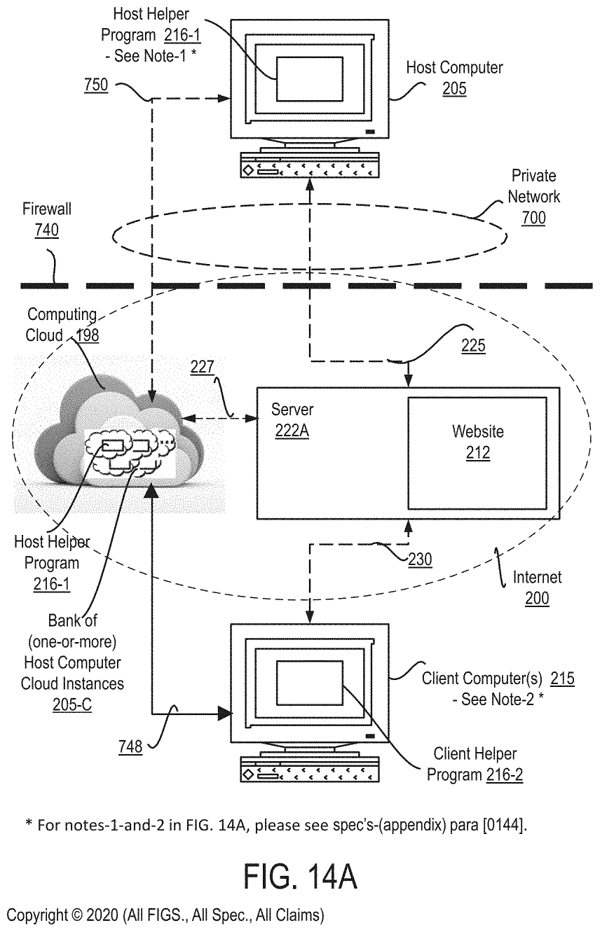

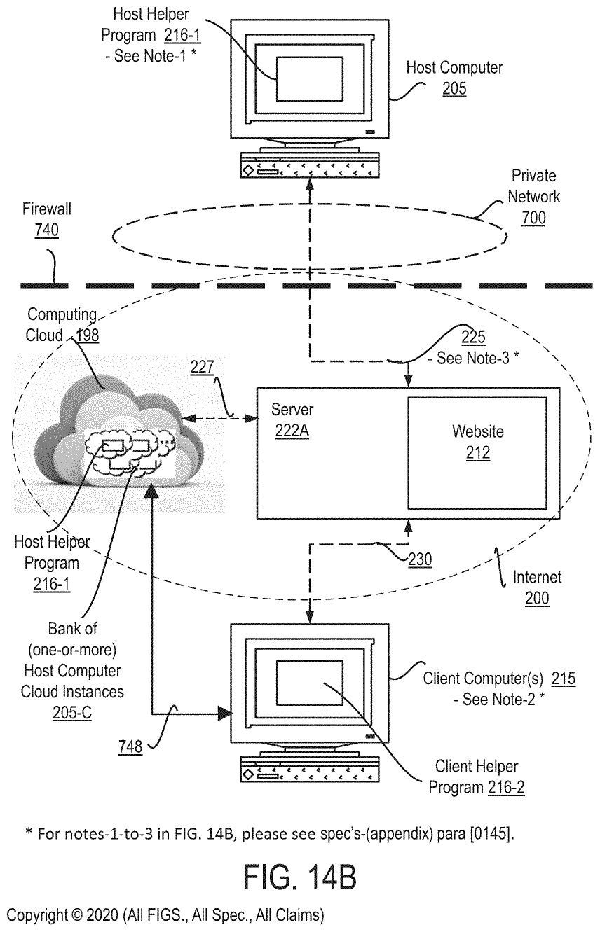

FIG. 14A illustrates a direct network connection using bank of (one-or-more) cloud instance, in accordance with one embodiment of the present invention, suitable for providing a direct network connection when one of the networked computers does not have a unique, publicly accessible IP address. The embodiment depicted in FIG. 14A includes a host computer 205, a client computer 215, a server 222A hosting a website 212A, a firewall 740, and a host computer cloud instance 205-C. The host computer 205 is connected to the Internet 200 through a private network 700. The private network 700 is protected by the firewall 740. Thus, the host computer 205 and the client computer 215 are both connected to the Internet 200, but are separated by the firewall 740.

In one embodiment, the direct network connection using bank of (one-or-more) cloud instance depicted in FIG. 14A functions largely as the direct network connection using bank of (one-or-more) cloud instance described above in reference to FIG. 9A. Specifically, the host computer cloud instance 205-C has a unique, publicly accessible IP address. The host computer 205 may be able to access the host computer cloud instance 205-C and form a network connection 750. Thus, the host computer cloud instance 205-C double duties provides a unique, publicly accessible IP address by which a client computer 215 outside of the private network 700 may join the Internet application service of the host computer 205 via a direct network connection 748 using the host computer cloud instance 205-C.

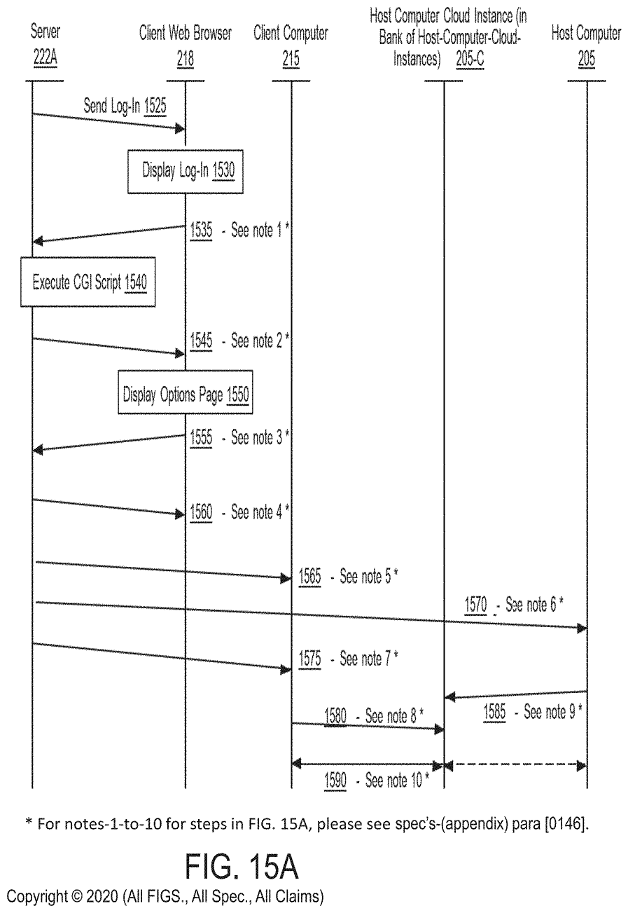

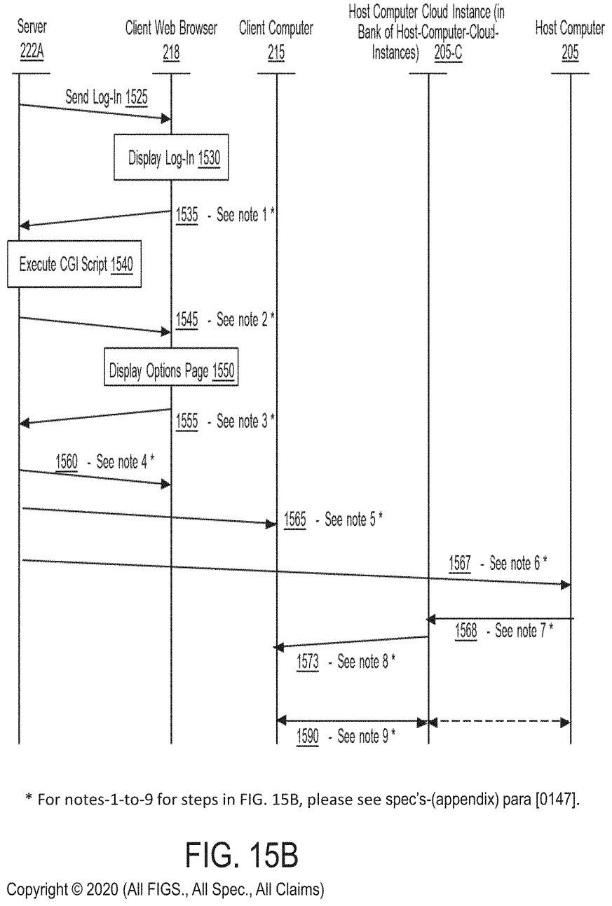

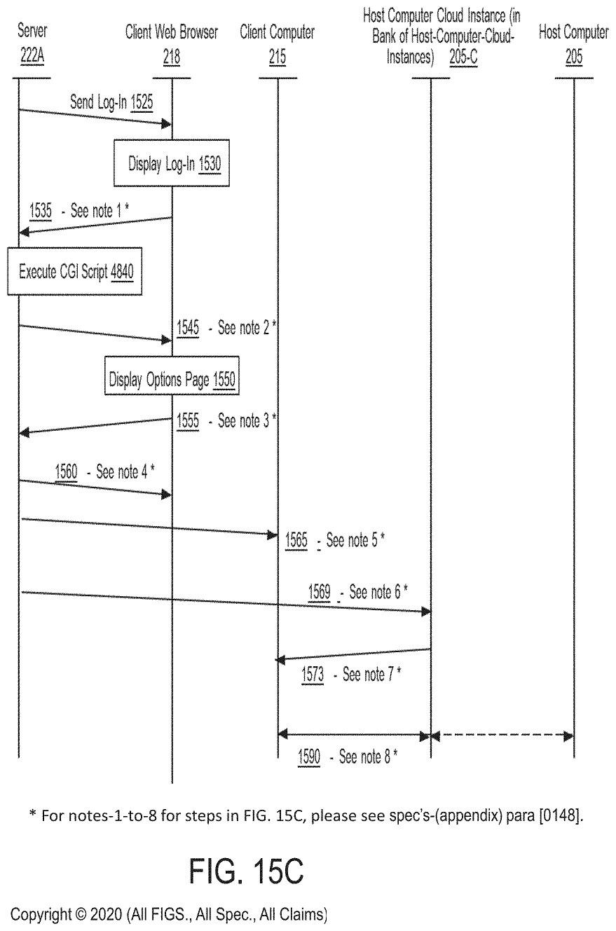

In one embodiment, when the host computer 205 accesses the website 212A to request starting a new Internet application service, the server 222A requests a computing cloud 198 (not shown) to launch-or-assign the host computer cloud instance 205-C. The host computer cloud instance 205-C is communicatively coupled to the hot computer 205. When a client computer 215 subsequently accesses the website 212A and selects to join the Internet application service of the host computer 205, the server 222A sends to the client computer 215 the IP address of the host computer cloud instance 205-C via a network connection 230. Once the client computer has the IP address of the host computer cloud instance 205-C, it may send data to the host computer cloud instance 205-C via a direct network connection 748. Moreover, the client computer 215 sends to the host computer cloud instance 205-C the IP address of the client computer 215 itself through the direct network connection 748. In other words, while the IP address of host computer cloud instance 205-C is sent to the client computer 215 through the server 222A via the indirect connections 225, 230, the IP address of the client computer 215 is sent to the host computer cloud instance 205-C via the direct connection 748. Thus, the client computer 215 and the host computer cloud instance 205-C are able to obtain one another's IP addresses and create a direct network connection 748. From this point onwards, the server 222A is not involved in communicating data between host computer 205 and client computer 215, and subsequent data exchange between the host computer cloud instance 205-C and the client computer 215 takes place via the direct network connection 748, and the host computer 205 is not needed for the data exchange. For the purpose of clarity, further details of a process for establishing a direct network connection using cloud instance with a host computer 205 on a private network 700 are provided below with reference to FIGS. 15A, 32, and 33A.

It should be noted that the host computer cloud instance 205-C provides double duties functions related to actively hosting an Internet application service session, including importantly forming a bridge between the non-accessible private network 700 and the public Internet 200, to facilitate data exchange.

In some embodiments, the direct network connection using cloud instance architectures depicted by FIG. 9A and FIG. 14A are adapted using the above-described techniques to provide Internet application services for multiple host computers 205 on private networks and/or multiple client computers 215. In such embodiments, the host computer cloud instance 205-C may need to distinguish between multiple host computers 205 to ensure that data is transmitted only to one or more proper destinations.

The server 222A may send a unique meeting ID corresponding to an Internet application service between the host computer 205 and the client computer 215 to the client computer 215 along with the IP address of the host computer cloud instance 205-C. The client computer 215 may then send to the host computer cloud instance 205-C the unique meeting ID along with the IP address of the client computer 215. In one embodiment, the server 222A also sends the unique meeting ID to the host computer 205, which in turn sends it to the host computer cloud instance 205-C. The host computer cloud instance 205-C may store both the unique meeting ID and the associated IP address of the host computer 205 in a look-up table. Thus, when a client computer 215 sends data to a host computer 205 via the direct network connection 748 using the host computer cloud instance 205-C, as illustrated in FIG. 14A, it may designate the data as corresponding to the particular meeting ID, allowing the host computer cloud instance 205-C, using the look-up table, to transmit the data to the appropriate host computer 205.

Typically, a private network with a firewall 740 will also have a SOCKS proxy executing between the client web browser 218 and the server. In such an embodiment, the CGI script executed by the server is forced to download the IP address of the SOCKS proxy rather than the IP address of the host computer 205. To resolve this issue, a name registration daemon is provided by the server which registers the IP address and port number of each host computer 205 or client computer 215. When the host/client helper programs 216-1, 216-2 start on host and client computers 205, 215 respectively, the two host/client helper programs 216-1, 216-2 connect to the daemon, allowing the daemon to register the IP addresses of the host and client computers 205, 215 respectively.

Referring now to FIG. 15A, a process is illustrated for providing a direct network connection using cloud instance for Internet application service between a client computer 215 and a host computer 205 on a private network in accordance with one embodiment of the present invention. The process illustrated in FIG. 15A is adapted from FIG. 11A. Specifically, the event diagram of FIG. 15A corresponds to a direct network connection using cloud instance for Internet application service with a host computer 205 on a private network 700. When a host computer 205 is on a private network 700, a unique meeting ID is sent 1570 by the server 222A to the host computer 205. The unique meeting ID is also downloaded 1575 from the server 222A by the client computer 215 along with the IP address of the host computer cloud instance 205-C. Then, the IP address of the client computer 215 and the meeting ID are sent 1580 by the client computer 215 to the host computer cloud instance 205-C, which is communicatively coupled to the host computer 205. The host computer 205 also sends 1585 the meeting ID to the host computer cloud instance 205-C. From this point onwards, data may be exchanged 1590 between the client computer 215 and the host computer cloud instance 205-C via the direct network connection 748, and the host computer 205 is not needed for the data exchange 1590; and the host computer cloud instance 205-C acts as a bridge between the private network 700 and the Internet 200, and as illustrated in FIG. 14A. When client computer 215 sends data to the host computer cloud instance 205-C, it may designate the data as corresponding to the particular meeting ID, allowing the host computer cloud instance 205-C, using the look-up table, to differentiate the data as for the appropriate Internet application service (running inside the host computer cloud instance 205-C) of the host computer 205.

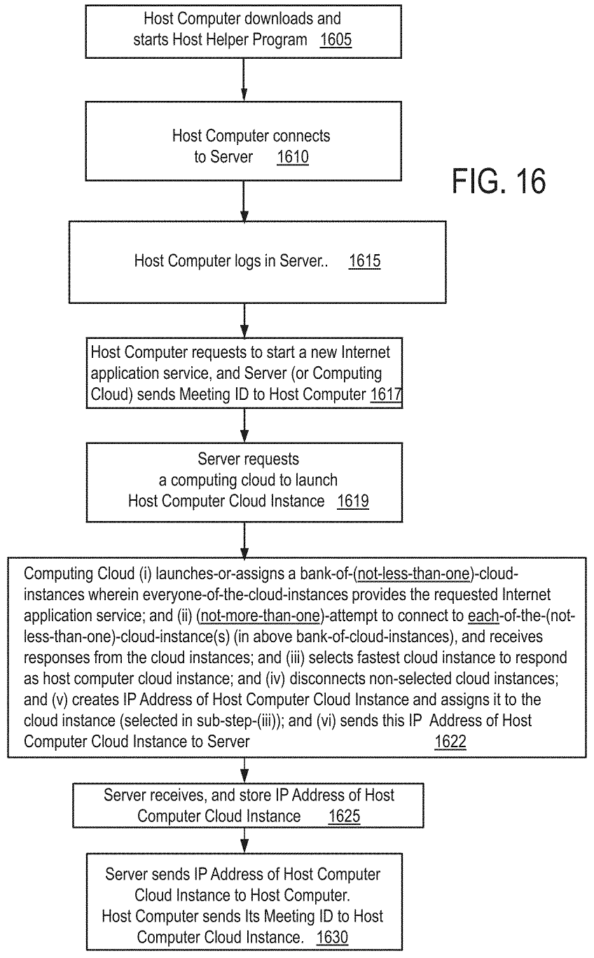

Please note: data exchange 1590 (in FIG. 15A) and FIG. 14B illustrate that after the Internet application service is started 1619 (in FIG. 16), and after the server 222A receives 1625 (in FIG. 16) the IP address of the host computer cloud instance 205-C, the host computer 205 is not needed to be communicatively linked 750 with the host computer cloud instance 205-C or linked 225 with the server 222A respectively (for the client computer 215 to use the Internet application service of the host computer cloud instance 205-C). Please further note: communication links 225, 750 appear in FIG. 14A, and do not appear in FIG. 14B.

Thus, in accordance with an embodiment of the present invention, FIGS. 14A, 14B, 15A, 32, and 33A above illustrate creating direct network connections for Internet application service between the client computer 215 and the host computer cloud instance 205-C via the Internet (including how to start the host computer cloud instance 205-C).

It is noted that the IP address of the client computer 215 may be sent to the host computer 205 and/or the host computer cloud instance 205-C using indirect connection 225, 230, or indirect connection 227, 230 (instead of using direct network connection 748, 750 in FIG. 14A) in further embodiments of the current invention.

In an embodiment of the current invention illustrated in FIG. 15B, which FIG. 15B is similar to FIG. 15A, but in FIG. 15B the server 222A sends 1567 (using indirect connection 225, 230 in FIG. 14A) the IP address of the client computer 215 and meeting ID to the host computer 205, which is communicatively coupled to the host computer cloud instance 205-C. The host computer cloud instance 205-C therefore also gets 1568 the IP address of the client computer 215 and meeting ID. The host computer cloud instance 205-C then sends 1573 its IP address and the meeting ID to client computer 215. Direct data exchange 1590 can then occur, using direct network connection 748 in FIG. 14A, between client computer 215 and the host computer cloud instance 205-C, and without going through the server 222A. The host computer 205 (in FIG. 14B) is not needed for direct data exchange 1590 (in FIG. 15B).

In another embodiment of the current invention illustrated in FIG. 15C, which FIG. 15C is similar to FIG. 15A, but in FIG. 15C the server 222A sends 1569 (using indirect connection 227, 230 in FIG. 14A) the IP address of the client computer 215 and meeting ID to the host computer cloud instance 205-C, which may be (but not required in FIGS. 14B and 15C to be) communicatively coupled to the host computer 205. The host computer cloud instance 205-C then sends 1573 its IP address and the meeting ID to client computer 215. Direct data exchange 1590 can then occur, using direct network connection 748 in FIG. 14B, between client computer 215 and host computer cloud instance 205-C, and without going through the server 222A. The host computer 205 (in FIG. 9B) is not needed for direct data exchange 1590 (in FIG. 15C).

FIG. 16 presents a flowchart of a process performed by a host computer 205 on a private network 700 to provide direct network connections using cloud instance for Internet application service between computers over a computer network in accordance with an embodiment of the present invention. First, the host computer 205 downloads and starts 1605 the host helper program 216-1. In one embodiment, the host helper program 216-1 is the Moodle learning management system (running on Linux-Apache-MySQL-PHP solution stack) Internet application (from the Australian company Moodle Pty Ltd.). The host computer 205 then connects 1610 to the server 222A. The host computer 205 logs in 1615 to a website 212A hosted by the server 222A. This allows a website 212A hosted by the server 222A to accurately reflect the status of the host computer 205 on an options page 305 (in FIG. 3). The host computer 205 requests 1617 to start a new Internet application service, and the server 222A sends 1617 a unique meeting ID to the host computer 205. The server 222A requests 1619 a computing cloud 198 (not shown) to launch-or-assign a host computer cloud instance 205-C. The host computer cloud instance 205-C sends 1620 its IP address to the server 222A. The server 222A receives 1625 and store 1625 the IP address of the host computer cloud instance 205-C, and sends 1630 the IP address of the host computer cloud instance 205-C to the host computer 205. Finally, the host computer 205 sends 1630 its meeting ID to the host computer cloud instance 205-C.

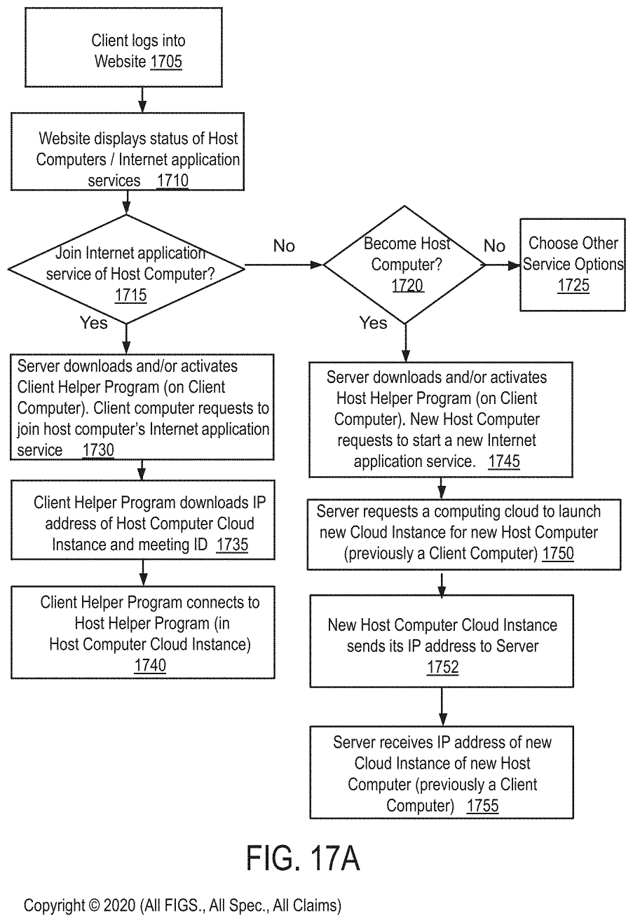

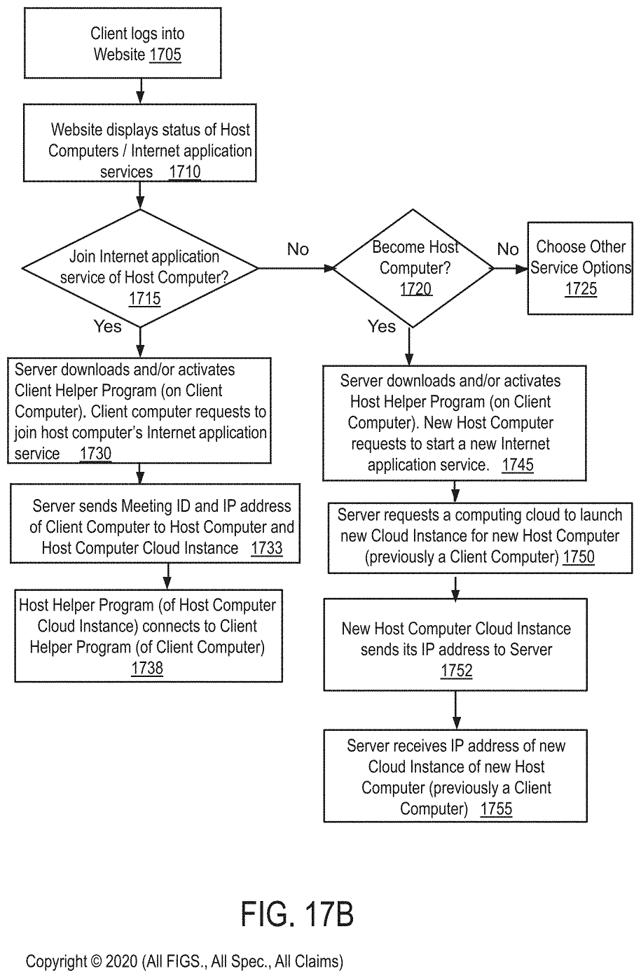

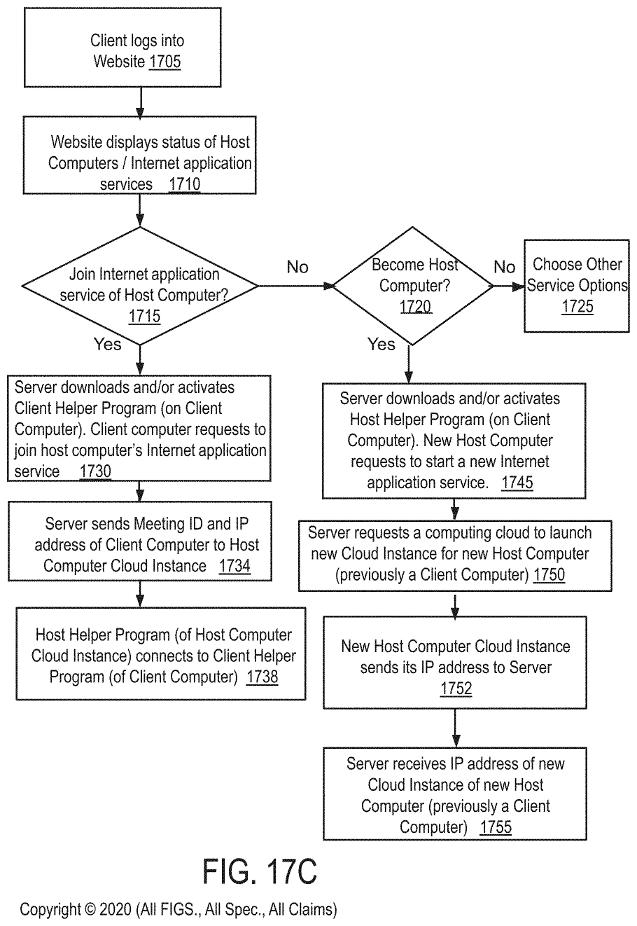

FIG. 17A presents a flowchart of a process performed by a client computer 215 to provide a direct network connection using cloud instance for Internet application service with a host computer 205 on a private network in accordance with an embodiment of the present invention. The process illustrated in FIG. 17A is adapted from FIG. 13A. Since the host computer 205 is in a private network communicating with the public Internet network 200 through the host computer cloud instance 205-C, when the client helper program 216-2 downloads 1735 the IP address of the host computer cloud instance 205-C, a unique meeting ID is also downloaded. As explained above, when client computer 215 sends data to the host computer cloud instance 205-C, it may designate the data as corresponding to the unique meeting ID, allowing the host computer cloud instance 205-C, using a look-up table, to differentiate the data as for the appropriate Internet application service (running inside the host computer cloud instance 205-C) of the host computer 205.

A host computer cloud instance 205-C may reside on a private network (e.g., an internal network for a company or organization) for security reasons, and have additional benefit of saving one public IP address for each host computer cloud instance 205-C residing on a private network. The Internet Assigned Numbers Authority (“IANA”) allocates a designated set of IP addresses for private networks, and routers on the Internet are configured to discard any data packets associated with IP addresses from that designated set. Private networks typically include a computer network security barrier, commonly called a “firewall.” to prevent unauthorized intrusion into the private network. As such, the IP address of a host computer cloud instance 205-C on a private network is not unique (i.e., other computers on private networks elsewhere globally may have the same IP address) and not accessible from the public Internet.

It is noted that the IP address of the client computer 215 may be sent to the host computer 205 and/or the host computer cloud instance 205-C using indirect connection 225, 230, or indirect connection 227, 230 (instead of using direct network connection 748, 750 in FIG. 14A) in further embodiments of the current invention.

In an embodiment of the current invention illustrated in FIG. 17B, which FIG. 17B is similar to FIG. 17A, but in FIG. 17B the server 222A sends 1733 (using indirect connection 225, 230 in FIG. 14A) the IP address of the client computer 215 and the meeting ID to the host computer 205 and the host computer cloud instance 205-C, which are communicatively coupled to each other. The host helper program 216-1 (of the host computer cloud instance 205-C) then connects 1738 to the client helper program 216-2 (of the client computer 215). Direct data exchange 1590 (in FIG. 15B can then occur, using direct network connection 748, 750 in FIG. 14A, between the client computer 215 and the host computer cloud instance 205-C, and without going through the server 222A. The host computer 205 (in FIG. 14B) is not needed for direct data exchange 1590 (in FIG. 15B).

In another embodiment of the current invention illustrated in FIG. 17C, which FIG. 17C is similar to FIG. 17A, but in FIG. 17C the server 222A sends 1734 (using indirect connection 227, 230 in FIG. 14A) the IP address of the client computer 215 and the meeting ID to the host computer cloud instance 205-C, which may be (but not required in FIGS. 14B and 17C to be) communicatively coupled to the host computer 205. The host helper program 216-1 (of the host computer cloud instance 205-C) then connects 1738 to the client helper program 216-2 (of the client computer 215). Direct data exchange 1590 (in FIG. 15C can then occur, using direct network connection 748 in FIG. 14B, between client computer 215 and host computer cloud instance 205-C, and without going through the server 222A. The host computer 205 (in FIG. 14B) is not needed for direct data exchange 1590 (in FIG. 15C).

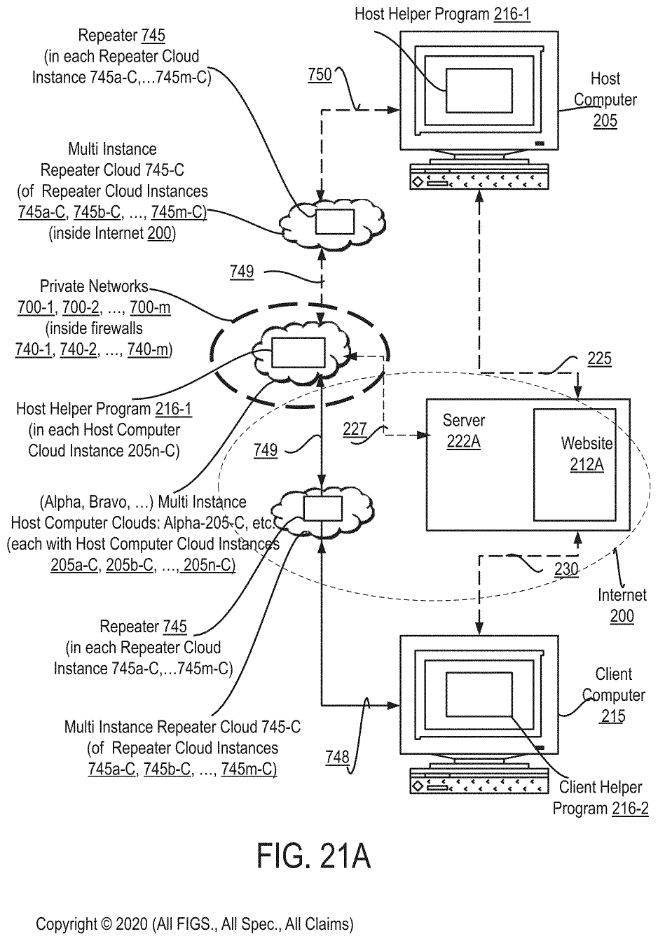

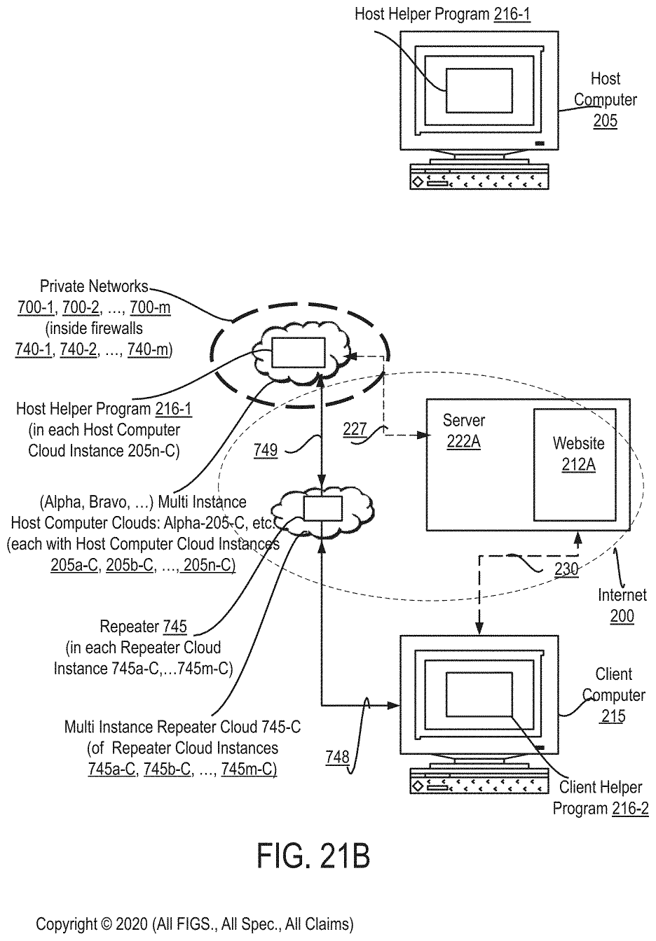

Referring to FIG. 21A, FIG. 21A illustrates a direct network connection using cloud instance, in accordance with one embodiment of the present invention, suitable for providing a direct network connection when one of the networked (bank of one-or-more) cloud instances (e.g. in a multi-instance-cloud or multi-tenant-cloud) does not have a unique, publicly accessible IP address. The embodiment depicted in FIG. 21A includes a host computer 205, a client computer 215, a server 222A hosting a website 212A, a firewall 740 (not shown), and a (bank of one-or-more) host computer cloud instance 205n-C (in private network 702, not shown). The (bank(s) of host-computer-cloud-instances Alpha-205-C, etc., each-(bank-of-cloud-instances) with (not-less-than-one) host-computer-cloud-instances 205a-C, 205b-C . . . 205n-C). The host computer cloud instance 205n-C is connected to the Internet 200 through a private network (not shown). The private network (not shown) is protected by a firewall (not shown). Thus, the host computer cloud instance 205n-C and the client computer 215 are both connected to the Internet 200, but are separated by the firewall (not shown).

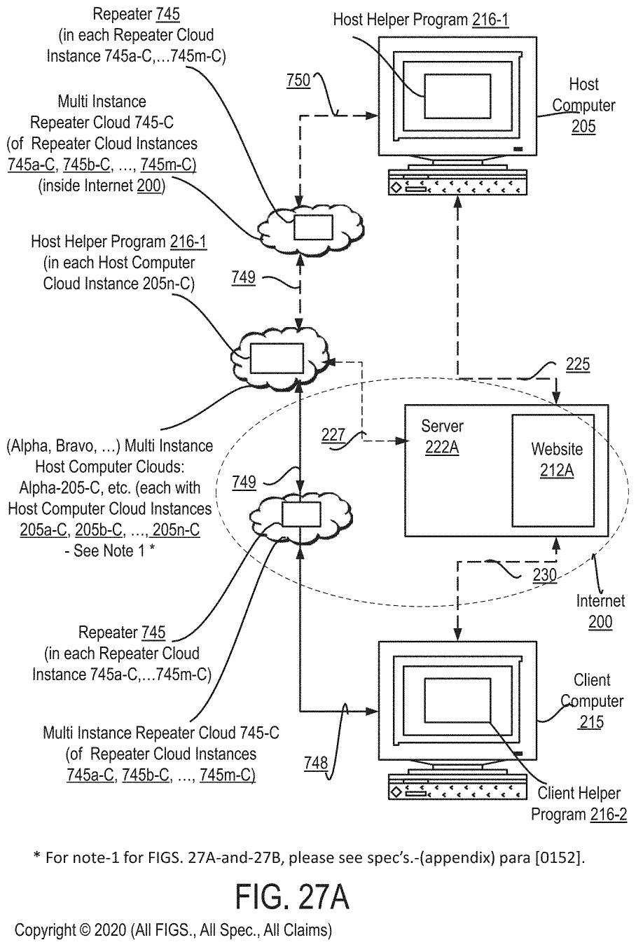

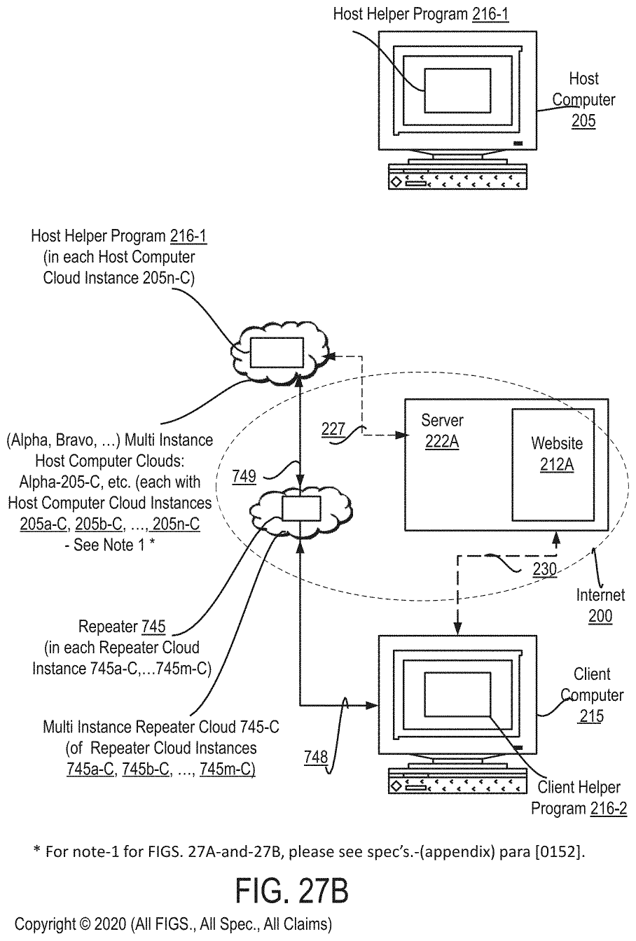

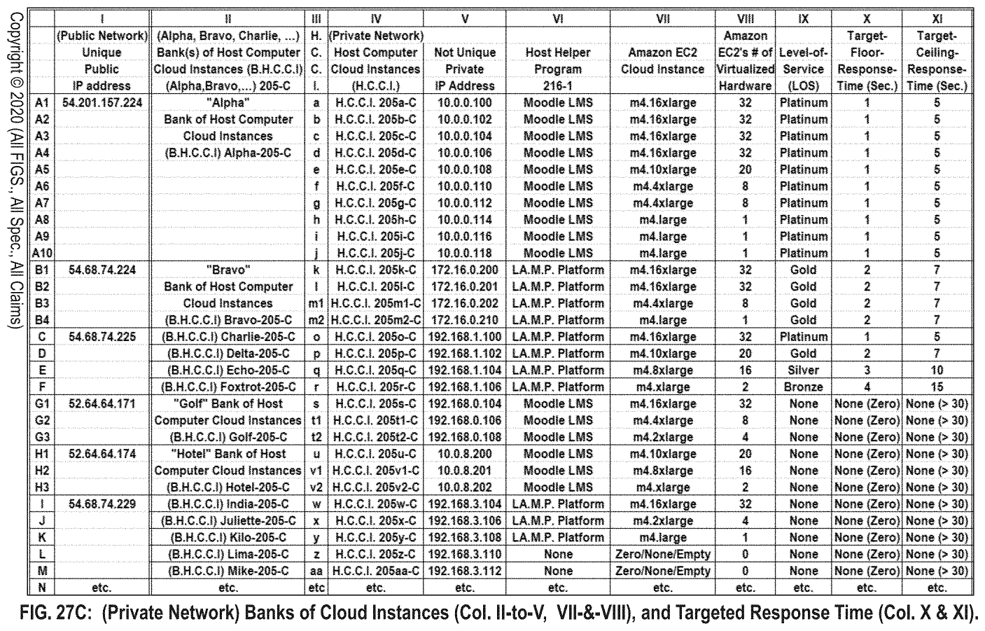

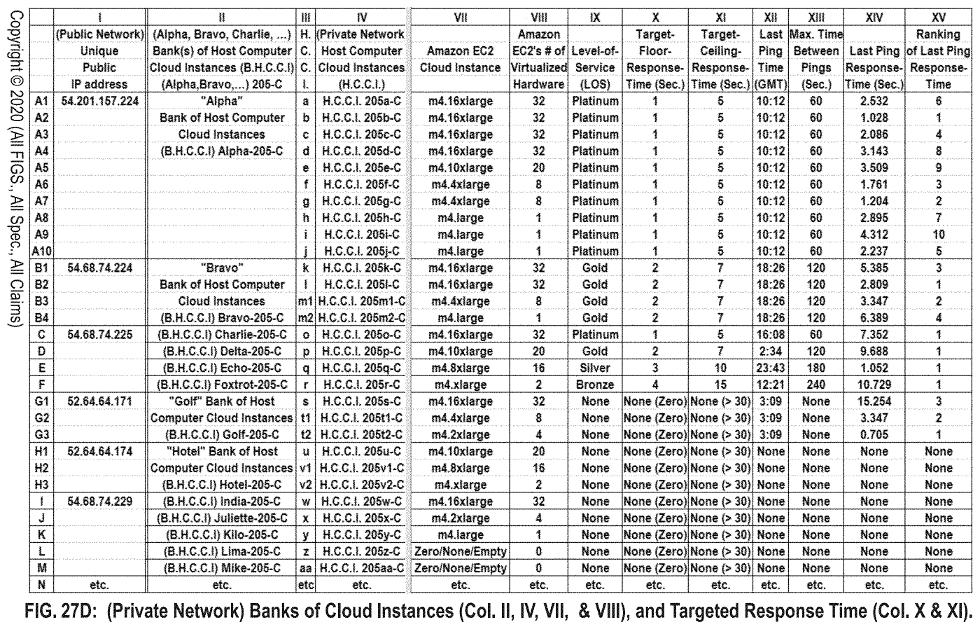

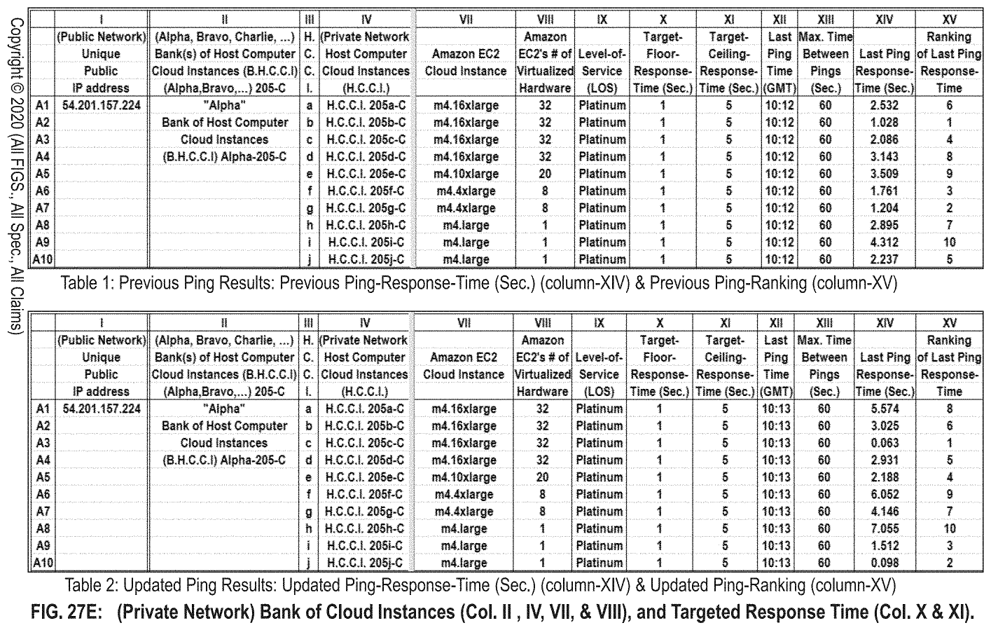

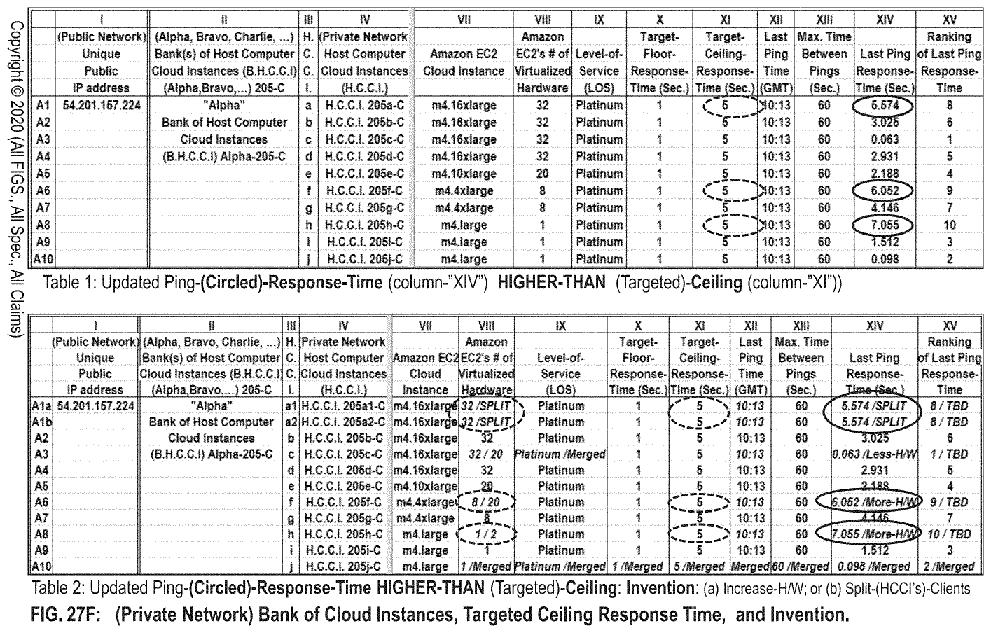

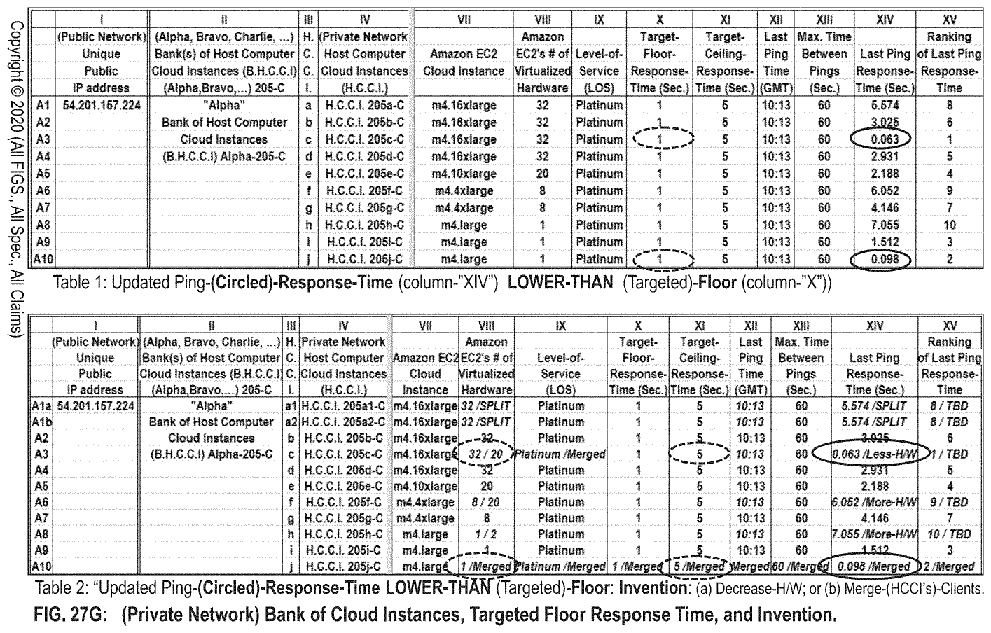

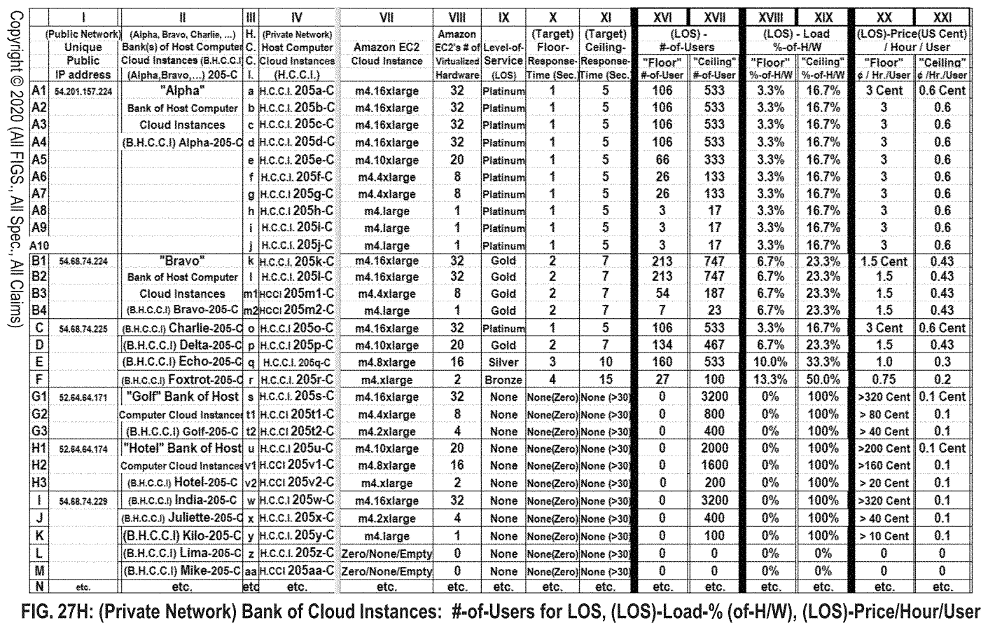

In one embodiment, the direct network connection using (bank of one-or-more) cloud instance 205n-C depicted in FIG. 21A functions largely as the direct network connection using (bank of one-or-more) cloud instance 205-C described above in reference to FIG. 14A, with a few modifications. Specifically, a repeater 745 or a repeater cloud instance 745m-C is added which has a unique, publicly accessible IP address. The repeater 745 or a repeater cloud instance 745m-C may be provided by a vendor (e.g. computing cloud vendor) providing Internet application services using the server 222A. The (bank of one-or-more) host computer cloud instance 205n-C may be able to access the repeater 745 or a repeater cloud instance 745m-C and form a network connection 749 (in FIG. 21A). Thus, the repeater 745 or the repeater cloud instance 745m-C provides a unique, publicly accessible IP address (for the (bank of one-or-more) host computer cloud instance 205n-C on private network (not shown)) by which a client computer 215 outside of the private network (not shown) may join the Internet application service of the host computer 205 via direct network connections 748, 749, 750 using the host-computer-cloud-instance 205n-C (i.e. one of host-computer-cloud-instances-(H.C.C.I.): 205a-C, 205b-C . . . , etc.) (in a bank of host-computer-cloud-instances, e.g. Alpha-205-C, Bravo-205-C, . . . etc. illustrated in FIGS. 21A, 27A, 27B, 27C, and 27D), and the repeater 745 or the repeater cloud instance 745m-C.

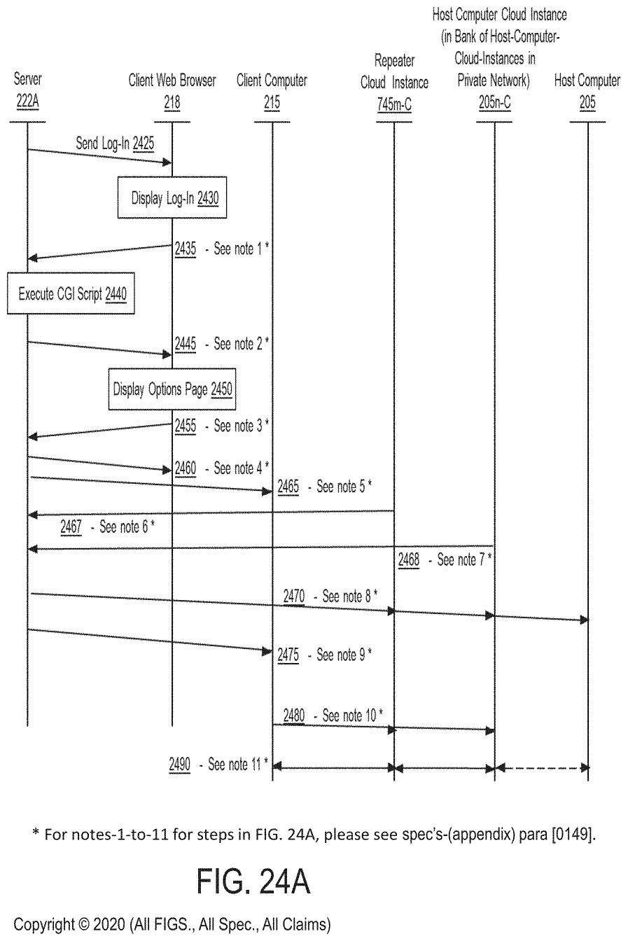

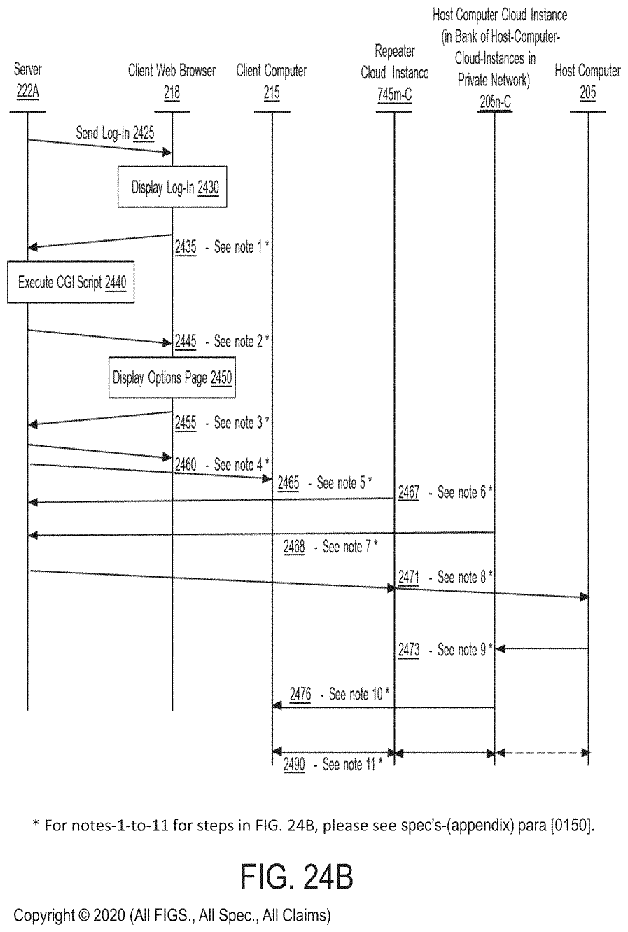

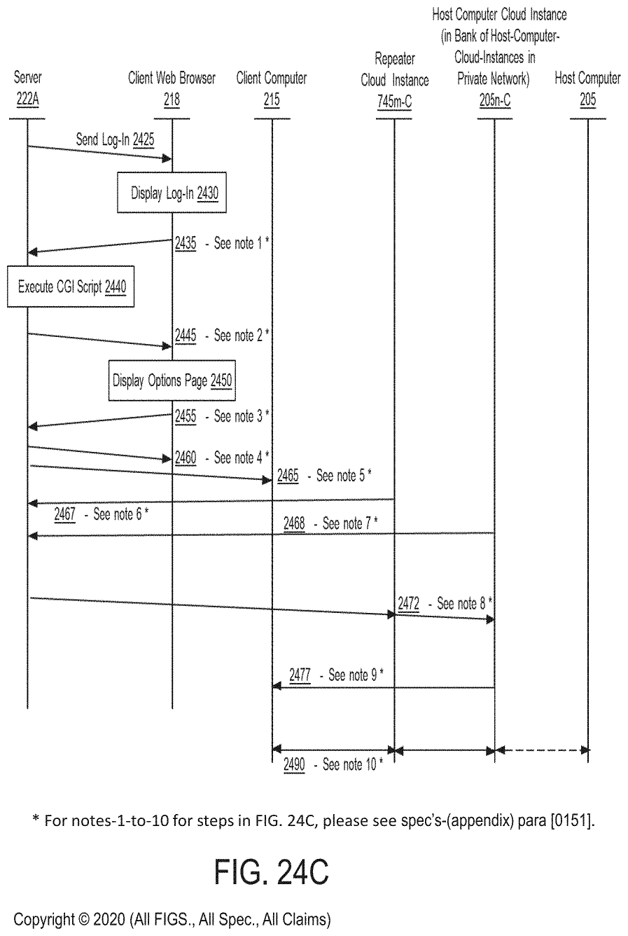

In one embodiment, when the host computer 205 accesses the website 212A to request starting a new Internet application service, the server 222A requests a computing cloud 198 (in FIGS. 9A-to-9B) to launch-or-assign the host computer cloud instance 205-C, which computing cloud 198 chooses to do it in private network (not shown). The (bank of one-or-more) host computer cloud instance 205-C (in private network) is communicatively coupled to the host computer 205, using the repeater 745 or the repeater cloud instance 745m-C. When a client computer 215 subsequently accesses the website 212A and selects to join the Internet application service of the host computer 205, the server 222A sends to the client computer 215 the public IP address of the repeater 745 or of the repeater cloud instance 745m-C, and the private IP address of the (bank of one-or-more) host computer cloud instance 205n-C (in private network) via a network connection 230. Once the client computer 215 has the public IP address of the repeater cloud instance 745m-C and the private IP address of the host computer cloud instance 205n-C, it may send data to the host computer cloud instance 205n-C (in private network) via direct network connections 748, 749. Moreover, the client computer 215 sends to the host computer cloud instance 205n-C the IP address of the client computer 215 itself through the direct network connections 748, 749. In other words, while the IP address of host computer cloud instance 205n-C is sent to the client computer 215 through the server 222A via the indirect connections 225, 230, the IP address of the client computer 215 is sent to the host computer cloud instance 205n-C via the direct connections 748, 749. Thus, the client computer 215 and the host computer cloud instance 205n-C are able to obtain one another's IP addresses and create direct network connections 748, 749. From this point onwards, the server 222A is not involved in communicating data between host computer cloud instance 205n-C (in private network) and client computer 215, and subsequent data exchange between the (bank of one-or-more) host computer cloud instance 205n-C and the client computer 215 takes place via the direct network connection 748, 749, and the host computer 205 is not needed for the data exchange. For the purpose of clarity, further details of a process for establishing a direct network connection using (bank of one-or-more) host computer cloud instance 205n-C on a private network are provided below with reference to FIGS. 24A. 25, and 26A.

Important note: Host computer cloud instance 205-C (and/or host computer cloud instance 205n-C) may interchangeably-(in-many-places) use either 205-C and/or 205n-C (as generic-notations) to denote the (bank of one-or-more) host computer cloud instance (to allow easier/simpler-reading of the specification-and-FIGS in different contexts through-out this patent application). For example: 205-C in FIGS. 9A and 9B may use 205n-C instead (of using 205-C), etc.

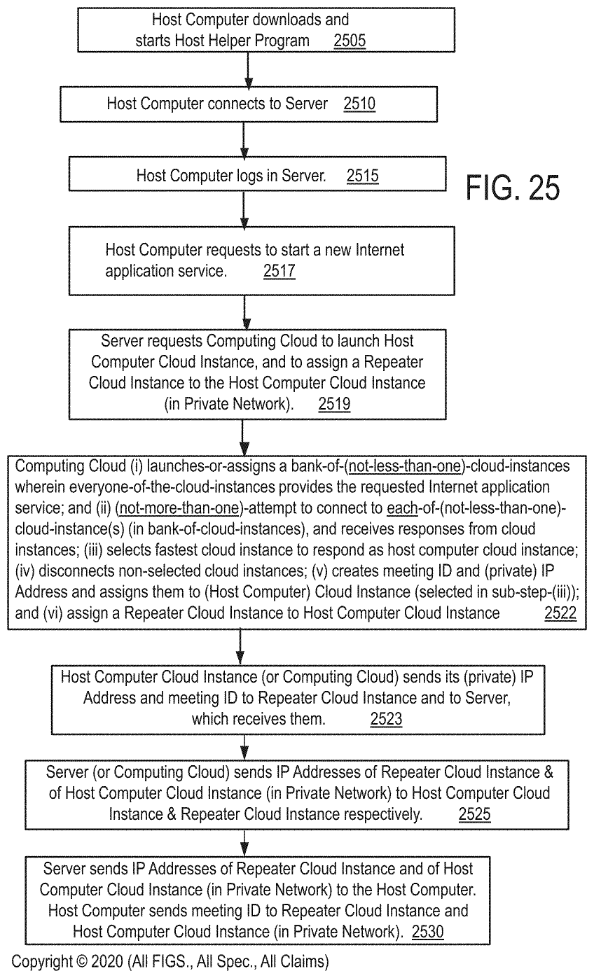

In some embodiments, the direct network connection using cloud instance architectures depicted by FIG. 9A, FIG. 25C, FIG. 14A, and FIG. 21A are adapted using the above-described techniques to provide Internet application services for multiple (bank of one-or-more) host computers cloud instances 205n-C on private networks, and/or in bank(s) of host-computer-cloud-instances Alpha-205-C. Bravo-205-C, . . . , etc., as illustrated in the two tables of FIGS. 27C and 27D. In such embodiments, the repeater 745 or repeater cloud instance 745m-C may need to distinguish between multiple (bank of one-or-more) host computer cloud instances 205n-C to ensure that data is transmitted only to one or more proper destinations.

The server 222A (and/or the computing cloud 198) may send to the client computer 215 a unique meeting ID, the public IP address of the repeater 745 or of the repeater cloud instance 745m-C, and the private IP address of the host computer cloud instance 205n-C (in bank of host-computer-cloud-instances and in private network). The client computer 215 may then send to the repeater 745 or of the repeater cloud instance 745m-C the unique meeting ID along with the IP address of the client computer 215. In one embodiment, the server 222A also sends the unique meeting ID to the host computer 205, which in turn sends it to the host computer cloud instance 205n-C, and the repeater 745 or of the repeater cloud instance 745m-C. The repeater 745 or of the repeater cloud instance 745m-C may store both the unique meeting ID and the associated (private) IP address of the host computer cloud instance 205-C in a look-up table. Thus, when a client computer 215 sends data to a host computer cloud instance 205n-C (in a bank of host-computer-cloud-instances, e.g. Alpha-205-C, Bravo-205-C, . . . etc. illustrated in FIGS. 21A, 27B, 27C, and 27D) via the direct network connections 748, 749 using the repeater 745 or the repeater cloud instance 745m-C, as illustrated in FIG. 21A, it may designate the data as corresponding to the particular meeting ID, allowing the repeater 745 or the repeater cloud instance 745m-C, using the look-up table, to transmit the data to the appropriate host computer cloud instance 205n-C (in a bank of host-computer-cloud-instances, e.g. Alpha-205-C. Bravo-205-C . . . etc. illustrated in FIGS. 21A, 27B, 27C, and 27D).

FIG. 21A is adapted from FIG. 14A and illustrates a direct network connection using (bank of one-or-more) host computer cloud instance 205-C (in a private network) for Internet application service between a client computer 215 and a host computer 205, in accordance with one embodiment of the present invention.

Referring now to FIG. 24A, a process is illustrated for providing a direct network connection using cloud instance (on a private network in a bank of host-computer-cloud-instances, e.g. Alpha-205-C. Bravo-205-C, . . . etc. illustrated in FIGS. 21A, 27B, 27C, and 27D) for Internet application service between a client computer 215 and a host computer 205 in accordance with one embodiment of the present invention. The process illustrated in FIG. 24A is adapted from FIG. 15A. Specifically, the event diagram of FIG. 24A corresponds to a direct network connection using cloud instance (in a bank of host-computer-cloud-instances, e.g. Alpha-205-C, Bravo-205-C, . . . etc. illustrated in FIGS. 21A, 27B, 27C, and 27D) for Internet application service with a host computer 205. When a host computer cloud instance 205n-C is on a private network, a unique meeting ID is assigned and sent 2470 by the server 222A to the repeater cloud instance 745m-C, the host computer cloud instance 205n-C, and the host computer 205. The unique meeting ID is also downloaded 2475 from the server 222A by the client computer 215 along with the public IP address of the repeater cloud instance 745m-C and the private IP address of the host computer cloud instance 205n-C. Then, the IP address of the client computer 215 and the meeting ID are sent 2480 by the client computer 215 to the repeater cloud instance 745m-C and the host computer cloud instance 205n-C, which is communicatively coupled to the host computer 205. From this point onwards, data may be exchanged 2490 between the client computer 215 and the host computer cloud instance 205n-C (using the repeater cloud instance 745m-C) via the direct network connections 748, 749 (in FIG. 21A), and the host computer 205 is not needed for the data exchange 2490. As explained above, when client computer 215 sends data to the host computer cloud instance 205n-C, it may designate the data as corresponding to the particular meeting ID, allowing the repeater cloud instance 745m-C, using the look-up table described above, to transmit the data to the appropriate host computer cloud instance 205n-C.

Please note: data exchange 2490 (in FIG. 24A) and FIG. 21B illustrate that after the Internet application service is started 2519 (in FIG. 25), and after the server 222A receives 2523 (in FIG. 25) the IP address of the host computer cloud instance 205n-C, the host computer 205 is not needed to be communicatively linked 750 with the repeater cloud instance 745m-C (or linked 749 with the host computer cloud instance 205n-C) or linked 225 with the server 222A respectively (for the client computer 215 to use the Internet application service of the host computer cloud instance 205n-C). Please further note: communication links 225, 750 appear in FIG. 21A, and do not appear in FIG. 21B.

Thus, in accordance with an embodiment of the present invention, FIGS. 21A, 21B, 24A, and 25 above illustrate creating direct network connections for Internet application service between the client computer 215 and the host computer cloud instance 205n-C (in a bank of host-computer-cloud-instances, e.g. Alpha-205-C. Bravo-205-C, . . . etc. illustrated in FIGS. 21A, 21B, 27C, and 27D) via the Internet (including how to (request to) start the host computer cloud instance 205n-C).

It is noted that the IP address of the client computer 215 may be sent to the host computer 205 and/or the host computer cloud instance 205n-C using indirect connection 225, 230, or indirect connection 227, 230 (instead of using direct network connection 748, 749, 750 in FIG. 21A) in further embodiments of the current invention.

In an embodiment of the current invention illustrated in FIG. 24B, which FIG. 24B is similar to FIG. 24A, but in FIG. 24B the server 222A sends 2471 (using indirect connection 225, 230 in FIG. 21A) the IP address of the client computer 215 and meeting ID to the host computer 205, which is communicatively coupled to the host computer cloud instance 205n-C. The host computer cloud instance 205n-C therefore also gets 2473 the IP address of the client computer 215 and meeting ID. The host computer cloud instance 205n-C then (using repeater cloud instance 745m-C) sends 2476 its IP address and the meeting ID to client computer 215. Direct data exchange 2490 (using repeater cloud instance 745m-C) can then occur, using direct network connection 748, 749 in FIG. 24B, between client computer 215 and host computer cloud instance 205n-C (in a bank of host-computer-cloud-instances, e.g. Alpha-205-C, Bravo-205-C, . . . etc. illustrated in FIGS. 21A, 21B, 27C, and 27D), and without going through the server 222A. The host computer 205 (in FIG. 24B) is not needed for direct data exchange 2490 in FIG. 24B (which uses direct network connection 748, 749 in FIG. 21B).

In another embodiment of the current invention illustrated in FIG. 24C, which FIG. 24C is similar to FIG. 24A, but in FIG. 24C the server 222A sends 2472 (using indirect connection 227, 230 in FIG. 21A) the IP address of the client computer 215 and meeting ID to the host computer cloud instance 205n-C, which may be (but not required in FIGS. 21B and 24C to be) communicatively coupled to the host computer 205. The host computer cloud instance 205n-C then sends 2477 its IP address and the meeting ID to client computer 215. Direct data exchange 2490 can then occur, using direct network connection 748, 749 in FIG. 21B, between client computer 215 and host computer cloud instance 205n-C, and without going through the server 222A. The host computer 205 (in FIG. 21B) is not needed for direct data exchange 2490 in FIG. 24C (which uses direct network connection 748, 749 in FIG. 21B).

FIG. 25 is adapted from FIG. 32 and presents a flowchart of a process performed by a host computer 205 to provide direct network connections using cloud instance (in a bank of host-computer-cloud-instances, e.g. Alpha-205-C, Bravo-205-C, . . . etc.) illustrated in FIGS. 21A, 21B, 27C, and 27D for Internet application service between computers over a computer network in accordance with an embodiment of the present invention. First, the host computer 205 downloads and starts 2505 the host helper program 216-1. In one embodiment, the host helper program 216-1 is the Moodle learning management system (running on Linux-Apache-MySQL-PHP (L.A.M.P. platform) solution stack) Internet application (from the Australian company Moodle Pty Ltd.). The host computer 205 then connects 2510 to the server 222A. The host computer 205 logs in 2515 to the server 222A. This allows a website 212A hosted by the server 222A to accurately reflect the status of the host computer 205 on an options page 305 (in FIG. 3).

The host computer 205 requests 2517 the server 222A to start a new Internet application service. The server 222A requests 2519 the computing cloud 198 to launch-or-assign a host computer cloud instance 205n-C (in a bank-of-(not-less-than-one)-cloud-instances, e.g. Alpha-205-C) illustrated in FIGS. 21A, 21B, 27C, and 27D), and to assign a repeater cloud instance 745m-C to the host computer cloud instance 205n-C (in private network). The repeater cloud instance 745m-C provides a public IP address for the host computer cloud instance 205n-C (in private network) so that the latter can be accessed from the Internet 200.

The computing cloud 198 in step 2522 (of FIG. 25):

(i) (The computing cloud 198) launches-or-assigns a bank-of-(not-less-than-one)-cloud-instance (e.g. Alpha-205-C illustrated in FIGS. 21A, 21B, 27C, and 27D) wherein everyone-of-the-cloud-instances-(in-the-bank) provides the requested Internet application service; and
(ii) (The computing cloud 198) attempts to connect-to (or ping) (in FIG. 19A's step-1932) any available cloud-instance (in the bank-of-cloud-instances in sub-step-(i)), and receives responses (in FIG. 19A's step-1932) from the cloud instances; and
(iii) (The computing cloud 198) selects the fastest cloud instance to respond (in FIG. 19A's step-1942) as the host computer cloud instance 205n-C (in FIGS. 27A and 27B); and
(iv) (The computing cloud 198) disconnects all non-selected cloud instances (in the bank-of-cloud-instances in sub-step-(i)); and
(v) (The computing cloud 198) creates the meeting ID and (private) IP address of the host computer cloud instance 205n-C and assigns it to the host computer cloud instance 205n-C (selected in sub-step-(iii)); and
(vi) sends 2523 this meeting ID and (private) IP address of host computer cloud instance 205n-C (in FIGS. 24A, 24B, and 24C, which I.P. address is (implicitly)-requested by the server 222A in step-2519 to the server 222A.

The server 222A in step 2523 receives, and stores the meeting ID and (private) IP address of the host computer cloud instance 205n-C. Server 222A in step 2525 (or computing cloud 198) sends IP addresses of repeater cloud instance 745m-C & of host computer cloud instance 205n-C (in private network) to host computer cloud instance 205n-C & repeater cloud instance 745m-C respectively.

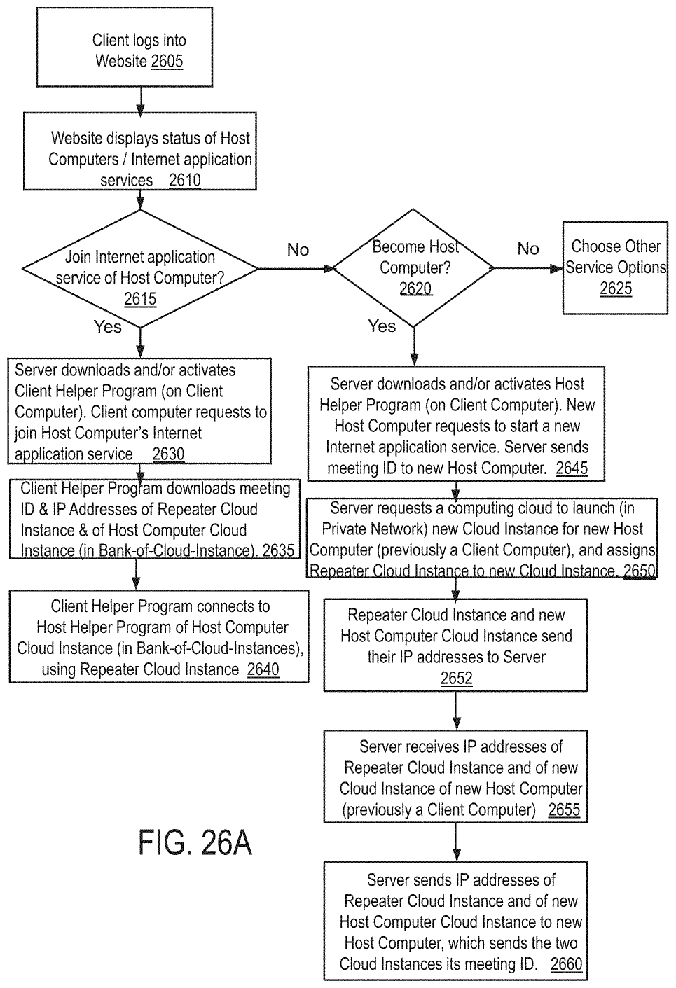

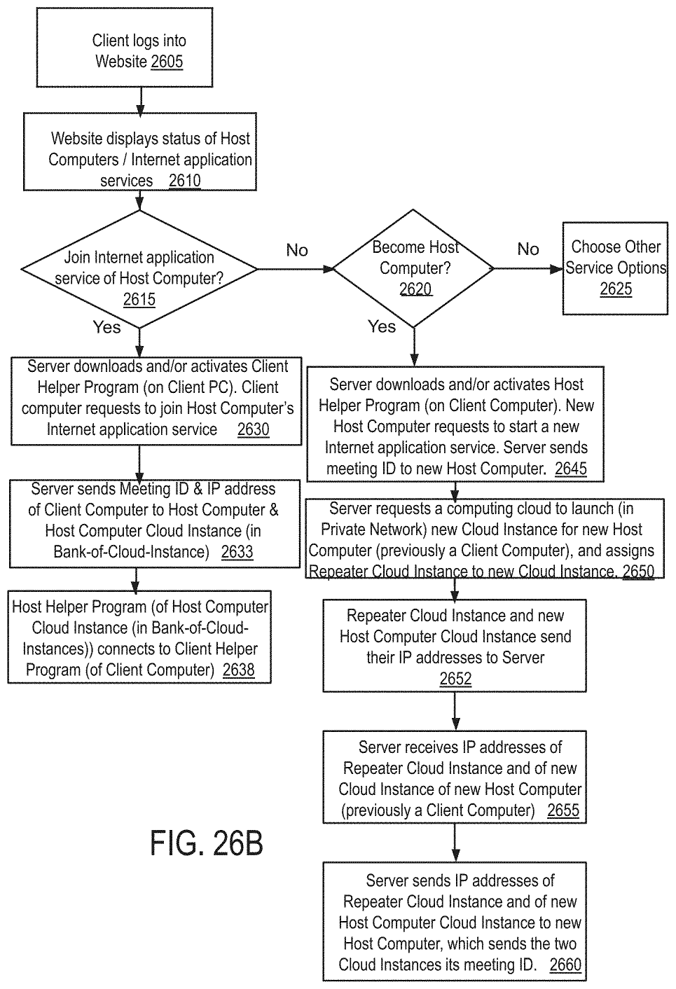

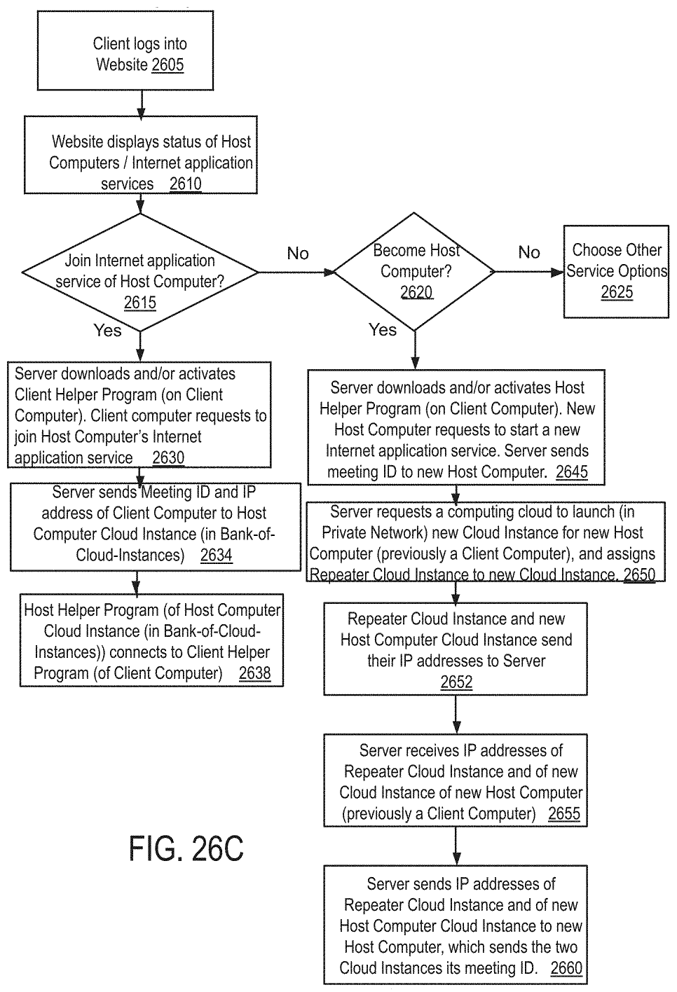

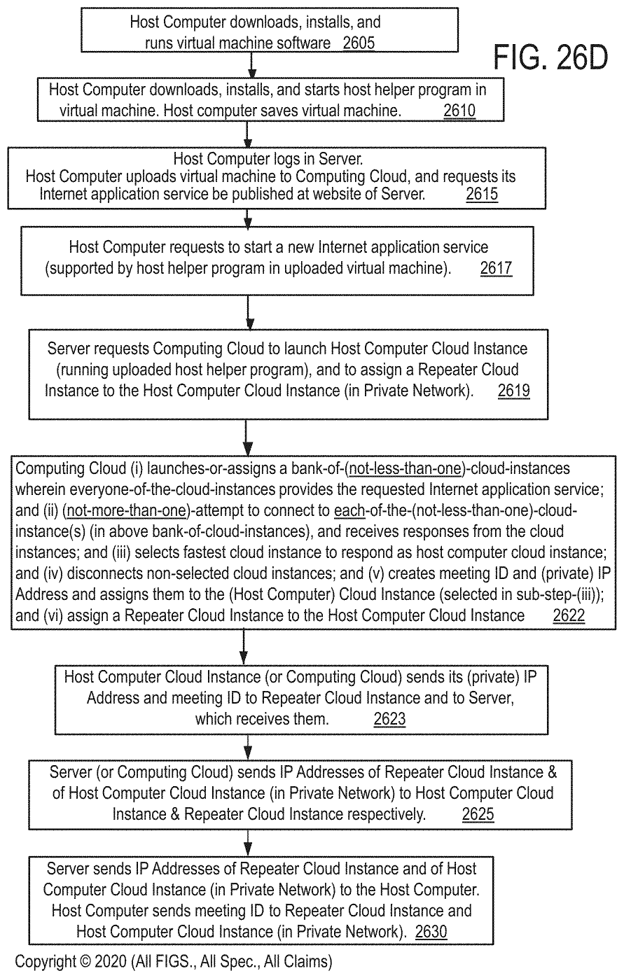

FIG. 26A is adapted from FIG. 17A and presents a flowchart of a process performed by a client computer 215 to provide a direct network connection using host computer cloud instance 205n-C (in a bank of host-computer-cloud-instances, e.g. Alpha-205-C, Bravo-205-C, . . . etc. illustrated in FIGS. 21A, 21B, 27C, and 27D) for Internet application service with a host computer 205 in accordance with an embodiment of the present invention. Since the host computer cloud instance 205n-C is in a private network communicating with the public Internet network 200 through the repeater cloud instance 745m-C, when the client helper program 216-2 downloads 2635 the public IP address of repeater cloud instance 745m-C and private IP address of the host computer cloud instance 205n-C (in private network in FIG. 21A), a unique meeting ID is also downloaded. As explained above, when client computer 215 sends data to a host computer cloud instance 205n-C, it may designate the data as corresponding to the unique meeting ID, allowing the repeater cloud instance 745m-C, using a look-up table, to differentiate the data as for the appropriate Internet application service (running inside the host computer cloud instance 205n-C) of the host computer 205.

It is noted that the IP address of the client computer 215 may be sent to the host computer 205 and/or the host computer cloud instance 205-C using indirect connection 225, 230, or indirect connection 227, 230 (instead of using direct network connection 748, 749, 750 in FIG. 21A) in further embodiments of the current invention.

In an embodiment of the current invention illustrated in FIG. 26B, Which FIG. 26B is similar to FIG. 26A, but in FIG. 26B the server 222A sends 2633 (using indirect connection 225, 230 in FIG. 21A) the IP address of the client computer 215 and the meeting ID to the host computer 205 and the host computer cloud instance 205n-C (in a bank of host-computer-cloud-instances, e.g. Alpha-205-C, illustrated in FIGS. 21A, 21B, 27C, and 27D), which are communicatively coupled to each other. The host helper program 216-1 (of the host computer cloud instance 205n-C) then (using repeater cloud instance 745m-C) connects 2638 to the client helper program 216-2 (of the client computer 215). Direct data exchange (step-2490 in FIG. 24B) can then occur, using (repeater cloud instance 745m-C and) direct network connection 748, 749 in FIG. 21B, between the client computer 215 and the host computer cloud instance 205n-C (in a bank of host-computer-cloud-instances, e.g. Alpha-205-C, illustrated in FIGS. 21A, 21B, 27C, and 27D), and without going through the server 222A. The host computer 205 (in FIG. 21B) is not needed for direct data exchange 2490 in FIG. 24B (which uses direct network connection 748, 749 in FIG. 21B).

In another embodiment of the current invention illustrated in FIG. 26C, which FIG. 26C is similar to FIG. 26A, but in FIG. 26C the server 222A sends 2634 (using indirect connection 227, 230 in FIG. 21A) the IP address of the client computer 215 and the meeting ID to the host computer cloud instance 205n-C (in a bank of host-computer-cloud-instances, e.g. Alpha-205-C, illustrated in FIGS. 21A, 21B, 27C, and 27D), which may be (but not required in FIGS. 21B and 26C to be) communicatively coupled to the host computer 205. The host helper program 216-1 (of the host computer cloud instance 205n-C) then (using repeater cloud instance 745m-C) connects 2638 to the client helper program 216-2 (of the client computer 215). Direct data exchange (2490 in FIG. 24C) can then occur, using (repeater cloud instance 745m-C and) direct network connection 748, 749 in FIG. 21B, between client computer 215 and host computer cloud instance 205n-C (in a bank of host-computer-cloud-instances, e.g. Alpha-205-C, illustrated in FIGS. 21A, 21B, 27C, and 27D), and without going through the server 222A. The host computer 205 (in FIG. 21B) is not needed for direct data exchange 2490 in FIG. 24C.

FIG. 26D is edited from FIG. 25 to include downloading, installing, and running virtual machine software (for host helper program) in steps 2605-to-2619. FIG. 26D presents a flowchart of a process performed by a host computer 205 to provide direct network connections using cloud instance (in a bank of host-computer-cloud-instances, e.g. Alpha-205-C) illustrated in FIGS. 21A, 21B, 27C, and 27D for Internet application service between computers over a computer network in accordance with an embodiment of the present invention. First, the host computer 205 downloads 2605, installs, and runs virtual machine software (e.g. the popular virtual machine software from VMWare, Inc.) on it. Then the host computer 205 downloads and starts 10A the host helper program 216-1 in its installed virtual machine, and saves the virtual machine (with its installed host helper program 216-1). In one embodiment, the host helper program 216-1 is the Moodle learning management system (running on Linux-Apache-MySQL-PHP (on L.A.M.P. platform) solution stack) Internet application (from the Australian company Moodle Pty Ltd.). The host computer 205 then connects to the server 222A. The host computer 205 logs in 2615 to the server 222A. This allows a website 212A hosted by the server 222A to accurately reflect the status of the host computer 205 on an options page 305 (in FIG. 3).

The host computer 205 (in FIG. 26D) uploads 2615 its (saved) virtual machine to a computing cloud 198 (in FIG. 14A). The host computer 205 requests 2617 the server 222A to start a new Internet application service (to be provided/supported by the host helper program 216-1 in the uploaded virtual machine earlier), and the server 222A requests the computing cloud 198 to launch-or-assign a host computer cloud instance 205n-C (in FIGS. 27A and 27B, and running the uploaded host helper program 216-1). The server 222A requests 2619 the computing cloud 198 to launch-or-assign a host computer cloud instance 205n-C (in a bank-of-(not-less-than-one)-cloud-instances, e.g. Alpha-205-C, Bravo-205-C, . . . etc. illustrated in FIGS. 21A, 21B, 27C, and 27D).

The computing cloud 198 in step 2622 (of FIG. 26D):

(i) (The computing cloud 198) launches-or-assigns a bank-of-(not-less-than-one)-cloud-instance (e.g. Alpha-205-C illustrated in FIGS. 21A, 21B, 27C, and 27D) wherein everyone-of-the-cloud-instances-(in-the-bank) provides the requested Internet application service; and
(ii) (The computing cloud 198) attempts to connect-to (or ping) (in FIG. 19A's step-1932) any available cloud-instance (in the bank-of-cloud-instances in sub-step-(i)), and receives responses (in FIG. 19A's step-1932) from the cloud instances; and
(iii) (The computing cloud 198) selects the fastest cloud instance to respond (in FIG. 19A's step-1942) as the host computer cloud instance 205n-C (in FIGS. 24A and 27B); and
(iv) (The computing cloud 198) disconnects all non-selected cloud instances (in the bank-of-cloud-instances in sub-step-(i)); and
(v) (The computing cloud 198) creates the meeting ID and (private) IP address of the host computer cloud instance 205n-C and assigns it to the host computer cloud instance 205n-C (selected in sub-step-(iii)); and
(vi) sends 2623 this meeting ID and (private) IP address of host computer cloud instance 205n-C (in FIGS. 24A, 24B, and 24C, which I.P. address is (implicitly)-requested by the server 222A in step-2619 to the server 222A.

The server 222A in step 2623 receives, and stores the meeting ID and (private) IP address of the host computer cloud instance 205n-C.

FIGS. 27A-to-27H (with host computer cloud instances 205-C using non-unique private-I.P.-addresses for private networks in “FIG. 27C's column-IV”) are edited from FIGS. 9A-to-9G (with host computer cloud instances 205-C using unique-public-I.P.-addresses for public network in “FIG. 9C's column-I”).

FIGS. 27A and 27B are block diagrams illustrating providing direct network connections using cloud instances (e.g. banks of host computer cloud instances 205a-C, 205b-C, . . . , 205n-C (in private networks (not shown)) for Internet application service between (one-or-more) client computer(s) 215 and a host computer 205 over a computer network, in accordance with an embodiment of the present invention.

FIGS. 27A and 27B also shows repeater cloud instance(s) 745a-C, . . . 745m-C connecting the banks-of-host-computer-cloud-instances (on private networks (not shown) to Internet 200.

FIG. 27B shows that the host computer 205 is not needed (to be connected-to-Internet-200) for Internet application service for the (one-or-more) client computer(s) 215 (after the service is setup in FIG. 27A).

FIGS. 27C, 27D, 27E, and 27F are tables illustrating examples of multi-instance computing cloud(s) 198, multiple banks of host computer cloud instances (e.g. Alpha-205-C, Bravo-205-C, Charlie-205-C, Delta-205-C, . . . , Mike-205-C), repeater cloud instance(s) (connecting-to-Internet-200 the banks-of-host-computer-cloud-instances on private network(s)), providing direct network connections using cloud instance for Internet application service over a computer network in accordance with an embodiment of the present invention.

FIGS. 27C-and-27D shows two tables illustrating features of “banks of cloud instances” (meaning “groups of cloud instances”) used to provide direct network connections using cloud instances (in the banks of cloud instances) for Internet application service over a computer network in accordance with an embodiment of the present invention.

A bank of cloud instances is a group of cloud instances, and may be implemented using software-and-database just like other cloud instances or other group(s) of cloud instances. The term “bank of cloud instances” (meaning “group of cloud instances”) allows easier understanding of how to work with one-or-more cloud-instances (offering the SAME-Internet-application-service of the SAME-host-computer-205) in this invention.

Please note that the individual cloud instances in the SAME bank-of-cloud-instances (meaning SAME “group-of-cloud-instances”) may be different (Amazon EC2) (virtualized-hardware)-cloud-instances (and have different # of (1X)-virtualized-hardware), as illustrated by FIG. 5's column-1, and by FIG.-27C's columns-“VII”-and-“VIII”.

FIGS. 27C-and-27D shows two tables illustrating examples of “banks of cloud instances” (meaning “groups of cloud instances” and implemented using software-and-database (not shown)) in following rows-of-the-two-tables:
(i) “Alpha” bank of ten (10) cloud-instances in row-“A”-and-columns-“I”-to “XI”-of-FIG-27C's-table, and in row-“A”-and-columns-“VII”-to-“XV”-of-FIG.-27D's-table; and
(ii) “Bravo” bank of four (4) cloud-instances in row-“B”-and-columns-“I”-to “XI”-of-FIG-27C's-table, and in row-“B”-and-columns-“VII”-to-“XV”-of-FIG.-27D's-table; and
(iii) “Charlie” bank of one (1) cloud-instance in row-“C”-and-columns-“I”-to “XI”-of-FIG-27C's-table, and in row-“C”-and-columns-“VII”-to-“XV”-of-FIG.-27D's-table; and
(iv) “Delta” bank of one (1) cloud-instance in row-“D”-and-columns-“I”-to “XI”-of-FIG-27C's-table, and in row-“D”-and-columns-“VII”-to-“XV”-of-FIG.-27D's-table; and
(v) “Echo” bank of one (1) cloud-instance in row-“E”-and-columns-“I”-to “XI”-of-FIG-27C's-table, and in row-“E”-and-columns-“VII”-to-“XV”-of-FIG.-27D's-table; and
(vi) “Foxtrot” bank of one (1) cloud-instance in row-“F”-and-columns-“I”-to “XI”-of-FIG-27C's-table, and in row-“F”-and-columns-“VII”-to-“XV”-of-FIG.-27D's-table; and
(vii) “Golf” bank of one (1) cloud-instance in row-“G”-and-columns-“I”-to “XI”-of-FIG-27C's-table, and in row-“G”-and-columns-“VII”-to-“XV”-of-FIG.-27D's-table; and (viii) etc.; and
(ix) “Mike” bank of four (4) cloud-instances in row-“I”-and-columns-“I”-to “XI”-of-FIG-27C's-table, and in row-“I”-and-columns-“VII”-to-“XV”-of-FIG.-27D's-table.
   Please note that the names for banks-of-cloud-instances: “Alpha”. “Bravo”, “Charlie”, . . . etc. are for easy references (and easier understanding) in this patent application and invention, and (the names) may not need to be implemented (in software-and-database).

The eleven (11) columns of FIG. 27C's table illustrating examples of “banks of cloud instances” (meaning “groups of cloud instances”) in the table's rows are: (i) Column-“I” (of FIG. 27C's table and of FIG. 27D's table) is (list of) “(Public Network) Unique Public IP address” (of the computing cloud 198 (or repeater 745m-C)) allowing the bank(s)-of-cloud-instance-(in-column-“II”-in FIGS. 27C-and-27D) (which cloud instances (in column-“IV”) may be on private networks (in FIG. 27C's column-“V”)) to access the Internet 200 (in FIG. 27A): e.g. Unique Public IP address: “54.201.157.224” (in row-“A”-and-column-“I”-of-FIG. 27C), 54.68.70.224, . . . etc.; and

(ii) Column-“II” (of FIG. 27C's table and of FIG. 27D's table) is (list of) “Bank(s) of Host Computer Cloud Instances (Alpha, Bravo . . . ) 205-C: e.g. “Alpha” Bank of Host Computer Cloud Instances Alpha-205-C (in row-“A”-and-column-“II”-of-FIG. 27C), etc.:
which list of banks-of-cloud-instances (meaning “groups-of-cloud-instances”) is summaried in Para [0125A]; and
   (iii) Column-“III” (of FIG. 27C's table and of FIG. 27D's table) is (list of) short-references to “Host Computer Cloud Instances (H.C.C.I.)”: e.g. a, b, c, d, e, f, g, h, i, j (in row-“A”-and-column-“III”-of-FIG. 27C), etc.; and
   (iv) Column-“IV” (of FIG. 27C's table and of FIG. 27D's table) is (list of names of) “Host Computer Cloud Instances (H.C.C.I.)”: e.g. H.C.C.I. 205a-C, H.C.C.I. 205b-C, H.C.C.I. 205c-C, . . . etc. (in row-“A”-and-column-“IV” of FIG. 27C and of FIG. 27D), etc.; and
   (v) Column-“V” (of FIG. 27C's table) is (list of) “(Private Network) Not Unique Private IP Address”: e.g. 10.0.0.100, 10.0.0.102, 10.0.0.104, . . . etc. (in row-“A”-and-column-“V”-of-FIG. 27C), . . . etc.; and
   (vi) Column-“VI” (of FIG. 27C's table) is (list of) “Host Helper Program 216-1” (software installed and running (to provide Internet application services) in Host Computer Cloud Instances (in column-“IV”): e.g. Moodle LMS. (in row-“A”-and-column-“VI”-of-FIG. 27C), L.A.M.P. Platform (in row-“B”-and-column-“VI”-of-FIG. 27C), . . . etc.; and
   (vii) Column-“VII” (of FIG. 27C's table) is (list of) “Amazon EC2 Cloud Instance” (used for Host Computer Cloud Instances (in column-“IV”): e.g. m4.16xlarge, m4.16xlarge, . . . m4.10xlarge, m4.4xlarge, . . . etc. (in row-“A”-and-column-“VII”-of-FIG. 27C), . . . etc.; and
   (viii) Column-“VIII” (of FIG. 27C's table) is (list of) “# of Virtualized (1X)-Hardware” (used for Host Computer Cloud Instances (in column-“IV”): e.g. 32, 32, 32, 32, 20, 8, 8, 1, 1, 1 (in row-“A”-and-column-“VII”-of-FIG. 27C); 32, 32, 8, 1; , . . . etc.; and
   (ix) Column-“IX” (of FIG. 27C's table) is (list of) “Level of Service (LOS)” (implemented for Host Computer Cloud Instances (in column-“IV”): e.g. Platinum, Platinum, Platinum, Platinum, Platinum, Platinum, Platinum, Platinum. Platinum, Platinum (in row-“A”-and-column-“IX”-of-FIG. 27C); Gold, Gold, Gold, Gold: . . . etc.
   (x) Column-“X” (of FIG. 27C's table) is (list of) “Targeted Floor-Response-Time (Sec.)” (implemented for Host Computer Cloud Instances (in column-“IV”): e.g. 1,1,1,1,1,1,1,1,1,1 (in row-“A”-and-column-“X”-of-FIG. 27C): 2,2,2,2: . . . etc.
   (xi) Column-“XI” (of FIG. 27C's table) is (list of) “Targeted Ceiling-Response-Time (Sec.)” (implemented for Host Computer Cloud Instances (in column-“IV”): e.g. 5,5,5,5,5,5,5,5,5,5 (in row-“A”-and-column-“XI”-of-FIG. 27C); 7,7,7,7; , . . . etc.

The thirteen (13) columns of FIG. 27D's table illustrating examples of “banks of cloud instances” (meaning “groups of cloud instances”) in the table's rows are:

(i) Columns-“I”-to-“IV” (of FIG. 27D's table) are same-as FIG. 27C's Columns-“f”-to-“IV”, which (FIG. 27C's Columns-“I”-to-“IV”) are described in Para [0125B] (i)-to-(iv) respectively; and
(ii) Column-“VII” (of FIG. 27D's table) is (list of) “Amazon EC2 Cloud Instance” (used for Host Computer Cloud Instances (in column-“IV”): e.g. m4.16xlarge, m4.16xlarge, . . . m4.10xlarge, m4.4xlarge, . . . etc. (in row-“A”-and-column-“VII”-of-FIG. 27D), . . . etc.; and
(iii) Column-“VIII” (of FIG. 27D's table) is “Amazon EC2's # of Virtualized (IX)-Hardware” (used for Host Computer Cloud Instances (in column-“IV”): e.g. 32, 32, 32, 32, 20, 8, 8, 1, 1, 1 (in row-“A”-and-column-“VIII”-of-FIG. 27D); 32, 32, 8, 1: , . . . etc.; and
(iv) Column-“IX” (of FIG. 27D's table) is “Level of Service (LOS)” (implemented for Host Computer Cloud Instances (in column-“IV”): e.g. Platinum. Platinum, Platinum, Platinum, Platinum, Platinum, Platinum, Platinum, Platinum, Platinum (in row-“A”-and-column-“IX”-of-FIG. 27D): Gold, Gold, Gold, Gold; , . . . etc.; and
(v) Column-“X” (of FIG. 27D's table) is “Target Floor Response Time (Sec.)” (for Host Computer Cloud Instances (in column-“IV”): e.g. 1, 1, 1, 1, 1, 1, 1, 1, 1, 1 (in row-“A”-and-column-“X”-of-FIG. 27D); 2, 2, 2, 2; , . . . etc.; and
(vi) Column-“XI” (of FIG. 27D's table) is “Target Ceiling Response Time (Sec.)” (for Host Computer Cloud Instances (in column-“IV”): e.g. 5, 5, 5, 5, 5, 5, 5, 5, 5, 5 (in row-“A”-and-column-“XI”-of-FIG. 27D); 7, 7, 7, 7; , . . . etc.; and
(vii) Column-“XII” (of FIG. 27D's table) is “Last Ping Time (GMT)” (for Host Computer Cloud Instances (in column-“W”): e.g. 10:12, 10:12, 10:12, 10:12, 10:12, 10:12, 10:12, 10:12, 10:12, 10:12 (in row-“A”-and-column-“XII”-of-FIG. 27D); 18:26, 18:26, 18:26, 18:26; . . . etc.; and
(viii) Column-“XIII” (of FIG. 27D's table) is “Max. Time Between Pings (Sec.)” (for Host Computer Cloud Instances (in column-“IV”): e.g. 60, 60, 60, 60, 60, 60, 60, 60, 60, 60 (in row-“A”-and-column-“XII”-of-FIG. 27D); 120, 120, 120, 120; , . . . etc.; and
(ix) Column-“XIV” (of FIG. 27D's table) is “Last Ping Response Time (Sec.)” (for Host Computer Cloud Instances (in column-“IV”): e.g. 2.532, 1.028, 2.086, 3.143, 3.509, 1.761, 1.204, 2.895, 4.312, 2.237 (in row-“A”-and-column-“XII”-of-FIG. 27D); 5.385, 2.809, 3.347, 6.389; , . . . etc.; and
(x) Column-“XV” (of FIG. 27D's table) is “Ranking of Last Ping Response Time” (for Host Computer Cloud Instances (in column-“V”): e.g. 6, 1, 4, 8, 9, 3, 2, 7, 10, 5 (in row-“A”-and-column-“XV”-of-FIG. 27D); 3, 1, 2, 4; , . . . etc.

FIG. 27E's Table-1's row-“A”-and-all-columns (are copied-from-and-identical to FIG. 27D's table's row-“A”-and-all-columns, and) illustrate “Previous-Ping-Results: Previous Ping-Response-Time (Sec.) (in column-XIV) & Previous Ping-Ranking (in column-XV):

(i) FIG. 27E's Table-1's column-“XII” shows that “Last Ping Time (GMT)) (in heading-of-column-“XII”) was at 10:12 GMT (Greenwich Mean Time) when:
Computing cloud 198 (in FIG. 27A) (not-more-than-twice)-attempted to connect (e.g. in FIG. 19A step 1932) to each-of-the-cloud-instances in “Alpha” Bank-of-Host-Computer-Cloud-Instances (B.H.C.C.I.) (in row-“A”-and-column-“IV”-of-FIG. 27E's-Table-1), which (“Alpha” bank's ten (10)host-computer-cloud-instances (HCCI)) are:
   (which 10 HCCI-cloud-instances are) HCCI-205a-C, HCCI-205b-C, HCCI-205c-C, HCCI-205d-C, HCCI-205e-C, HCCI-205f-C, HCCI-205g-C, HCCI-205h-C, HCCI-205i-C, and HCCI-205j-C (in row-“A”-and-column-“IV” of FIG. 27E's Table-1); and
Computing cloud 198 (in FIG. 27A) received responses (e.g. in FIG. 19A step 1932) from the HCCI-cloud instances (in above “Alpha” bank's 10 HCCI-cloud-instances); and
   (ii) FIG. 27E's Table-1's column-“XIV” shows “Last Ping Response Time (Sec.)) (in heading-of-column-“XIV”) that Computing cloud 198 saved (at 10:12-GMT) the HCCI cloud-response-times (in row-“A”-and-column-“XIV”-of-Table-1): 2.532 sec., 1.028 sec., 2.086 sec., 3.143 sec., etc.; and
   (iii) FIG. 27E's Table-1's column-“XV” shows “Ranking of Last Ping Response Time” (in heading-of-column-“XV”) that computing cloud 198 ranked (in order) from-fastest-to-slowest (at 10:12-GMT), and saved the ranking (in column-“XV”-of-Table-1) of the last/previous-ping-response-times (at 10:12-GMT, and in column-“XIV”-of-Table-1) of the 10 HCCI-cloud-instances (in above “Alpha” bank): 6, 1, 4, 8, 9, 3, 2, 7, 10, 5 (which ranking order would/could be used as the “attempts-to-connect”-order when computing cloud 198 next-time (after 10:12-GMT) attempts-to-connect (e.g. in FIG. 19A step 1932) to any available cloud-instance of the “Alpha” bank).

FIG. 27E's Table-2's columns-“XII”-and-“XIV”-and-“XV” (updated-(at-10:13-GMT) those columns-“XII”-and-“XIV”-and-“XV” of FIG. 27E's Table-1 and) illustrate “Updated-Ping-Results: Updated Ping-Response-Time (Sec.) (in column-XIV) & Updated Last-Ping-Ranking (in column-XV):

(i) FIG. 27E's Table-2's column-“XII” shows that (Updated-(at-10:13-GMT))-“Last Ping Time (GMT)) (in heading-of-column-“XII”) was (updated-to)-10:13-GMT (Greenwich Mean Time) when:
Computing cloud 198 (in FIG. 27A) at 10:13 GMT:
   (i)(a) in FIG. 20A step-2025: “Do-steps-1932-to-1948-in-FIG. 19A” (including computing cloud 198 (not-more-than-twice)-“attempts-to connect-to-all-cloud-instances-in-bank (in FIG. 19A step 1932)”); or
   (i)(b) in FIG. 20A step-2048: “If” “Yes” (Elapsed-Time>Maximum-Targeted), then Do-steps-1932-to-1948-in-FIG. 19A to (not-more-than-twice)-“attempt-to-connect-to-all-cloud-instances-in-bank” (FIG. 19A step 1932); or
   (i)(c) etc. (others not shown).
   (ii) FIG. 27E's Table-2's column-“XIV” shows (Updated-(at-10:13-GMT))-“Last Ping Response Time (Sec.)) (in heading-of-column-“XIV”) that computing cloud 198 saved (at 10:13-GMT) the HCCI cloud-instance-response-times (in row-“A”-and-column-“XIV”-of-Table-2): 5.574 sec., 3.025 sec., 1.263 sec., 2.931 sec., etc.; and
   (iii) FIG. 27E's Table-2's column-“XV” shows (Updated-(at-10:13-GMT))-“Ranking of Last Ping Response Time” (in heading-of-column-“XV”) that computing cloud 198 ranked (in order) from-fastest-to-slowest (at 10:13-GMT), and saved the ranking (in column-“XV”-of-Table-2) of the (Updated-(at-10:13-GMT))-last-ping-response-times (at 10:13-GMT, and in column-“XV”-of-Table-2) of the 10 HCCI-cloud-instances (in above “Alpha” bank): 8, 6, 1, 5, 4, 9, 7, 10, 3, 2 (which (updated-at-10:13-GMT) ranking-order would/could be used as the pinging-order when computing cloud 198 next-time (after 10:13-GMT) pings/attempts-to-connect (e.g. in FIG. 19A step 1932) to any available cloud-instance of the “Alpha” bank).

(FIG. 27F's Table-1 is identical to FIG. 27E's Table-2:) FIG. 27F's Table-1's columns-“XII”-and-“XIV”-and-“XV” (updated-(at-10:13-GMT) those columns-“XII”-and-“XIV”-and-“XV” of FIG. 27E's Table-1 and) illustrate (FIG. 27F's Table-1's) “Updated-(at-10:13-GMT) Ping-Response-Time (column-XIV) HIGHER-THAN (Targeted)-Ceilings-(column-XI)”, and:
FIG. 27F's Table-2: “Updated Ping-Response-Time (column-XIV) HIGHER-THAN (Targeted)-Ceilings (column-XI)” IMPLIES: (a) Increase-(HCCI's)-H/W: or (b) Split-(HCCI's)-Clients-(Loads), and illustrated as follows:
   (i) (FIG. 27F's Table-1's row-A's) H.C.C.I. 205a-C: “Updated Ping-Response-Time (=5.574 sec. in column-XIV, and is) HIGHER-THAN (Targeted)-Ceilings (=5 sec. in column-XI, and)” IMPLIES (as illustrated in FIG.-19A's step-1946(ii): “(ii) If above-ceiling cloud-instance(s) cannot add more (virtualized)-hardware, off-load 50%-of-clients-(of-these-cannot-add-H/W-instance(s)-in-(i)) to (run on) new-cloud-instance(s)”): split-(in-Table-2)-(HCCI-205a-C's)-clients-(loads) (into 50%-for H.C.C.I.-“205a1-C” and 50%-for-H.C.C.I-“205a2-C”) as H.C.C.I. 205a-C cannot-increase its EC2-H/W (as it is already at 32-(max.#-of)-(1X)-H/W); and
   (ii) (FIG. 27F's Table-1's row-A's) H.C.C.I. 205f-C: “Updated Ping-Response-Time (=6.052 sec. in column-XIV, and is) HIGHER-THAN (Targeted)-Ceilings (=5 sec. in column-XI, and)” IMPLIES (as illustrated in FIG.-19A's step-1946(i): “(i) If possible, add more (virtualized)-hardware to above-ceiling-of-targeted-range cloud-instances”): increase-(in-Table-2's-column-VIII)-(HCCI-205f-C's)-H/W (to 20-(1X)-H/W (from 8-(1X)-H/W) for HCCI-205f-C); and
   (iii) (FIG. 27F's Table-1's row-A's) H.C.C.I. 205h-C: “Updated Ping-Response-Time (=7.055 sec. in column-XIV, and is) HIGHER-THAN (Targeted)-Ceilings (=5 sec. in column-XI, and)” IMPLIES (as illustrated in FIG.-19A's step-1946(i): “(i) If possible, add more (virtualized)-hardware to above-ceiling-of-targeted-range cloud-instances”): increase-(in-Table-2's-column-VIII)-(HCCI-205h-C's)-H/W (to 24X)-H/W (from 14X)-H/W) for HCCI-205h-C).

(FIG. 27G's Table-1 is identical to FIG. 27E's Table-2:) FIG. 27G's Table-1's columns-“XII”-and-“XIV”-and-“XV” (updated-(at-10:13-GMT) those columns-“XII”-and-“XIV”-and-“XV” of FIG. 27E's Table-1 and) illustrate (FIG. 27G's Table-1's) “Updated-(at-10:13-GMT) Ping-Response-Time (column-XIV) LOWER-THAN (Targeted)-Floors-(column-X)”, and:
FIG. 27G's Table-2: “Updated Ping-Response-Time (column-XIV) LOWER-THAN (Targeted)-Floors (column-X)” IMPLIES: (a) Decrease-(HCCI's)-H/W: or (b) Merge-(HCCI's)-Clients-(Loads), and illustrated as follows:
   (i) (FIG. 27G's Table-1's row-A's) H.C.C.I. 205c-C: “Updated Ping-Response-Time (0.063 sec. in column-XIV, and is) LOWER-THAN (Targeted)-Floor (=1 sec. in column-X, and)” IMPLIES (as illustrated in FIG.-19A's step-1940(i): “(i) If possible, remove (virtualized)-hardware from (below-floor-of-targeted-range) fastest-to-respond cloud-instances”): remove-(in-Table-2's-column-VIII)-(HCCI-205c-C's)-H/W (to 20-(1X)-H/W (from 32-(1X)-H/W) for HCCI-205c-C); and
   (ii) (FIG. 27G's Table-1's row-A's) H.C.C.I. 205j-C: “Updated Ping-Response-Time (=0.098 sec. in column-XIV, and is) LOWER-THAN (Targeted)-Floor (=1 sec. in column-X, and)” IMPLIES (as illustrated in FIG.-19A's step-1940(ii)&(iii): “(ii). Transfer-(any-other)-below-floor-response-time (cloud-instances')-clients to fastest-cloud-instance-to-respond; and/or (iii). (Optional) Merge/Close (below-floor)-cloud-instance(s)-(without-clients)”): merge/close-(in-Table-2's-column-VIII)-HCCI-205j-C-(cloud-instance) (and transfer HCCI-205j-C's-clients to (fastest-cloud-instance-to-respond)-HCCI-205c-C).

(For-(LOS)-#-of-users:) FIG. 27H's columns-I-to-IV-and-VII-to-XI are copied-from/same-as FIG. 27C's table's columns-I-to-IV-and-VII-to-XI-respectively, and:

(i) Floor-#-of-users-(for-LOS) (for banks-of-cloud-instances) are shown in FIG. 27H's column-XVI, and equal-to:
(Floor-#-of-users-(for-LOS)=) “Target-Floor-Response-Time” (in column-X) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (not shown)); and
   (i)(a). As-an-example, for row-A's H.C.C.I. 205a-C, Floor-#-of-users-(for-LOS)=1-sec. (which is its “Target-Floor-Response-Time” (in column-X) TIMES 32 (which is its #-of-virtualized-hardware (in column-VIII)) TIMES 100-users-(per-1X-H/W) (from Linear-formula from FIG. 18B's Table-1) DIVIDED-by-30 (assuming its 100%-load has 30-sec.-response-time (not shown))
   =1*32*100/30=106 (in column-XVI of row-A's H.C.C.I. 205a-C); and response-time); and
   (i)(b). As-another-example, for row-B's H.C.C.I. 205m-C, Floor-#-of-users-(for-LOS)=2-sec. (which is its “Target-Floor-Response-Time” (in column-X) TIMES 8 (which is its #-of-virtualized-hardware (in column-VIII)) TIMES 100-users-(per-1X-H/W) (from Linear-formula from FIG. 18B's Table-1) DIVIDED-by-30 (assuming its 100%-load has 30-sec.-response-time (not shown))
   =2*8*100/30=53 (in column-XVI of row-B for H.C.C.I. 205m-C); and
      (ii) Ceiling-#-of-users-(for-LOS) (for banks-of-cloud-instances) are shown in FIG. 27H's column-XVII, and equal-to:
(Ceiling-#-of-users-(for-LOS)=) “Target-Ceiling-Response-Time” (in column-XI) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (not shown)); and
   (ii)(a). As-an-example, for row-A's H.C.C.I. 205a-C, Ceiling-#-of-users-(for-LOS)=5-sec. (which is its “Target-Ceiling-Response-Time” (in column-XI) TIMES 32 (which is its #-of-virtualized-hardware (in column-VIII)) TIMES 100-users-(per-1X-H/W) (from Linear-formula from FIG. 18B's Table-1) DIVIDED-by-30 (assuming its 100%-load has 30-sec.-response-time (not shown))
   =5*32*100/30=533 (in column-XVII of row-A's H.C.C.I. 205a-C); and
   (ii)(b). As-another-example, for row-B's H.C.C.I. 205m-C, Ceiling-#-of-users-(for-LOS)=7-sec. (which is its “Target-Ceiling-Response-Time” (in column-XI) TIMES 8 (which is its #-of-virtualized-hardware (in column-VIII)) TIMES 100-users-(per-1X-H/W) (from Linear-formula from FIG. 18B's Table-1) DIVIDED-by-30 (assuming its 100%-load has 30-sec.-response-time (not shown))
      =7*8*100/30=187 (in column-XVII of row-B for H.C.C.I. 205m-C).

(For-(LOS)-load-%-(of-hardware):) FIG. 27H's columns-I-to-IV-and-VII-to-XI are copied-from/same-as FIG. 27C's table's columns-I-to-IV-and-VII-to-XI-respectively, and:

(i) Floor-Load-o-(of-hardware)-(for-LOS) (for banks-of-cloud-instances) are shown in FIG. 27H's column-XVIII, and equal-to:
(Floor-Load-%-(of-hardware)-(for-LOS)=) “Target-Floor-Response-Time” (in column-X) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (not shown)); and
   (i)(a). As-an-example, for row-A's H.C.C.I. 205a-C, Floor-Load-%-(of-hardware)-(for-LOS)=1-sec. (which is its “Target-Floor-Response-Time” (in column-X) DIVIDED-by-30 (assuming its 100%-load has 30-sec.-response-time (not shown))
   =1/30=3.3% (in column-XVIII of row-A's H.C.C.I. 205a-C); and
   (i)(b). As-another-example, for row-B's H.C.C.I. 205m-C, Floor-Load-%-(of-hardware)-(for-LOS)=2-sec. (which is its “Target-Floor-Response-Time” (in column-X) DIVIDED-by-30 (assuming its 100%-load has 30-sec.-response-time (not shown))
   =2/30=6.7% (in column-XVIII of row-B for H.C.C.I. 205m-C); and
      (ii) Ceiling-Load-%-(of-hardware)-(for-LOS) (for banks-of-cloud-instances) are shown in FIG. 27H's column-XIX, and equal-to:
(Ceiling-Load-%-(of-hardware)-(for-LOS)=) “Target-Ceiling-Response-Time” (in column-XI) TIMES #-of-virtualized-hardware (in column-VIII) TIMES 100-users-(per-1X-H/W) (from Linear-formula from FIG. 18B's Table-1) DIVIDED-by-30 (assuming 100%-load has 30-sec.-response-time (not shown)); and
   (ii)(a). As-an-example, for row-A's H.C.C.I. 205a-C, Ceiling-Load-%-(of-hardware)-(for-LOS)=5-sec. (which is its “Target-Ceiling-Response-Time” (in column-XI) DIVIDED-by-30 (assuming its 100%-load has 30-sec.-response-time (not shown))
   =5/30=16.7% (in column-XIX of row-A's H.C.C.I. 205a-C); and
   (ii)(b). As-another-example, for row-B's H.C.C.I. 205m-C, Ceiling-Load-%-(of-hardware)-(for-LOS)=7-sec. (which is its “Target-Ceiling-Response-Time” (in column-XI) DIVIDED-by-30 (assuming its 100%-load has 30-sec.-response-time (not shown))
      =7/30=23.3% (in column-XIX of row-B for H.C.C.I. 205m-C).

(For-(LOS)-Price/Hour/User:) FIG. 27H's columns-I-to-IV-and-VII-to-XI are copied-from/same-as FIG. 27C's table's columns-I-to-IV-and-VII-to-XI-respectively, and:

(i) Floor-Price/Hour/User-(for-LOS) (for banks-of-cloud-instances) are shown in FIG. 27H's column-XX, and equal-to:
(Floor-Price/Hour/User-(for-LOS)=) “Price/Hour (from FIG. 29A's column-VII) of H.C.C.I.'s-EC2-Instance (in column-VII)” DIVIDED-by-H.C.C.I.'s-“Floor-#-of-users” (in column-XVI); and
   (i)(a). As-an-example, for row-A's H.C.C.I. 205a-C, Floor-Price/Hour/User-(for-LOS)=US$3.2-per-Hour (which ($3.2/Hr.) is price/hour (for “m4.16xlarge”-Instance in FIG. 29A's row-D-and-column-VII, and) for H.C.C.I.-205a-C's Amazon-EC2-“m4.16xlarge”-Instance in FIG. 27H's column-VII) DIVIDED-by-106 (which is row-A's H.C.C.I.-205a-C's “Floor-#-of-users” in column-XVI)
   =US$3.2/Hr./106=3 US-cent/Hr.(in column-XX of row-A's H.C.C.I. 205a-C); and
   (i)(b). As-another-example, for row-B's H.C.C.I. 205m-C, Floor-Price/Hour/User-(for-LOS)=US$0.8-per-Hour (which ($0.8/Hr.) is price/hour (for “m4.4xlarge”-Instance in FIG. 29A's row-J-and-column-VII, and) for H.C.C.I.-205m-C's Amazon-EC2-“m4.4xlarge”-Instance in FIG. 27H's column-VII) DIVIDED-by-53 (which is row-B's H.C.C.I.-205m-C's “Floor-#-of-users” in column-XVI)
   =US$0.8/Hr./53=1.5 US-cent/Hr.(in column-XX of row-B's H.C.C.I. 205m-C); and
      (ii) Ceiling-Price/Hour/User-(for-LOS) (for banks-of-cloud-instances) are shown in FIG. 27H's column-XXI, and equal-to:
(Ceiling-Price/Hour/User-(for-LOS)=) “Price/Hour (from FIG. 29A's column-VII) of H.C.C.I.'s-EC2-Instance (in column-VII)” DIVIDED-by-H.C.C.I.'s-“Ceiling-#-of-users” (in column-XVII); and
   (ii)(a). As-an-example, for row-A's H.C.C.I. 205a-C, Ceiling-Price/Hour/User-(for-LOS)=US$3.2-per-Hour (which ($3.2/Hr.) is price/hour (for “m4.16xlarge”-Instance in FIG. 29A's row-D-and-column-VII, and) for H.C.C.I.-205a-C's Amazon-EC2-“m4.16xlarge”-Instance in FIG. 27H's column-VII) DIVIDED-by-533 (which is row-A's H.C.C.I.-205a-C's “Ceiling-#-of-users” in column-XVII)
   =US$3.2/Hr./533=0.6 cent/Hr. (in column-XXI of row-A's H.C.C.I. 205a-C); and
   (ii)(b). As-another-example, for row-B's H.C.C.I. 205m-C, Ceiling-Price/Hour/User-(for-LOS)=US$0.8-per-Hour (which ($0.8/Hr.) is price/hour (for “m4.4xlarge”-Instance in FIG. 29A's row-J-and-column-VII, and) for H.C.C.I.-205m-C's Amazon-EC2-“m4.4xlarge”-Instance in FIG. 27H's column-VII) DIVIDED-by-187 (which is row-B's H.C.C.I.-205m-C's “Ceiling-#-of-users” in column-XVII)
   =US$0.8/Hr./187=0.43 cent/Hr. (in column-XXI of row-B's H.C.C.I. 205m-C).

Please note that the (LOS)-price/hour/user even for platinum-level-of-service-(LOS) is only 0.6-US-cent/hour/user (for ceiling-load in column-XXI in FIG. 27H) to 3-US-cent/hour/user (for ceiling-load in column-XX in FIG. 27H), which:
0.6-US-cent/hour/user to 3-US-cent/hour/user is extremely cost-effective to provide best (platinum)-level-of-service to users/prospective-customers visiting one's website (and to avoid them to go to a competitor's website (with one-click!)).

Important note: Host computer cloud instance 205-C (and/or host computer cloud instance 205n-C) may interchangeably-(in-many-places) use either 205-C and/or 205n-C (as generic-notations) to denote the (bank of one-or-more) host computer cloud instance (to allow easier/simpler-reading of the specification-and-FIGS in different contexts through-out this patent application). For example: 205-C in FIGS. 9A and 9B may use 205n-C instead (of using 205-C), etc.

Referring back to FIG. 19A, FIG. 19A is a flowchart illustrating how steps 1910 to 1948 (in FIG. 19A) can be added to FIGS. 19M, 19N, 19O, 19P, and 19Q respectively, to have the server 222A to request a computing cloud 198 (in FIG. 9A) to launch-or-assign the host computer cloud instance 205-C:
(a). Step 1910 (FIG. 19A): In previous step “A” in FIGS. 19M, 19N, 19O, 19P, and 19Q respectively, host computer 205 (FIG. 9A) requested to start a new Internet application service;
(b). Step 1920 (FIG. 19A):
   (i) User (not shown) of host computer 205 (FIG. 9A) previously created a computing cloud account (subscribing a number-of single-(virtualized)-hardware (e.g. using Amazon-EC2-instance-plan in FIG. 18B's Table-2's columns-IV-to-VII, or similar pricing data from other computing cloud vendors).
   (ii) Host computer 205 or computing cloud 198 may specify targeted-range-of-(cloud-instance's)-response-time-(to-client) (by choosing hypothetical new price plan with new level-of-service as new feature (not shown) to (i)-and-Table-2-of-FIG. 18B). As illustration, FIG. 2A's Table 2 shows possible new level-of-service (LOS) (in FIG. 2A's Table 2's columns-II-to-V) as possible new feature to Amazon EC2 instance: “m4.16xlarge” (32X virtualized-H/W, in FIG. 38B's Table-2's row I-and-columns-IV-to-VII for “m4.16xlarge” EC2 instance).
(c). Step 1925 (FIG. 19A): Server requests computing cloud 198 to launch-or-assign host computer cloud instance 205-C implementing the requested-number (in step 1920(i)) of single-(virtualized)-hardware.
(d). Step 1930 (FIG. 19A): Computing cloud 198 (in FIG. 9A) launches-or-assigns a bank-of-host-computer-cloud-instances 205C wherein everyone-of-the-host-computer-cloud-instances 205-C (in FIG. 9A) provides the requested Internet application service.
(e). Step 1932 (FIG. 19A): Computing cloud 198 attempts to connect to any available host-computer-cloud-instances 205C (in above bank-of-host-computer-cloud-instances 205C), and receives responses from the host-computer-cloud-instances 205C.
(f). Step 1934 (FIG. 19A): Computing cloud 198 saves the response times (in order, from-fastest-to-slowest) of the host-computer-cloud-instances 205C (in above bank-of-host-computer-cloud-instances 205C in Para [0126E]). When computing cloud 198 next time attempts again to connect (e.g. in FIG. 19A step 1932) to any available cloud-instance (in above bank-of-host-computer-cloud-instances 205C in Para [0126E]), computing cloud may use the saved-order-(from-fastest-to-slowest, in step 1934 in FIG. 19A) to “next time-attempt-again to connect (e.g. in FIG. 19A step 1932) to any available cloud-instance”.
(g). Step 1936 (FIG. 19A): (i) If fastest-response-time (from responses (in step 1932) from the host-computer-cloud-instances 205C) is greater than floor-of-targeted-range-of-response-time (floor-of-range illustrated in FIG. 2's Table 2's column III):
Computing cloud 198 selects fastest-cloud-instance-to-respond (in next step 1942) as the host-computer-cloud-instances 205C (which I.P. address is later sent to the server 222A, e.g. in step 1920 in FIG. 19B).
   (ii) If fastest-response-time is less than floor-of-targeted-range-of-response-time, go to next step 1938 (in FIG. 19A)
(h). Steps 1938, 1940-(i)-&-(ii) (FIG. 19A): In step 1938, if MORE-than-one fastest-cloud-instance-to-respond (in step 1932) are BELOW floor-of-targeted-range-of-response-time, then in next-step 1940-(i)-&-(ii):
(in step 1940(i):) Transfer-(all)-their-clients-(of-“below-floor-response-time”-host-computer-cloud-instances)-to-fastest-cloud-instance-to-respond (which fastest-instance-to-respond is selected in step 1942 below).
(in step 1940(ii): Optional) Close (below-floor-response-time)-host-computer-cloud-instance(s)-(which-are-also-now-without-clients) to release-“unused/not-needed”-(virtualized)-hardware-back-to-computing-cloud 198 (for possible use by other cloud instances (not shown)).
(i). Step 1942 (FIG. 19A): Computing cloud 198 selects (as host-computer-cloud-instances 205C) fastest-cloud-instance-to-respond (to its-(in-step-1932): “attempts to connect to any available cloud-instance (in above bank-of-cloud-instances (meaning above(meaning “Alpha” “group-of-cloud-instances”) “group-of-cloud-instances”)), and receives responses from the cloud instances”).
(j). Steps 1944, 1946-(i)-&-(ii) (FIG. 19A): (i) If response-time (from responses (in step 1932) from the host-computer-cloud-instances 205C) is greater than ceiling-of-targeted-range-of-response-time (ceiling-of-range illustrated in FIG. 2's Table 2's column IV), then do next-step 1946-(i)-&-(ii):
step 1946-(i): If possible, add more (virtualized)-hardware to above-ceiling-of-targeted-range-(of-response-time) cloud-instances, or
step 1946-(ii): if above-ceiling cloud-instance(s) (in step 1946-(i)) cannot add more (virtualized)-hardware, off-load 50%-of-clients-(of-these-cannot-add-H/W-instance(s)-in-step-1946-(i)) to (run on) new-(e.g.-newly-launched)-cloud-instance(s)-(of-the-bank-of-host-computer-cloud-instances 205-C).
(k). Step 1948-(i): (i) Computing cloud disconnects (not-less-than-zero)-non-selected cloud-instance (in Bank).
Step 1948-(ii) Computing cloud uses-(and-assigns-and-saves) IP address of selected-fastest-cloud-instance-(to-respond) (in step-1947) as IP address of host computer cloud instance.
Step 1948-(iii): Save current-(Greenwich-standard)-time (as “last-time-to attempt-to-connect to all-clouds-in-bank of host-computer-cloud-instances 205-C”).
After step 1948-(iii), next step is to “Go back to step “B” In SAME FIG. 19M, 19N, 19O, 19P, or 19Q, as in step “A” in step 1910 above.

FIGS. 19M, 19N, 19O, 19P, and 19Q are flowcharts illustrating how steps 1910-to-1948 (from FIG. 19A) can be added to FIGS. 19M, 19N, 19O, 19P, and 19Q respectively, in accordance with an embodiment of the present invention.

It is noted that the IP address of the client computer 215 may be sent to the host computer 205 and/or the host computer cloud instance 205-C (in bank of cloud instances) using indirect connection 225, 230, or indirect connection 227, 230 (instead of using direct network connection 240, 245 in FIG. 9A) in further embodiments of the current invention illustrated in FIGS. 19P and 19Q respectively and described below.

In an embodiment of the current invention illustrated in FIG. 19E, which FIG. 19E is similar to FIG. 19D, but in FIG. 19E the server 222A (gets 1905 and) sends 1933 (using indirect connection 225, 230 in FIG. 9A) the IP address of the client computer 215 to the host computer 205 and the host computer cloud instance 205-C (in bank of cloud instances), which are communicatively coupled to each other. The host helper program 216-1 (of the host computer cloud instance 205-C (in bank of cloud instances)) then connects 245 to the client helper program 216-2 (of the client computer 215). Direct data exchange (not shown) can then occur, using direct network connection 240, 245 in FIG. 9A, between the client computer 215 and the host computer cloud instance 205-C (in bank of cloud instances), and without going through the server 222A. The host computer 205 (in FIG. 9A) is not needed for direct data exchange (not shown).

In another embodiment of the current invention illustrated in FIG. 19F, which FIG. 19F is similar to FIG. 19D, but in FIG. 19F the server 222A (gets 1905 and) sends 1934 (using indirect connection 227, 230 in FIG. 9A) the IP address of the client computer 215 to the host computer cloud instance 205-C (in bank of cloud instances), which is communicatively coupled to the host computer 205. The host helper program 216-1 (of the host computer cloud instance 205-C (in bank of cloud instances)) then connects 1938 to the client helper program 216-2 (of the client computer 215). Direct data exchange (not shown) can then occur, using direct network connection 240, 245 in FIG. 9A, between the client computer 215 and the host computer cloud instance 205-C (in bank of cloud instances), and without going through the server 222A. The host computer 205 (in FIG. 9A) is not needed for direct data exchange (not shown).

Similar to FIG. 19A, FIGS. 20A, 20B, and 20C are flowcharts illustrating (when the client computer 215 requests to join Internet application service of the host computer 205,) how steps 2010 to 2048 (from FIG. 20A) can be added to FIGS. 20B, and 20C respectively, as follows:
(a). Step 2010 (FIG. 20A): Client computer (i) joins Internet application service of host computer cloud instance 205-C (in a bank of cloud instances); (ii) Computing cloud 198 attempts to connect to host computer cloud-instance 205-C, and receives response and saves its response time.
(b). Steps 2020, 2025 (FIG. 20A): If (in step 2020) response-time (of response (in step 2010(ii)) from the host-computer-cloud-instance 205C) is greater than ceiling-of-targeted-range-of-response-time (ceiling-of-range illustrated in FIG. 2's Table 2's column IV), then go-to and do step 2025.
step 2025: Do-steps-192-to-1948-in-FIG. 19A (to update response-time of all cloud instances, etc.), including:
Computing cloud attempts-to (in step-1932-in-FIG. 19A) connect-to-all-cloud-instances-in-bank; and
Computing cloud selects (in step-1942-in-FIG. 19A) fastest cloud instance to respond as host computer cloud instance 205-C.
(c). Steps 2030, 2048 (FIG. 20A): If (in step 2030) elapsed-time-(from-last-attempt-to-connect-to-all-clouds-in-bank) is greater than maximum-elapsed-time-targeted-(between-successive-attempts-to-connect-to-all-clouds-in-bank), then go-to and do step 2048.
step 2048: Do-steps-1932-to-1948-in-FIG. 19A (to update response-time of all cloud instances, etc.).

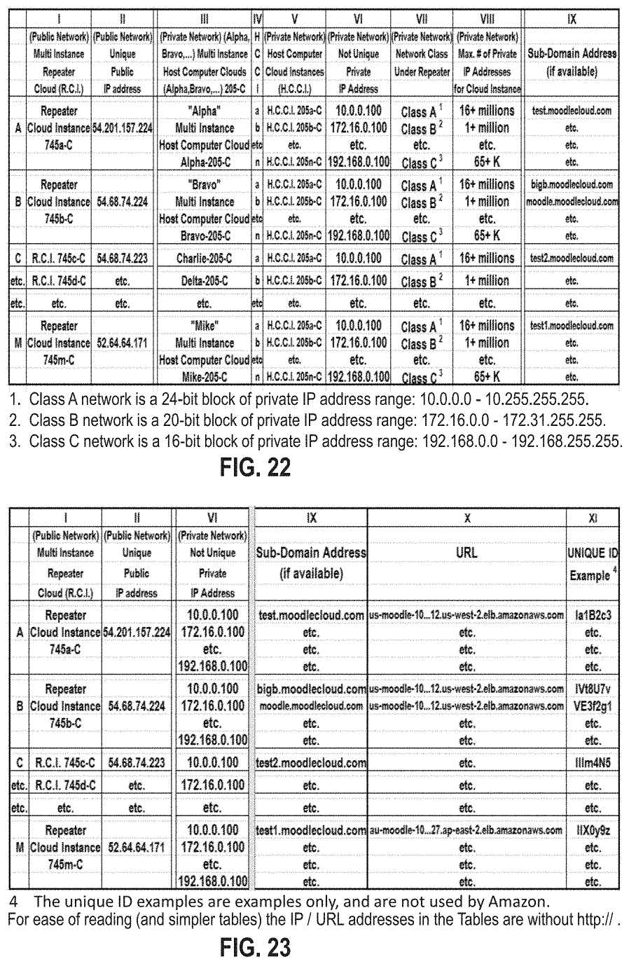

Referring back to FIG. 21A, FIG. 21A is adapted from FIG. 14A and illustrates a direct network connection using host computer cloud instance 205n-C (in a private network 700-n) for Internet application service between a client computer 215 and a host computer 205, in accordance with one embodiment of the present invention. FIG. 21A is further described in FIGS. 22 and 23 below.

Note that the computing cloud provider (not shown) uses more-than-one or multiple computing clouds (e.g. Alpha-205-C, Bravo-205-C, Charlie-205-C, Delta-205-C, . . . Mike-205-C) in FIGS. 21A, 21B and FIGS. 22, 23

FIGS. 22, 23 are tables illustrating examples of multi-instance repeater cloud, repeater cloud instance, multi-instance host computer cloud, host computer cloud instance, sub-domain address, and unique ID (or meeting ID, assigned by server 222A or computing cloud 198) for a computing-cloud-provider.

Note that the computing cloud provider (not shown) uses more-than-one or multiple computing clouds (e.g. Alpha-205-C, Bravo-205-C, Charlie-205-C, Delta-205-C, . . . , Mike-205-C) in FIGS. 21A, 21B and FIGS. 22, 23.

FIG. 22's table's rows-“A”-“B”-“M” illustrate that by using private networks, one single public I.P. address (in column-“II”) allows the multi instance host computer clouds (in column-“II”: “Alpha-205-C”, “Bravo-205-C”, etc.) to support 16+ millions host-computer-cloud-instances (H.C.C.I.) in their columns-“V”-to-“VIII” (which 16+ millions is documented in FIG. 22's footnotes (1)-to-(3) below:
Class A network is a 24-bit block of private IP address range: 10.0.0.0-10.255.255.255, and of 16,777.216 addresses.
Class B network is a 20-bit block of private IP address range: 172.16.0.0-172.31.255.255, and of 1,048,576 addresses.
Class C network is a 16-bit block of private IP address range: 192.168.0.0-192.168.255.255, and of 65,536 addresses.)

### Scaling One's (Virtualized)-Hardware Resources Using Increase/Decrease (Virtualized)-Hardware-(in-Cloud-Instance)

One (e.g. computing cloud 198 and/or host computer cloud instance 205-C) may scale-(up-or-down) one's (virtualized)-hardware resources (to the requirements (e.g. virtualized-hardware/cloud-instance-response-time/quality-of-service(QoS) requirements) of one's target workload) using increase/decrease-(virtualized)-hardware-(in-cloud-instance) (in Para [0035A]).

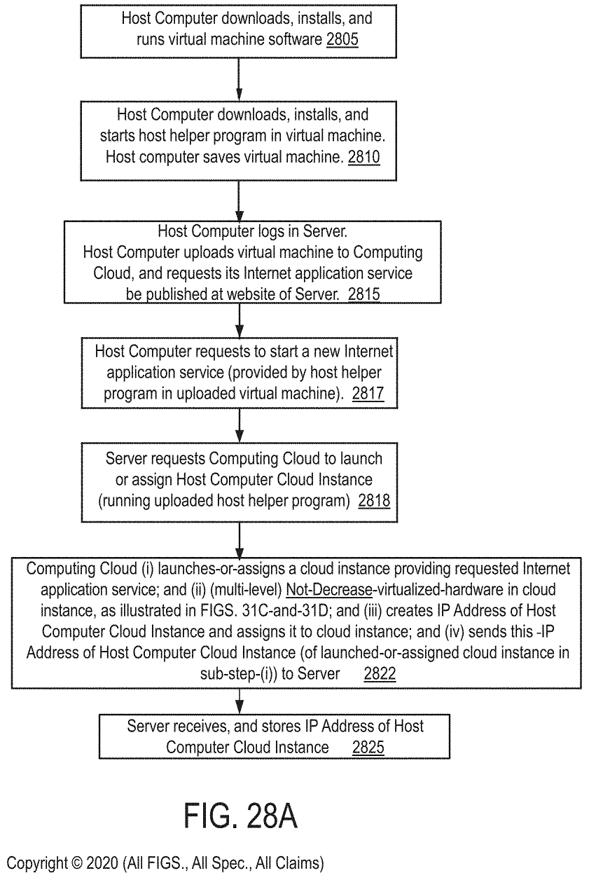

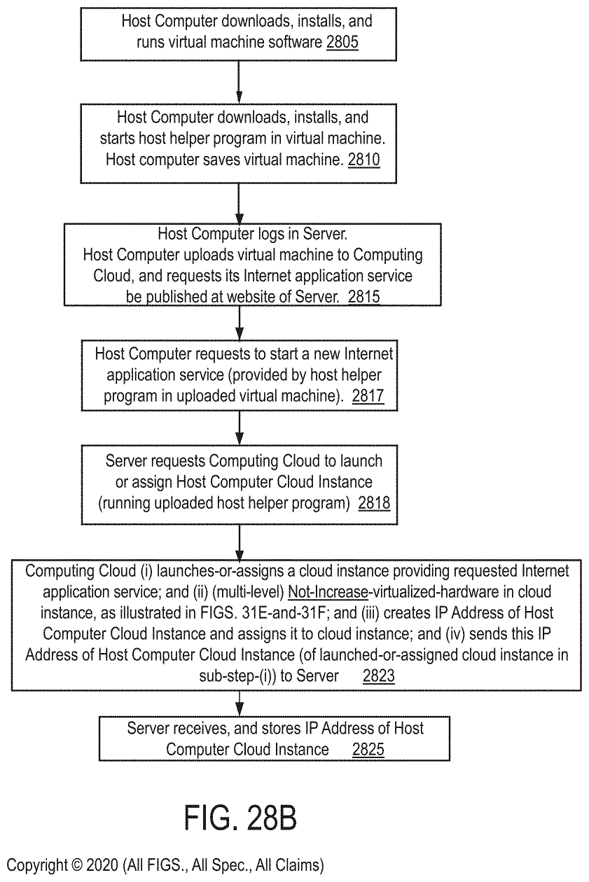

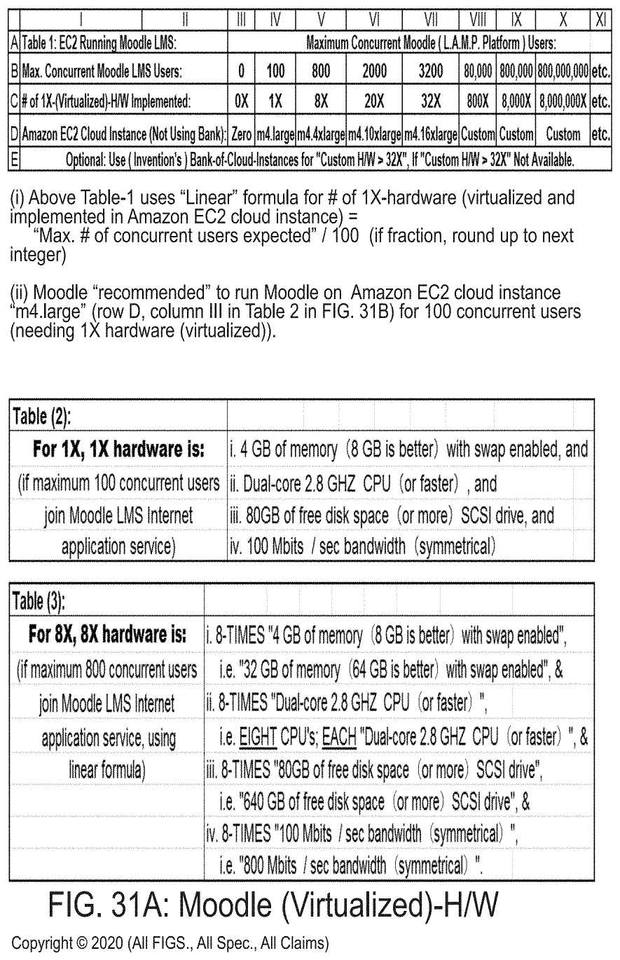

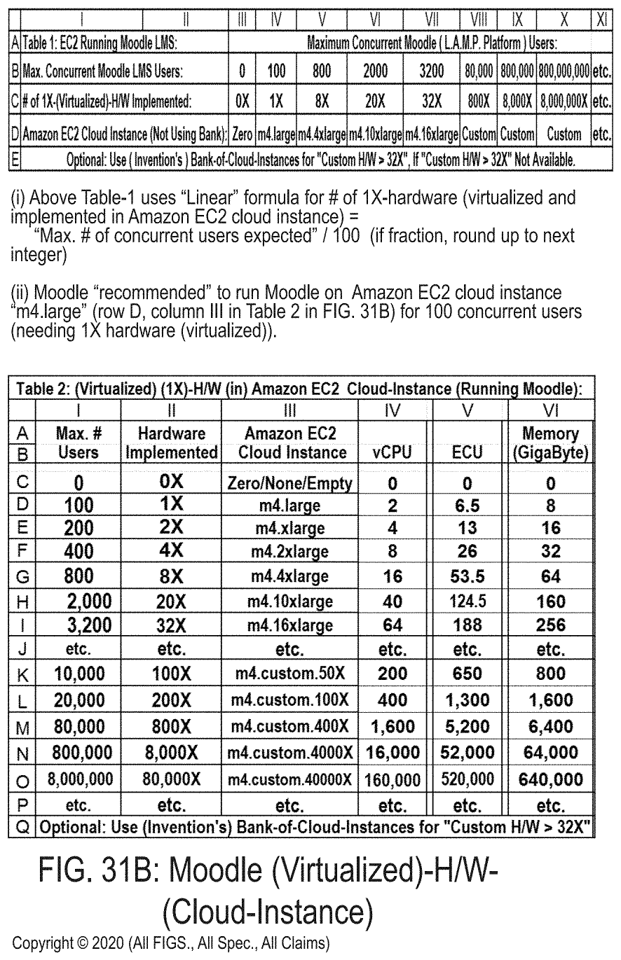

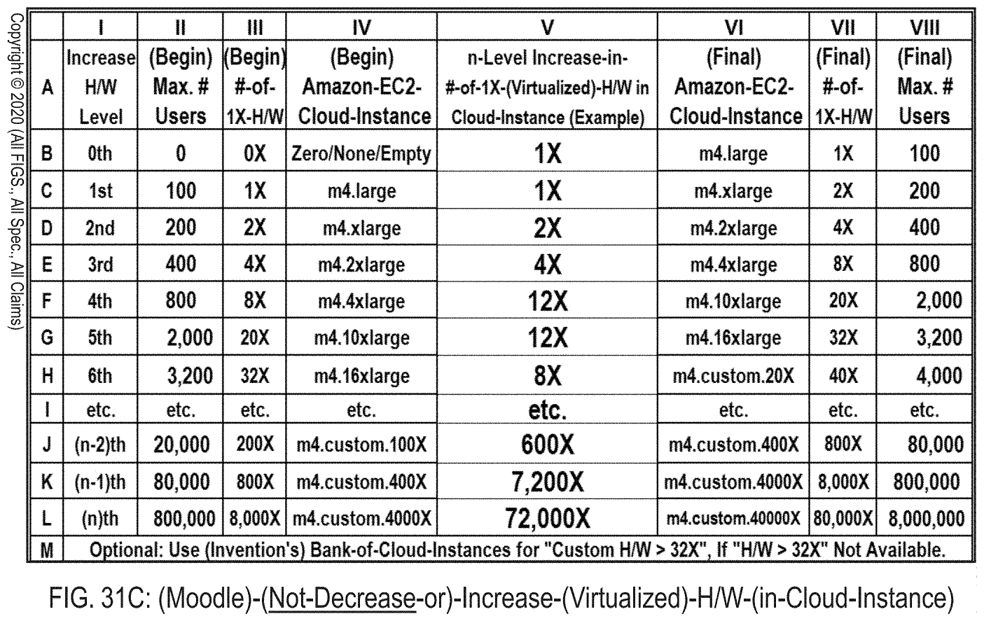

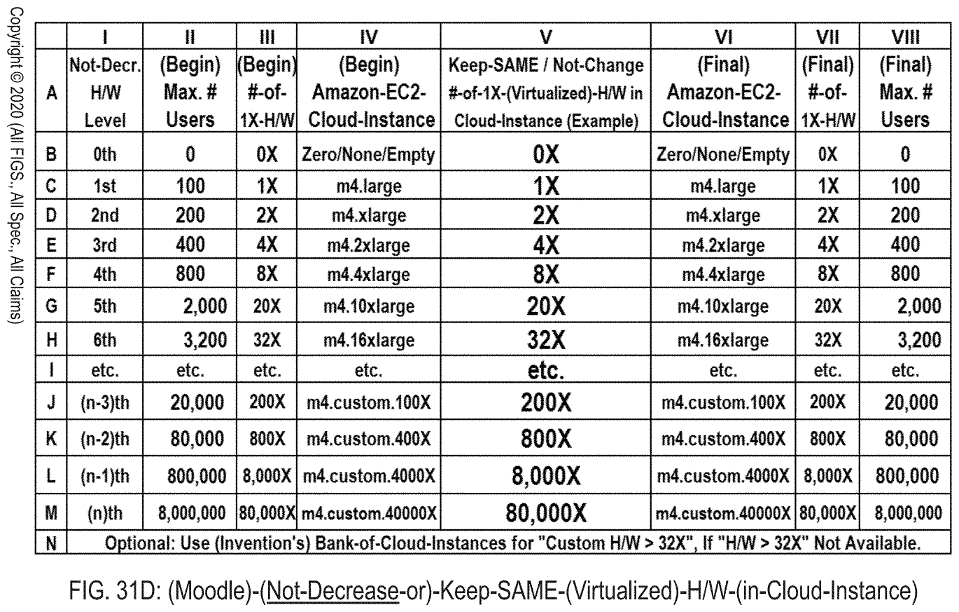

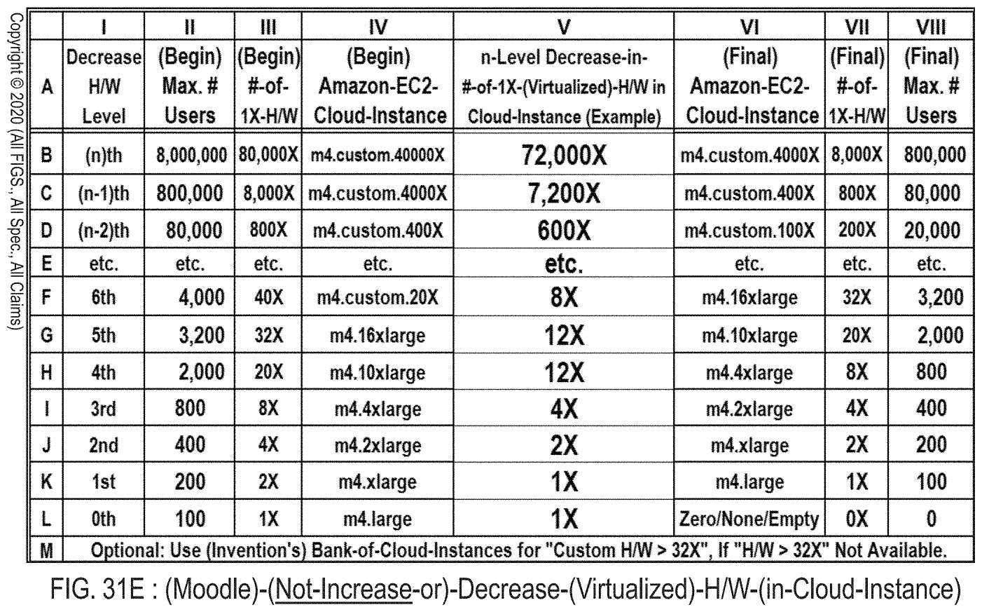

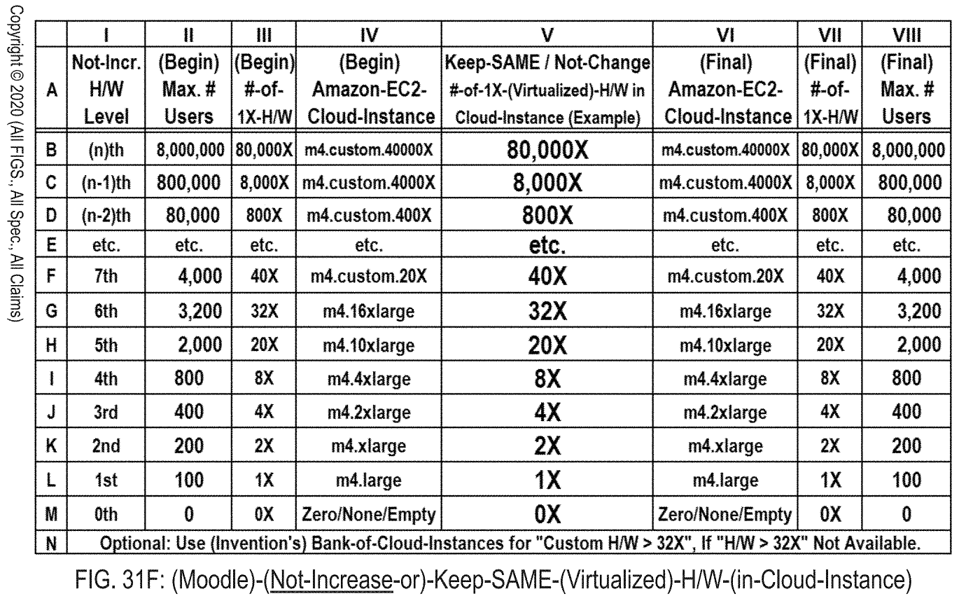

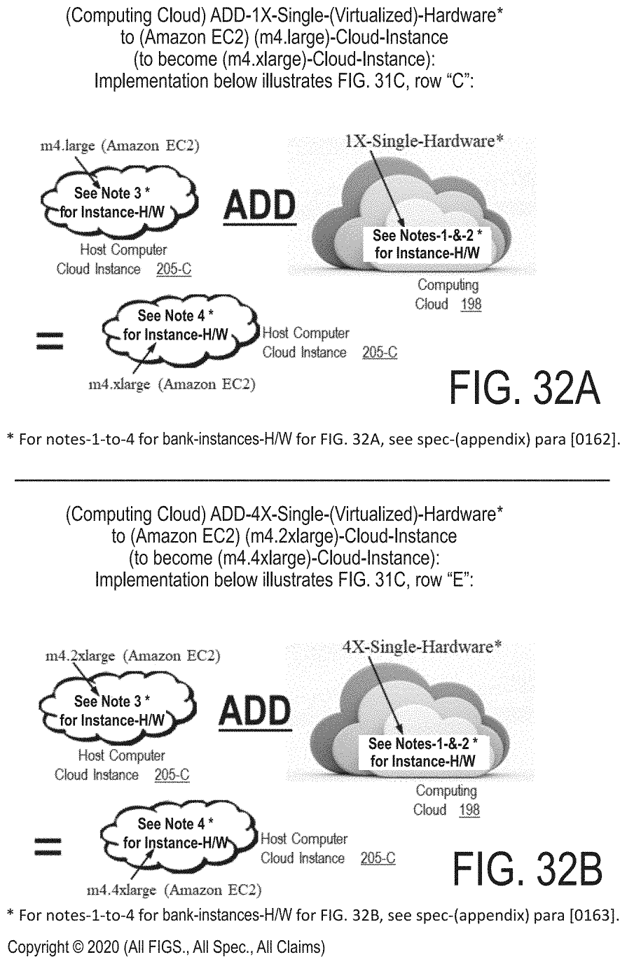

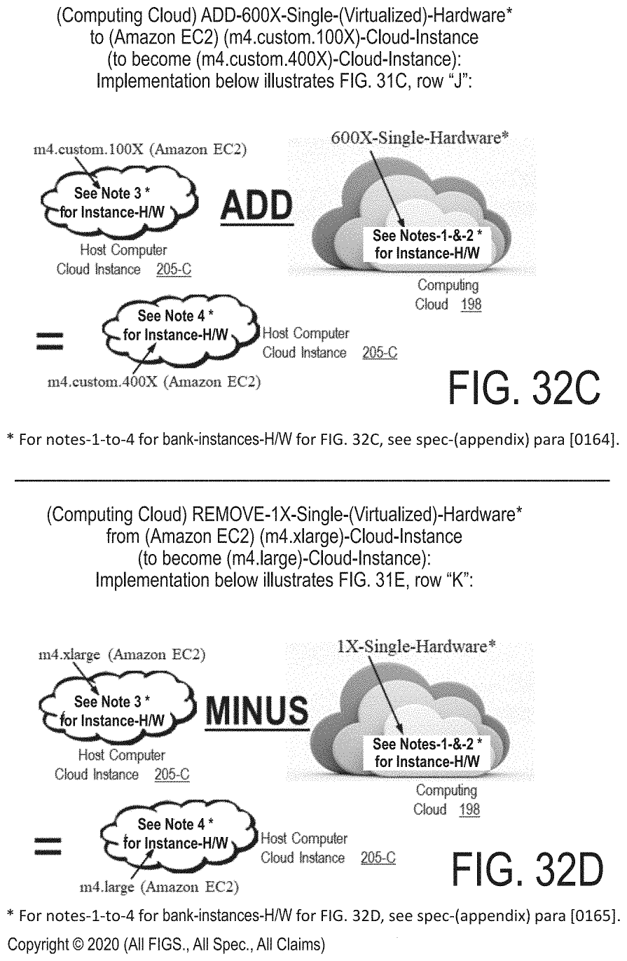

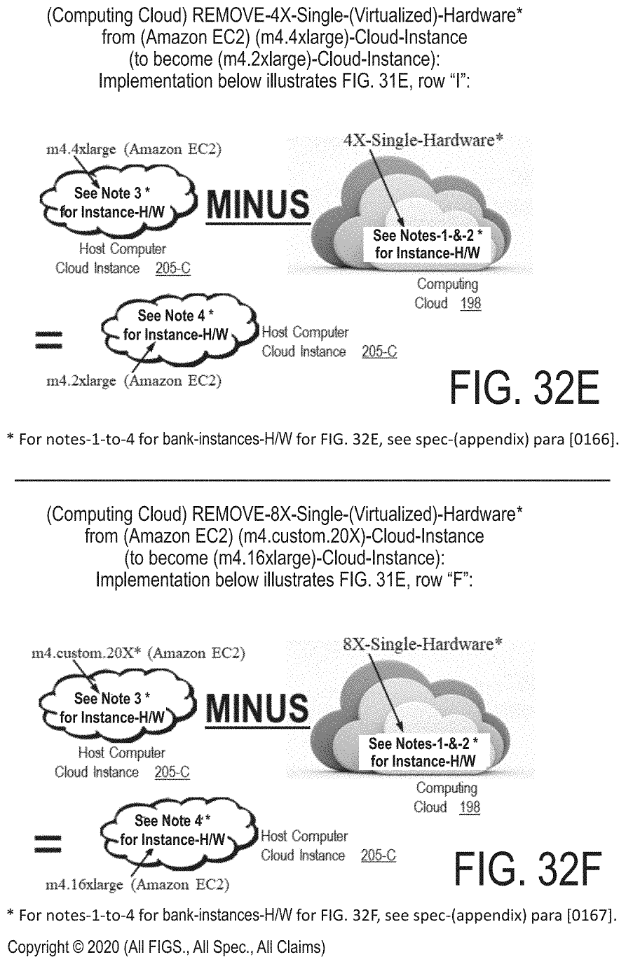

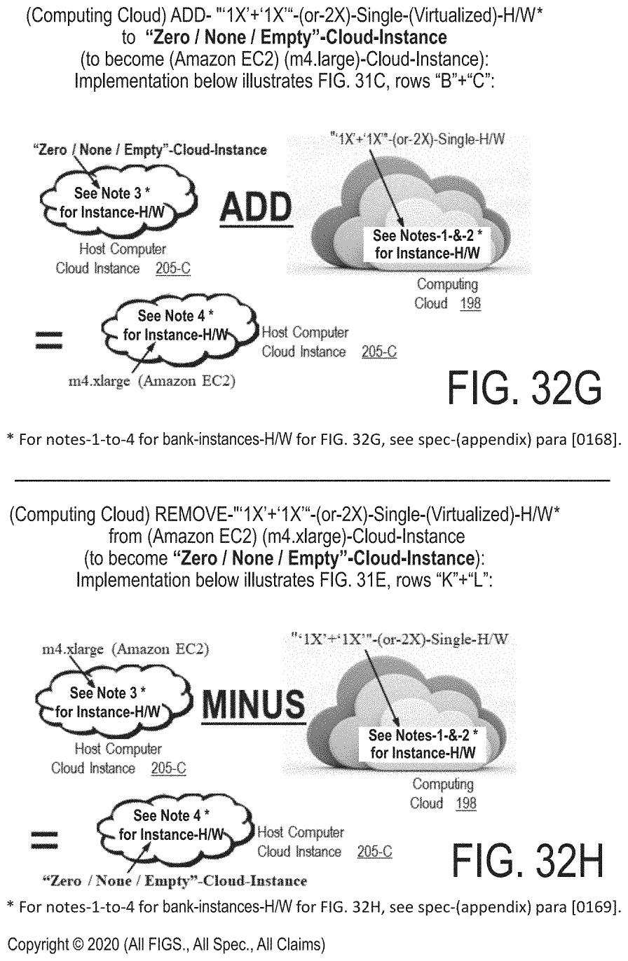

FIGS. 18C&18D, and FIGS. 31C&31D are illustrative examples of multi-level not-decrease-(virtualized)-hardware-(in-cloud-instance) (to scale-up one's (virtualized)-hardware resources) of FIG. 28A's step-2822(ii): “(multi-level) Not-Decrease-virtualized-hardware in cloud instance, as illustrated in FIGS. 31C-and-31D”. Increase-(virtualized)-hardware-(in-cloud-instance) (illustrated in FIGS. 18C (using invention's bank-of-(more)-cloud-instances) and 31C (using invention's more-hardware-in-(single/same)-instance) means improved-cloud-instance-response-time/higher-QoS (quality of service) for clients/users.

FIGS. 18E-&-18F, and FIGS. 31E&31F are illustrative examples of multi-level not-increase-(virtualized)-hardware-(in-cloud-instance) (to scale-down one's (virtualized)-hardware resources) of FIG. 28B's step-2823(ii): “(multi-level) Not-Increase-virtualized-hardware in cloud instance, as illustrated in FIGS. 31E-and-31F”. Decrease-(virtualized)-hardware-(in-cloud-instance) (illustrated in FIGS. 18E (using invention's bank-of-(less)-cloud-instances) and 31E (using invention's less-hardware-in-(single/same)-instance)) means that the not-needed (virtualized)-hardware can be returned back to the computing cloud 198, for possible use for other-(including-new) cloud instances.

Increase-(virtualized)-hardware-(in-cloud-instance) means improved-cloud-instance-response-time/higher-QoS (quality of service) for attendees/users.

FIG. 31E are “(Moodle)-(Not-Increase-or)-Decrease-(Virtualized)-H/W-(in-Cloud-Instance)” (to scale-down one's (virtualized)-hardware resources):
Implementation of FIG. 31E are illustrated in FIGS. 32D-to-32F, and are examples of “(Computing Cloud) Remove-(Multiple)-Single-(Virtualized)-Hardware From (Amazon EC2) Cloud-Instance”.
   Decrease-(virtualized)-hardware-(in-cloud-instance) means that the not-needed (virtualized)-hardware can be returned back to the computing cloud 198, for possible use for other-(including-new) cloud instances.

(Implementation of) Increase-(Virtualized)-Hardware-(in-Cloud-Instance), referred-to in FIG. 31C, is illustrated in FIGS. 32A-to-32C. For example, FIG. 32A illustrates “(Computing Cloud) ADD-1X-Single-(Virtualized)-Hardware to (Amazon EC2) (m4.large)-Cloud-Instance (to become (m4.xlarge)-Cloud-Instance)”. Implementation in FIG. 32A illustrates FIG. 31C, row “B”. More implementation details (of FIG. 32A) are in Notes 1-and-2 below.

Note 1 (of FIG. 32A): 1X-single-(virtualized)-hardware-(for FIG. 31C, row “B”, column V) is defined-(here)-as-equal-to (i) “computing cloud's virtualized-hardware (i.e. vCPU, ECU, memory, bandwidth-(of), and other computing-cloud-resources, if any)”-in-(or-used-by)-cloud-instance-“m4.large”-(Amazon EC2) MINUS (ii) “computing cloud's virtualized-hardware-(i.e. vCPU, ECU, memory, bandwidth-(of), and other computing cloud resources, if any)”-in-(or-used-by)-cloud-instance-“m4.xlarge”-(Amazon EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.
   Note 2 (of FIG. 32A): To add-(virtualized)-hardware above (as alternative-to-“Note 1”), Computing Cloud 198 may:
   (a) Launch-or-assign a m4.xlarge Amazon-EC2-cloud-instance; and
   (b) Assign the I.P./URL address of Host Computer Cloud Instance 205-C (of m4.large Amazon-EC2) to the launched-or-assigned cloud-instance in (a), which replaces it (Host Computer Cloud Instance 205-C).

(Implementation of) Decrease-(Virtualized)-Hardware-(in-Cloud-Instance), referred-to in FIG. 31E, is illustrated in FIG. 32E. For example. FIG. 32E illustrates “(Computing Cloud) REMOVE-4X-Single-(Virtualized)-Hardware from (Amazon EC2) (m4.4xlarge)-Cloud-Instance (to become (m4.2xlarge)-Cloud-Instance)”. Implementation in FIG. 32E illustrates FIG. 31E, row “I”. More implementation details (of FIG. 32E) are in Notes 1-and-2 below.

Note 1 (of FIG. 32E): 4X-single-(virtualized)-hardware-(for FIG. 31E, row “I”, column V) is defined-(here)-as-equal-to (i) “computing cloud's virtualized-hardware (i.e. vCPU, ECU, memory, bandwidth-(of), and other computing-cloud-resources, if any)”-in-(or-used-by)-cloud-instance-“m4.4xlarge”-(Amazon EC2) MINUS (ii) “computing cloud's virtualized-hardware-(i.e. vCPU, ECU, memory, bandwidth-(of), and other computing cloud resources, if any)”-in-(or-used-by)-cloud-instance-“m4.2xlarge”-(Amazon EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances. Optional: Use (invention's) bank-of-cloud-instances for “virtualized H/W>32X”, if “custom H/W>32X” is not available from Amazon (in FIG. 31B's Table-2).
   Note 2 (of FIG. 32E): To remove-(virtualized)-hardware above (as alternative-to-“Note 1”), Computing Cloud 198 may:
   (a) Launch-or-assign a m4.2xlarge Amazon-EC2-cloud-instance; and
   (b) Assign the I.P./URL address of Host Computer Cloud Instance 205-C (of m4.4xlarge Amazon-EC2) to the launched-or-assigned cloud-instance in (a), which replaces it (Host Computer Cloud Instance 205-C).

Combining (i) multi-level increase-(virtualized)-hardware and/or (ii) multi-level decrease-(virtualized)-hardware illustrated and described above, the computing cloud 198 (and the host computer cloud instance 205-C) may “scale one's resources to the requirements (e.g. virtualized-hardware/cloud-instance-response-time/quality-of-service (QoS) requirements) of one's target workload” (in Para [0035], [0035A], including the cloud-instance-response-time/QoS requirements, and not limited to the illustrative examples in this disclosure), e.g. in FIG. 19A Step 1940 and Step 1946, etc.

The scaling of one's resources may be done by database and software coding (e.g. in FIG. 2E: Overview of Virtualization and Para [0041B]) to implement the required virtual machines for the required cloud instance(s) for the targeted workload(s), limited only by the (underlying) physical hardware (available) and technology available to the computing cloud 198.

FIGS. 29A (for mobile) and 29B (for 5G) are Amazon Cloud-Instance Strawman-Pricing (in columns I-and-II-and-VII), with straw-man targeted-response-time/LOS (in columns III-to-VI), to illustrate providing direct network connections using cloud instance for application services over a computer network in accordance with another embodiment of the present invention.

FIGS. 29C-and-29D are conceptual sketches for 5G. 5G is next-generation global mobile communications including Massive Machine Type Communications (mMTC) (illustrated in FIG. 29D), such as auto-(automatic-driverless)-driving (illustrated in FIG. 29C), intelligent transport/E-vehicles, E-health, office/home automation, industrial automation, intelligent building, smart-grid/utilities.

5G (and mobile communications) may be used to implement the present invention providing direct network connections using cloud instance for application services over a computer network.

(Going back to) FIGS. 31A-to-31F are copied-and-edited-(and-differ) from FIGS-18A-to-18F to illustrate (in-lieu-of using “bank(s)-of-(not-less-than-one)-cloud-instances” in FIGS.-18A-to-18F (e.g. in FIG. 18B's Table-2's columns-III-and-IV)):
use only single-cloud-instances in FIGS.-31A-to-31F (e.g. in FIG. 31B's Table-1's column-III), and
“Optional: Use (invention's) bank-of-cloud-instances for “virtualized H/W>32X”, if “custom H/W>32X” is not available from Amazon (in FIG. 31B's Table-2).” (e.g. in FIGS. 31C's-and-31D's rows-J-to-K and columns-III-and-IV).

FIGS.-31A-to-31F (like FIGS.-18A-to-18F) also illustrates “Each (Amazon EC2) instance type includes one or more instance sizes, allowing one to scale (increase-or-decrease) one's (virtualized-hardware) resources (described in Para [0035A]) to the requirements (e.g. virtualized-hardware/targeted-response-time/quality-of-service (QoS) requirements) of one's target workload” (in Para [0035], lines 6-8).

FIG. 31C illustrates n-level (not-decrease-or)-increase-virtualized-(1X)-hardware in cloud-instance (running Moodle LMS, and using linear formula hardware) in the following columns:

(i) Column-I (of FIG. 31C) illustrates (not-decrease-or)-increase hardware levels of 1st-level, 2nd-level, . . . etc., nth-level (in rows “B”, “C” . . . “J” respectively of column-I of FIG. 31C).
(ii) Column-II (of FIG. 31C) illustrates (begin)-maximum-#-of-users of 100, 200, . . . , etc., 800,000 (in rows “B”, “C”, . . . “K” respectively of column-II of FIG. 31C (for their respective increase-hardware-levels in column-I of FIG. 31C).
(iii) Column-III (of FIG. 31C) illustrates (begin)-#-of-(1X)-hardware of 1X, 4X, . . . , etc., 8,000X (in rows “B”, “C”, . . . “K” respectively of column-III of FIG. 31C (for their respective (begin)-maximum-#-of-users in column-II of FIG. 31C).
(iv) Columns-IV (of FIG. 31C) illustrates (begin)-EC2-cloud-instances-(implementing-“begin”-(1X)-H/W) of m4.large, m4.2xlarge, . . . , etc., m4.custom.4000X (in rows “B”, “C” . . . “K” respectively of column-IV of FIG. 31C (for their respective (begin)-#-of-(1X)-hardware in column-III of FIG. 31C).
(v) Column-V (of FIG. 31C) illustrates n-level-increase-(1X)-H/W-in-(bank-of)-cloud-instances of 1X, 2X, . . . , etc., 72,000X (in rows “B”, “C”, . . . “K” respectively of column-V of FIG. 31C (for their respective increase-hardware-level in column-I of FIG. 31C).
(vi) Columns-VI (of FIG. 31C) illustrates (final)-EC2-cloud-instances-(implementing-“final”-(1X)-H/W) of m4.xlarge, m4.2xlarge, . . . etc., m4.custom.40000X (in rows “B”, “C”, . . . “K” respectively of column-VI of FIG. 31C (for their respective (final)-#-of-(1X)-hardware in column-VII of FIG. 31C).
(vii) Column-VII (of FIG. 31C) illustrates (final)-#-of-(1X)-hardware of 2X, 4X, . . . etc., 80,000X (in rows “B”, “C”, . . . “K” respectively of column-VII of FIG. 31C (for their respective (final)-maximum-#-of-users in column-VII of FIG. 31C).
(viii) Column-VIII (of FIG. 31C) illustrates (final)-maximum-#-of-users of 200, 400, . . . , etc., 8-millions (in rows “B”, “C”, . . . “K” respectively of column-VIII of FIG. 31C (for their respective (final)-#-of-(1X)-hardware in column-VIII of FIG. 31C).

In FIG. 31C, please note that “not-decrease”-virtualized-(1X)-hardware in cloud-instance means-(and-its-implementation-may-use): (a) “(not-decrease-or)-increase”-virtualized-(1X)-hardware (illustrated in FIG. 31C), and/or (b) “(not-decrease-or)-keep-SAME/not-change”-virtualized-(1X)-hardware (illustrated in FIG. 31D).

Increase-(#-of-1X)-single-(virtualized)-hardware-(in-FIG.-31C's-column-V=column-VII-(of-FIG.-31C) MINUS column-III-(of-FIG.-31C)) is defined-as-equal-to (computing cloud's (1X)-virtualized-hardware of) “(Final)-Amazon-EC2-Cloud-Instance(s)-(in-Column-VII-(of-FIG.-31C))” MINUS “(Begin)-Amazon-EC2-Cloud-Instance-(in-Column-III-(of-FIG.-31C))”.

Implementation illustrations of rows “B”, “D”, and “F”, of FIG. 31C are in FIGS. 32A, 32B, and 32C respectively.

(ii) Implementation illustrations of rows “B”, “D”, and “F”, of FIG. 31C are in FIGS. 32A, 32B, and 32C respectively; other FIG. 31C's rows may be similarly illustrated (not shown):
FIG. 32A illustrates: (computing cloud 198) add-1X-single-(virtualized)-hardware to (Amazon EC2) “m4.large”-cloud-instance to become “m4.xlarge”-cloud-instance

The implementation illustrates FIG. 31C, row “B”. More description of the implementation are in FIG. 32A's notes-1-and-2.
FIG. 32B illustrates: (computing cloud 198) add-4X-single-(virtualized)-hardware to (Amazon EC2) “m4.2xlarge”-cloud-instance to become “m4.4xlarge”-cloud-instance. The implementation illustrates FIG. 31C, row “D”. More description of the implementation are in FIG. 32B's notes-1-and-2.
FIG. 32C illustrates: (computing cloud 198) add-600X-single-(virtualized)-hardware to (Amazon EC2) (m4.custom.100X)-Cloud-Instance to become “m4.custom.400X”-cloud-instance.
   The implementation illustrates FIG. 32C, row “I”. More description of the implementation are in FIG. 32C's notes-1-and-2.

More-(virtualized)-hardware-(in host computer cloud instance 205-C) means quicker-response-time/higher-QoS-(quality of service) for users (of client computers 215).

FIG. 31D is copied-and-edited-(and-differ) from FIG-18D to illustrate (in-lieu-of using “bank(s)-of-(not-less-than-one)-cloud-instances” in FIG.-18D (e.g. in FIG. 18D's columns-IV-and-V)):
use only single-cloud-instances in FIG.-31D (e.g. in FIG. 31D's columns-IV-and-VI), and
“Option: Use (Invention's) Bank-of-Cloud-Instances for “H/W>32X”, If “Custom H/W>32X” Not Available.” (e.g. in FIG.-31D's rows-I-to-L and columns-III-and-IV).

FIG. 31D illustrates n-level (not-decrease-or)-keep-SAME/not-change-virtualized-(1X)-hardware in cloud-instance (running Moodle LMS, and using linear formula hardware) in the following columns:

(i) Column-I (of FIG. 31D) illustrates (not-decrease-or)-keep-SAME/not-change hardware levels of 1st-level, 2nd-level, . . . , etc., nth-level (in rows “B”, “C”, . . . “L” respectively of column-I of FIG. 31D).
(ii) Column-II (of FIG. 31D) illustrates (begin)-maximum-#-of-users of 100, 200, . . . , etc., 8-millions (in rows “B”, “C”, . . . “L” respectively of column-II of FIG. 31D (for their respective keep-SAME/not-change-hardware-levels in column-I of FIG. 31D).
(iii) Column-III (of FIG. 31D) illustrates (begin)-#-of-(1X)-hardware of 1X, 4X, . . . , etc., 80,000X (in rows “B”, “C”, . . . “L” respectively of column-III of FIG. 31D (for their respective (begin)-maximum-#-of-users in column-II of FIG. 31D).
(iv) Columns-IV (of FIG. 31D) illustrates (begin)-EC2-cloud-instances-(implementing-“begin”-(1X)-H/W) of m4.large, m4.2xlarge, . . . etc., m4.custom.4000X (in rows “B”, “C”, . . . “L” respectively of column-IV of FIG. 31D (for their respective (begin)-#-of-(1X)-hardware in column-III of FIG. 31D).
(v) Column-V (of FIG. 31D) illustrates (n-level)-keep-SAME/not-change-(1X)-H/W-in-(bank-of)-cloud-instances of 1X, 4X, . . . , etc., 80,000X (in rows “B”, “C”, . . . “L” respectively of column-V of FIG. 31D (for their respective keep-SAME/not-change-hardware-level in column-I of FIG. 31D).
(vi) Columns-VI (of FIG. 31D) illustrates (final)-EC2-cloud-instances-(implementing-“final”-(1X)-H/W) of m4.large, m4.2xlarge, . . . etc., m4.custom.40000X (in rows “B”, “C”, . . . “L” respectively of column-VI of FIG. 31D (for their respective (final)-#-of-(1X)-hardware in column-VII of FIG. 31D).
(vii) Column-VII (of FIG. 31D) illustrates (final)-#-of-(1X)-hardware of 1X, 4X, . . . etc., 80,000X (in rows “B”, “C”, . . . “L” respectively of column-VIII of FIG. 31D (for their respective (final)-maximum-#-of-users in column-VIII of FIG. 31D).
(viii) Column-VIII (of FIG. 31D) illustrates (final)-maximum-#-of-users of 100, 200, . . . , etc., 8-millions (in rows “B”, “C”, . . . “L” respectively of column-VIII of FIG. 31D (for their respective (final)-#-of-(1X)-hardware in column-VII of FIG. 31D).

In FIGS. 31C-and-31D, please note that “not-decrease”-virtualized-(1X)-hardware in cloud-instance means-(and-its-implementations-illustrated-in-FIGS. 31C-and-31D-may-use): (i) “(not-decrease-or)-increase”-virtualized-(1X)-hardware (illustrated in FIG. 31C), and/or (ii) “(not-decrease-or)-keep-SAME/not-change”-virtualized-(1X)-hardware (illustrated in FIG. 31D).

(Not-decrease-or)-Keep-SAME/Not-Change-(Virtualized)-(1X)-Hardware-(in-Cloud-Instance) means SAME-QoS for users (of client computers 215).

FIG. 31D illustrates (not-decrease-or)-keep-SAME/not-change-virtualized-(1X)-hardware), and complements FIG. 31C, which illustrates (not-decrease-or)-increase-(virtualized)-(1X)-H/W.

FIG. 31E is copied-and-edited-(and-differ) from FIG-18E to illustrate (in-lieu-of using “bank(s)-of-(not-less-than-one)-cloud-instances” in FIG.-18E (e.g. in FIG. 18E's columns-IV-and-V)):
use only single-cloud-instances in FIG.-31E (e.g. in FIG. 31E's columns-IV-and-VI), and
“Option: Use (Invention's) Bank-of-Cloud-Instances for “H/W>32X”, If “Custom H/W>32X” Not Available.” (e.g. in FIG.-31E's rows-B-to-F and columns-III-and-IV).

FIG. 31E illustrates n-level (not-increase-or)-decrease-virtualized-(1X)-hardware in cloud-instance (running Moodle LMS, and using linear formula hardware) in the following columns:

(i) Column-I (of FIG. 31E) illustrates (not-increase-or)-decrease hardware levels of nth-level, (n−1)th-level, . . . , etc., 1st-level (in rows “B”, “C” . . . “K” respectively of column-I of FIG. 31E).
(ii) Column-II (of FIG. 31E) illustrates (begin)-maximum-#-of-users of 8-millions, 800,000, . . . , etc., 200 (in rows “B”, “C”, . . . “K” respectively of column-II of FIG. 31E (for their respective decrease-hardware-levels in column-I of FIG. 31E).
(iii) Column-III (of FIG. 31E) illustrates (begin)-#-of-(1X)-hardware of 80,000X, 8,000X, . . . , etc., 2X (in rows “B”, “C”, . . . “L” respectively of column-III of FIG. 31E (for their respective (begin)-maximum-#-of-users in column-II of FIG. 31E).
(iv) Columns-IV (of FIG. 31E) illustrates (begin)-EC2-cloud-instances-(implementing-“begin”-(1X)-H/W) of m4.custom.40000X, m4.custom.4000X, . . . , etc., m4.xlarge (in rows “B”, “C”, . . . “L” respectively of column-IV of FIG. 31E (for their respective (begin)-#-of-(1X)-hardware in column-III of FIG. 31E).
(v) Column-V (of FIG. 31E) illustrates n-level-decrease-(1X)-H/W-in-(bank-of)-cloud-instances of 72,000X, 7,200X, . . . , etc., 1X (in rows “B”, “C”, . . . ‘J’ respectively of column-VI of FIG. 31E (for their respective increase-hardware-level in column-I of FIG. 31E).
(vi) Columns-VI (of FIG. 31E) illustrates (final)-EC2-cloud-instances-(implementing-“final”-virtualized-(1X)-hardware) of m4.custom.40000, m4.custom.400X, . . . etc., m4.large (in rows “B”, “C”, . . . “L” respectively of column-VI of FIG. 31E (for their respective (final)-#-of-(1X)-hardware in column-VII of FIG. 31E).
(vii) Column-VII (of FIG. 31E) illustrates (final)-#-of-(1X)-hardware of 8,000X, 800X, . . . etc., 1X (in rows “B”, “C”, . . . “L” respectively of column-VIII of FIG. 31E (for their respective (final)-maximum-#-of-users in column-VII of FIG. 31E).
(viii) Column-VIII (of FIG. 31E) illustrates (final)-maximum-#-of-users of 800,000, 80,000, . . . , etc., 100 (in rows “B”, “C”, . . . “L” respectively of column-VIII of FIG. 31E (for their respective (final)-#-of-(1X)-hardware in column-VII of FIG. 31E).

FIG. 31F is copied-and-edited-(and-differ) from FIG-18F to illustrate (in-lieu-of using “bank(s)-of-(not-less-than-one)-cloud-instances” in FIG.-18F (e.g. in FIG. 18F's columns-IV-and-V)):
use only single-cloud-instances in FIG.-31F (e.g. in FIG. 31F's columns-IV-and-VI), and
“Option: Use (Invention's) Bank-of-Cloud-Instances for “H/W>32X”, if “Custom H/W>32X” Not Available.” (e.g. in FIG.-31F's rows-B-to-F and columns-III-and-IV).

FIG. 31F illustrates n-level (not-decrease-or)-keep-SAME/not-change-virtualized-(1X)-hardware in cloud-instance (running Moodle LMS, and using linear formula hardware) in the following columns:

(i) Column-I (of FIG. 31F) illustrates (not-decrease-or)-keep-SAME/not-change hardware levels of nth-level, (n−1)th-level, . . . , etc., 1st-level (in rows “B”, “C”, . . . “L” respectively of column-I of FIG. 31F).
(ii) Column-II (of FIG. 31F) illustrates (begin)-maximum-#-of-users of 8-millions, 800,000 . . . etc., 100 (in rows “B”, “C”, . . . “L” respectively of column-II of FIG. 31F (for their respective keep-SAME/not-change-hardware-levels in column-I of FIG. 31F).
(iii) Column-III (of FIG. 31F) illustrates (begin)-#-of-(1X)-hardware of 80,000X, 8,000X, . . . , etc., 1X (in rows “B”, “C”, . . . “l” respectively of column-III of FIG. 31F (for their respective (begin)-maximum-#-of-users in column-II of FIG. 31F).
(iv) Columns-IV (of FIG. 31F) illustrates (begin)-EC2-cloud-instances-(implementing-“begin”-(1X)-H/W) of m4.custom.40000X, m4.custom.4000X, . . . , etc., m4.large (in rows “B”, “C”, . . . “L” respectively of column-IV of FIG. 31F (for their respective (begin)-#-of-(1X)-hardware in column-III of FIG. 31F).
(v) Column-V (of FIG. 31F) illustrates (n-level)-keep-SAME/not-change-(1X)-H/W-in-cloud-instance of 80,000X, 8,000X, . . . , etc., 1X (in rows “B”, “C”, . . . “L” respectively of column-V of FIG. 31F (for their respective keep-SAME/not-change-hardware-level in column-I of FIG. 31F).
(vi) Columns-VI (of FIG. 31F) illustrates (final)-EC2-cloud-instances-(implementing-“final”-(1X)-H/W) of m4.custom.40000X, m4.custom.4000X, . . . etc., m4.large (in rows “B”, “C”, . . . “L” respectively of column-VI of FIG. 31F (for their respective (final)-#-of-(1X)-hardware in column-VII of FIG. 31F).
(vii) Column-VII (of FIG. 31F) illustrates (final)-#-of-(1X)-hardware of 80,000X, 8,000X, . . . etc., 1X (in rows “B”, “C”, . . . “L” respectively of column-VII of FIG. 31F (for their respective (final)-maximum-#-of-users in column-VIII of FIG. 31F).
(viii) Column-VIII (of FIG. 31F) illustrates (final)-maximum-#-of-users of 8-millions, 800,000, . . . , etc., 100 (in rows “B”. “C”, . . . “L” respectively of column-VIII of FIG. 31F (for their respective (final)-#-of-(1X)-hardware in column-VII of FIG. 31F).

(i) In FIGS. 31E-and-31F, please note that “not-increase”-virtualized-(1X)-hardware in cloud-instance means-(and-its-implementation-illustrated-in-FIGS. 31E-and-31F-may-use): (i) “(not-increase-or)-decrease”-virtualized-(1X)-hardware (illustrated in FIG. 31E), and/or (ii) “(not-increase-or)-keep-SAME/not-change”-virtualized-(1X)-hardware (illustrated in FIG. 31F).

Decrease-(#-of-1X)-single-(virtualized)-hardware-(in-FIG.-31E's-column-V=column-VII-(of-FIG.-31E) MINUS column-III-(of-FIG.-31E)) is defined-as-equal-to (computing cloud's (IX)-virtualized-hardware of) “(Final)-Amazon-EC2-Cloud-Instance(s)-(in-Column-VI-(of-FIG.-31E))” MINUS “(Begin)-Amazon-EC2-Cloud-Instance-(in-Column-IV-(of-FIG.-31E))”.

Implementation illustrations of row “F” (with (begin)-40X-(1X)-H/W, as example of “Option: Use (Invention's) Bank-of-Cloud-Instances for “H/W>32X”, if “Custom H/W>32X” Not Available.”) of FIG. 31E are in FIG. 32D respectively.

(ii) Implementation illustrations of rows “K”, “I”, and “F” of FIG. 31E are in FIGS. 32D, 32E and 32F respectively; other FIG. 31E's rows may be similarly illustrated (not shown):
FIG. 32D illustrates: (computing cloud 198) remove-1X-single-(virtualized)-hardware from (Amazon EC2) “m4.xlarge”-Cloud-Instance to become “m4.large”-cloud-instance. The implementation illustrates FIG. 31E, row “K”. More description of the implementation are in FIG. 32D's notes-1-and-2.
FIG. 32E illustrates: (computing cloud 198) remove-4X-single-(virtualized)-hardware from (Amazon EC2) “m4.4xlarge”-cloud-instance to become “m4.2xlarge”-cloud-instance. The implementation illustrates FIG. 31E, row “F”. More description of the implementation are in FIG. 32E's notes-1-and-2.
FIG. 32F illustrates: (computing cloud 198) remove-8X-single-(virtualized)-hardware from (Amazon EC2) “m4.custom.20X”-Cloud-Instance to become “m4.16xlarge”-cloud-Instance.
   The implementation illustrates FIG. 31E, row “F”. More description of the implementation are in FIG. 32F's notes-1-and-2.
   (iii) Less-(virtualized)-hardware-(in host computer cloud instance 205-C) means the not-needed (virtualized)-hardware (in the host computer cloud instance 205-C) can be returned to the computing cloud 198, when client-computers 215 leave Moodle (and/or L.A.M.P. platform) application service.

Please note that since a cloud vendor may use different hardware and (software)-virtualization (than those used by Amazon's EC2), a cloud vendor:
may use (for its cloud instance) substantially-equivalent-(to-Amazon's vCPU/ECU/Memory EC2 H/W in FIG. 31B's columns-“IV”-to-“VI”)-virtualized-H/W,
to implement #-of-(1X)-H/W (in FIG. 31B's Table-2's column-“II” and/or in “Linear formula” in FIG. 31B's Table-1's note (i)) in invention's specifications,
to support-(by-its-cloud-instance)-substantially-equivalent max.-#-of-concurrent-users (in FIG. 31B's Table-2's column-“I”) in one's Internet application service.
   For example, Microsoft may use its Microsoft Azure Cloud Services (General Purpose—For websites, small-to-medium databases, and other everyday applications) to do above (Microsoft's implementation not shown), especially since Microsoft is highly competitive to Amazon (and Microsoft would offer highly competitive and comparable computing cloud offerings to Amazon's).
   Similarly, Google may use its Google Cloud (Standard machine types) to do above (Google's implementation not shown), especially since Google is also highly competitive to Amazon (and Google would also offer highly competitive and comparable computing cloud offerings to Amazon's).

### Additional Considerations

It is noted that in one embodiment, the processes described herein are configured for operation as software or a computer program product. The software can be stored as instructions in a computer readable medium such as a memory 204 or a storage module (or device) 206 and is executable. The instructions (e.g., steps) of the process may also be configured as one or more hardware or software modules that are configured to perform the function or functions described herein.

It is also noted that although the disclosure herein makes references in some embodiments to a client computer 215 sending to a host computer cloud instance 205-C the IP address of the client computer 215 via a direct network connection 245, the principles disclosed herein are also applicable to a client computer 215 sending to a host computer cloud instance 205-C the IP address of the client computer 215 via an indirect network connection 225, 230 (e.g. in FIG. 2A) or via an indirect network connection 227, 230 (e.g. in FIG. 2A).

It is noted that although the disclosure herein makes references in some embodiments to using multi instance computing cloud to provide direct network connections for Internet application service over a computer network, the principles disclosed herein are also applicable to using multi tenancy computing cloud to provide direct network connections for Internet application service over a computer network.

It is noted that although the disclosure herein makes references in some embodiments to using a computing cloud to provide direct network connections for Internet application service over a computer network, the principles disclosed herein are also applicable to using more-than-one or multiple computing clouds (illustrated in FIGS. 53A, 53B and FIGS. 54A, 54B and described in Para [0363], [0364]) to provide direct network connections for Internet application service over a computer network.

It is noted that although the disclosure herein makes references in some embodiments to using Amazon EC2, Microsoft, and Google cloud offerings to provide direct network connections for Internet application service over a computer network, the principles disclosed herein are also applicable to (i) using other Amazon, Microsoft, and Google computing cloud offerings (not shown), and (ii) other computing-cloud-providers' (e.g. IBM, Oracle, Alibaba, etc.) computing cloud offerings (not shown), and (iii) internal company cloud providers' (e.g. of top Global 2000 companies, etc.) public-and-private computing cloud offerings (not shown) to provide direct network connections for Internet application service over a computer network.

It is also noted that although the disclosure herein makes references in some embodiments to interaction between a host computer 205 and a client computer 215, the principles disclosed herein are applicable to any configuration in which two computing devices are communicatively coupled to a network. For example, in some embodiments there may be communications between a first computing device and a second computing device wherein the first device can be any computing type device (e.g., a server computer system, a personal computer, a desktop computer, a laptop computer, a (computing) notebook, a personal digital assistant, a gaming device, a smart phone, a computing device in Internet of Things (IoT), etc.) and the second device can be any computing device (e.g. a server computer system, a personal computer, a desktop computer, a laptop computer, a (computing) notebook, a personal digital assistant, a gaming device, a smart phone, a computing device in Internet of Things, etc.), of which one device may be a host and the other device may be a client, or the devices may be peers (e.g., peer to peer connection).

In addition, the two computing devices may or may not be communicatively coupled to each other at any time, or at all. For example, a first computing device (e.g. Google.com webmaster) communicatively coupled to a network may request a server to start an Internet application service (e.g. website, data base, operating system, desktop applications, software infrastructure, developer tools, business software, etc.) when the second computing device (e.g. Internet user) is not communicatively coupled to the network. After the server has started the Internet application service on a cloud instance, the first computing device may be communicatively decoupled from the network. At a later time, a second computing device may be communicatively coupled to the network and requests the server to join the Internet application service (provided by the cloud instance) started earlier by the first computing device (e.g. Google.com webmaster), and the first computing device is not needed (to be coupled to the network) when the second computing device joins the Internet application service on the cloud instance.

(i) (This patent application is) Copyright © 2020 by LEUNG Kang Wing. All Rights Reserved.
(ii) Copyright-(claim-globally, e.g. in Australia, Austria. Belgium. Brazil. Canada, China, E.U., Finland, France, Germany, Hong Kong, India, Indonesia. Iran, Israel, Italy, Japan, Mexico, Netherlands, Nigeria, Norway, PCT-(national-phase)-countries, Poland, Russia, Singapore. South Africa, South Koria, Spain, Saudi Arabia, Sweden, Switzerland. Taiwan, Thailand, Turkey, U.A.E., U.K., U.S.A., etc.) © 2019-(2020) by LEUNG Kang Wing for (all) specification(s), (all) FIGURES, and (all) patent claims (of the present patent application herein; copyright protection provided-by-(but-NOT-limited-to) WIPO Copyright Treaty (WCT) (1996) under the Beme Convention). All Rights Reserved.

Upon reading this disclosure, those of ordinary skill in the art will appreciate still additional alternative structural and functional designs for a system and a process for Internet application service (including multipoint meeting) via direct network connections using cloud instance between computers through the disclosed principles of the present invention. Thus, while particular embodiments and applications of the present invention have been illustrated and described, it is to be understood that the present invention is not limited to the precise construction and components disclosed herein and (it is to be understood) that various modifications, changes and variations which will be apparent to those skilled in the art may be made in the arrangement, operation and details of the method and apparatus of the present invention disclosed herein without departing from the spirit and scope of the present invention as defined in the claims.

Copyright © 2020 by inventor/author LEUNG Kang Wing. All Rights Reserved. (Please see Para [0139B](i)-and-(ii)).

### Appendix: (Explanation)-Notes to FIGURES

(Explanation)-notes for steps-(1135-to-1180) in FIG. 14A:

(i) note 1: Return Log-In 1135
(ii) note 2: Send Options Page 1145
(iii) note 3: Send User Selection 1155
(iv) note 4: Download ActiveX Control 1160
(v) note 5: Download Client Helper Program 1165
(vi) note 6: Download Host Computer Cloud Instance IP Address 1170
(vii) note 7: Send Client IP Address 1175
(viii) note 8: Direct Data Exchange 1180 (between Client Computer and Host Computer Cloud Instance. Host Computer is not required for the data exchange.)

(Explanation)-notes for steps-(135-to-1180) in FIG. 14B:

(i) note 1: Return Log-In 1135
(ii) note 2: Send Options Page 1145
(iii) note 3: Send User Selection 1155
(iv) note 4: Download ActiveX Control 1160
(v) note 5: Download Client Helper Program 1165
(vi) note 6: Send Client IP Address 1167
(vii) note 7: Host Computer Cloud Instance Gets Client IP Address 1168
(viii) note 8: Send Host Computer Cloud Instance IP Address 1173
(ix) note 9: Direct Data Exchange 1180 (between Client Computer and Host Computer Cloud Instance. Host Computer is not required for the data exchange.)

(Explanation)-notes for steps-(1135-to-1180) in FIG. 14C:

(i) note 1: Return Log-In 1135
(ii) note 2: Send Options Page 1145
(iii) note 3: Send User Selection 1155
(iv) note 4: Download ActiveX Control 1160
(v) note 5: Download Client Helper Program 1165
(vi) note 6: Send Client IP Address 1169
(vii) note 7: Host Computer Cloud Instance Gets Client IP Address 1173
(viii) note 8: Direct Data Exchange 1180 (between Client Computer and Host Computer Cloud Instance. Host Computer is not required for the data exchange.)

(Explanation)-Notes-1-and-2 for FIG. 14A:

(i) Note-1: Host Helper Program 216-1 runs in Host Computer 205 (e.g. in FIGS. 9A, 9B, 14A. 14B, and in other FIGS. and invention/patent embodiments and implementations).
Optionally, Host Helper Program 216-1 may run in installed virtual machine (virtual machine not shown) operating in Host Computer 205.

(ii) Note-2: (One-or-More) Client Computer(s) 215 (or 215a, 215b, . . . 215n)

(Explanation)-Notes-1-and-2-and-3 for FIG. 14B:

(i) Note-1: Optionally, Host Helper Program 216-1 may run in installed virtual machine (virtual machine not shown) operating in Host Computer 205.

(ii) Note-2: (One-or-More) Client Computer(s) 215 (or 215, 21b . . . 215n)

(iii) Note-3: (indirect-network-connection)-225 (not needed, and may be disconnected)

(Explanation)-notes for steps-(535-to-1590) in FIG. 15A:

(i) note 1: Return Log-In 1535
(ii) note 2: Send Options Page 1545
(iii) note 3: Send User Selection 1555
(iv) note 4: Download ActiveX Control 1560
(v) note 5: Download Client Helper Program 1565
(vi) note 6: Send Meeting ID 1570
(vii) note 7: Download Host Computer Cloud, Instance IP Address, and Meeting ID 1575
(viii) note 8: Send Client IP Address and Meeting ID 1580
(ix) note 9: Send Meeting ID 1585
(x) note 10: Direct Data Exchange (Between Client Computer and Host Computer Cloud Instance. Host Computer is not needed for the Data Exchange.) 1590

(Explanation)-notes for steps-(1535-to-1590) in FIG. 15B:

(i) note 1: Return Log-In 1535
(ii) note 2: Send Options Page 1545
(iii) note 3: Send User Selection 1555
(iv) note 4: Download ActiveX Control 1560
(v) note 5: Download Client Helper Program 1565
(vi) note 6: Send Client IP Address and Meeting ID 1567
(vii) note 7: Host Computer Cloud Instance Gets Client IP Address and Meeting ID 1568
(viii) note 8: Send Host Computer Cloud Instance IP Address and Meeting ID 1573
(ix) note 9: Direct Data Exchange (Between Client Computer and Host Computer Cloud Instance. Host Computer is not needed for the Data Exchange.) 1590

(Explanation)-notes for steps-(1535-to-1590) in FIG. 15C:

(i) note 1: Return Log-In 1535
(ii) note 2: Send Options Page 1545
(iii) note 3: Send User Selection 1555
(iv) note 4: Download ActiveX Control 1560
(v) note 5: Download Client Helper Program 1565
(vi) note 6: Send Client IP Address and Meeting ID 1569
(vii) note 7: Send Host Computer Cloud Instance IP Address and Meeting ID 1573
(ix) note 8: Direct Data Exchange (Between Client Computer and Host Computer Cloud Instance. Host Computer is not needed for the Data Exchange.) 1590

(Explanation)-notes for steps-(2435-to-2490) in FIG. 24A:

(i) note 1: Return Log-In 2435
(ii) note 2: Send Options Page 2445
(iii) note 3: Send User Selection 2455
(iv) note 4: Download ActiveX Control 2460
(v) note 5: Download Client Helper Program 2465
(vi) note 6: Send IP address of Repeater Cloud Instance to Server, which receives it. 2467
(vii) note 7: Send IP address of Host Computer Cloud Instance (in Private Network) to Server, which receives it. 2468
(viii) note 8: Send meeting ID, IP Addresses of Repeater Cloud Instance and of Host Computer Cloud Instance to Repeater Cloud Instance, Host Computer Cloud Instance, and Host Computer 470
(ix) note 9: Download meeting ID, and IP Address of Repeater Cloud Instance and IP Address of Host Computer Cloud Instance 2475
(x) note 10: Send Client Computer I.P. Address, meeting ID, and IP Addresses of Client, Repeater Cloud Instance, and Host Computer Cloud Instance to Repeater Cloud Instance & Host Computer Cloud Instance 2480
(xi) note 11: Direct Data Exchange (between Client Computer and Host Computer Cloud Instance (in Private Network), using Repeater Cloud Instance. Host Computer is not needed for the Data Exchange.) 2490

(Explanation)-notes for steps (2435-to-2490) in FIG. 24B:

(i) note 1: Return Log-In 2435
(ii) note 2: Send Options Page 2445
(iii) note 3: Send User Selection 2455
(iv) note 4: Download ActiveX Control 2460
(v) note 5: Download Client Helper Program 2465
(vi) note 6: Send IP address of Repeater Cloud Instance to Server, which receives it. 2467
(vii) note 7: Send IP address of Host Computer Cloud Instance (in Private Network) to Server, which receives it. 2468
(viii) note 8: Send meeting ID, IP Addresses of Client, Repeater Cloud Instance and Host Computer Cloud Instance to Repeater Cloud Instance, and Host Computer 2471
(ix) note 9: Host Computer Cloud Instance Gets Client IP Address and Meeting ID 2473
(x) note 10: Send meeting ID, and IP Address of Repeater Cloud Instance and IP Address of Host Computer Cloud Instance to Client 2476
(xi) note 11: Direct Data Exchange (between Client Computer and Host Computer Cloud Instance (in Private Network), using Repeater Cloud Instance. Host Computer is not needed for the Data Exchange.) 2490

(Explanation)-notes for steps-(2435-to-290) in FIG. 24C:

(i) note 1: Return Log-In 2435
(ii) note 2: Send Options Page 2445
(iii) note 3: Send User Selection 2455
(iv) note 4: Download ActiveX Control 2460
(v) note 5: Download Client Helper Program 2465
(vi) note 6: Send IP address of Repeater Cloud Instance to Server, which receives it. 2467
(vii) note 7: Send IP address of Host Computer Cloud Instance (in Private Network) to Server, which receives it. 2468
(viii) note 8: Send meeting ID, IP Addresses of Client, Repeater Cloud Instance and Host Computer Cloud Instance to Repeater Cloud Instance, and Host Computer Cloud Instance 2472
(ix) note 9: Send meeting ID, and IP Address of Repeater Cloud Instance and IP Address of Host Computer Cloud Instance to Client 2477
(x) note 10: Direct Data Exchange (between Client Computer and Host Computer Cloud Instance (in Private Network), using Repeater Cloud Instance. Host Computer is not needed for the Data Exchange.) 2490

(iii) Note 3 (for Bank-of-Instance(s)-H/W): (Amazon EC2 instance) (4X-H/W) for m4.2xlarge (in FIG. 18B's Table 2, row F) is “8-vCPU, 26-ECU, and 32-Gigabyte (Memory)”;

(and (not-used)-[0153]) Note-1 for FIGS. 27A-and-27B: In Computing Cloud 198 (not-shown):
(Alpha, Bravo, . . . Banks of Host Computer Cloud Instances for) Multi Instance Host Computer Clouds: Alpha-205-C, etc. (each with Host Computer Cloud Instances 205a-C, 205b-C, . . . , 205n-C).

(Explanation)-notes-1-to-4 for Bank-of-Instance(s)-H/W in FIG. 30A:

(i) Note 1 (for Bank-of-Instance(s)-H/W): 4X-single-(virtualized)-hardware-(for FIG. 18C, row-“D”, column-“VI”) is defined-(here)-as-equal-to (1) “computing cloud's virtualized-hardware (i.e. vCPU, ECU, memory, bandwidth-(of), and other computing-cloud-resources, if any)”-in-(or-used-by)-cloud-instance-“m4.4xlarge”-(Amazon-EC2) MINUS (2) “computing cloud's virtualized-hardware-(i.e. vCPU. ECU, memory, bandwidth-(of), and other computing-cloud-resources, if any)”-in-(or-used-by)-cloud-instance-“m4.2xlarge”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 4X-single-(virtualized)-hardware-(for Notes-1-and-2 in FIG. 30A, and for FIG. 18C, row-“D”, column-“VI”) is:
(by definition here:) “16-vCPU, 53.5-ECU, and 64-Gigabyte (Memory)”-(which is “m4.4xlarge”-8X-H/W-(from-Note-4-below)) MINUS “8-vCPU, 26-ECU, and 32-Gigabyte (Memory)”—(which is “m4.2xlarge”-4X-H/W-(from-Note-3-below).
   =(4X-H/W)-“8-vCPU, 27.5-ECU, and 32-Gigabyte (Memory)” (which (for illustration) is 4X-single-(virtualized)-hardware-(for Notes-1-and-2 in FIG. 30A, and for FIG. 18C, row-“D”, column-“VI”).
   Please note that the 4X-Single-Hardware in Note-1 is NOT “m4.2xlarge”-(4X-H/W)-cloud-instance (in Note-3 below) (and they CANNOT be interchanged).

(ii) Note 2 (for Bank-of-Instance(s)-H/W): To add-(virtualized)-hardware above (as alternative-to-“Note 1”), Computing Cloud 198 may (in FIG. 30A):

(a) Launch-or-assign a m4.4xlarge Amazon-EC2-cloud-instance; and
(b) Assign the I.P./URL address of Host Computer Cloud Instance 205-C (of m4.2xlarge Amazon-EC2) to the launched-or-assigned (m4.4xlarge) cloud-instance in “(a)”, which replaces it (previous (m4.2xlarge) Host Computer Cloud Instance 205-C).

(iii) Note 3 (for Bank-of-Instance(s)-H/W): (Amazon EC2 instance) (4X-H/W) for m4.2xlarge (in FIG. 18B's Table 2, row F) is “8-vCPU, 26-ECU, and 32-Gigabyte (Memory)”.

(iv) Note 4 (for Bank-of-Instance(s)-H/W): (Amazon EC2 instance) (8X-H/W) for m4.4xlarge (in FIG. 18B's Table 2, row G) is “16-vCPU, 53.5-ECU, and 64-Gigabyte (Memory)”.

(Explanation)-notes-1-to-4 for Bank-of-Instance(s)-H/W in FIG. 30B:

(i) Note 1 (for Bank-of-Instances-H/W): 68X-single-(virtualized)-hardware-(for FIG. 18C, row “F”, column VI) is defined-(here)-as-equal-to (i) “computing cloud's virtualized-hardware (i.e. vCPU, ECU, memory, bandwidth-(of), and other computing-cloud-resources, if any)”-in-(or-used-by)-“Bank-of-(m4.2xlarge+3-TIMES-‘32X-H/W’)-Cloud-Instances” (Amazon EC2) MINUS (ii) “computing cloud's virtualized-hardware-(i.e. vCPU, ECU, memory, bandwidth-(of), and other computing cloud resources, if any)”-in-(or-used-by)-cloud-instance-“m4.16xlarge”-(Amazon EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 68X-single-(virtualized)-hardware-(for Notes-1-and-2 in FIG. 30B, and for FIG. 18C, row-“F”, column-“VI”) is:
(by definition here: 68X-H/W is) “8-vCPU, 26-ECU, and 32-Gigabyte (Memory)” PLUS “3-TIMES-‘(32X-H,-W)’”-(which is “m4.2xlarge”-PLUS“3-TIMES-‘(32X-H/W)’”-(or-100X-H/W)-(from-Note-4-below)) MINUS “64-vCPU, 188-ECU, and 256-Gigabyte (Memory)”—(which is “m4.16xlarge”-(or-32X-H/W)-(from-Note-3-below))
   =(68X-H/W)-“m4.2xlarge(or-4X-H/W)+2-TIMES-‘m4.16xlarge-(or-32X-H/W)’” (which (for illustration) is 68X-single-(virtualized)-hardware-(for Notes-1-and-2 in FIG. 30B, and for FIG. 18C, row-“D”, column-“VI”).

“Bank-of-(m4.2xlarge+3-TIMES-‘32X-H/W’)-Cloud-Instances” (Amazon EC2) is also shown in FIG. 18B's Table-2's row-“J”-and-column-“IV”, as “32X-H/W” is m4.16xlarge (Amazon EC2 instance).

m4.2xlarge cloud-instance (Amazon EC2) is shown in FIG. 18B's Table-2's row-“F”.

(ii) Note 2 (for Bank-of-Instances-H/W): To add-(virtualized)-hardware above (as alternative-to-“Note 1”), Computing Cloud 198 may (in FIG. 30B):

(a) Launch-or-assign a Bank-of-Cloud-Instances: “m4.2xlarge+3-TIMES-‘m4.16xlarge’” (in FIG. 18B's Table-2's row-“J”-and-column-“IV”) Amazon-EC2-cloud-instances; and
(b) Assign the I.P./URL address of (previous) Host Computer Cloud Instance 205-C (of m4.16xlarge Amazon-EC2) to the launched-or-assigned (Bank-of-Cloud-Instances: “m4.2xlarge+3-TIMES-‘m4.16xlarge’”) Amazon-EC2 in “(a)”, which replaces it (previous (m4.16xlarge) Host Computer Cloud Instance 205-C).

(iii) Note 3 (for Bank-of-Instance-H/W): m4.16xlarge cloud-instance (Amazon EC2) is shown in FIG. 18B's Table-2's row-“I”.

(iv) Note 4 (for Bank-of-Instances-H/W): “Bank-of-(m4.2xlarge+3-TIMES-‘32X-H/W’)-Cloud-Instances” (Amazon EC2) is shown in FIG. 18B's Table-2's row-“J”-and-column-“IV”, as “32X-H/W” is m4.16xlarge (Amazon EC2 instance). m4.2xlarge cloud-instance (Amazon EC2) is shown in FIG. 18B's Table-2's row-“F”. m4.16xlarge cloud-instance (Amazon EC2) is shown in FIG. 18B's Table-2's row-“I”.

(Explanation)-notes-1-to-4 for Bank-of-Instance(s)-H/W in FIG. 30C:

(i) Note 1 (for Bank-of-Instances-H/W): 72,000X-single-(virtualized)-hardware-(for FIG. 18C, row “I”, column VI) is defined-(here)-as-equal-to (i) “computing cloud's virtualized-hardware (i.e. vCPU, ECU, memory, bandwidth-(of), and other computing-cloud-resources, if any)”-in-(or-used-by)-“Bank-of-(2,5000-TIMES-‘m4.16xlarge’)-Cloud-Instances” (Amazon EC2) MINUS (ii) “computing cloud's virtualized-hardware-(i.e. vCPU, ECU, memory, bandwidth-(of), and other computing cloud resources, if any)”-in-(or-used-by)-Bank-of-(250-TIMES-“m4.16xlarge”)-Cloud-Instances”-(Amazon EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 72,000X-single-(virtualized)-hardware-(for Notes-1-and-2 in FIG. 30C, and for FIG. 18C, row-“I”, column-“VI”) is:
(by definition here: 72,000X-H/W is) “Bank-of-2,250-TIMES-‘m4.16xlarge’-(which is “2,250-TIMES-‘32X-H/W’”-(from-Note-4-below)) MINUS “Bank-of-250-TIMES-‘m4.16xlarge’-(which is 250-TIMES-(32X-H/W))-(from-Note-3-below))
   =72,000X-H/W (which (for illustration) is 72,000X-single-(virtualized)-hardware-(for Notes-1-and-2 in FIG. 30C, and for FIG. 18C, row-“I”, column-“VI”).

“Bank-of-(250-TIMES-‘m4.16xlarge’)-Cloud-Instances” (Amazon EC2) is shown in FIG. 18B's Table-2's row-“L”-and-columns-“III-and-IV”, as “32X-H/W” is also m4.16xlarge (Amazon EC2 instance) (in this embodiment of the invention).

“Bank-of-(2,500-TIMES-‘m4.16xlarge’)-Cloud-Instances” (Amazon EC2) is shown in FIG. 18B's Table-2's row-“M”-and-columns-“III-and-V”, as “32X-H/W” is also m4.16xlarge (Amazon EC2 instance) (in this embodiment of the invention).

(ii) Note 2 (for Bank-of-Instances-H/W): To add-(virtualized)-hardware above (as alternative-to-“Note 1”), Computing Cloud 198 may (in FIG. 30C):

(a) Launch-or-assign a Bank-of-Cloud-Instances: “Bank-of-(2,500-TIMES-‘m4.16xlarge’)-Cloud-Instances” (in FIG. 18B's Table-2's row-“M”-and-columns-“III-and-IV”) Amazon-EC2-cloud-instances, as “32X-H/W” is also m4.16xlarge (Amazon EC2 instance) (in this embodiment of the invention), and
(b) Assign the I.P./,URL address of (previous) Host Computer Cloud Instance 205-C (of 250-TIMES-‘m4.16xlarge’ Amazon-EC2) to the launched-or-assigned (Bank-of-Cloud-Instances: 2,500-TIMES-“m4.16xlarge”) Amazon-EC2 in “(a)”, which replaces it (previous (250-TIMES-‘m4.16xlarge’) Host Computer Cloud Instance 205-C).

(iii) Note 3 (for Bank-of-Instances-H/W): 250-TIMES-“m4.16xlarge” cloud-instances (Amazon EC2) is shown in FIG. 18B's Table-2's row-“L”-and-columns-“III-and-IV”.

m4.16xlarge cloud-instance (Amazon EC2) is shown in FIG. 18B's Table-2's row-“I”.

(iv) Note 4 (for Bank-of-Instances-H/W): 2,500-TIMES-“m4.16xlarge” cloud-instances (Amazon EC2) is shown in FIG. 18B's Table-2's row-“M”-and-columns-“III-and-IV”.

m4.16xlarge cloud-instance (Amazon EC2) is shown in FIG. 18B's Table-2's row-“I”.

(Explanation)-notes-1-to-4 for Bank-of-Instance(s)-H/W in FIG. 30D:

(i) Note 1 (for Bank-of-Instances-H/W): 4X-single-(virtualized)-hardware-(for FIG. 18E, row “I”, column VI) is defined-(here)-as-equal-to (i) “computing cloud's virtualized-hardware (i.e. vCPU. ECU, memory, bandwidth-(of), and other computing-cloud-resources, if any)”-in-(or-used-by)-“m4.4xlarge”-cloud-instance (Amazon EC2) MINUS (ii) “computing cloud's virtualized-hardware-(i.e. vCPU, ECU, memory, bandwidth-(of), and other computing cloud resources, if any)”-in-(or-used-by)-“m4.2xlarge”-cloud-instance-(Amazon EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 4X-single-(virtualized)-hardware-(for Notes-1-and-2 in FIG. 30D, and for FIG. 18E, row-“I”, column-“VI”) is:
(by definition here: 4X-H/W is) “m4.4xlarge”-cloud-instance-(from-Note-3-below)) MINUS “m4.2xlarge”-cloud-instance-(from-Note-4-below))
   =4X-H/W (which (for illustration) is 4X-single-(virtualized)-hardware-(for Notes-1-and-2 in FIG. 30D, and for FIG. 18E, row-“I”, column-“VI”).

“m4.2xlarge”-cloud-instance (Amazon EC2) is shown in FIG. 18B's Table-2's row-“F”-and-column-“IV”.

“m4.4xlarge”-cloud-instance (Amazon EC2) is shown in FIG. 18B's Table-2's row-“G”-and-column-“IV”.

Please note that the 4X-Single-Hardware in Note-1 is NOT “m4.2xlarge”-(4X-H/W)-cloud-instance (in Note-4 below) (and they CANNOT be interchanged).

(ii) Note 2 (for Bank-of-Instance-H/W): To remove-(virtualized)-hardware above (as alternative-to-“Note 1”), Computing Cloud 198 may (in FIG. 30D):

(a) Launch-or-assign a Bank-of-Cloud-Instance: “m4.2xlarge”-cloud-instance (in FIG. 18B's Table-2's row-“F”-and-column-“IV”) Amazon-EC2; and
(b) Assign the I.P./URL address of (previous) Host Computer Cloud Instance 205-C (of “m4.4xlarge”-cloud-instance Amazon-EC2) to the launched-or-assigned (Bank-of-Cloud-Instance: “m4.2xlarge”-cloud-instance) Amazon-EC2 in “(a)”, which replaces it (previous (“m4.4xlarge”-cloud-instance) Host Computer Cloud Instance 205-C).

(iii) Note 3 (for Bank-of-Instance-H/W): “m4.4xlarge”-cloud-instance (Amazon EC2) is shown in FIG. 18B's Table-2's row-“G”-and-column-“IV”.

(iv) Note 4 (for Bank-of-Instances-H/W): “m4.2xlarge”-cloud-instance-(Amazon EC2) is shown in FIG. 18B's Table-2's row-“F”-and-column-“IV”.

(Explanation)-notes-1-to-4 for Bank-of-Instance(s)-H/W in FIG. 30E:

(i) Note 1 (for Bank-of-Instances-H/W): 68X-single-(virtualized)-hardware-(for FIG. 18E, row “G”, column VI) is defined-(here)-as-equal-to (i) “computing cloud's virtualized-hardware (i.e. vCPU, ECU, memory, bandwidth-(of), and other computing-cloud-resources, if any)”-in-(or-used-by)-“Bank-of-(m4.2xlarge+3-TIMES-‘32X-H/W’)-Cloud-Instances” (Amazon EC2) MINUS (ii) “computing cloud's virtualized-hardware-(i.e. vCPU, ECU, memory, bandwidth-(of), and other computing cloud resources, if any)”-in-(or-used-by)-cloud-instance-“m4.16xlarge”-(Amazon EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 68X-single-(virtualized)-hardware-(for Notes-1-and-2 in FIG. 30E, and for FIG. 18E, row-“G”, column-“VI”) is:
(by definition here: 68X-H/W is) “8-vCPU, 26-ECU, and 32-Gigabyte (Memory)” PLUS “3-TIMES-‘(32X-H/W)’”-(which is “m4.2xlarge”-PLUS“3-TIMES-‘(32X-H/W)’”-(or-100X-H/W)-(from-Note-3-below)) MINUS “64-vCPU, 188-ECU, and 256-Gigabyte (Memory)”—(which is “m4.16xlarge”-(or-32X-H/W)-(from-Note-4-below))
   =(68X-H/W)-“m4.2xlarge(or-4X-H/W)+2-TIMES-‘m4.16xlarge-(or-32X-H/W)’” (which (for illustration) is 68X-single-(virtualized)-hardware-(for Notes-1-and-2 in FIG. 30E, and for FIG. 18E, row-“G”, column-“VI”).

“Bank-of-(m4.2xlarge+3-TIMES-‘32X-H/W’)-Cloud-Instances” (Amazon EC2) is also shown in FIG. 18B's Table-2s row-“J”-and-column-“IV”, as “32X-H/W” is m4.16xlarge (Amazon EC2 instance). m4.2xlarge cloud-instance (Amazon EC2) is shown in FIG. 18B's Table-2's row-“F”.

(ii) Note 2 (for Bank-of-Instances-H/W): To remove-(virtualized)-hardware above (as alternative-to-“Note 1”), Computing Cloud 198 may (in FIG. 30E):

(a) Launch-or-assign a “m4.16xlarge”-cloud-instance (Amazon-EC2); and
(b) Assign the I.P./URL address of (previous) Host Computer Cloud Instance 205-C (of Bank-of-Cloud-Instances: “m4.2xlarge+3-TIMES-‘m4.16xlarge’”) to the launched-or-assigned (“m4.16xlarge”-cloud-instance) Amazon-EC2 in “(a)”, which replaces it (previous (Bank-of-Cloud-Instances) Host Computer Cloud Instance 205-C).

(iii) Note 3 (for Bank-of-Instances-H/W): “Bank-of-(m4.2xlarge+3-TIMES-‘32X-H/W’)-Cloud-Instances” (Amazon EC2) is shown in FIG. 18B's Table-2's row-“J”-and-column-“IV”, as “32X-H/W” is m4.16xlarge (Amazon EC2 instance). m4.2xlarge cloud-instance (Amazon EC2) is shown in FIG. 18B's Table-2's row-“F”. m4.16xlarge cloud-instance (Amazon EC2) is shown in FIG. 18B's Table-2's row-“I”.

(iv) Note 4 (for Bank-of-Instance-H/W): m4.16xlarge cloud-instance (Amazon EC2) is shown in FIG. 18B's Table-2's row-“I”.

(Explanation)-notes-1-to-4 for Bank-of-Instance(s)-H/W in FIG. 30F:

(i) Note 1 (for Bank-of-Instances-H/W): 72,000X-single-(virtualized)-hardware-(for FIG. 18E, row “D”, column VI) is defined-(here)-as-equal-to (i) “computing cloud's virtualized-hardware (i.e. vCPU, ECU, memory, bandwidth-(of), and other computing-cloud-resources, if any)”-in-(or-used-by)-“Bank-of-(2,5000-TIMES-‘m4.16xlarge’)-Cloud-Instances” (Amazon EC2) MIN (ii) “computing cloud's virtualized-hardware-(i.e. vCPU, ECU, memory, bandwidth-(of), and other computing cloud resources, if any)”-in-(or-used-by)-Bank-of-(250-TIMES-“m4.16xlarge”)-Cloud-Instances”-(Amazon EC2):
Bandwidth-(of) and other computing cloud resources, if any, in the (e.g. Amazon EC2) cloud instances (in addition to their vCPU. ECU, and memory) are by definition-in-this-invention part of the virtualized-hardware of the (e.g. Amazon EC2) cloud instances.

In other words, (for illustration) 72,000X-single-(virtualized)-hardware-(for Notes-1-and-2 in FIG. 30F, and for FIG. 18E, row-“D”, column-“VI”) is:
(by definition here: 72.000X-H/W is) “Bank-of-2,250-TIMES-‘m4.16xlarge’-(which is “2,250-TIMES-‘32X-H/W’”-(from-Note-3-below)) MINUS “Bank-of-250-TIMES-‘m4.16xlarge’-(which is 250-TIMES-(32X-H/W))-(from-Note-4-below))=72,000X-H/W (which (for illustration) is 72,000X-single-(virtualized)-hardware-(for Notes-1-and-2 in FIG. 30F, and for FIG. 18E, row-“D”, column-“VI”).

“Bank-of-(250-TIMES-‘m4.16xlarge’)-Cloud-Instances” (Amazon EC2) is shown in FIG. 18B's Table-2's row-“L”-and-columns-“III-and-IV”, as “32X-H/W” is also m4.16xlarge (Amazon EC2 instance) (in this embodiment of the invention).

“Bank-of-(2,500-TIMES-‘m4.16xlarge’)-Cloud-Instances” (Amazon EC2) is shown in FIG. 18B's Table-2's row-“M”-and-columns-“III-and-IV”, as “32X-H/W” is also m4.16xlarge (Amazon EC2 instance) (in this embodiment of the invention).

(ii) Note 2 (for Bank-of-Instances-H/W): To remove-(virtualized)-hardware above (as alternative-to-“Note 1”). Computing Cloud 198 may (in FIG. 30F):

(a) Launch-or-assign a Bank-of-Cloud-Instances: “Bank-of-(250-TIMES-‘m4.16xlarge’)-Cloud-Instances” (in FIG. 18B's Table-2's row-“L”-and-columns-“III-and-IV”) Amazon-EC2-cloud-instances, as “32X-H/W” is also m4.16xlarge (Amazon EC2 instance) (in this embodiment of the invention); and
(b) Assign the I.P./URL address of (previous) Host Computer Cloud Instance 205-C (of 2,500-TIMES-‘m4.16xlarge’ Amazon-EC2) to the launched-or-assigned (Bank-of-Cloud-Instances: 250-TIMES-“m4.16xlarge”) Amazon-EC2 in “(a)”, which replaces it (previous (2,500-TIMES-‘m4.16xlarge’) Host Computer Cloud Instance 205-C).

(iii) Note 3 (for Bank-of-Instances-H/W): 2,500-TIMES-“m4.16xlarge” cloud-instances (Amazon EC2) is shown in FIG. 18B's Table-2's row-“M”-and-columns-“III-and-IV”.

m4.16xlarge cloud-instance (Amazon EC2) is shown in FIG. 18B's Table-2's row-“I”.

(iv) Note 4 (for Bank-of-Instances-H/W): 250-TIMES-“m4.16xlarge” cloud-instances (Amazon EC2) is shown in FIG. 18B's Table-2's row-“L”-and-columns-“III-and-IV”.

m4.16xlarge cloud-instance (Amazon EC2) is shown in FIG. 18B's Table-2's row-“I”.

(Explanation)-notes-1-to-4 for Bank-of-Instance(s)-H/W in FIG. 30G:

(i) Note 1 (for Bank-of-Instance(s)-H/W): 1X-single-(virtualized)-hardware-(for FIG. 18C, row-“B”, column-“VI”) is defined-(here)-as-equal-to (1) “computing cloud's virtualized-hardware (i.e. vCPU. ECU, memory, bandwidth-(of), and other computing-cloud-resources, if any)”-in-(or-used-by)-cloud-instance-“m4.large”-(Amazon-EC2) MINUS (2) “computing cloud's virtualized-hardware-(i.e. vCPU, ECU, memory, bandwidth-(of), and other computing-cloud-resources, if any)”-in-(or-used-by)-cloud-instance-“Zero/None/Empty”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 1X-single-(virtualized)-hardware-(for Notes-1-and-2 in FIG. 30G, and for FIG. 18C, row-“B”, column-“VI”) is:
(by definition here:) “2-vCPU, 6.5-ECU, and 8-Gigabyte (Memory)”-(which is “m4. large”-1X-H/W-(from-Note-4-below)) MINUS “0-vCPU, 0-ECU, and 0-Gigabyte (Memory)”-(which is “Zero/None/Empty”-cloud-instance-(0X-H/W)-(from-Note-3-below)).
   =(1X-H/W)-“2-vCPU, 6.5-ECU, and 8-Gigabyte (Memory)” (which (for illustration) is 1X-single-(virtualized)-hardware-(for Notes-1-and-2 in FIG. 30G, and for FIG. 18C, row-“B”, column-“VI”).

(ii) Note 2 (for Bank-of-Instance(s)-H/W): To add-(virtualized)-hardware above (as alternative-to-“Note 1”), Computing Cloud 198 may (in FIG. 30G):

(a) Launch-or-assign a m4.large Amazon-EC2-cloud-instance; and
(b) Assign the I.P./URL address of (previous) Host Computer Cloud Instance 205-C (of “Zero/None/Empty”-cloud-instance-(0X-H/W) Amazon-EC2) to the launched-or-assigned (m4.large) cloud-instance in “(a)”, which replaces it (previous (“Zero/None/Empty”-cloud-instance-(0X-H/W)) Host Computer Cloud Instance 205-C).

(iii) Note 3 (for Bank-of-Instance(s)-H/W): (Amazon EC2 instance) (0X-H/W) for “Zero/None/Empty”-cloud-instance-(0X-H/W) (in FIG. 18B's Table-2, row C) is “0-vCPU, 0-ECU, and 0-Gigabyte (Memory)”.

“Zero/None/Empty”-(0X-H/W)-cloud-instance (Amazon EC2) may need custom-(virtualized)-H/W from Amazon (since it is not in regular price-list of Amazon EC2).

(iv) Note 4 (for Bank-of-Instance-H/W): (Amazon EC2 instance) (1X-H/W) for m4.large-cloud-instance-(1X-H/W) (in FIG. 18B's Table-2, row D) is “2-vCPU, 6.5-ECU, and 8-Gigabyte (Memory)”.

(Explanation)-notes-1-to-4 for Bank-of-Instance(s)-H/W in FIG. 30H:

(i) Note 1 (for Bank-of-Instance-H/W): 1X-single-(virtualized)-hardware-(for FIG. 18E, row-“K”, column-“VI”) is defined-(here)-as-equal-to (1) “computing cloud's virtualized-hardware (i.e. vCPU, ECU, memory, bandwidth-(of), and other computing-cloud-resources, if any)”-in-(or-used-by)-cloud-instance-“m4.large”-(Amazon-EC2) MINUS (2) “computing cloud's virtualized-hardware-(i.e. vCPU, ECU, memory, bandwidth-(of), and other computing-cloud-resources, if any)”-in-(or-used-by)-cloud-instance-“Zero/None/Empty”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 1X-single-(virtualized)-hardware-(for Notes-1-and-2 in FIG. 30H, and for FIG. 18E, row-“K”, column-“VI”) is:
(by definition here:) “2-vCPU, 6.5-ECU, and 8-Gigabyte (Memory)”-(which is “m4.large”-1X-H/W-(from-Note-3-below))MINUS “0-vCPU, 0-ECU, and 0-Gigabyte (Memory)”-(which is “Zero/None/Empty”-cloud-instance-(0X-H/W)-(from-Note-4-below)).
   =(1X-H/W)-“2-vCPU, 6.5-ECU, and 8-Gigabyte (Memory)” (which (for illustration) is 1X-single-(virtualized)-hardware-(for Notes-1-and-2 in FIG. 30H, and for FIG. 18E, row-“K”, column-“VI”).

(ii) Note 2 (for Bank-of-Instance-H/W): To remove-(virtualized)-hardware above (as alternative-to-“Note 1”), Computing Cloud 198 may (in FIG. 30H):

(a) Launch-or-assign a “Zero/None/Empty”-(0X-H/W) Amazon-EC2-cloud-instance, and
(b) Assign the I.P./URL address of (previous) Host Computer Cloud Instance 205-C (of “m4.large”-cloud-instance-(1X-H/W) Amazon-EC2) to the launched-or-assigned “Zero/None/Empty”-(0X-H/W) cloud-instance in “(a)”, which replaces it (previous “m4.large”-cloud-instance-(1X-H/W)) Host Computer Cloud Instance 205-C).

(iii) Note 3 (for Bank-of-Instance-H/W): (Amazon EC2 instance) (1X-H/W) for m4.large-cloud-instance (in FIG. 18B's Table-2, row D) is “2-vCPU, 6.5-ECU, and 8-Gigabyte (Memory)”.

(iv) Note 4 (for Bank-of-Instance-H/W): (Amazon EC2 instance) (0X-H/W) for “Zero/None/Empty”-cloud-instance (in FIG. 18B's Table-2, row C) is “0-vCPU, 0-ECU, and 0-Gigabyte (Memory)”.

“Zero/None/Empty”-(0X-HL/W)-cloud-instance (Amazon EC2) may need custom-(virtualized)-H/W from Amazon (since it is not in regular price-list of Amazon EC2).

(Explanation)-notes-1-to-4 for Bank-of-Instance(s)-H/W in FIG. 32A:

(i) Note 1 (for Bank-of-Instance-H/W): 1X-single-(virtualized)-hardware-(for FIG. 31C, row-“C”, column-“VI”) is defined-(here)-as-equal-to (1) “computing cloud's virtualized-hardware (i.e. vCPU, ECU, memory, bandwidth-(of), and other computing-cloud-resources, if any)”-in-(or-used-by)-cloud-instance-“m4.xlarge”-(Amazon-EC2) MINUS (2) “computing cloud's virtualized-hardware-(i.e. vCPU, ECU, memory, bandwidth-(of), and other computing-cloud-resources, if any)”-in-(or-used-by)-cloud-instance-“m4.large”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 1X-single-(virtualized)-hardware-(for Notes-1-and-2 in FIG. 32A, and for FIG. 31C, row-“C”, column-“VI”) is:
(by definition here:) “4-vCPU, 13-ECU, and 16-Gigabyte (Memory)”-(which is “m4.xlarge”-(2X-H/W)-(from-Note-4-below)) MINUS “2-vCPU, 6.5-ECU, and 8-Gigabyte (Memory)”-(which is “m4.large”-cloud-instance-(1X-H/W)-(from-Note-3-below)).
   =(1X-H/W)-“2-vCPU, 6.5-ECU, and 8-Gigabyte (Memory)” (which (for illustration) is 1X-single-(virtualized)-hardware-(for Notes-1-and-2 in FIG. 32A, and for FIG. 31C, row-“C”, column-“VI”).

(ii) Note 2 (for Bank-of-Instance-H/W): To add-(virtualized)-hardware above (as alternative-to-“Note 1”), Computing Cloud 198 may (in FIG. 32A):

(a) Launch-or-assign a “m4.xlarge”-(2X-H/W) Amazon-EC2-cloud-instance; and
(b) Assign the I.P./URL address of (previous) Host Computer Cloud Instance 205-C (of “m4.large”-cloud-instance-(1X-H/W) Amazon-EC2) to the launched-or-assigned “m4.xlarge”-(2X-H/W) cloud-instance in “(a)”, which replaces it (previous “m4.large”-cloud-instance-(1X-H/W)) Host Computer Cloud Instance 205-C).

(iii) Note 3 (for Bank-of-Instance-H/W): (Amazon EC2 instance) (1X-H/W) for m4.large-cloud-instance (in FIG. 18B's Table-2, row D) is “2-vCPU, 6.5-ECU, and 8-Gigabyte (Memory)”.

(iv) Note 4 (for Bank-of-Instance-H/W): (Amazon EC2 instance) (2X-H/W) for “m4.xlarge”-cloud-instance (in FIG. 18B's Table-2, row E) is “4-vCPU, 13-ECU, and 16-Gigabyte (Memory)”.

(Explanation)-notes-1-to-4 for Bank-of-Instance-H/W in FIG. 32B:

(i) Note 1 (for Bank-of-Instance-H/W): 4X-single-(virtualized)-hardware-(for FIG. 31C, row-“E”, column-“VI”) is defined-(here)-as-equal-to (1) “computing cloud's virtualized-hardware (i.e. vCPU. ECU, memory, bandwidth-(of), and other computing-cloud-resources, if any)”-in-(or-used-by)-cloud-instance-“m4.4xlarge”-(Amazon-EC2) MINUS (2) “computing cloud's virtualized-hardware-(i.e. vCPU, ECU, memory, bandwidth-(of), and other computing-cloud-resources, if any)”-in-(or-used-by)-cloud-instance-“m4.2xlarge”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 4X-single-(virtualized)-hardware-(for Notes-1-and-2 in FIG. 32A, and for FIG. 31C, row-“C”, column-“VI”) is:
(by definition here:) “16-vCPU, 53.5-ECU, and 64-Gigabyte (Memory)”-(which is “m4.4xlarge”-(8X-H/W)-(from-Note-4-below)) MINUS “8-vCPU, 26-ECU, and 32-Gigabyte (Memory)”-(which is “m4.2xlarge”-cloud-instance-(4X-H/W)-(from-Note-3-below)).
   =(4X-H/W)-“8-vCPU, 27.5-ECU, and 32-Gigabyte (Memory)” (which (for illustration) is 4X-single-(virtualized)-hardware-(for Notes-1-and-2 in FIG. 32B, and for FIG. 31C, row-“E”, column-“VI”).

Please note that the 4X-Single-Hardware in Note-1 is NOT “m4.2xlarge”-(4X-H/W)-cloud-instance (in Note-3 below) (and they CANNOT be interchanged).

(ii) Note 2 (for Bank-of-Instance-H/W): To add-(virtualized)-hardware above (as alternative-to-“Note 1”), Computing Cloud 198 may (in FIG. 32B):

(a) Launch-or-assign a “m4.4xlarge”-(8X-H/W) Amazon-EC2-cloud-instance; and
(b) Assign the I.P./URL address of (previous) Host Computer Cloud Instance 205-C (of “m4.2xlarge”-cloud-instance-(4X-H/W) Amazon-EC2) to the launched-or-assigned “m4.4xlarge”-(8X-H/W) cloud-instance in “(a)”, which replaces it (previous “m4.2xlarge”-cloud-instance-(4X-H/W)) Host Computer Cloud Instance 205-C).

(iii) Note 3 (for Bank-of-Instance-H/W): (Amazon EC2 instance) (4X-H/W) for m4.2xlarge-cloud-instance (in FIG. 18B's Table-2, row F) is “8-vCPU, 26-ECU, and 32-Gigabyte (Memory)”.

(iv) Note 4 (for Bank-of-Instance-H/W): (Amazon EC2 instance) (8X-H/W) for “m4.4xlarge”-cloud-instance (in FIG. 18B's Table-2, row G) is “16-vCPU, 53.5-ECU, and 64-Gigabyte (Memory)”.

(Explanation)-notes-1-to-4 for Bank-of-Instance-H/W in FIG. 32C:

(i) Note 1 (for Bank-of-Instance-H/W): 600X-single-(virtualized)-hardware-(for FIG. 31C, row-“J”, column-“VI”) is defined-(here)-as-equal-to (1) “computing cloud's virtualized-hardware (i.e. vCPU. ECU, memory, bandwidth-(of), and other computing-cloud-resources, if any)”-in-(or-used-by)-cloud-instance-“m4.custom.400X”-(Amazon-EC2) MINUS (2) “computing cloud's virtualized-hardware-(i.e. vCPU, ECU, memory, bandwidth-(of), and other computing-cloud-resources, if any)”-in-(or-used-by)-cloud-instance-“m4.custom.100X”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 600X-single-(virtualized)-hardware-(for Notes-1-and-2 in FIG. 32C, and for FIG. 31C, row-“J”, column-“VI”) is:
(by definition here:) “1,600-vCPU, 5.200-ECU, and 6,400-Gigabyte (Memory)”-(which is “m4.custom.400X”-(800X-H/W)-(from-Note-4-below)) MINUS “400-vCPU, 1,300-ECU, and 1,600-Gigabyte (Memory)”-(which is “m4.custom.400X”-cloud-instance-(800X-H/W)-(from-Note-3-below)).
   =(600X-H/W)-“1,200-vCPU, 3,900-ECU, and 4,800-Gigabyte (Memory)” (which (for illustration) is 600X-single-(virtualized)-hardware-(for Notes-1-and-2 in FIG. 32C, and for FIG. 31C, row-“J”, column-“VI”).

(ii) Note 2 (for Bank-of-Instance-H/W): To add-(virtualized)-hardware above (as alternative-to-“Note 1”), Computing Cloud 198 may (in FIG. 32C):

(a) Launch-or-assign a “m4.custom.400X”-(800X-H/W) Amazon-EC2-cloud-instance; and
(b) Assign the I.P./URL address of (previous) Host Computer Cloud Instance 205-C (of “m4.custom.100X”-cloud-instance-(200X-H/W) Amazon-EC2) to the launched-or-assigned “m4.custom.400X”-(800X-H/W) cloud-instance in “(a)”, which replaces it (previous “m4.custom.100X”-cloud-instance-(200X-H/W)) Host Computer Cloud Instance 205-C).

(iii) Note 3 (for Bank-of-Instance-H/W): (Amazon EC2 instance) (200X-H/W) for “m4.custom.100X”-cloud-instance (in FIG. 31B's Table-2, row L) is “400-vCPU, 1,300-ECU, and 1,600-Gigabyte (Memory)”.

“m4.custom.100X”-(200X-H/W)-cloud-instance (Amazon EC2) requires custom-(virtualized)-H/W from Amazon (since it is not in regular price-list of Amazon EC2).

(iv) Note 4 (for Bank-of-Instance-H/W): (Amazon EC2 instance) (800X-H/W) for “m4.custom.400X”-cloud-instance (in FIG. 31B's Table-2, row M) is “1,600-vCPU, 5,200-ECU, and 6,400-Gigabyte (Memory)”.

“m4.custom.400X”-(800X-H/W)-cloud-instance (Amazon EC2) requires custom-(virtualized)-H/W from Amazon (since it is not in regular price-list of Amazon EC2).

(Explanation)-notes-1-to-4 for Bank-of-Instance(s)-H/W in FIG. 32D:

(i) Note 1 (for Bank-of-Instance-H/W): 1X-single-(virtualized)-hardware-(for FIG. 31E, row-“K”, column-“VI”) is defined-(here)-as-equal-to (1) “computing cloud's virtualized-hardware (i.e. vCPU, ECU, memory, bandwidth-(of), and other computing-cloud-resources, if any)”-in-(or-used-by)-cloud-instance-“m4.xlarge”-(Amazon-EC2) MINUS (2) “computing cloud's virtualized-hardware-(i.e. vCPU. ECU, memory, bandwidth-(of), and other computing-cloud-resources, if any)”-in-(or-used-by)-cloud-instance-“m4.large”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 1X-single-(virtualized)-hardware-(for Notes-1-and-2 in FIG. 32D, and for FIG. 31E, row-“K”, column-“VI”) is:
(by definition here:) “4-vCPU, 13-ECU, and 16-Gigabyte (Memory)”-(which is “m4.xlarge”-(2X-H/W)-(from-Note-3-below)) MINUS “2-vCPU, 6.5-ECU, and 8-Gigabyte (Memory)”-(which is “m4.large”-cloud-instance-(1X-HL/W)-(from-Note-4-below)).
   =(1X-H/W)-“2-vCPU, 6.5-ECU, and 8-Gigabyte (Memory)” (which (for illustration) is 1X-single-(virtualized)-hardware-(for Notes-1-and-2 in FIG. 32D, and for FIG. 31E, row-“K”, column-“VI”).
   Please note that the 1X-Single-Hardware in Note-1 is NOT “m4.large”-(1X-H/W)-cloud-instance (in Note-4 below) (and they CANNOT be interchanged).

(ii) Note 2 (for Bank-of-Instance-H/W): To remove-(virtualized)-hardware above (as alternative-to-“Note 1”), Computing Cloud 198 may (in FIG. 32D):

(a) Launch-or-assign a “m4.large”-(1X-H/W) Amazon-EC2-cloud-instance; and
(b) Assign the I.P./URL address of (previous) Host Computer Cloud Instance 205-C (of “m4.xlarge”-cloud-instance-(2X-H/W) Amazon-EC2) to the launched-or-assigned “m4.large”-(1X-H/W) cloud-instance in “(a)”, which replaces it (previous “m4.xlarge”-cloud-instance-(2X-H/W)) Host Computer Cloud Instance 205-C).

(iii) Note 3 (for Bank-of-Instance-H/W): (Amazon EC2 instance) (2X-H/W) for m4.xlarge-cloud-instance (in FIG. 18B's Table-2, row “E”) is “4-vCPU, 13-ECU, and 16-Gigabyte (Memory)”.

(iv) Note 4 (for Bank-of-Instance-H-W): (Amazon EC2 instance) (1X-H/W) for “m4.large”-cloud-instance (in FIG. 18B's Table-2, row “D”) is “2-vCPU, 6.5-ECU, and 8-Gigabyte (Memory)”.

(Explanation)-notes-1-to-4 for Bank-of-Instance-H/W in FIG. 32E:

(i) Note 1 (for Bank-of-Instance-H/W): 4X-single-(virtualized)-hardware-(for FIG. 31E, row-“I”, column-“VI”) is defined-(here)-as-equal-to (1) “computing cloud's virtualized-hardware (i.e. vCPU. ECU, memory, bandwidth-(of), and other computing-cloud-resources, if any)”-in-(or-used-by)-cloud-instance-“m4.4xlarge”-(Amazon-EC2) MINUS (2) “computing cloud's virtualized-hardware-(i.e. vCPU, ECU, memory, bandwidth-(of), and other computing-cloud-resources, if any)”-in-(or-used-by)-cloud-instance-“m4.2xlarge”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 4X-single-(virtualized)-hardware-(for Notes-1-and-2 in FIG. 32E, and for FIG. 31E, row-“I”, column-“VF”) is:
(by definition here:) “16-vCPU, 53.5-ECU, and 64-Gigabyte (Memory)”-(which is “m4.4xlarge”-(8X-H/W)-(from-Note-3-below)) MINUS “8-vCPU, 26-ECU, and 32-Gigabyte (Memory)”-(which is “m4.2xlarge”-cloud-instance-(4X-H/W)-(from-Note-4-below)).
   =(4X-H/W)-“8-vCPU, 27.5-ECU, and 32-Gigabyte (Memory)” (which (for illustration) is 4X-single-(virtualized)-hardware-(for Notes-1-and-2 in FIG. 32E, and for FIG. 31E, row-“1”, column-“VI”).

Please note that the 4X-Single-Hardware in Note-1 is NOT “m4.2xlarge”-(4X-H/W)-cloud-instance (in Note-4 below) (and they CANNOT be interchanged).

(ii) Note 2 (for Bank-of-Instance-H/W): To remove-(virtualized)-hardware above (as alternative-to-“Note 1”), Computing Cloud 198 may (in FIG. 32E):

(a) Launch-or-assign a “m4.2xlarge”-(4X-H/W) Amazon-EC2-cloud-instance; and
(b) Assign the I.P/URL address of (previous) Host Computer Cloud Instance 205-C (of “m4.4xlarge”-cloud-instance-(8X-H/W) Amazon-EC2) to the launched-or-assigned “m4.2xlarge”-(4X-H/W) cloud-instance in “(a)”, which replaces it (previous “m4.4xlarge”-cloud-instance-(8X-H/W)) Host Computer Cloud Instance 205-C).

(iii) Note 3 (for Bank-of-Instance-H/W): (Amazon EC2 instance) (8X-H/W) for m4.4xlarge-cloud-instance (in FIG. 31B's Table-2, row G) is “16-vCPU, 53.5-ECU, and 64-Gigabyte (Memory)”.

(iv) Note 4 (for Bank-of-Instance-H/W): (Amazon EC2 instance) (4X-H/W) for “m4.2xlarge”-cloud-instance (in FIG. 31B's Table-2, row F) is “8-vCPU, 26-ECU, and 32-Gigabyte (Memory)”.

(Explanation)-notes-1-to-4 for Bank-of-Instance(s)-H/W in FIG. 32F:

(i) Note 1 (for Bank-of-Instance-H/W): 4X-single-(virtualized)-hardware-(for FIG. 31E, row-“I”, column-“VI”) is defined-(here)-as-equal-to (1) “computing cloud's virtualized-hardware (i.e. vCPU, ECU, memory, bandwidth-(of), and other computing-cloud-resources, if any)”-in-(or-used-by)-cloud-instance-“m4.custom.20X”-(Amazon-EC2) MINUS (2) “computing cloud's virtualized-hardware-(i.e. vCPU, ECU, memory, bandwidth-(of), and other computing-cloud-resources, if any)”-in-(or-used-by)-cloud-instance-“m4.16xlarge”-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 8X-single-(virtualized)-hardware-(for Notes-1-and-2 in FIG. 32F, and for FIG. 31E, row-“I”, column-“VI”) is:
(by definition here:) “m4.custom.20X”-(40X-H/W)-(which is “80-vCPU, 235-ECU, and 320-Gigabyte (Memory)”)-(which equals (from Note-3 below): (40X-H/W)=40-TIMES-(1X-H/W)=40-TIMES-“2-vCPU, 6.5-ECU, and 8-Gigabyte (Memory)” (which (“1X-H/W”)-is-shown-in-FIG. 31B's row-“D”-and-columns-“IV-to-VI”) MINUS

“64-vCPU, 188-ECU, and 256-Gigabyte (Memory)”-(which is “m4.16xlarge”-cloud-instance-(32X-H/W)-(from-Note-4-below))

=(8X-H/W)-“16-vCPU, 47-ECU, and 64-Gigabyte (Memory)” (which (for illustration) is 8X-single-(virtualized)-hardware-(for Notes-1-and-2 in FIG. 32F, and for FIG. 31E, row-“I”, column-“VI”).

(ii) Note 2 (for Bank-of-Instance-H/W): To remove-(virtualized)-hardware above (as alternative-to-“Note 1”), Computing Cloud 198 may (in FIG. 32F):

(a) Launch-or-assign a “m4.16xlarge”-(32X-H/W) Amazon-EC2-cloud-instance; and
(b) Assign the I.P./URL address of (previous) Host Computer Cloud Instance 205-C (of “m4.custom.20X”-cloud-instance-(40X-H/W) Amazon-EC2) to the launched-or-assigned “m4.16xlarge”-(32X-H/W) cloud-instance in “(a)”, which replaces it (previous “m4. custom.20X”-cloud-instance-(40X-H/W)) Host Computer Cloud Instance 205-C).

(iii) Note 3 (for Bank-of-Instance-H/W): (Amazon EC2 instance) (40X-H/W) for “m4.custom.20X”-cloud-instance is “80-vCPU, 235-ECU, and 320-Gigabyte (Memory)”. Please note that 40X-HW=40-TIMES-(1X-H/W)

=40-TIMES-“2-vCPU, 6.5-ECU, and 8-Gigabyte (Memory)”, which is (from-“1X-H/W”)-shown-in-FIG. 31B's row-“D”-and-columns-“IV-to-VI”), and =“80-vCPU, 235-ECU, and 320-Gigabyte (Memory)”-(40X-H/W) (for “m4.custom.20X”-cloud-instance).

“m4.custom.20X”-(40X-H/W)-cloud-instance (Amazon EC2) (not shown in FIG. 31B's Table-2) requires custom-(virtualized)-H/W from Amazon (since it is not in regular price-list of Amazon EC2).

(iv) Note 4 (for Bank-of-Instance-H/W): (Amazon EC2 instance) (32X-H/W) for “m4.16xlarge”-cloud-instance (in FIG. 31B's Table-2, row I) is “64-vCPU, 188-ECU, and 256-Gigabyte (Memory)”.

(Explanation)-notes-1-to-4 for Bank-of-Instance-H/W in FIG. 32G:

(i) Note 1 (for Bank-of-Instance-H/W): 2X-single-(virtualized)-hardware-(for FIG. 31C, rows-“B+C”, column-“VI”) is defined-(here)-as-equal-to (1) “computing cloud's virtualized-hardware (i.e. vCPU, ECU, memory, bandwidth-(of), and other computing-cloud-resources, if any)”-in-(or-used-by)-cloud-instance-“m4.xlarge”-(Amazon-EC2) MINUS (2) “computing cloud's virtualized-hardware-(i.e. vCPU, ECU, memory, bandwidth-(of), and other computing-cloud-resources, if any)”-in-(or-used-by)-“Zero/None/Empty”-cloud-instance-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 2X-single-(virtualized)-hardware-(for Notes-1-and-2 in FIG. 32G, and for FIG. 31C, rows-“‘B’+‘C.’”, column-“VI”) is:
(by definition here:) “4-vCPU, 13-ECU, and 16-Gigabyte (Memory)”-(which is “m4.xlarge”-(2X-H/W)-(from-Note-4-below)) MINUS “0-vCPU, 0-ECU, and 0-Gigabyte (Memory)”-(which is “Zero/None/Empty”-cloud-instance-(0X-H/W)-(from-Note-3-below)).
   =(2X-H/W)-“4-vCPU, 13-ECU, and 16-Gigabyte (Memory)” (which (for illustration) is 2X-single-(virtualized)-hardware-(for Notes-1-and-2 in FIG. 32G, and for FIG. 31C, rows-“‘B’+° C.’”, column-“VI”).

Please note that the 2X-Single-Hardware in Note-1 may NOT be “m4.xlarge”-(2X-H/W)-cloud-instance (in Note-4 below) (and they should NOT be interchanged).

(ii) Note 2 (for Bank-of-Instance-H/W): To add-(virtualized)-hardware above (as alternative-to-“Note 1”), Computing Cloud 198 may (in FIG. 32F):

(a) Launch-or-assign a “m4.2xlarge”-(4X-H/W) Amazon-EC2-cloud-instance; and
(b) Assign the I.P./URL address of (previous) Host Computer Cloud Instance 205-C (of “Zero/None/Empty”-cloud-instance-(0X-H/W) Amazon-EC2) to the launched-or-assigned “m4. xlarge”-(2X-H/W) cloud-instance in “(a)”, which replaces it (previous “Zero/None/Empty”-cloud-instance-(0X-H/W)) Host Computer Cloud Instance 205-C).

(iii) Note 3 (for Bank-of-Instance-H/W): (Amazon EC2 instance) (0X-H/W) for “Zero/None/Empty”-cloud-instance (in FIG. 31B's Table-2, row C) is “0-vCPU, 0-ECU, and 0-Gigabyte (Memory)”.

“Zero/None/Empty”-(0X-H/W)-cloud-instance (Amazon EC2) may need custom-(virtualized)-H/W from Amazon (since it is not in regular price-list of Amazon EC2).

(iv) Note 4 (for Bank-of-Instance-H/W): (Amazon EC2 instance) (4X-H/W) for “m4.2xlarge”-cloud-instance (in FIG. 31B's Table-2, row F) is “8-vCPU, 26-ECU, and 32-Gigabyte (Memory)”.

(Explanation)-notes-1-to-4 for Bank-of-Instance-H/W in FIG. 32H:

(i) Note 1 (for Bank-of-Instance-H/W): 2X-single-(virtualized)-hardware-(for FIG. 31E, rows-“K”-and-“L”, column-“VI”) is defined-(here)-as-equal-to (1) “computing cloud's virtualized-hardware (i.e. vCPU, ECU, memory, bandwidth-(of), and other computing-cloud-resources, if any)”-in-(or-used-by)-cloud-instance-“m4.xlarge”-(Amazon-EC2) MINUS (2) “computing cloud's virtualized-hardware-(i.e. vCPU, ECU, memory, bandwidth-(of), and other computing-cloud-resources, if any)”-in-(or-used-by)-“Zero/None/Empty”-(0X-H/W)-cloud-instance-(Amazon-EC2):
Bandwidth-(of) and other computing cloud resources, if any, in the (e.g. Amazon EC2) cloud instances (in addition to their vCPU, ECU, and memory) are by definition-in-this-invention part of the virtualized-hardware of the (e.g. Amazon EC2) cloud instances.

In other words, (for illustration) 2X-single-(virtualized)-hardware-(for Notes-1-and-2 in FIG. 32H, and for FIG. 31E, rows-“‘K’-and-‘L’”, column-“VI”) is:
(by definition here:) “4-vCPU, 13-ECU, and 16-Gigabyte (Memory)”-(which is “m4.xlarge”-(2X-H/W)-(from-Note-4-below)) MINUS “0-vCPU, 0-ECU, and 0-Gigabyte (Memory)”-(which is “Zero/None/Empty”-cloud-instance-(0X-H/W)-(from-Note-3-below)).
   =(2X-H/W)-“4-vCPU, 13-ECU, and 16-Gigabyte (Memory)” (which (for illustration) is 2X-single-(virtualized)-hardware-(for Notes-1-and-2 in FIG. 32G, and for FIG. 31C, rows-“K”-and-“L”, column-“VI”).

Please note that the 2X-Single-Hardware in Note-1 may NOT be “m4.xlarge”-(2X-H/W)-cloud-instance (in Note-4 below) (and they should NOT be interchanged).

(ii) Note 2 (for Bank-of-Instance-H/W): To remove-(virtualized)-hardware above (as alternative-to-“Note 1”), Computing Cloud 198 may (in FIG. 32H):

(a) Launch-or-assign a “Zero/None/Empty”-(0X-H/W) Amazon-EC2-cloud-instance; and
(b) Assign the I.P./URL address of (previous) Host Computer Cloud Instance 205-C (of “m4.xlarge”-cloud-instance(2X-H/W) Amazon-EC2) to the launched-or-assigned “Zero/None/Empty”-(0X-H/W) cloud-instance in “(a)”, which replaces it (previous “m4.xlarge”-cloud-instance-(2X-H/W)) Host Computer Cloud Instance 205-C).

(iii) Note 3 (for Bank-of-Instance-H/W): (Amazon EC2 instance) (0X-H/W) for “Zero/None/Empty”-cloud-instance (in FIG. 31B's Table-2, row C) is “0-vCPU, 0-ECU, and 0-Gigabyte (Memory)”.

“Zero/None/Empty”-(0X-H/W)-cloud-instance (Amazon EC2) may need custom-(virtualized)-H/W from Amazon (since it is not in regular price-list of Amazon EC2).

(iv) Note 4 (for Bank-of-Instance-HL/W): (Amazon EC2 instance) (2X-H/W) for “m4.xlarge”-cloud-instance (in FIG. 31B's Table-2, row E) is “4-vCPU, 13-ECU, and 16-Gigabyte (Memory)”.

1. A computer-implemented method used in a server (capable-of-use-together with a computer-implemented method used in a computing cloud, and/or capable-of-use-together with a computer-implemented method used in one or more first computers) for facilitating Internet application services between one or more first computers and one or more second computers coupled to a network, the method comprising the steps of:
receiving, by the server, from one of the first computers a request to start a new Internet application service; and
requesting, by the server (and responsive to said request from said-one-of-the-first-computers to start said new Internet application service), to a computing cloud to send to the server, a first internet protocol (IP) address corresponding to a cloud instance (of said computing cloud and providing said Internet application service) of said-one-of-the-first-computers, wherein said cloud instance (of said computing cloud and) of said-one-of-the-first-computers is communicatively coupled to said-one-of-the-first-computers; and
said request (by the server to said computing cloud to send to the server, a first internet protocol (IP) address corresponding to a cloud instance (of said computing cloud and providing said Internet application service) of said-one-of-the-first-computers) enables said computing cloud to operate:
(i) (said request by the server to said computing cloud enables said computing cloud) to launch a group of not-less-than-one cloud instance(s), wherein each-of-the-said-(not-less-than-one)-cloud-instance(s) (is/are) providing said Internet application service (requested by said-one-of-the-first-computers); and
(ii)(a) DELETED
(ii)(b) DELETED
(ii)(c) DELETED-
(iii) (said request by the server to said computing cloud enables said computing cloud) to select-(randomly) (not-less-than-one) cloud-instance as the host computer cloud instance (in said group-of-(not-less-than-one)-cloud-instance(s) providing said Internet application service)); and
(iv) (said request by the server to said computing cloud enables said computing cloud) to use-(and-assign-and-save) the IP address of said selected-(randomly) (not-less-than-one) cloud-instance as the IP address of host computer cloud instance (and which (IP address) is ((to-be-assigned) to-be the first IP address) (in said group-of-cloud-instances providing said Internet application service requested by said-one-of-the-first-computers); and
(v) (said request by the server to said computing cloud enables said computing cloud) to have said said-selected-(randomly) cloud instance (which IP address was used-and-assigned-to-be said first IP address, and which (cloud instance) provides said Internet application service requested by said-one-of-the-first-computers) to be communicatively coupling to said-one-of-the-first-computers; and
(vi) (said request by the server to said computing cloud enables said computing cloud) to send (by said computing cloud) to the server said first IP address, and corresponding to said-selected-(randomly)-cloud-instance, and which (cloud-instance) is in said group-of-(not-less-than-one)-cloud-instances (providing said Internet application service requested by said-one-of-the-first-computers), (said-computing-cloud) responsive to said computing cloud receiving said request, from the server, to send to the server a first IP address corresponding to a cloud instance (of said computing cloud and) providing said Internet application service requested by said-one-of-the-first-computers; and
receiving, by the server (and responsive to the server requesting said computing cloud to send to the server an IP address corresponding to a cloud instance (of said computing cloud and) providing said Internet application service of said-one-of-the-first-computers), from said computing cloud said first IP address corresponding to said cloud instance of said-one-of-the-first-computers providing said Internet application service; and
storing, by the server, said first IP address (received from said computing cloud, and) corresponding to said cloud instance (of said computing cloud and) of said-one-of-the-first-computers, and providing said Internet application service requested by said-one-of-the-first-computers.

2. The method of claim 1, further comprising the step of:
receiving, by the server, from one of the second computers a request to join said Internet application service of said cloud instance (of said computing cloud and identified by said first IP address, and) of said-one-of-the-first-computers; and
receiving, by the server, from said one of the second computers a second internet protocol (IP) address corresponding to said one of the second computers.

3. The method of claim 2, further comprising the steps of:
sending, by the server, to said one of the second computers said first IP address corresponding to said cloud instance (of said computing cloud and) of said-one-of-the-first-computers providing said Internet application service, responsive to the server receiving said request from said one of the second computers to join said Internet application service; and
said first IP address enabling said one of the second computers to directly connect to said cloud instance (of said computing cloud and identified by said first IP address) of said-one-of-the-first-computers providing said Internet application service; and
said first IP address (corresponding to said cloud instance of said computing cloud and providing said Internet application service of said-one-of-the-first-computers) enabling said one of the second computers to send data directly to said cloud instance (of said computing cloud and identified by said first IP address and) of said-one-of-the-first-computers, and (said first IP address) enabling said one of the second computers to receive data directly from said cloud instance (identified by said first IP address) of said-one-of-the-first-computers, via a direct network connection between said first IP address corresponding to said cloud instance of said-one-of-the-first-computers and said second IP address corresponding to said one of the second computers.

4. The method of claim 2, further comprising the steps of:
connecting, by the server, to said first IP address corresponding to said cloud instance of said-one-of-the-first-computers providing said Internet application service, responsive to receiving, by the server, a request from said one of the second computers to join said Internet application service of said cloud instance (identified by said first IP address) of said-one-of-the-first-computers; and
sending, by the server, to said first IP address (corresponding to said cloud instance of said-one-of-the-first-computers) said second IP address corresponding to said one of the second computers, responsive to the server receiving said request from said one of the second computers to join said Internet application service, and
said second IP address enabling said cloud instance (identified by said first IP address) of said-one-of-the-first-computers, using said second IP address, to directly connect to said one of the second computers identified by said second IP address; and
said second IP address enabling said cloud instance (identified by said first IP address) of said-one-of-the-first-computers to send data directly to said one of the second computers, and (said second IP address) enabling said cloud instance (identified by said first IP address) of said-one-of-the-first-computers to receive data directly from said one of the second computers, via a direct network connection between said first IP address corresponding to said cloud instance of said-one-of-the-first-computers and said second IP address corresponding to said one of the second computers.

5. The method of claim 2, wherein receiving, by the server, said request from said one of the second computers to join said Internet application service comprises the steps of;
hosting, by the server, a website displaying a list of one or more Internet application services (including said Internet application service of said cloud instance (identified by said first IP address and running one or more host helper programs) of said-one-of-the-first-computers) available; and
receiving, by the server, from said one of the second computers a selection of one or more of said Internet application services (including said Internet application service of said cloud instance (identified by said first IP address) of said-one-of-the-first-computers) to join (and to use (said-selection-of-Internet-application-services), to request (by the server) said computing cloud to launch a cloud instance (of said-one-of-the-first-computers) to provide said Internet application service(s)).

6. The method of claim 2, wherein receiving said request from said one of the second computers to join said Internet application service comprises the step of:
receiving, by the server, from said one of the second computers a sub-domain uniform resource locator (URL) to URL forward to said first IP address corresponding to said cloud instance of said-one-of-the-first-computers providing said Internet application service.

7. The method of claim 1, wherein receiving said request from said-one-of-the-first-computers to start said new Internet application service comprises the steps of:
hosting, by the server, a website displaying a list of one or more of the host helper programs available for the first computers; and
receiving, by the server, from said-one-of-the-first-computers a selection of one or more of said host helper programs to use (by the server) to said computing cloud to launch a cloud instance to provide said Internet application service (using said (selection by said-one-of-the-first-computers of) one or more of said host helper programs).

8. The method of claim 1, wherein said cloud instance (identified by said first IP address) of said-one-of-the-first-computers is communicatively coupled to said-one-of-the-first-computers; and
said cloud instance (identified by said first IP address) of said-one-of-the-first-computers being coupled to the network enables said-one-of-the-first-computers to decouple from the network.

9. The method of claim 1, wherein:
(i) said request by the server (to said computing cloud to send to the server, a first IP address corresponding to a cloud instance (of said computing cloud and providing said Internet application service) of said-one-of-the-first-computers) enables said computing cloud) to launch a group of not-less-than-one cloud instance(s), wherein each-of-the-said-(not-less-than-one)-cloud-instance(s) (is/are) providing said Internet application service (requested by said-one-of-the-first-computers); and further comprising the steps of:
said request by the server (to said computing cloud enabling said computing cloud to launch a group of not-less-than-one cloud instance(s)) enables said computing cloud to launch (a group of) one cloud instance (providing said Internet application service requested by said-one-of-the-first-computers), as:
one cloud instance is (also) a group of one cloud instance, which is (also) a group of not-less-than-one cloud instance (as one is (also) not-less-than-one).
(ii). DELETED
(ii)(a). DELETED
(ii)(b). DELETED
(iii) (said request by the server to said computing cloud enables said computing cloud) to select-(randomly) (not-less-than-one) cloud-instance as the host computer cloud instance (in said group-of-(not-less-than-one)-cloud-instance(s) providing said Internet application service)); and further comprising the steps of:
said request by the server to said computing cloud enabling said computing cloud to select-(randomly) (not-less-than-one) cloud-instance as the host computer cloud instance enables said computing cloud to select the-on-(one)-cloud-instance (in said bank-of-(one)-cloud-instance providing said Internet application service) as host computer cloud instance, as:
“the-only-one” is (also) “one”, which is (also) (not-more-than-one); and
(iv) said request by the server to said computing cloud enables said computing cloud to use-(and-assign-and-save) the IP address of said selected-(randomly) (not-more-than-one) cloud-instance as the IP address of host computer cloud instance (and which (IP address) is (to-be-assigned) to-be the first IP address) (in said group-of-cloud-instances providing said Internet application service requested by said-one-of-the-first-computers); and further comprising the steps of:
said request by the server to said computing cloud enabling said computing cloud to use-(and-assign-and-save) the IP address of said selected-(randomly) (not-more-than-one) cloud-instance (as the IP address of host computer cloud instance) enables said computing cloud to use-(and-assign-and-save) the IP address of said-selected-(the-only-one) (said)-cloud-instance as IP address of host computer cloud instance (and which IP address) is (to-be-assigned) to-be the first IP address), as:
“the-only-one” is (also) “one”, which is (also) (not-more-than-one); and
(v) said request by the server (to said computing cloud to send to the server, a first IP address corresponding to a cloud instance (of said computing cloud and providing said Internet application service) of said-one-of-the-first-computers) enables said computing cloud to send to the server said first IP address, which first-IP-address used-and-was-assigned the IP address of said-selected the-only-one-said-cloud-instance.

10. A computer-implemented method used in a computing cloud (capable-of-use-together with a computer-implemented method used in a server, and/or capable-of-use-together with a computer-implemented method used in one or more first computers), running on top of one or more data-center computers for facilitating Internet application services between one or more first computers and one or more second computers coupled to a network, the method comprising the steps of:
receiving, by said computing cloud, a request from a server to send to said server an Internet protocol (IP) address corresponding to (a cloud instance providing) an Internet application service, (said server) responsive to said server receiving a request from one of the first computers to publish (for use by Internet users) said Internet application service (provided by a cloud instance of said computing cloud); and
launching, by said computing cloud, a group of not-less-than-one cloud instance(s) providing said Internet application service (requested to-be-published by said-one-of-the-first-computers). (said-computing-cloud responsive to said computing cloud receiving said request, from said server, to send to said server an Internet protocol (IP) address corresponding to (a cloud instance of said computing cloud and providing) said Internet application service (requested to-be-published by said-one-of-the-first-computers), wherein:
(i) said computing cloud (not-more-than-one)-attempts to connect to each-of-the-(not-less-than-one)-cloud-instance(s) (in said group-of-cloud-instances providing said Internet application service), and to receive (not-more-than-one)-response from each of said-(not-less-than-one)-cloud-instance(s); and
(ii) said computing cloud selects the (not-more-than-one) fastest-cloud-instance-(to-respond) (to said-computing-cloud's said (not-more-than-one)-attempt(s) to connect to each-of-the-(not-less-than-one)-said-cloud-instance(s) (in said group-of-cloud-instances providing said Internet application service)); and
(iii) said computing cloud uses-(and-assigns-and-saves) IP address of selected-fastest-(not-more-than-one)-cloud-instance-(to-respond) as the IP address (to-be-identified-as the first IP address) of (selected) host computer cloud instance providing said Internet application service (requested by said server and) requested-to-be-published by said-one-of-the-first-computers; and
(iv). said computing cloud has said cloud instance (and (assigned-to-and-be)-identified-by the first IP address, and providing said Internet application service (requested by said server and) requested-to-be-published by said-one-of-the-first-computers) to be communicatively coupling to said-one-of-the-first-computers; and
(v) said computing cloud sends (by said computing cloud) to said server said first IP address (assigned-to-and)-corresponding to said cloud instance, and which is in said group-of-cloud-instances (of said computing cloud and) of said-one-of-the-first-computers providing said Internet application service, (said-computing-cloud) responsive to said computing cloud receiving said request, from said server, to send to said server a(n) (first) IP address corresponding to a cloud instance (of said computing cloud and) providing said Internet application service of said-one-of-the-first-computers; and
said first IP address, sent by said computing cloud and to said server (and said-computing-cloud responsive to said computing cloud receiving said request, from said server, to send to said server a first IP address corresponding to a cloud instance (of said computing cloud and) providing said Internet application service), enables said server to receive and to store (by said server) said first IP address corresponding to said cloud instance (of said computing cloud and) of said-one-of-the-first-computers (which said cloud instance was assigned (said first IP address), and providing said Internet application service requested to-be-published by said-one-of-the-first-computers).

11. The method of claim 10, wherein sending (by said computing cloud) to said server said first IP address corresponding to said cloud instance (of said computing cloud and providing said Internet application service requested to be published (at a website of said server) by said-one-of-the-first-computers further comprises the steps of:
said computing cloud imports a virtual machine, from said-one-of-the-first-computers, with an installed host helper program to provide said Internet application service of said cloud instance (of said computing cloud and identified by said first IP address, and) of said-one-of-the-first-computers; and
said computing cloud launches said cloud instance (of said computing cloud and identified by said first IP address, and of said-one-of-the-first-computers) by starting and operating said imported virtual machine (imported from said-one-of-the-first-computers, and running said installed host helper program to provide said Internet application service); and
said computing cloud sends to said server said first IP address corresponding to said cloud instance (of said computing cloud and launched by said computing cloud and providing said Internet application service) of said-one-of-the-first-computers, (said-computing-cloud) responsive to said computing cloud receiving said request, from said server, to send to said server an IP address corresponding to a cloud instance (of said computing cloud and providing said Internet application service requested to be published (at a website of said server) by said-one-of-the-first-computers); and
(said request, from said server, to send to said server said (first) IP address enables) receiving, by said server (and responsive to said server requesting said computing cloud to send to said server an IP address corresponding to a cloud instance (of said computing cloud and) providing said Internet application service of said-one-of-the-first-computers), from said computing cloud said first IP address corresponding to said cloud instance (of said computing cloud and) of said-one-of-the-first-computers providing said Internet application service; and
(said request, from said server, to send to said server said (first) IP address enables:) (i) (enables receiving and) storing, by said server, said first IP address corresponding to said cloud instance (of said computing cloud and) providing said Internet application service of said-one-of-the-first-computers, and (ii) (enables) publishing said Internet application service (requested to-be-published by said-one-of-the-first-computers) at a website of said server.

12. The method of claim 11, wherein said computing cloud sending to said server said first IP address (corresponding to said cloud instance launched by said computing cloud, and providing said Internet application service requested to-be-published by said-one-of-the-first-computers) enables said server to publish said Internet application service at said website of said server which (said publishing said Internet application service) enables, and further comprising:
(a)(i) (said publishing of said Internet application service) enables receiving, at said website and by said server, from one of the second computers a request to join said Internet application service provided by said cloud instance (of said computing cloud and identified by said first IP address, and) of said-one-of-the-first-computers; and
(a)(ii) (said publishing of said Internet application service) enables receiving, at said website and by said server, from said one of the second computers a second internet protocol (IP) address corresponding to said one of the second computers; and
(b)(i) said computing cloud sending (to said server) said first IP address corresponding to said cloud instance (of said computing cloud and providing said Internet application service of said-one-of-the-first-computers) enables aid server to send to one of the second computers said first IP address corresponding to said cloud instance (of said computing cloud and providing said Internet application service) of said-one-of-the-first-computers, (said server) responsive to said server receiving said request from said one of the second computers to join said Internet application service, and
(b)(ii) (said computing cloud sending to said server said first IP address, which enables said server to send (it) to said one of the second computers, which) said first IP address enables said one of the second computers to directly connect to said cloud instance (of said computing cloud and identified by said first IP address, and) of said-one-of-the-first-computers, (said one of the second computers) responsive to said one of the second computers receiving, from said server (responsive to said server receiving said request, from said one of the second computers, to join said Internet application service), said first IP address corresponding to said cloud instance (of said computing cloud and providing said Internet application service) of said-one-of-the-first-computers; and
said first IP address enables said one of the second computers to send data directly to said cloud instance (of said computing cloud and identified by said first IP address, and) of said-one-of-the-first-computers, and enables said one of the second computers to receive data directly from said cloud instance (of said computing cloud and identified by said first IP address, and) of said-one-of-the-first-computers, via a direct network connection between said first IP address corresponding to said cloud instance (of said computing cloud and) of said-one-of-the-first-computers and said second IP address corresponding to said one of the second computers.

13. The method of claim 11, wherein said computing cloud sending to said server said first IP address (corresponding to said cloud instance launched by said computing cloud, and providing said Internet application service requested to-be-published by said-one-of-the-first-computers) enables said server to publish said Internet application service at said website of said server which (said publishing said Internet application service) enables, and further comprising:
(a)(i) (said publishing of said Internet application service) enables receiving, at said website and by said server, from one of the second computers a request to join said Internet application service provided by said cloud instance (of said computing cloud and identified by said first IP address, and) of said-one-of-the-first-computers; and
(a)(ii) (said publishing of said Internet application service) enables receiving, at said website and by said server, from said one of the second computers a second internet protocol (IP) address corresponding to said one of the second computers; and
(b) said computing cloud sending (to said server) said first internet protocol (IP) address corresponding to said cloud instance (of said computing cloud and providing said Internet application service of said-one-of-the-first-computers) enables said server to send to said cloud instance (of said computing cloud and identified by said first IP address, and) of said-one-of-the-first-computers said second IP address corresponding to said one of the second computers, (said server) responsive to said server receiving a request from said one of the second computers to join said Internet application service (provided by said cloud instance (of said computing cloud and identified by said first IP address, and) of said-one-of-the-first-computers); and
receiving, by said cloud instance (of said computing cloud and identified by said first IP address, and) of said-one-of-the-first-computers and from said server, said second internet protocol (IP) address corresponding to said one of the second computers, (said server) responsive to said server receiving a request from said one of the second computers to join said Internet application service; and
connecting, by said cloud instance (of said computing cloud and of said-one-of-the-first-computers, and) identified by said first IP address and using said second IP address corresponding to said one of the second computers, directly to said one of the second computers identified by said second IP address; and
said second IP address enables said cloud instance (of said computing cloud and identified by said first IP address, and) of said-one-of-the-first-computers to send data directly to said one of the second computers, and enables said cloud instance (of said computing cloud and identified by said first IP address, and) of said-one-of-the-first-computers to receive data directly from said one of the second computers, via a direct network connection between said first IP address corresponding to said cloud instance (of said computing cloud and) of said-one-of-the-first-computers and said second IP address corresponding to said one of the second computers.

14. The method of claim 10, wherein said cloud instance (of said computing cloud and identified by said first IP address, and) of said-one-of-the-first-computers is communicatively coupled to said-one-of-the-first-computers and to the network; and
said cloud instance (of said computing cloud and identified by said first IP address, and) of said-one-of-the-first-computers being communicatively coupled to said-one-of-the-first-computers enables said-one-of-the-first-computers to decouple from the network.

15. The method of claim 10, wherein, and further comprising the steps of:
(i). receiving, by said computing cloud, said request from said server to send to said server an Internet protocol (IP) address corresponding to (a cloud instance providing) an Internet application service (of said-one-of-the-first-computers) enables said computing cloud to launch a group of not-less-than-one cloud instance(s) providing said Internet application service (requested by said-one-of-the-first-computers); and further comprising the steps of:
said receiving of said request (from said server to said computing cloud enabling said computing cloud to launch a group of not-less-than-one cloud instance(s)) enables said computing cloud to launch (a group of) one-(and-only-one) cloud instance (providing said Internet application service, and) of said-one-of-the-first-computers, as:
(a group of) one-(and-only-one) cloud instance is-(also) one cloud instance, which is-(also) a group of not-less-than-one cloud instance (as one is (also) not-less-than-one); and
(ii). said receiving of said request (from said server to said computing cloud enabling said computing cloud to launch a group of not-less-than-one cloud instance(s)) enables said computing cloud to (not-more-than-one)-attempt to connect to each-of-the-“not-less-than-one”-cloud-instance(s) (in said group-of-cloud-instances providing said Internet application service), and (enables said computing cloud) to receive (not-more-than-one)-response from each-of-the-said-“not-less-than-one”-cloud-instance(s); and further comprising the steps of:
(ii)(a). said receiving of said request (from said server to said computing cloud enabling said computing cloud to (not-more-than-one)-attempt to connect to each-of-the-said-(not-less-than-one)-cloud-instance(s)) enables said computer cloud to zero-(and-not)-attempt to connect to said-one-(and-only-one)-cloud-instance (providing said Internet application service), as
zero-(and-not)-attempt-to-connect is-(also) “zero”-attempt-to-connect, which is-(also) (not-more-than-one)-attempt to connect (as zero is (also) not-more-than-one); and
one-(and-only-one)-cloud-instance is-(also) one-cloud-instance, which is-(also) (each-of-the)-“not-less-than-one”-cloud-instance, as “one” is (also) “not-less-than-one”, and
(ii)(b). said receiving of said request (from said server to said computing cloud enabling said computing cloud to receive “not-more-than-one”-response from each-of-the-“not-less-than-one”-said-cloud-instance(s)) enables said computer cloud to receive zero-(and-no)-response from said-one-(and-only-one)-cloud-instance, as
receive zero-(and-no)-response is-(also) receive “zero”-response, which is-(also) receive “not-more-than-one”-response, and
one-(and-only-one)-cloud-instance is-(also) one-cloud-instance, which is-(also) “not-less-than-one”-cloud-instance; and
(ii)(c) said receiving of zero-(and-no)-response enables (said computing cloud to) create (one)-“virtual”-(zero-“cloud-instance”)-“response” (using software-and-database) (and “virtual”-(zero-“cloud-instance”)-“responses” implementation (by said computing cloud using software-and-database) would be very fast and be fastest-cloud-instances-to-“respond”), as:
“virtual” is digital, and
“virtual”-response is “digital”-response (which is (also) response, and
zero-“cloud-instance” is also cloud-instance (with zero-(virtualized)-hardware), which can be implemented (using software-and-database) with zero-(virtualized)-hardware, and
(ii)(d) (said computing cloud) add-(and-merge) “the-only-(one)-cloud-instance-(and-its-virtualized-hardware)”-(in-above-group-of-cloud-instances launched by said computing cloud above) to the-(one)-virtual-(zero-cloud-instance)-response (created above), and
(ii)(e) (said computing cloud) use-(and-select) the-only-(one)-cloud-instance-(above) (now merged with the (one)-“virtual”-(zero-“cloud-instance”)-“response” as the selected-“fastest”-cloud-instance-(to-“respond”), as:
“virtual”-(zero-“cloud-instance”)-“responses” implementation (by said computing cloud using software-and-database) would be very fast and be fastest-cloud-instances-to-“respond”; and
(iii) said receiving of said request (from said server to said computing cloud enables said computing cloud to select the (not-more-than-one) fastest-cloud-instance-to-respond (to said-computing-cloud's said (not-more-than-one)-attempt(s) to connect to each-of-the-(not-less-than-one)-said-cloud-instance(s)); and further comprising the steps of:
said receiving of said request (from said server to said computing cloud enabling said computing cloud to select the (not-more-than-one) fastest-cloud-instance-to-respond) enables said computing cloud to use-(and-select) the-only-(one)-cloud-instance-(above) (now merged-in-(ii)(d)-above with the (one)-“virtual”-(zero-“cloud-instance”)-“response” as the selected-“fastest”-cloud-instance-(to-“respond”), as
“virtual”-(zero-“cloud-instance”)-“responses” implementation (by said computing cloud using software-and-database) would be very fast and be fastest-cloud-instances-to-“respond”; and
(iv) said receiving of said request (from said server to said computing cloud) enables said computing cloud to use-(and-assign-and-save) IP address of selected-fastest-(not-more-than-one)-cloud-instance-(to-respond) as the IP address (to-be-identified-as the first IP address) of (selected) host computer cloud instance providing said Internet application service (requested by said server and) requested-to-be-published by said-one-of-the-first-computers; and further comprising the steps of:
said receiving (of said request from said server to said computing cloud enabling said computing cloud to assign the first IP address to the said-selected-fastest-cloud-instance-to-respond) enables said computing cloud to use-(and-assign-and-save) IP-address (to-be-identified-as the first IP address) (of said selected-(and-now-merged)-“fastest”-cloud-instance-(to-“respond”) in (iii)) as the IP-address-of-host-computer-cloud-instance.
(v) said request by said server (to said computing cloud to send to said server, a first IP address corresponding to a cloud instance (of said computing cloud and providing said Internet application service) of said-one-of-the-first-computers) enables said computing cloud to send to said server said first IP address corresponding to (said-selected)-host-computer-cloud-instance providing said Internet application service (requested by said server and) requested-to-be-published by said-one-of-the-first-computers.

16. A computer-implemented method used in one or more first computers (capable-of-use-together with a computer-implemented method used in a server, and/or capable-of-use-together with a computer-implemented method used in a computing cloud) for facilitating Internet application services between said one or more first computers and one or more second computers coupled to a network, the method comprising the steps of:
uploading, by said-one-of-the-first-computers, a virtual machine with an installed host helper program (for use by an Internet application service) to a computing cloud; and
requesting, by said-one-of-the-first-computers, to said computing cloud to publish (for use by Internet users) said Internet application service (provided by a cloud instance of said computing cloud) at a website of a server, and:
(a). (said requesting, by said-one-of-the-first-computers, to said computing cloud to publish said Internet application service (of said-one-of-the-first-computers) for use by Internet users) enables said server to publish (for use by Internet users) said Internet application service at said website of said server; and
(b). (said requesting, by said-one-of-the-first-computers, to said computing cloud to publish said Internet application service (of said-one-of-the-first-computers) for use by Internet users at said website of said server) enables said server to request (by said server) to said computing cloud to send to said server, a first Internet protocol (IP) address corresponding to a cloud instance (of said computing cloud and) of said-one-of-the-first-computers providing said Internet application service (using said host helper program), wherein said cloud instance (of said computing cloud and) of said-one-of-the-first-computers is communicatively coupled to said-one-of-the-first-computers; and
(c). (said requesting, by said-one-of-the-first-computers, to said computing cloud to publish said Internet application service at said website of said server enables) said server to request said computing cloud to send to said server, a first IP address corresponding to a cloud instance (of said computing cloud and providing said Internet application service) of said-one-of-the-first-computers, which (said server's request) enables said computing cloud to operate:
(c)(i). (said requesting, by said-one-of-the-first-computers, to said computing cloud to publish said Internet application service at said website of said server, enables said requesting by said server to said computing cloud which enables said computing cloud) to launch a group of not-less-than-one cloud instance(s) providing said Internet application service (requested-to-be-published by said-one-of-the-first-computers); and
(c)(ii). (said requesting, by said-one-of-the-first-computers, to said computing cloud to publish said Internet application service at said website of said server, enables said requesting by said server to said computing cloud which enables said computing cloud) to (not-more-than-one)-attempt to connect to each-of-the-(not-less-than-one)-cloud-instance(s) (in said group-of-cloud-instances of said computing cloud and providing said Internet application service), and to receive (not-more-than-one)-response from each-of-said-(not-less-than-one)-cloud-instance(s); and
(c)(iii). (said requesting, by said-one-of-the-first-computers, to said computing cloud to publish said Internet application service at said website of said server, enables said requesting by said server to said computing cloud which enables said computing cloud) to select the (not-more-than-one) fastest-cloud-instance-to-respond (to said-computing-cloud's said attempt(s) to connect to said-cloud-instance(s) (in said group-of-cloud-instances of said computing cloud and providing said Internet application service)); and
(c)(iv). (said requesting, by said-one-of-the-first-computers, to said computing cloud to publish said Internet application service at said website of said server, enables said requesting by said server to said computing cloud which enables said computing cloud) to use-(and-assig-and-save) IP address of selected-fastest-(not-more-than-one)-cloud-instance-(to-respond) as IP address (to-be-assigned-as-first-IP-address) of the host computer cloud instance (which “cloud-instance's-to-response” is (cloud-instance's)-to-response-to said-computing-cloud's said attempt(s) to connect to said-cloud-instance(s) (in said group-of-cloud-instances (each-of-which) providing said Internet application service requested by said-one-of-the-first-computers)); and
(c)(v). (said requesting, by said-one-of-the-first-computers, to said computing cloud to publish said Internet application service at said website of said server, enables said requesting by said server to said computing cloud which enables said computing cloud) to have said cloud instance (identified-by said-(assigned)-first-IP-address and providing said Internet application service requested by said-one-of-the-first-computers) to be communicatively coupling to said-one-of-the-first-computers; and
(c)(vi) (said requesting, by said-one-of-the-first-computers, to said computing cloud to publish said Internet application service at said website of said server, enables said requesting by said server to said computing cloud which enables said computing cloud) to send (by said computing cloud) to said server said-(assigned) first IP address corresponding to said cloud instance, and which is in said group-of-cloud instances of said-one-of-the-first-computers providing said Internet application service, (said-computing-cloud) responsive to said computing cloud receiving said request, from said server, to send to said server the first IP address corresponding to a cloud instance (of said computing cloud and) providing said Internet application service of (and requested to be published by) said-one-of-the-first-computers; and
(d). (said requesting, by said-one-of-the-first-computers, to said computing cloud to publish said Internet application service at said website of said server enables) said request, by said server and to said computing cloud, to send to said server said first IP address (corresponding to said cloud instance (of said computing cloud and) providing said Internet application service requested-to-be-published by said-one-of-the-first-computers) which (said server's request) enables said server to receive (by said server and from said computing cloud, and store) said first IP address (assigned above, and corresponding to said cloud instance (of said computing cloud and) of said-one-of-the-first-computers providing said Internet application service (requested-to-be-published by said-one-of-the-first-computers).

17. The method of claim 16, and further comprising the steps of, and wherein:
(a) said requesting, by said-one-of-the-first-computers, to said computing cloud (to publish said Internet application service (provided by a cloud instance of said computing cloud) for use by Internet users at said website of said server) enables said server to publish said Internet application service at said website of said server; and
(a)(i). said requesting, by said-one-of-the-first-computers, to said-computing-cloud (to publish said-Internet-application-service for use by Internet users at said website of said-server) enables receiving, at said website and by said server, from one of the second computers a request to join said Internet application service (provided by said cloud instance of said computing cloud and) requested-to-be-published by said-one-of-the-first-computers; and
(a)(ii). said requesting, by said-one-of-the-first-computers, to said-computing-cloud (to publish said-Internet-application-service for use by Internet users at said website of said-server) enables receiving, at said website and by said server, from said one of the second computers a second Internet protocol (IP) address corresponding to said one of the second computers; and
(b)(i). ((said requesting, by said-one-of-the-first-computers, to said computing cloud to publish said Internet application service at said website of said server enables said server to request said computing cloud to send to said server, a first IP address corresponding to a cloud instance (providing said Internet application service) of said-one-of-the-first-computers, which (said server's request) enables said first IP address (corresponding to said cloud instance (of said-one-of-the-first-computers) and providing said Internet application service requested-to-be-published by said-one-of-the-first-computers), (to be) received by said server and from said computing cloud, and (which receipt of said first IP address by said server)) enables said server to send to said one of the second computers said first IP address corresponding to said cloud instance of said-one-of-the-first-computers providing said Internet application service, (said server also) responsive to said server receiving said request from said one of the second computers to join said Internet application service provided by said cloud instance of-(and-requested-to-be-published-by) said-one-of-the-first-computers; and
(b)(ii). (said requesting, by said-one-of-the-first-computers, to publish said Internet application service at said website of said server enables said one of the second computers to request to join said Internet application service of said-one-of-the-first-computers, which enables said server to send to said one of the second computers said first IP address (corresponding to said cloud instance of said-one-of-the-first-computers providing said Internet application service), which (receiving by said one of the second computers of)) said first IP address enables said one of the second computers to directly connect to said cloud instance (identified by said first IP address) of said-one-of-the-first-computers providing said Internet application service, (said one of the second computers) responsive to said one of the second computers receiving said first IP address from said server responsive to said server receiving said request from said one of the second computers to join said Internet application service provided by said cloud instance of said-one-of-the-first-computers; and
(b)(iii). (said requesting, by said-one-of-the-first-computers, to publish said Internet application service at said website of said server enables said one of the second computers to request to join said Internet application service of said-one-of-the-first-computers, which enables said server to send to said one of the second computers said first IP address (corresponding to said cloud instance of said-one-of-the-first-computers providing said Internet application service), which (receiving by said one of the second computers of)) said first IP address enables said one of the second computers to send data directly to said cloud instance (identified by said first IP address) of said-one-of-the-first-computers, and (said first IP address) enables said one of the second computers to receive data directly from said cloud instance (identified by said first IP address) of said-one-of-the-first-computers, via a direct network connection between said first IP address corresponding to said cloud instance of said-one-of-the-first-computers and said second IP address corresponding to said one of the second computers.

18. The method of claim 16, and further comprising the steps of, and wherein:
(a) said requesting, by said-one-of-the-first-computers, to said computing cloud (to publish said Internet application service (of said-one-of-the-first-computers, and provided by a cloud instance of said computing cloud) for use by Internet users at said website of said server) enables said server to publish said Internet application service at said website of said server; and
(a)(i) (said requesting, by said-one-of-the-first-computers, to said-computing-cloud (to publish said-Internet-application-service for use by Internet users at said website of said-server) enables) receiving, at said website and by said server, from one of the second computers a request to join said Internet application service (provided by said cloud instance of said computing cloud and) requested-to-be-published by said-one-of-the-first-computers; and
(a)(ii) (said requesting, by said-one-of-the-first-computers, to said-computing-cloud (to publish said-Internet-application-service for use by Internet users at said website of said-server) enables) receiving, at said website and by said server, from said one of the second computers a second IP address corresponding to said one of the second computers; and further comprising the steps of:
(b). said first IP address (corresponding to a cloud instance created by said computing cloud and providing said Internet application service requested-to-be-published by said-one-of-the-first-computers), received by said server and from said computing cloud, enables said server to send said second IP address (corresponding to said one of the second computers) to said first IP address corresponding to said cloud instance of said-one-of-the-first-computers, (said server) responsive to said server receiving a request from said one of the second computers to join said Internet application service provided by said cloud instance (identified by said first IP address) of said-one-of-the-first-computers; and
said second IP address, received said server at said cloud instance (identified by said first IP address) of said-one-of-the-first-computers), enables it (i.e. said cloud instance (identified by said first IP address)) to connect (using said second IP address corresponding to said one of the second computers) directly to said one of the second computers identified by said second IP address; and
said second IP address enables said cloud instance (identified by said first IP address) of said-one-of-the-first-computers to send data directly to said one of the second computers, and enables said cloud instance (identified by said first IP address) of said-one-of-the-first-computers to receive data directly from said one of the second computers, via a direct network connection between said first IP address corresponding to said cloud instance of said-one-of-the-first-computers and said second IP address corresponding to said one of the second computers.

19. The method of claim 16, further comprising the step of:
said cloud instance (identified by said first IP address) of said-one-of-the-first-computers is communicatively coupled to said-one-of-the-first-computers and to the network; and
said cloud instance (identified by said first IP address) of said-one-of-the-first-computers being communicatively coupled to said-one-of-the-first-computers enables said-one-of-the-first-computers to decouple from the network.

20. The method of claim 16, wherein, and further comprising the steps of;
(i). (said requesting, by said-one-of-the-first-computers, to said computing cloud to publish said Internet application service at said website of said server enables) said server to request said computing cloud to send to said server, a first IP address corresponding to a cloud instance (of said computing cloud and providing said Internet application service) of said-one-of-the-first-computers, which (said server's request) enables said computing cloud to operate:
said-request-by-said-server (to said computing cloud enabling said computing cloud to launch a group of not-less-than-one cloud instance(s)) enables said computing cloud to launch one-(and-only-one) cloud instance (providing said Internet application service, and) of said-one-of-the-first-computers, as:
one-(and-only-one) cloud instance is-(also) one cloud instance, which is-(also) a group of one cloud instance, which is-(also) a group of not-less-than-one cloud instance, and
(ii). said-request-by-said-server to said computing cloud enables said computing cloud to (not-more-than-one)-attempt to connect to each-of-the-“not-less-than-one”-cloud-instance(s) (in said group-of-cloud-instances providing said Internet application service), and to receive (not-more-than-one)-response from each-of-the-said-“not-less-than-one”-cloud-instance(s):
(ii)(a). said-request-by-said-server (to said computing cloud enabling said computing cloud to (not-more-than-one)-attempt to connect to each-of-the-said (not-less-than-one)-cloud-instance(s)) enables said computer cloud to zero-(and-not)-attempt to connect to said-one-(and-only-one)-cloud-instance (providing said Internet application service), as
zero-(and-not)-attempt-to-connect is (also) “zero”-attempt-to-connect, which is (also) (not-more-than-one)-attempt to connect; and
one-(and-only-one)-cloud-instance is (also) one-cloud-instance, which is (also) “not-less-than-one”-cloud-instance.
(ii)(b). (said-request-by-said-server to said computing cloud enabling said computing cloud to receive “not-more-than-one”-response from each-of-the-“not-less-than-one”-said-cloud-instance(s)) enables said computer cloud to receive zero-(and-no)-response from said-one-(and-only-one) cloud-instance, as
receive zero-(and-no)-response is-(also) receive “zero”-response, which is-(also) receive “not-more-than-one”-response; and
one-(and-only-one)-cloud-instance is-(also) one-cloud-instance, which is-(also) “not-less-than-one”-cloud-instance.
(ii)(c) said receiving of zero-(and-no)-response enables (said computing cloud to) create (one)-“virtual”-(zero-“cloud-instance”)-“response” (using software-and-database) (and “virtual”-(zero-“cloud-instance”)-“responses” implementation (by said computing cloud using software-and-database) would be very fast and be fastest-cloud-instances-to-“respond”), as:
“virtual” is digital, and
“virtual”-response is “digital”-response (which is (also) response, and
zero-“cloud-instance” is also cloud-instance (with zero-(virtualized)-hardware), which can be implemented (using software-and-database) with zero-(virtualized)-hardware, and
(ii)(d) (said computing cloud) add-(and-merge) “the-only-(one)-cloud-instance-(and-its-virtualized-hardware)”-(in-above-group-of-cloud-instances launched by said computing cloud above) to the-(one)-virtual-(zero-cloud-instance)-response (created above), and
(ii)(e) (said computing cloud) use-(and-select) the-only-(one)-cloud-instance-(above) (now merged with the (one)-“virtual”-(zero-“cloud-instance”)-“response” as the selected-“fastest”-cloud-instance-(to-“respond”), as:
“virtual”-(zero-“cloud-instance”)-“responses” implementation (by said computing cloud using software-and-database) would be very fast and be fastest-cloud-instances-to-“respond”; and
(iii) said receiving of said request (from said server to said computing cloud enables said computing cloud to select the (not-more-than-one) fastest-cloud-instance-to-respond (to said-computing-cloud's said (not-more-than-one)-attempt(s) to connect to each-of-the-(not-less-than-one)-said-cloud-instance(s)); and further comprising the steps of:
said receiving of said request (from said server to said computing cloud enabling said computing cloud to select the (not-more-than-one) fastest-cloud-instance-to-respond) enables said computing cloud to use-(and-select) the-only-(one)-cloud-instance-(above) (now merged-in-(ii)(d)-above with the (one)-“virtual”-(zero-“cloud-instance”)-“response” as the selected-“fastest”-cloud-instance-(to-“respond”), as
“virtual”-(zero-“cloud-instance”)-“responses” implementation (by said computing cloud using software-and-database) would be very fast and be fastest-cloud-instances-to-“respond”; and
(iv) said receiving of said request (from said server to said computing cloud) enables said computing cloud to use-(and-assign-and-save) IP address of selected-fastest-(not-more-than-one)-cloud-instance-(to-respond) as the IP address (to-be-identified-as the first IP address) of (selected) host computer cloud instance providing said Internet application service (requested by said server and) requested-to-be-published by said-one-of-the-first-computers; and further comprising the steps of:
said receiving (of said request from said server to said computing cloud enabling said computing cloud to assign the first IP address to the said-selected-fastest-cloud-instance-to-respond) enables said computing cloud to use-(and-assign-and-save) IP-address (to-be-identified-as the first IP address) (of said selected-(and-now-merged)-“fastest”-cloud-instance-(to-“respond”) in (iii)) as the IP-address-of-host-computer-cloud-instance.
(v). (said requesting, by said-one-of-the-first-computers, to said computing cloud to publish said Internet application service at said website of said server enables) said server to request said computing cloud to send to said server, a first IP address corresponding to a cloud instance (of said computing cloud and providing said Internet application service) of said-one-of-the-first-computers, which (said server's request) enables said computing cloud to send to said server said first IP address corresponding to (said-selected)-host-computer-cloud-instance providing said Internet application service (requested by said server and) requested-to-be-published by said-one-of-the-first-computers.

21. The method of claim 16, wherein, and further comprising the steps of:
(i). (said requesting, by said-one-of-the-first-computers, to said computing cloud to publish said Internet application service at said website of said server enables) said server to request said computing cloud to send to said server, a first IP address corresponding to a cloud instance (of said computing cloud and providing said Internet application service) of said-one-of-the-first-computers, which (said server's request) enables said computing cloud to operate:
said-request-by-said-server (to said computing cloud enabling said computing cloud to launch a group of not-less-than-one cloud instance(s)) enables said computing cloud to launch (a group of) one-(and-only-one) cloud instance (providing said Internet application service, and) of said-one-of-the-first-computers, as:
one-(and-only-one) cloud instance is-(also) one cloud instance, which is-(also) a group of one cloud instance, which is-(also) a group of not-less-than-one cloud instance; and
(ii). said-request-by-said-server to said computing cloud enables said computing cloud to (not-more-than-one)-attempt to connect to each-of-the-“not-less-than-one”-cloud-instance(s) (in said group-of-cloud-instances providing said Internet application service), and to receive (not-more-than-one)-response from each-of-the-said-“not-less-than-one”-cloud-instance(s):
(ii)(a). said-request-by-said-server (to said computing cloud enabling said computing cloud to (not-more-than-one)-attempt to connect to each-of-the-said (not-less-than-one)-cloud-instance(s)) enables said computer cloud to (one-(and-only-one))-attempt to connect to said-one-(and-only-one)-cloud-instance (providing said Internet application service), as
one-(and-only-one)-attempt is-(also) one-attempt which is-(also) not-more-than-“one”-attempt; and
one-(and-only-one)-cloud-instance is-(also) one-cloud-instance, which is-(also) (each-of-the)-“not-less-than-one”-cloud-instance.
(ii)(b). (said-request-by-said-server to said computing cloud enabling said computing cloud to receive “not-more-than-one”-response from each-of-the-“not-less-than-one”-said-cloud-instance(s)) enables said computer cloud to receive “one-(and-only-one)”-response from said-one-(and-only-one)-cloud-instance, as
receive one-(and-only-one)-response is-(also) receive one-response, which is-(also) receive “not-more-than-one”-response; and
one-(and-only-one)-cloud-instance is-(also) one-cloud-instance, which is-(also) (each-of-the)-“not-less-than-one”-cloud-instance.
(iii) said-request-by-said-server to said computing cloud enables said computing cloud) to select the (not-less-than-one) fastest-cloud-instance-to-respond (to said-computing-cloud's said attempt(s) to connect to said-cloud-instance(s) (in said group-of-cloud-instances providing said Internet application service); and further comprising the steps of:
said-request-by-said-server to said computing cloud enabling said computing cloud to select the (not-less-than-one) fastest-cloud-instance-to-respond enables said computing cloud to select one-(fastest)-cloud-instance-to-respond, as
select “the one”-((fastest)-cloud-instance-to-respond) is-(also) select the-one-cloud-instance-(to-respond), which is-(also) select “not-more-than-one” fastest-cloud-instance-to-respond”.
(iv) said-request-by-said-server to said computing cloud enables said computing cloud to create and assign a first internet protocol (IP) address to the said-selected-(not-less-than-one) fastest-cloud-instance-to-respond (to said-computing-cloud's said attempt(s) to connect to said-cloud-instance(s) (in said group-of-cloud-instances providing said Internet application service requested by said-one-of-the-first-computers); and further comprising the steps of:
said-request-by-said-server to said computing cloud enabling said computing cloud to create and assign a first internet protocol (IP) address to the said-selected-(not-less-than-one) fastest-cloud-instance-to-respond enables said computing cloud to create and assign a first IP address to the selected-one-(fastest)-cloud-instance-(to-respond), as
the (selected)-one-(fastest)-cloud-instance-(to-respond) is-(also) the (selected)-one-cloud-instance-(to-respond), which is-(also) the (selected)-(not-less-than-one) fastest-cloud-instance-to-respond.
(v). (said requesting, by said-one-of-the-first-computers, to said computing cloud to publish said Internet application service at said website of said server enables) said server to request said computing cloud to send to said server, a first IP address corresponding to a cloud instance (of said computing cloud and providing said Internet application service) of said-one-of-the-first-computers, which (said server's request) enables said computing cloud to send to said server said first IP address of said selected-one-(fastest)-cloud-instance-(to-respond).

22. The method of claim 10, wherein, and further comprising the steps of:
(i). receiving, by said computing cloud, said request from said server to send to said server an Internet protocol (IP) address corresponding to (a cloud instance providing) an Internet application service (of said-one-of-the-first-computers) enables said computing cloud to launch a group of not-less-than-one cloud instance(s) providing said Internet application service (requested by said-one-of-the-first-computers); and further comprising the steps of:
said receiving of said request (from said server to said computing cloud enabling said computing cloud to launch a group of not-less-than-one cloud instance(s)) enables said computing cloud to launch (a group of) one-(and-only-one) cloud instance (providing said Internet application service, and) of said-one-of-the-first-computers, as:
(a group of) one-(and-only-one) cloud instance is-(also) one cloud instance, which is-(also) a group of not-less-than-one cloud instance; and
(ii). said receiving of said request (from said server to said computing cloud enabling said computing cloud to launch a group of not-less-than-one cloud instance(s)) enables said computing cloud to (not-more-than-one)-attempt to connect to each-of-the-“not-less-than-one”-cloud-instance(s) (in said group-of-cloud-instances providing said Internet application service), and (enables said computing cloud) to receive (not-more-than-one)-response from each-of-the-said-“not-less-than-one”-cloud-instance(s); and further comprising the steps of:
(ii)(a). said receiving of said request (from said server to said computing cloud enabling said computing cloud to (not-more-than-one)-attempt to connect to each-of-the-said-(not-less-than-one)-cloud-instance(s)) enables said computer cloud to (one-(and-only-one)-attempt to connect to said-one-(and-only-one)-cloud-instance (providing said Internet application service), as
(one-(and-only-one)-attempt-to-connect is-(also) “one”-attempt-to-connect, which is-(also) (not-more-than-one)-attempt to connect; and
one-(and-only-one)-cloud-instance is-(also) one-cloud-instance, which is-(also) (each-of-the)-“not-less-than-one”-cloud-instance; and
(ii)(b). said receiving of said request (from said server to said computing cloud enabling said computing cloud to receive “not-more-than-one”-response from each-of-the-“not-less-than-one”-said-cloud-instance(s)) enables said computer cloud to receive one-(and-only-one)-response from said-one-(and-only-one)-cloud-instance, as
receive one-(and-only-one)-response is-(also) receive one-response, which is-(also) receive “not-more-than-one”-response; and
one-(and-only-one)-cloud-instance is-(also) one-cloud-instance, which is-(also) (each-of-the)-“not-less-than-one”-cloud-instance; and
(iii) said receiving of said request (from said server to said computing cloud enabling said computing cloud to receive “not-more-than-one”-response from each-of-the-“not-less-than-one”-said-cloud-instance(s)) enables said computing cloud to select the (not-less-than-one) fastest-cloud-instance-to-respond (to said-computing-cloud's said attempt(s) to connect to said-cloud-instance(s) (in said group-of-cloud-instances providing said Internet application service); and further comprising the step of:
said receiving of said request (from said server to said computing cloud enabling said computing cloud to select the (not-less-than-one) fastest-cloud-instance-to-respond) enables said computing cloud to select the on-(fastest)-cloud-instance-to-respond, as
select “the one”-(fastest)-cloud-instance-to-respond is-(also) select the-one-cloud-instance-(to-respond), which is-(also) select “not-more-than-one” fastest-cloud-instance-to-respond”; and
(iv) said receiving of said request (from said server to said computing cloud) enables said computing cloud to create and assign a first IP address to the said-selected-(not-less-than-one) fastest-cloud-instance-to-respond (to said-computing-cloud's said attempt(s) to connect to said-cloud-instance(s) (in said group-of-cloud-instances providing said Internet application service requested by said-one-of-the-first-computers); and further comprising the steps of:
said receiving (of said request from said server to said computing cloud enabling said computing cloud to create and assign a first IP address to the said-selected-(not-less-than-one) fastest-cloud-instance-to-respond enables said computing cloud to create and assign a first IP address to the selected-one-(fastest)-cloud-instance-(to-respond), as:
the (selected)-one-(fastest)-cloud-instance-(to-respond) is-(also) the (selected)-one-cloud-instance-(to-respond), which is-(also) the (selected)-(not-less-than-one) fastest-cloud-instance-to-respond, and
(v) said request by said server (to said computing cloud to send to said server, a first IP address corresponding to a cloud instance (of said computing cloud and providing said Internet application service) of said-one-of-the-first-computers) enables said computing cloud to send to said server said first IP address of said (selected)-one-(fastest)-cloud-instance-(to-respond).
